(19) United States
(12) Patent Application Publication
(10) Pub. No.: US 2026/0050423 A1
(43) Pub. Date: Feb. 19, 2026

(54) Code Enhancement System and Method Using Artificial Intelligence

(71) Applicant: Turing Intelligence Technology Limited, London (GB)

(72) Inventors: Leslie Kanthan, West Wickham (GB); Michail Basios, London (GB)

(73) Assignee: Turing Intelligence Technology Limited, London (GB)

(21) Appl. No.: 19/299,938

(22) Filed: Aug. 14, 2025

Related U.S. Application Data
(60) Provisional application No. 63/684,740, filed on Aug. 19, 2024.

(51) Int. Cl. G06F 8/35; G06F 8/34; G06F 8/36

(52) U.S. Cl. CPC G06F 8/35; G06F 8/34; G06F 8/36

(57) ABSTRACT

A method for enhancing software code includes sectioning, by one or more artificial intelligence (AI) sectioning tools, to produce one or more versions of AI sectioned code. The method further includes enhancing, by one or more AI code enhancing tools, the one or more versions of AI sectioned code to produce a plurality of versions of AI enhanced codes. The method further includes evaluating, by one or more AI evaluation tools, the plurality of versions of AI enhanced codes to produce one or more evaluated AI enhanced codes. The method further includes evaluating, by one or more trusted evaluation tools, the one or more evaluated AI enhanced codes to produce a final version of enhanced code.

### CROSS-REFERENCE TO RELATED APPLICATIONS

The present U.S. Utility Patent Application claims priority pursuant to 35 U.S.C. § 119(e) to U.S. Provisional Application No. 63/684,740, entitled “Code Enhancement System and Method Using Artificial Intelligence”, filed Aug. 19, 2024, which is hereby incorporated herein by reference in its entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF INVENTION

### Technical Field of Invention

The disclosed subject matter relates to data, computing, and/or communication networks, components thereof, and the software of such networks and/or components thereof; more particularly, the disclosed subject matter relates to enhancing software one or more such networks and/or one or more components thereof.

### Description of Related Art

Computers, cell phones, tablets, servers, etc., have similar core hardware and software architectures. Such devices vary, to a degree, based on user applications, size, processing capabilities, and/or storage capabilities. For example, a cell phone includes user applications for video capture, image capture, audio recording, audio playback, notes, etc. and is designed to fit into a human hand. A tablet can include similar user applications but is designed to have a display area that is several multiples of the display area of a cell phone.

In addition, computers, cell phones, tablets, servers, etc. can be used as a stand-alone device or they can be coupled to a network. For example, each type of device may be coupled to the internet, a local area network, a wide area network, etc., to send and/or receive data with another device coupled to the network.

All such devices rely on software to perform their user functions, to perform the functions of an operating system, to perform utility applications, to perform system applications, etc. As such devices evolve, their software needs to keep up. In particular, new software needs to be created and existing software needs to be updated, upgraded, and/or replaced. U.S. Pat. Nos. 8,972,928 and 11,029,934 discuss ways to update, upgrade, replace, and/or create software.

### BRIEF DESCRIPTION OF THE SEVERAL VIEWS OF THE DRAWING(S)

FIG. 1 is a schematic block diagram of an embodiment of a data, computing, and/or communication network;

FIGS. 2A through 2E are schematic block diagrams of various embodiments of a computing entity;

FIGS. 3A through 3G are schematic block diagrams of various embodiments of a computing devices;

FIG. 4 is a schematic block diagram of an embodiment of a database;

FIG. 5 is a schematic block diagram of an embodiment of an analysis computing entity;

FIG. 6 is a schematic block diagram of an example of enhancing existing code;

FIG. 7 is a schematic block diagram of an example of enhancing new code;

FIG. 8A is a schematic block diagram of an embodiment of a code enhancement system;

FIG. 8B is a schematic block diagram of another embodiment of a code enhancement system;

FIG. 8C is a schematic block diagram of an example of trusted tools and AI tools;

FIG. 8D is a schematic block diagram of an example of purpose parameters and operation parameters;

FIG. 9 is a schematic block diagram of another embodiment of a code enhancement system;

FIG. 10 is a schematic block diagram of another embodiment of a code enhancement system;

FIG. 11 is a schematic block diagram of another embodiment of a code enhancement system;

FIGS. 12A-12C are a logic diagram of an embodiment of a method for enhancing code;

FIG. 13 is a logic diagram of an embodiment of another method for enhancing code;

FIG. 14 is a logic diagram of an embodiment of another method for enhancing code;

FIG. 15A is a schematic block diagram of an example of code enhancing;

FIG. 15B is a schematic block diagram of another example of code enhancing;

FIG. 16 is a schematic block diagram of another example of code enhancing;

FIG. 17 is a schematic block diagram of another example of code enhancing;

FIG. 18 is a schematic block diagram of another example of code enhancing;

FIG. 19 is a schematic block diagram of another example of code enhancing;

FIG. 20 is a schematic block diagram of an embodiment of an enhanced code evaluation module and enhanced code scoring module;

FIG. 21 is a schematic block diagram of another example of code enhancing;

FIG. 22 is a schematic block diagram of another example of code enhancing;

FIG. 23 is a schematic block diagram of an example of a table of artificial intelligence (AI) tools;

FIG. 24 is a schematic block diagram of an example of a table regarding an artificial intelligence (AI) tool;

FIG. 25 is a schematic block diagram of an example of a table of trusted tools;

FIG. 26 is a schematic block diagram of an example of a table regarding trusted tool;

FIG. 27 is a schematic block diagram of an example of a providing a list of projects and selection of a project;

FIG. 28A is a schematic block diagram of an example of a selecting parameters for a particular project;

FIG. 28B is a schematic block diagram of another example of a selecting parameters for a particular project;

FIG. 29 is a schematic block diagram of an example of operation of a code sectioning module and corresponding components of the code enhancement system;

FIGS. 30A-30C are a logic diagram of an embodiment of a method for sectioning code;

FIG. 31 is a schematic block diagram of an example of a table of AI code sectioning tools;

FIGS. 32A and 32B are a schematic block diagram of an example of a table regarding an AI code sectioning tool;

FIG. 33 is a schematic block diagram of an example of a table of trusted code sectioning tools;

FIGS. 34A and 34B are a schematic block diagram of an example of a table regarding a trusted code sectioning tool;

FIG. 35 is a schematic block diagram of an example of obtaining code for sectioning and obtaining information regarding the sectioning;

FIGS. 36A-36E are schematic block diagrams of an example of selecting tools for sectioning code;

FIG. 37 is a schematic block diagram of an example of obtaining code for selecting one or more sectioned codes;

FIG. 38 is a schematic block diagram of an example of evaluating one or more selected sectioned codes;

FIG. 39 is a schematic block diagram of another example of evaluating one or more selected sectioned codes;

FIG. 40 is a schematic block diagram of another example of evaluating one or more selected sectioned codes;

FIG. 41 is a schematic block diagram of an example of selecting one or more new tools for sectioning code;

FIG. 42 is a schematic block diagram of an example of determining whether to re-section at least a portion of code;

FIG. 43 is a schematic block diagram of another example of evaluating one or more sectioned codes;

FIGS. 44A-44D are a logic diagram of an embodiment of a method for enhancing sectioned code;

FIGS. 45A-45D are diagrams of examples of ordering code enhancing categories for enhancing code;

FIG. 46 is a logic diagram of an embodiment of a method for using ordered categories to enhance sectioned code;

FIG. 47 is a schematic block diagram of an example of a table of AI refactoring tools;

FIGS. 48A and 48B are a schematic block diagram of an example of a table regarding an AI refactoring tool;

FIG. 49 is a schematic block diagram of an example of a table of AI optimizing tools;

FIGS. 50A and 50B are a schematic block diagram of an example of a table regarding an AI optimizing tool;

FIGS. 51A and 51B are schematic block diagrams of an example of a table of AI accelerating tools;

FIGS. 52A-52D are a schematic block diagram of an example of a table regarding an AI accelerating tool;

FIG. 53 is a schematic block diagram of an example of a table of AI simulating tools;

FIGS. 54A and 54B are a schematic block diagram of an example of a table regarding an AI simulating tool;

FIG. 55 is a schematic block diagram of an example of a table of AI migrating tools;

FIGS. 56A and 56B are a schematic block diagram of an example of a table regarding an AI migrating tool;

FIG. 57 is a schematic block diagram of an example of a table of AI translating tools;

FIGS. 58A and 58B are a schematic block diagram of an example of a table regarding an AI translating tool;

FIG. 59 is a schematic block diagram of an example of a table of AI code generating tools;

FIGS. 60A and 60B are a schematic block diagram of an example of a table regarding an AI code generating tool;

FIG. 61 is a schematic block diagram of an example of receiving sectioned code and corresponding code information;

FIG. 62 is a schematic block diagram of an example of obtaining enhancement parameters;

FIG. 63A is a schematic block diagram of an example of performing code analysis;

FIG. 63B is a schematic block diagram of another example of performing code analysis;

FIG. 63C is a schematic block diagram of an example of scoring code snippets;

FIG. 64 is a schematic block diagram of an example of performing code analysis on nested and/or grouped code sections;

FIG. 65A is a schematic block diagram of an example of identifying tools for enhancement;

FIG. 65B is a schematic block diagram of another example of identifying tools for enhancement;

FIG. 65C is a schematic block diagram of another example of scoring enhanced code;

FIG. 65D is a schematic block diagram of another example of scoring enhanced code;

FIG. 66 is a schematic block diagram of an example of listing refactoring tools;

FIG. 67 is a schematic block diagram of an example of listing optimizing tools;

FIG. 68 is a schematic block diagram of an example of listing accelerating tools;

FIG. 69 is a schematic block diagram of an example of listing translating tools;

FIG. 70 is a schematic block diagram of an example of listing migrating tools;

FIG. 71 is a schematic block diagram of an example of listing code generating tools;

FIG. 72 is a schematic block diagram of an example of listing simulating tools;

FIGS. 73A-73J are schematic block diagram of an example of selecting tools for enhancing sectioned code;

FIG. 74 is a schematic block diagram of an example of an optimization page with various enhanced code versions;

FIG. 75 is a schematic block diagram of an example of an optimized enhanced code version;

FIG. 76 is a schematic block diagram of an example of a comparison of an optimized enhanced code version with the original code version;

FIG. 77 is a schematic block diagram of an example of an optimization comparison with multiple runs of an enhanced code version;

FIG. 78 is a schematic block diagram of an example of a comparison of an optimized enhanced code version with respect to green metrics;

FIG. 79 is a schematic block diagram of an example of an optimization log of enhancing code;

FIGS. 80A-80C are a logic diagram of an embodiment of a method for refactoring code;

FIGS. 81A-81C are a logic diagram of an embodiment of a method for optimizing code;

FIGS. 82A-82C are a logic diagram of an embodiment of a method for accelerating code;

FIGS. 83A-83C are a logic diagram of an embodiment of a method for translating code;

FIGS. 84A-84C are a logic diagram of an embodiment of a method for migrating code;

FIGS. 85A-85C are a logic diagram of an embodiment of a method for code generation; and

FIGS. 86A-86C are a logic diagram of an embodiment of a method for simulating code.

### DETAILED DESCRIPTION OF INVENTION

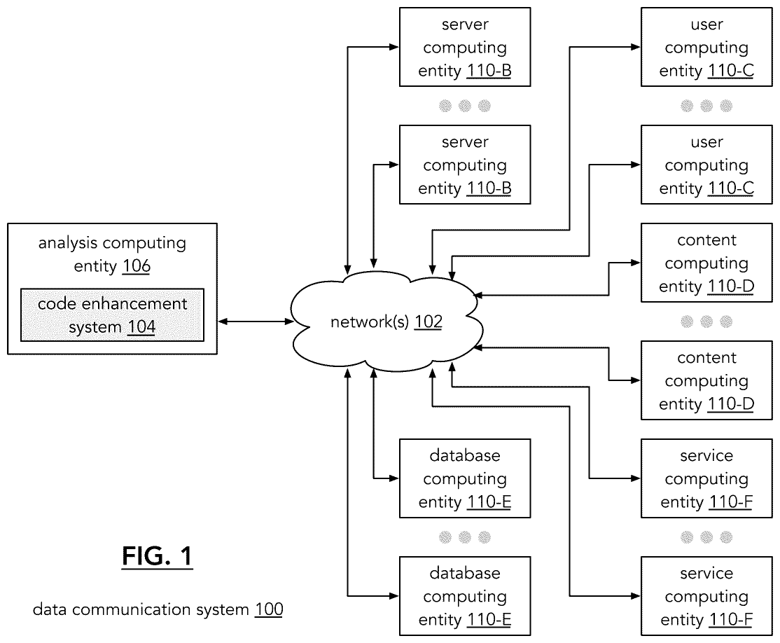

FIG. 1 is a schematic block diagram of an embodiment of a data communication system 100, which includes one or more networks 102, an analysis computing entity 106, and a plurality of computing entities 110. The network(s) 14 includes the internet, a cellular network, one or more wide area networks (WAN), one or more local area networks (LAN), one or more wireless LANs (WLAN), one or more cellular networks, one or more satellite networks, one or more virtual private networks (VPN), one or more campus area networks (CAN), one or more metropolitan area networks (MAN), one or more storage area networks (SAN), one or more enterprise private networks (EPN), and/or one or more other type of networks.

A network includes networking equipment, such as routers, switches, edge devices, wireless access points, and other types of communication devices that intercouple in a wired or wireless fashion. The networking equipment facilitates the creation of one or more networks that are tasked to service all or a portion of a company's communication needs, e.g., Wide Area Networks, Local Area Networks, Virtual Private Networks, etc. Each networking equipment includes hardware and associated software to perform its respective functions.

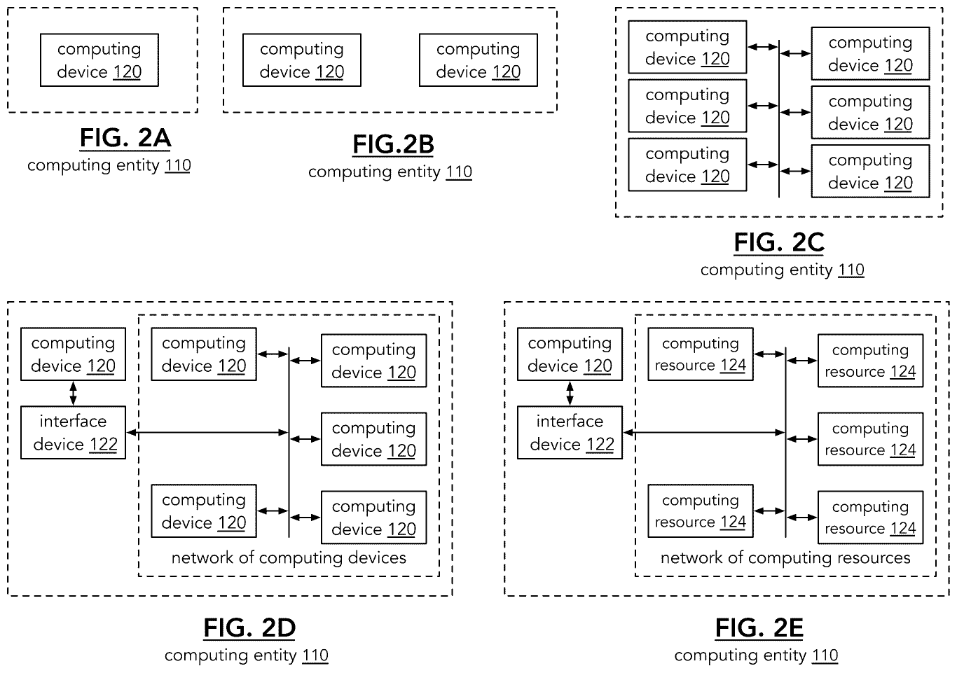

Each computing entity 106 and 110, which will be described in further detail with reference to FIGS. 2A-2E, includes hardware and software to interpret, process, store, manipulate, edit, etc. data. As used herein, data is the digital representation of anything that can be expressed in digital form. In this instance, anything literally means anything, from numbers, to letters, to alphanumerical characters, to biological functions, to cells of living organisms, to visual content, to audio content, to light, to sound, and so on.

While each computing entity 106 and 110 generally includes hardware and software, a computing entity will include particular types of hardware and/or software based on a primary function of the computing entity. As shown in FIG. 1, which is far from an exhaustive list of computing entity functions, computing entity 106 functions as an analysis computing entity; computing entities 110-B function as servers, computing entities 110-C function as user computing entities (e.g., cell phones, tablets, laptop computers personal computers, etc.); computing entities 110-D function as content provider devices (e.g., video content distribution, audio content distribution, video and/or audio broadcast, etc.); computing entities 110-E function as databases; and computing entities 110-F function as service computing entities (e.g., software as a service, computing as a service, storage as a service, etc.).

The analysis computing entity 106 includes a code enhancement system 104 that functions to enhance the software of the other computing entities and of the network equipment. The code enhancement system 104 uses intelligent software to enhance software based on inputted parameters, where intelligent software includes software that performs one or more of artificial intelligence (AI), machine learning (ML), data processing, data storage, data analysis, etc.

As used herein, the word “software” includes software, applications, computer programs, programs, sub-routines, etc. Software is written using one or more programming languages to produce a particular type of software such as an operating system, firmware, word processing, spreadsheet, presentation, internet browser, graphics design tool, video editing tool, audio editing tool, video capture, audio capture, database, database management, an application programming interface (API), security, biometric identification, etc.

There are a plethora of programming languages that can be used to write software. A few include (some of which may be trademarked) Python, JavaScript, Java, C++, C#, Ruby, Hypertext Preprocessor (PHP), Swift, Kotlin, Go, TypeScript, Rust, R, MATLAB, Perl, Objective-C, Scala, Lua, Haskell, and Dart. Each programming language includes its own set of operational codes, which generally include: add, subtract, multiply, divide, move data, push onto a stack, pop from a stack, load data from memory, store data to memory, compare, jump to address, jump if equal, jump if not equal, jump if greater than, jump if less than, call procedure, return from procedure, no operation, logical AND, logical OR, logical XOR, logical NOT, shift left, shift right, increment, decrement, interrupt, halt, etc. As used herein, “code” refers to, but is not limited to, one or more lines of code of software, where software includes a computer algorithm, fixes thereto, versions thereof, updates thereto, upgrades thereto; where software also includes a computer program, fixes thereto, versions thereof, updates thereto, upgrades thereto; and/or where software further includes an application, fixes thereto, versions thereof, updates thereto, upgrades thereto. A line of code includes one or more of an operational code, a comment, inline documentation, naming, etc.

To write reliable software, programmers follow a generally accepted practice, which includes meaningful naming, consistent formatting, code comments, modular design, single response principle, separation of concerns, don't repeat, keep it simple, only include necessary functionality, straightforward error handling and messaging, exception management, unit test, integration testing, adequate test coverage, version control, inline documentation, external documentation, code annotations, code review, input validation, secure code guidelines, data protection, refactoring, consistency of style, profiling, benchmarking, resource management, use of tools to assist with programming (i.e., coding) software, etc.

Given the size of applications, the edits to them, the newer versions of them, and the number of people involved, it is common for efficiency of such applications to be less than optimal and for the efficiency to further degrade overtime. Such software inefficiency is costly. In a study by Evans Data Corp., it is estimated that 17.3 hours per week is consumed due to bad code at a global cost of $85 Billion. Further, inefficient software negatively impacts its scalability and sustainability by up to 50%. Still further, inefficient software adversely impacts a business' ROI.

Inefficient software consumes up to 40% more energy than efficient software. One of the top concerns of future data processing is power consumption. As the rate of data storage and data processing increases each year, which is increasing more rapidly due to the AI boom, powering computing devices is going to be the limiting factor in the near future, not hardware limitations or data bandwidth limitations.

As described below, the code enhancement system 104 running on the analysis computing entity 106 improves the efficiency of software in a reliable and trustworthy manner. The code enhancement system 104 utilizes intelligent software to select AI and/or ML code enhancing tools in light of inputted efficiency parameters to generate a multitude of versions of enhanced code (e.g., enhanced software). Since AI tools have the tendency to hallucinate (i.e., produce incorrect answers), the intelligent software of the code enhancement system 104 further generates a version of enhanced code using a set of trusted tools (where a set includes one or more) to test the multitude of AI and/or ML versions of the enhanced code to yield an optimally enhanced code that complies with the inputted parameters.

As new enhancing tools become available, as existing enhancing tools evolve (e.g., bug fixes, new versions, new features, improve performance etc.) as the inputted parameters changes, as software changes, the code enhancement system 104 can continually enhance software. As such, enhancing software is an on-going and dynamic process for which the intelligent software of the code enhancement system 104 is uniquely adept at handling.

While the code enhancement system 104 is shown to be included in the analysis computing entity 106, any of the other computing entities could include its own copy of the code enhancement system. For example, each of computing entity 110 includes its own code enhancement system to keep its software as efficient as possible in light of the inputting parameters. In this scenario, the analysis computing entity 106 maintains a master version of the code enhancement system 104 and updates the other computing entities as the code enhancement system 104 itself evolves.

FIGS. 2A through 2E are schematic block diagrams of various embodiments of a computing entity. Regardless of the particular embodiment of a computing entity, one or more computing entities are configurable to provide a neural network that includes an input layer, one or more intermediate layers, and an output layer. A neural network may be implemented in a variety of ways. As a few examples, a neural network is configured as a feedforward neural network; a neural network is configured as a convolutional neural network; a neural network is configured as a recurrent neural network; and a neural network is configured as a generative adversarial neural network. Such neural networks have a variety of applications, which include image and voice recognition, natural language processing, large language modeling (LLM), executing AI functions, executing NIL functions, speech recognition, recommender systems, and video gaming.

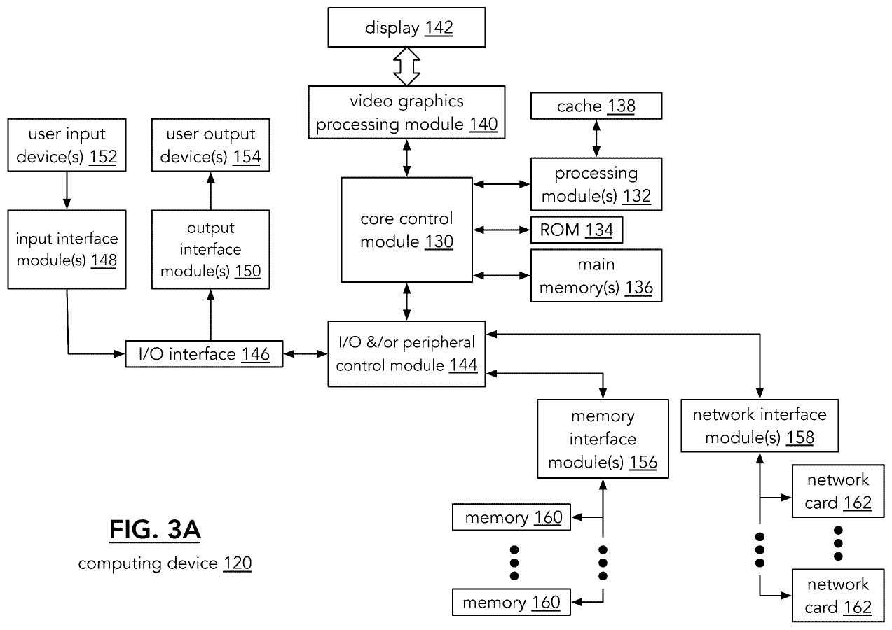

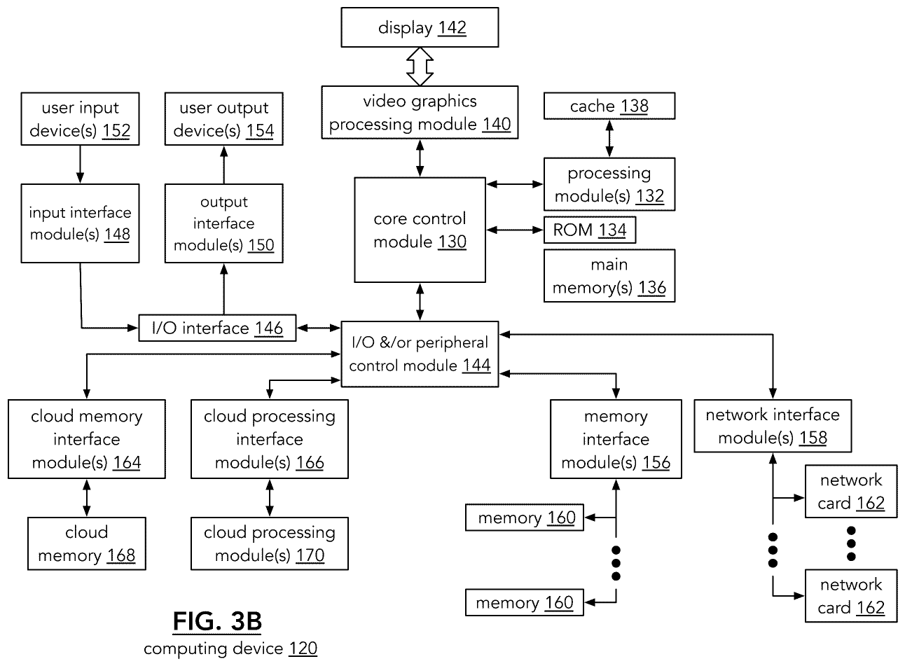

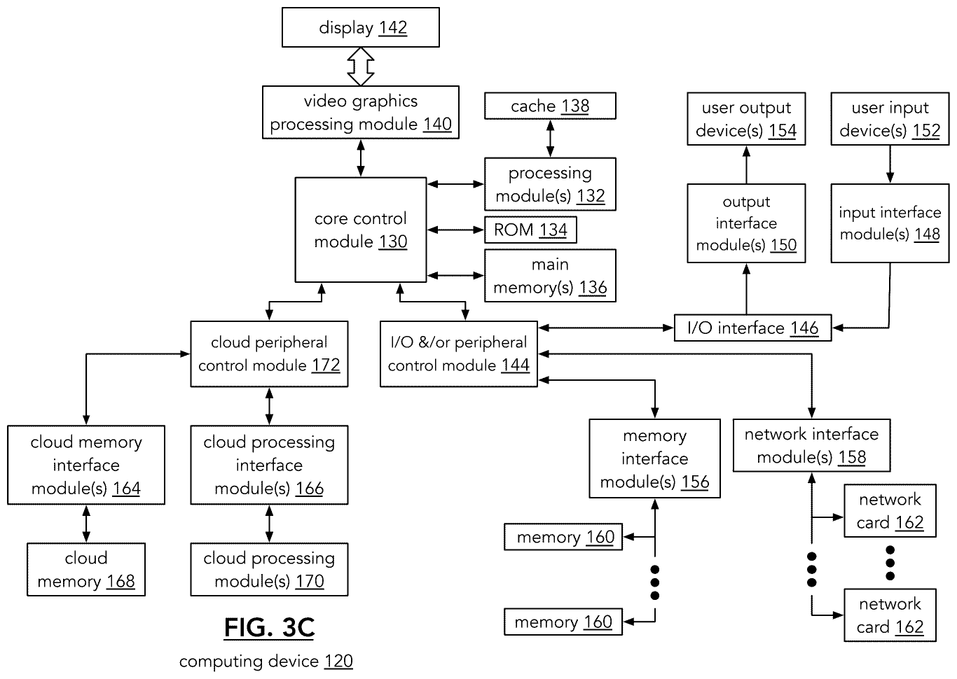

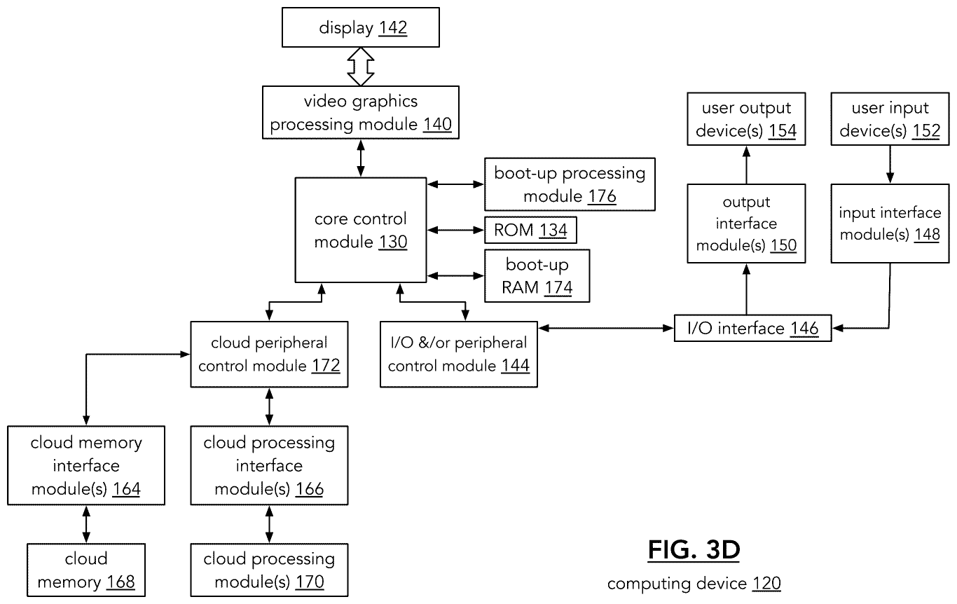

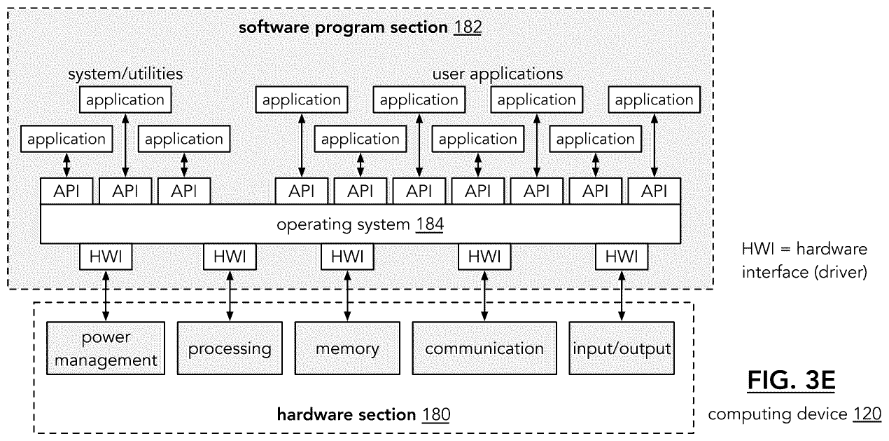

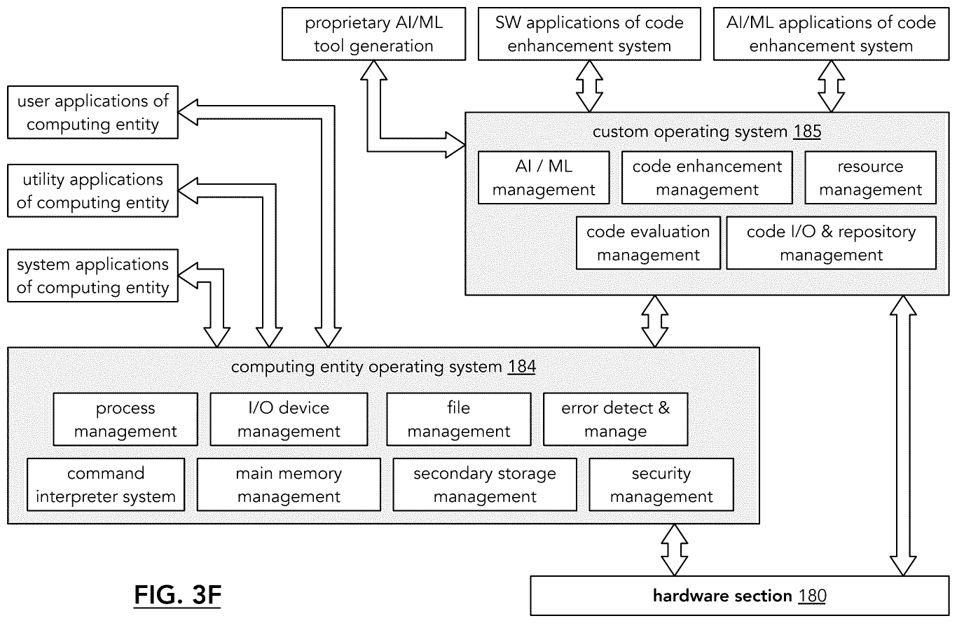

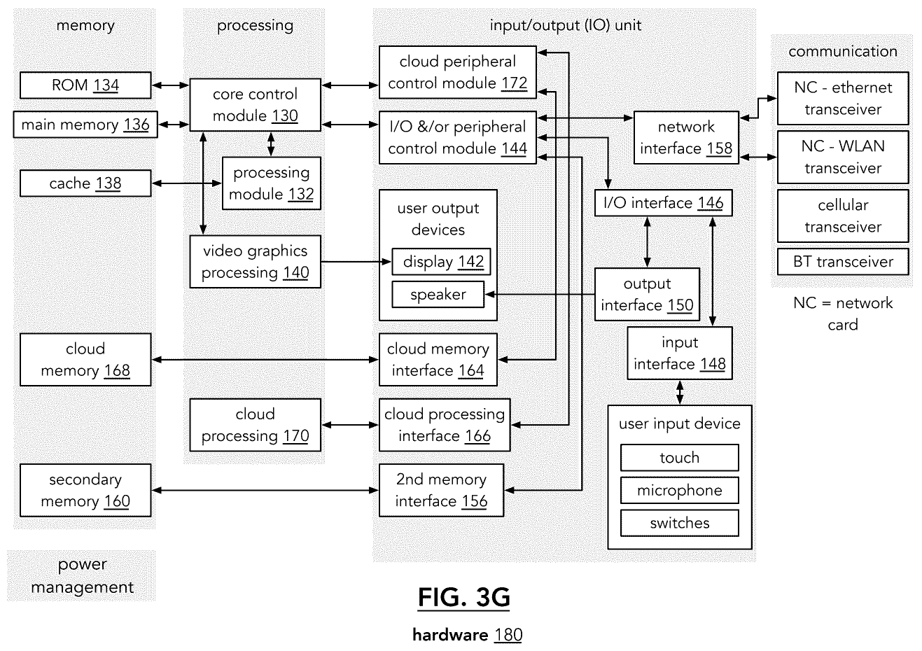

FIG. 2A is schematic block diagram of an embodiment of a computing entity 110 that includes a computing device 120 (e.g., one or more of the embodiments of FIGS. 3A-3G). A computing device may function as a user computing device, a server, a system computing device, a data storage device, a data security device, a networking device, a user access device, a cell phone, a tablet, a laptop, a printer, a game console, a satellite control box, a cable box, etc.

FIG. 2B is schematic block diagram of an embodiment of a computing entity 110 that includes two or more computing devices 120 (e.g., two or more from any combination of the embodiments of FIGS. 3A-3G). The computing devices 120 perform the functions of a computing entity in a peer processing manner (e.g., coordinate together to perform the functions), in a master-slave manner (e.g., one computing device coordinates and the other supports it), and/or in another manner.

FIG. 2C is schematic block diagram of an embodiment of a computing entity 110 that includes a network of computing devices 120 (e.g., two or more from any combination of the embodiments of FIGS. 3A-3G). The computing devices are coupled together via one or more network connections (e.g., WAN, LAN, cellular data, WLAN, etc.) and perform the functions of the computing entity.

FIG. 2D is schematic block diagram of an embodiment of a computing entity 110 that includes a primary computing device (e.g., any one of the computing devices of FIGS. 3A-3G), an interface device (e.g., a network connection), and a network of computing devices 120 (e.g., one or more from any combination of the embodiments of FIGS. 3A-3G). The primary computing device utilizes the other computing devices as co-processors to execute one or more the functions of the computing entity, as storage for data, for other data processing functions, and/or storage purposes.

FIG. 2E is schematic block diagram of an embodiment of a computing entity 110 that includes a primary computing device (e.g., any one of the computing devices of FIGS. 3A-3G), an interface device (e.g., a network connection) 122, and a network of computing resources 124 (e.g., two or more resources from any combination of the embodiments of FIGS. 3A-3G). The primary computing device utilizes the computing resources as co-processors to execute one or more the functions of the computing entity, as storage for data, for other data processing functions, and/or storage purposes.

FIGS. 3A through 3G are schematic block diagrams of various embodiments of a computing device. FIG. 3A is a schematic block diagram of an embodiment of a computing device 120 that includes a plurality of computing resources. The computing resources, which form a computing core, include one or more core control modules 130, one or more processing modules 132, one or more main memories 136, a read only memory (ROM) 134 for a boot up sequence, cache memory 138, one or more video graphics processing modules 140, one or more displays 142 (optional), an Input-Output (I/O) peripheral control module 144, an I/O interface module 146 (which could be omitted if direct connect IO is implemented), one or more input interface modules 148, one or more output interface modules 150, one or more network interface modules 158, and one or more memory interface modules 156.

A processing module 132 is described in greater detail at the end of the detailed description section and, in an alternative embodiment, has a direction connection to the main memory 136. In an alternate embodiment, the core control module 130 and the I/O and/or peripheral control module 144 are one module, such as a chipset, a quick path interconnect (QPI), and/or an ultra-path interconnect (UPI).

The processing module 132, the core module 130, and/or the video graphics processing module 140 form a processing core for a computer computing. Additional combinations of processing modules 132, core modules 130, and/or video graphics processing modules 140 form co-processors for the improved computer for technology. Computing resources 124 of FIG. 2E include one more of the components shown in this Figure and/or in or more of FIGS. 3B through 3G.

Each of the main memories 136 includes one or more Random Access Memory (RAM) integrated circuits, or chips. In general, the main memory 136 stores data and operational instructions most relevant for the processing module 132. For example, the core control module 130 coordinates the transfer of data and/or operational instructions between the main memory 136 and the secondary memory device(s) 160. The data and/or operational instructions retrieve from secondary memory 160 are the data and/or operational instructions requested by the processing module or will most likely be needed by the processing module. When the processing module is done with the data and/or operational instructions in main memory, the core control module 130 coordinates sending updated data to the secondary memory 160 for storage.

The secondary memory 160 includes one or more hard drives, one or more solid state memory chips, and/or one or more other large capacity storage devices that, in comparison to cache memory and main memory devices, is/are relatively inexpensive with respect to cost per amount of data stored. The secondary memory 160 is coupled to the core control module 130 via the I/O and/or peripheral control module 144 and via one or more memory interface modules 156. In an embodiment, the I/O and/or peripheral control module 144 includes one or more Peripheral Component Interface (PCI) buses to which peripheral components connect to the core control module 130. A memory interface module 156 includes a software driver and a hardware connector for coupling a memory device to the I/O and/or peripheral control module 144. For example, a memory interface 156 is in accordance with a Serial Advanced Technology Attachment (SATA) port.

The core control module 130 coordinates data communications between the processing module(s) 132 and network(s) via the I/O and/or peripheral control module 144, the network interface module(s) 158, and one or more network cards 162. A network card 160 includes a wireless communication unit or a wired communication unit. For example, a wireless communication unit includes a wireless local area network (WLAN) communication device, a cellular communication device, a Bluetooth device, and/or a ZigBee communication device. For example, a wired communication unit includes a Gigabit LAN connection, a Firewire connection, and/or a proprietary computer wired connection. A network interface module 158 includes a software driver and a hardware connector for coupling the network card to the I/O and/or peripheral control module 144. For example, the network interface module 158 is in accordance with one or more versions of IEEE 802.11, cellular telephone protocols, 10/100/1000 Gigabit LAN protocols, etc.

The core control module 130 coordinates data communications between the processing module(s) 132 and input device(s) 152 via the input interface module(s) 148, the I/O interface 146, and the I/O and/or peripheral control module 144. An input device 152 includes a keypad, a keyboard, control switches, a touchpad, a microphone, a camera, etc. An input interface module 148 includes a software driver and a hardware connector for coupling an input device to the I/O and/or peripheral control module 144. In an embodiment, an input interface module 148 is in accordance with one or more Universal Serial Bus (USB) protocols.

The core control module 130 coordinates data communications between the processing module(s) 132 and output device(s) 154 via the output interface module(s) 150 and the I/O and/or peripheral control module 144. An output device 154 includes a speaker, auxiliary memory, headphones, etc. An output interface module 150 includes a software driver and a hardware connector for coupling an output device to the I/O and/or peripheral control module 144. In an embodiment, an output interface module 150 is in accordance with one or more audio codec protocols.

The processing module 132 communicates directly with a video graphics processing module 140 to display data on the display 142. The display 142 includes an LED (light emitting diode) display, an LCD (liquid crystal display), and/or other type of display technology. The display has a resolution, an aspect ratio, and other features that affect the quality of the display. The video graphics processing module 140 receives data from the processing module 132, processes the data to produce rendered data in accordance with the characteristics of the display, and provides the rendered data to the display 142.

FIG. 3B is a schematic block diagram of an embodiment of a computing device 120 that includes a plurality of computing resources similar to the computing resources of FIG. 3A with the addition of one or more cloud memory interface modules 164, one or more cloud processing interface modules 166, cloud memory 168, and one or more cloud processing modules 170. The cloud memory 168 includes one or more tiers of memory (e.g., ROM, volatile (RAM, main, etc.), non-volatile (hard drive, solid-state, etc.) and/or backup (hard drive, tape, etc.)) that is remoted from the core control module and is accessed via a network (WAN and/or LAN). The cloud processing module 170 is similar to processing module 132 but is remoted from the core control module and is accessed via a network.

FIG. 3C is a schematic block diagram of an embodiment of a computing device 120 that includes a plurality of computing resources similar to the computing resources of FIG. 3B with a change in how the cloud memory interface module(s) 164 and the cloud processing interface module(s) 166 are coupled to the core control module 130. In this embodiment, the interface modules 164 and 166 are coupled to a cloud peripheral control module 172 that directly couples to the core control module 130.

FIG. 3D is a schematic block diagram of an embodiment of a computing device 120 that includes a plurality of computing resources, which includes include a core control module 130, a boot up processing module 176, boot up RAM 174, a read only memory (ROM) 134, a one or more video graphics processing modules 140, one or more displays 48 (optional), an Input-Output (I/O) peripheral control module 144, one or more input interface modules 148, one or more output interface modules 150, one or more cloud memory interface modules 164, one or more cloud processing interface modules 166, cloud memory 168, and cloud processing module(s) 170.

In this embodiment, the computing device 120 includes enough processing resources (e.g., module 176, ROM 134, and RAM 174) to boot up. Once booted up, the cloud memory 168 and the cloud processing module(s) 170 function as the computing device's memory (e.g., main and hard drive) and processing module.

FIG. 3E is a schematic block diagram of another embodiment of a computing device 120 that includes a hardware section 180 and a software program section 182. The hardware section 180 includes the hardware functions of power management, processing, memory, communications, and input/output. FIG. 3G illustrates the hardware section 180 in greater detail.

The software program section 182 includes an operating system 184, system and/or utilities applications, and user applications. The software program section further includes APIs and HWIs. APIs (application programming interface) are the interfaces between the system and/or utilities applications and the operating system and the interfaces between the user applications and the operating system 184. HWIs (hardware interface) are the interfaces between the hardware components and the operating system. For some hardware components, the HWI is a software driver. The functions of the operating system 184 are discussed in greater detail with reference to FIG. 3F.

FIG. 3F is a diagram of an example of the functions of the operating system of a computing device 120, which includes a computing entity (CE) operating system 184 and a custom operating system 185. In general, the operating system 184 functions to identify and route input data to the right places within the computer and to identify and route output data to the right places within the computer. Input data is with respect to the processing module and includes data received from the input devices, data retrieved from main memory, data retrieved from secondary memory, and/or data received via a network card. Output data is with respect to the processing module and includes data to be written into main memory, data to be written into secondary memory, data to be displayed via the display and/or an output device, and data to be communicated via a network care.

The operating system 184 includes the OS functions of process management, command interpreter system, I/O device management, main memory management, file management, secondary storage management, error detection & correction management, and security management. The process management OS function manages processes of the software section operating on the hardware section, where a process is a program or portion thereof.

The process management OS function includes a plurality of specific functions to manage the interaction of software and hardware. The specific functions include:
load a process for execution;
enable at least partial execution of a process;
suspend execution of a process;
resume execution of a process;
terminate execution of a process;
load operational instructions and/or data into main memory for a process;
provide communication between two or more active processes;
avoid deadlock of a process and/or interdependent processes; and
control access to shared hardware components.

The I/O Device Management OS function coordinates translation of input data into programming language data and/or into machine language data used by the hardware components and translation of machine language data and/or programming language data into output data. Typically, input devices and/or output devices have an associated driver that provides at least a portion of the data translation. For example, a microphone captures analog audible signals and converts them into digital audio signals per an audio encoding format. An audio input driver converts, if needed, the digital audio signals into a format that is readily usable by a hardware component.

The File Management OS function coordinates the storage and retrieval of data as files in a file directory system, which is stored in memory of the computing device. In general, the file management OS function includes the specific functions of:
File creation, editing, deletion, and/or archiving;
Directory creation, editing, deletion, and/or archiving;
Memory mapping files and/or directors to memory locations of secondary memory; and
Backing up of files and/or directories.

The Network Management OS function manages access to a network by the computing device. Network management includes
Network fault analysis;
Network maintenance for quality of service;
Network access control among multiple clients; and
Network security upkeep.

The Main Memory Management OS function manages access to the main memory of a computing device. This includes keeping track of memory space usage and which processes are using it; allocating available memory space to requesting processes; and deallocating memory space from terminated processes.

The Secondary Storage Management OS function manages access to the secondary memory of a computing device. This includes free memory space management, storage allocation, disk scheduling, and memory defragmentation.

The Security Management OS function protects the computing device from internal and external issues that could adversely affect the operations of the computing device. With respect to internal issues, the OS function ensures that processes negligibly interfere with each other; ensures that processes are accessing the appropriate hardware components, the appropriate files, etc.; and ensures that processes execute within appropriate memory spaces (e.g., user memory space for user applications, system memory space for system applications, etc.).

The security management OS function also protects the computing device from external issues, such as, but not limited to, hack attempts, phishing attacks, denial of service attacks, bait and switch attacks, cookie theft, a virus, a trojan horse, a worm, click jacking attacks, keylogger attacks, eavesdropping, waterhole attacks, SQL injection attacks, and DNS spoofing attacks.

The custom operating system 185 includes modules for AI/ML management, code enhancement management, resource management, code evaluation management, and code input/output repository management. In general, the custom operating system 185 manages the software and tools of the code enhancement system 104 (e.g., proprietary AI/ML tool generation, SW applications for code enhancement, and AI/ML applications for code enhancement). The custom operating system 185 accesses the hardware section 180 directly or through the computing entity operating system 184.

FIG. 3G is a schematic block diagram of the hardware components of the hardware section 180 of a computing device. The memory portion of the hardware section includes the ROM 134, the main memory 136, the cache memory 138, the cloud memory 168, and the secondary memory 160. The processing portion of the hardware section includes the core control module 130, the processing module 132, the video graphics processing module 140, and the cloud processing module 170.

The input/output portion of the hardware section includes the cloud peripheral control module 172, the I/O and/or peripheral control module 144, the network interface module 158, the I/O interface module 146, the output device interface 150, the input device interface 148, the cloud memory interface module 164, the cloud processing interface module 166, and the secondary memory interface module 156. The IO portion further includes input devices such as a touch screen, a microphone, and switches. The IO portion also includes output devices such as speakers and a display.

The communication portion includes an ethernet transceiver network card (NC), a WLAN network card, a cellular transceiver, a Bluetooth transceiver, and/or any other device for wired and/or wireless network communication.

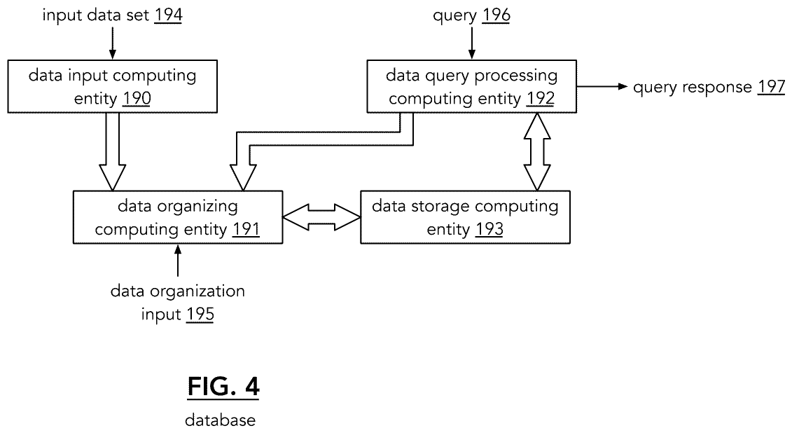

FIG. 4 is a schematic block diagram of an embodiment of a database that includes a data input computing entity 190, a data organizing computing entity 191, a data query processing computing entity 192, and a data storage computing entity 193. Each of the computing entities is implementation in accordance with one or more of the embodiments of FIGS. 2A through 2E.

The data input computing entity 190 is operable to receive an input data set 195. The input data set 195 is a collection of related data that can be represented in a tabular form of columns and rows, and/or other tabular structure. In an example, the columns represent different data elements of data for a particular source and the rows corresponds to the different sources (e.g., employees, licenses, email communications, etc.).

If the data set 195 is in a desired tabular format, the data input computing entity 190 provides the data set to the data organizing computing entity 191. If not, the data input computing entity 190 reformats the data set to put it into the desired tabular format.

The data organizing computing entity 191 organizes the data set 195 in accordance with a data organizing input 197. In an example, the input 197 is regarding a particular query and requests that the data be organized for efficient analysis of the data for the query. In another example, the input 197 instructions the data organizing computing entity 191 to organize the data in a time-based manner. The organized data is provided to the data storage computing entity for storage.

When the data query processing computing entity 192 receives a query 196, it accesses the data storage computing entity 193 regarding a data set for the query. If the data set is stored in a desired format for the query, the data query processing computing entity 192 retrieves the data set and executes the query to produce a query response 198. If the data set is not stored in the desired format, the data query processing computing entity 192 communicates with the data organizing computing entity 191, which re-organizes the data set into the desired format and stores the re-organized data in the data storage computing entity 193.

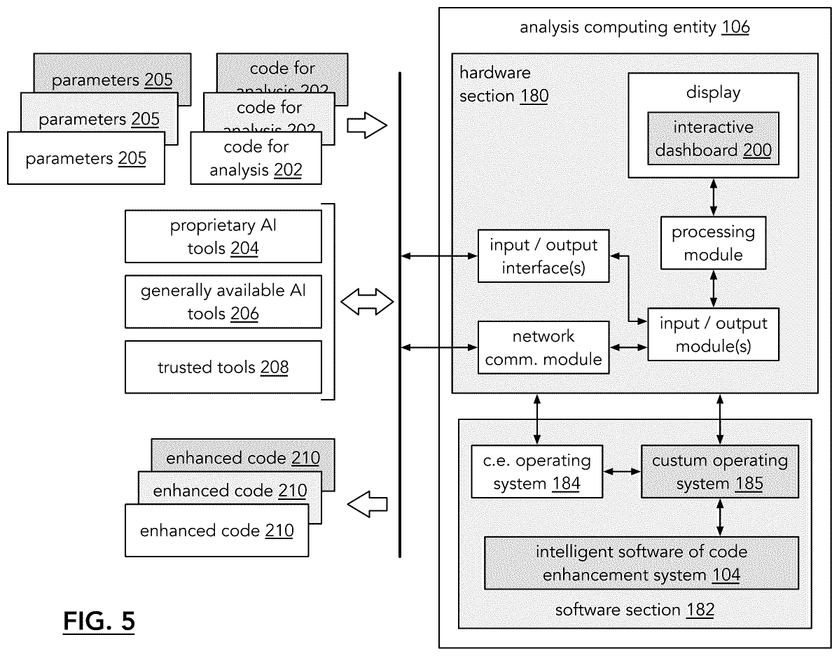

FIG. 5 is a schematic block diagram of an embodiment of the analysis computing entity 106, which could be implemented in accordance with one or more of FIGS. 2A-2E, includes a hardware section 180 and a software section 182. The hardware section 180 includes a display, one or more processing modules, one or more input/output modules, one or more input/output interfaces, and one or more network communication interfaces. The software section 182 includes the computing entity (c.e.) operating system 184, the custom operating system 185, and the software (SW) and AI/ML applications of the code enhancement system 104. The display displays a video graphics rendering of an interactive dashboard 200 of the code enhancement system 104.

In an example of operation, the analysis computing entity 106 executes the intelligent software of the code enhancement system 104, the computing entity (c.e.) operating system, and/or the custom operating system 185 to enhance code and/or evaluate code in accordance with one or more parameters 203. Recall that intelligent software includes software that performs one or more of artificial intelligence (AI), machine learning (NIL), data processing, data storage, data analysis, etc.

To begin, the analysis computing entity 106 receives one or more codes for analysis 202 and one or more corresponding parameters 203, which provide one or more objectives for enhancing their corresponding code 202. In general, the parameters 203 includes purpose parameters (e.g., why enhance or evaluate) and/or operation parameters (e.g., desired outcome of enhancing). As such, the analysis computing entity 106 can enhance the code 202 in accordance with the parameter(s) 203 or it can evaluate the code 202 in accordance with the parameter(s) 203.

Examples of purpose parameters include, but are not limited to, translation, migration, update, upgrade, improve software (SW) efficiencies, improve hardware (HW) efficiencies, expand functionality of code, add new code to existing code, improve user experience, add new features to existing code, improve data management, improved data analysis, adherence to regulatory requirements, improve data integrity, adapt to new technologies, improve user efficiency, improve user productivity, reduce costs from manufacturer and/or user, score the code with respect to one or more operation parameters, generate a confidence factor for the code (e.g., the code will execute reliably), and generate a trustworthiness factor for the code (e.g., the code will execute securely, it will not cause data loss, and/or it will not compromise data integrity).

Examples of the operational parameters include, but are not limited to, quality, security, mitigating IP (intellectual property) risk, context and reasoning, improve execution speed, reduce memory storage, reduce CPU (central processing unit) usages, increasing parallelism, improve robustness, improve portability, improve clarity, improve performance, improve maintainability, improve scalability, and improve interoperability.

For each code 202 (as defined above in paragraph 109), the analysis computing entity 106 interprets the code 202 and its corresponding parameter(s) 203 to determine the objectives of enhancing and/or evaluating the code. Next, the analysis computing entity 106 identifies generally available AI tools 204, trusted tools 208, and/or proprietary AI tools based on the objectives. As used herein, a “tool” is a software program or application that assists in the creation, maintenance, testing, debugging, assessing, and/or otherwise manipulating, interpreting, evaluating, enhancing code; an AI tool is a tool that incorporates artificial intelligence, large language modeling (LLM), machine learning, natural language processing (NLP), and/or the like; a trusted tool is a tool that has proven to provide consistent and trustworthy results; and a proprietary AI tool is a tool that the analysis computing entity creates based on its learnings of enhancing and/or evaluation code for a single fact pattern (e.g., set of parameters and the particulars of the code) to enhancing and/or evaluating code across a broad spectrum of fact patterns.

In general, AI tools are very fast and intuitive in comparison to trusted tools, but their results tend to be less reliable. The challenges of using tools, especially AI tools, to enhance and/or evaluate code include, but are not limited to: (a) ensuring quality (e.g., no errors, bug-free, latest update, etc.); (b) ensuring security (e.g., unprotected vulnerabilities, new attack vectors, etc.); (c) IP risks (e.g., private code leaks, copyright violations, etc.); and (d) context and reasoning (e.g., limited to small lines of code, ease of hallucination, etc.).

Having identified AI tools and/or proprietary tools, the analysis computing entity 106 establishes an ordering of AI tools and/or proprietary AI tools (“Orderings”) to be applied on the code 202 to enhance it and/or evaluated it. Because of the fast and intuitive nature of AI tools, the analysis computing entity 106 can create one to millions of orderings of the selected AI tool and/or selected proprietary AI tools to produce one to millions of different preliminary versions of enhanced code.

The analysis computing entity 106 uses the selected trusted tool(s) to produce trusted enhanced and/or evaluated code data. Typically, a trusted tool is a traditional tool that has proven to be reliable but, in comparison to AI tools, is slow and less intuitive. A trusted tool may further include an AI tool or proprietary AI tool that has proven to be as reliable as a traditional tool.

The analysis computing entity 106 uses the trusted enhanced code data to determine which, if any, of the Orderings produced enhanced and/or evaluated code that is comparatively favorable with the trusted enhanced and/or evaluated code data. The trusted enhanced and/or evaluated code data may be in a variety of forms. For example, the trusted enhanced and/or evaluated code data is an enhanced version of the code as produced by the selected trusted tool(s). As another example, the trusted enhanced and/or evaluated code data is an evaluation of the code as produced by the selected trusted tool(s). As a further example, the trusted enhanced and/or evaluated code data is an enhanced version of one or more sections the code as produced by the selected trusted tool(s). As a still further example, the trusted enhanced and/or evaluated code data is an evaluation of one or more sections of the code as produced by the selected trusted tool(s).

In an embodiment, the analysis computing entity 106 generates a score for the resulting enhanced code of each of the Orderings and generates a score for the enhanced version of the code as produced by the selected trusted tool(s). The scoring is based on how well the resulting enhanced code met the objectives as established by the parameters. The scoring ranges from a low number to a higher number, where the high number represents that the resulting enhanced code exceeded the objectives and a low number represents that the resulting enhanced code did not meet any of the objectives, or vice versa with respect to high and low numbers.

The analysis computing entity 106 compares the score of each Ordering with the score of the trusted tools. For each Ordering that has an equal or greater score than that of the trusted tools (assuming that a high number corresponds to exceeding the objectives), the Ordering is identified as having a favorable comparison. If there is only one Ordering, the analysis computing entity 106 output it as the enhanced code 210.

If there are multiple Orderings that have a favorable score comparison to the trusted tool(s), the analysis computing entity picks one of the Orderings as the outputted enhanced code 210. There are a variety of ways the analysis computing entity 106 can select one of the Orderings. For example, the analysis computing entity 106 selects the Ordering with the highest score. As another example, the analysis computing entity 106 selects the Ordering with the highest score regarding a priority objective of enhancing the code; in this example, each objective is individually scored and combined to produce an overall score. As a further example, the analysis computing entity 106 selects the Ordering with the best RMS (root mean square) value, or average value, of its individually scored objectives.

If no Orderings produced a favorable comparison, the analysis computing entity 106 provides a message indicating such and prompts the user to select one or more new AI tools and/or to change one or more parameters. Once a new tool and/or a new parameter is received, the process repeats for enhancing the code. Thus, it can be an interactive process between a user and the analysis computing entity to enhance code.

In an embodiment, the analysis computing entity 106 generates a score for one or more sections of the resulting enhanced code of each of the Orderings and generates a score for one mor more sections of the enhanced version of the code as produced by the selected trusted tool(s). The analysis computing entity 106 compares the score of each section of the code produced by each Ordering with the score of each section of the code produced by the trusted tools. For each section of code of an Ordering that has an equal or greater score than that of the corresponding section of the coded of the trusted tools, the section of the code produced by the Ordering is identified as having a favorable comparison.

If the score of each section of the code produced by an Ordering compares favorably to the score of each corresponding section of the code produced by the trusted tool(s), then the Ordering is deemed to have a favorable comparison with the trusted tool. If there is only one Ordering that had a favorable comparison, then the analysis computing entity 106 output it as the enhanced code 210. If there are multiple Orderings that have a favorable score comparison to the trusted tool(s), the analysis computing entity picks one of the Orderings as the outputted enhanced code 210 as discussed above.

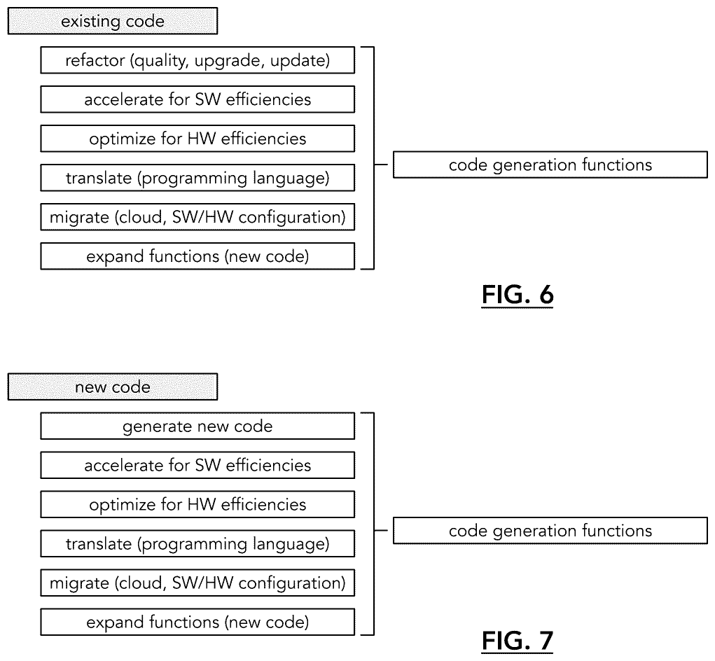

FIG. 6 is a schematic block diagram of an example of enhancing existing code. The existing code may be enhanced by refactoring (e.g., quality improvement, upgrade, update, etc.), by accelerating for software (SW) efficiencies, by optimizing for hardware (HW) efficiencies, by translating programming languages and/or spoken languages, and/or by migrating (e.g., to a cloud platform, for a HW/SW platform change (e.g., Mac to PC)), expand functionality and/or features through new code. Each of these functions can be augmented by one or more code generation functions.

FIG. 7 is a schematic block diagram of an example of enhancing new code. The new code is generated using one or more code generation functions. The new code may be enhanced by accelerating for SW efficiencies, by optimizing for HW efficiencies, by translating programming languages and/or spoken languages. by migrating (e.g., to a cloud platform, for a HW/SW platform change (e.g., Mac to PC)), and/or by expanding functionality and/or features through new code. Each of the enhancing functions can be augmented by one or more code generation functions.

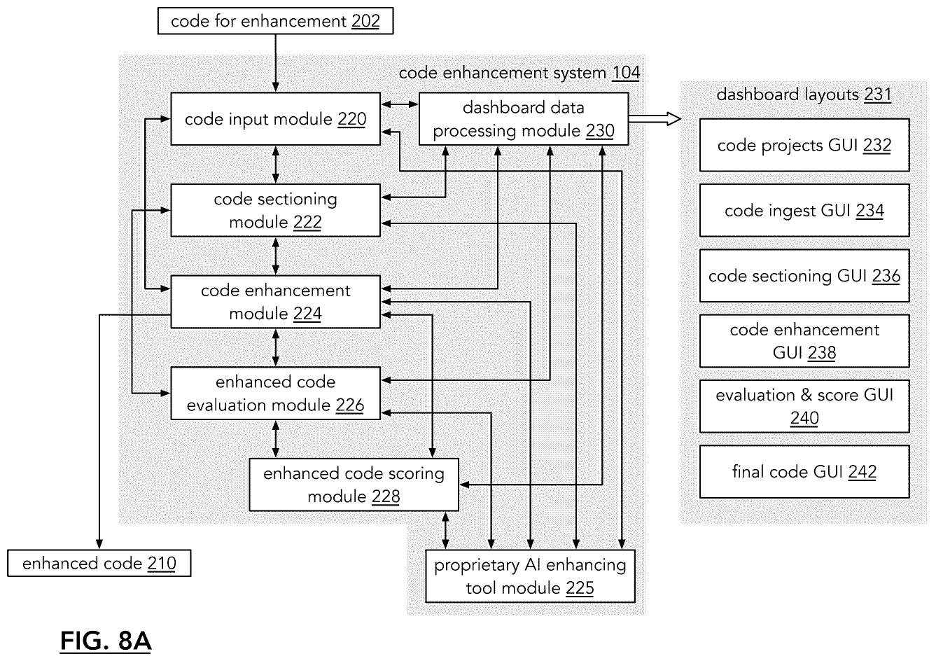

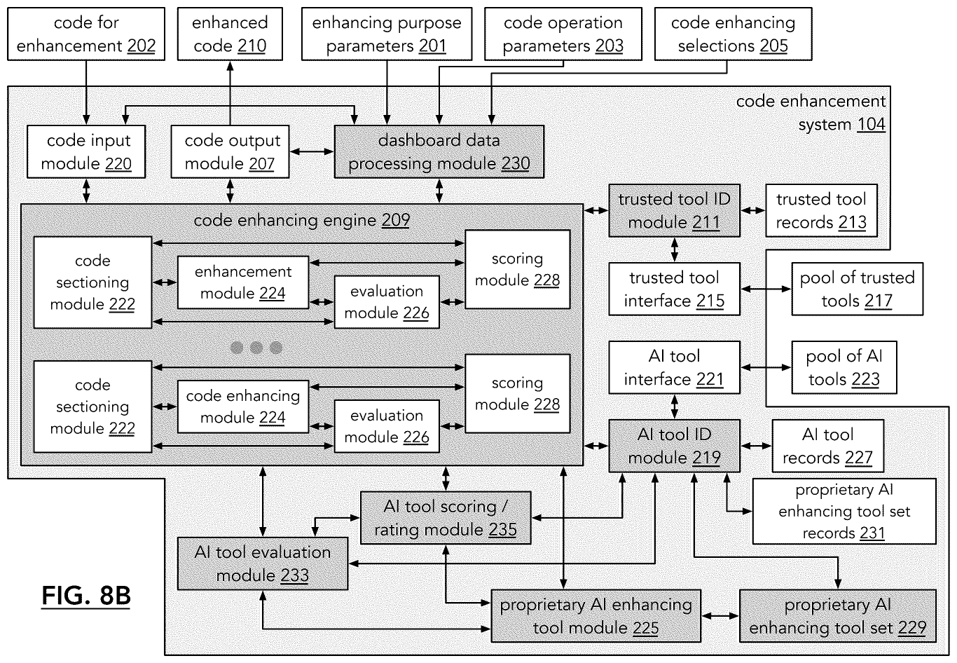

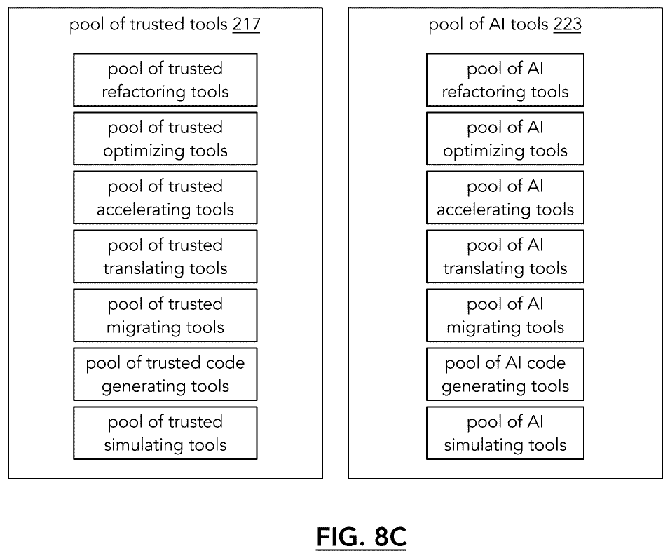

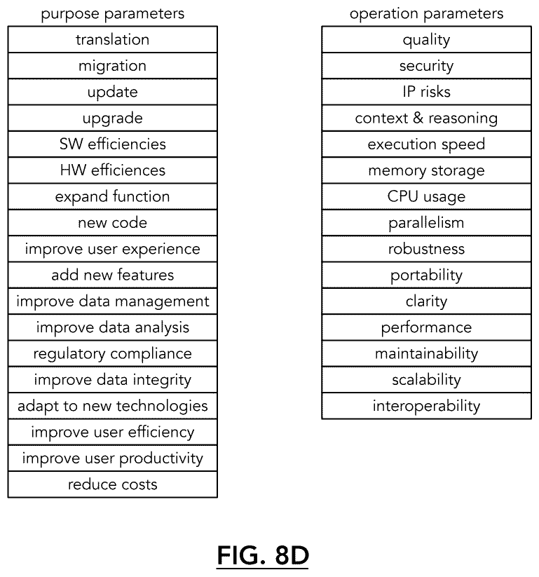

FIG. 8A is a schematic block diagram of an embodiment of a code enhancement system 104 that includes a code input module 220, a code sectioning module 222, a code enhancement module 224, an enhanced code evaluation module 226, an enhanced code scoring module 228, a custom AI enhancing tool module 225, and a dashboard data processing module 230. The dashboard data processing module 230 is operable to produce dashboard layouts 231, which include, but are not limited to, a code project GUI (graphical user interface) 232, a code ingest GUI 234, a code sectioning GUI 236, a code enhancement GUI 238, an evaluation and score GUI 242, and a final code GUI 242.

In an example of operation, the code input module 220 and the dashboard data processing module 230 facilitate the inputting of code for enhancement 202. For instance, the dashboard data processing module 230 generates the code projects GUI 232, which is displayed on a display of the analysis computing entity. The code projects GUI 232 is a graphical representation of a list of code that is available for enhancing and where each code is currently stored.

Via the code projects GUI 232, a user can select one or more codes for enhancement. If there is code that the user desires to enhance but it is not currently listed, the user can add it to the list, which can be done in a variety of ways. For example, the user can enter the name of the code and its current storage location (e.g., URL address, API information, file path system, bucket and object key, container name, folder and file name, etc.). As another example, the user inputs the code into the code input section 220 via a GUI input code function.

When the code for enhancement is identified, the dashboard data processing module 230 displays the code ingest GUI 234, which allows the user to select a local memory location to store the code for enhancement 202. Further, the code ingest GUI 234 provides the user with options regarding where iterations of enhancing the code are to be stored, which could be in the same local memory that storing the copy of the original code, a different local memory, the storage location of the original code, and/or other cloud storage.

The code input module 220 downloads a copy of the code and stores it locally as indicated by the user. If the user does not specify a storage location, the code enhancement system 104 selects a local storage location.

Next, the dashboard data processing module 230 displays the code sectioning GUI 236. The code sectioning GUI allows the user to select which code sectioning tools to use (i.e., which AI code sectioning tools, which proprietary AI code sectioning tools, and/or which trusted code sectioning tools). Alternatively, the user could select an auto selection of the code sectioning tools to use. In this instance, the code sectioning selects which tools to use based on the code and the corresponding parameters.

With the code sectioning tools selected, the code processing unit 220 sections the code using each of the selected AI code sectioning tool and/or selected proprietary AI code sectioning tool to produce one or more AI sectioned codes. The dashboard data processing module 230 updates the code sectioning GUI 236 to illustrate the one or more AI sectioned codes and may further illustrate their respective code sections.

The enhanced code evaluation module 226 and the enhanced code scoring module 228 could evaluate and score, respectively, each of the one or more AI sectioned codes or wait to evaluate the resulting enhanced code versions produced by the code enhancement module 224. When the enhanced code evaluation module 226 and the enhanced code scoring module 228 evaluate and score, respectively, each of the one or more AI sectioned codes, the dashboard data processing module 230 updates the code sectioning GUI 236 to illustrate the evaluation and/or scores of the one or more AI section codes.

When evaluating AI sectioned code(s), the enhanced code evaluation module 226 evaluates each of the AI sectioned codes in light of trusted sectioned code. In an embodiment, the enhanced code evaluation module 226 utilizes one or more selected trusted code sectioning tools to produce the trusted sectioned code. It then compares each of the AI sectioned codes to the trusted sectioned code in light of the parameters. Each AI sectioned code that compares favorably to the trusted sectioned code is deemed to have passed evaluation.

In another embodiment, the enhanced code evaluation module 226 utilizes one or more trusted tools to evaluate an AI sectioned code. For example, a trusted tool interprets the code sectioning of an AI sectioned code to determine validity of the sectioning in light the sectioning functions employed by the AI code sectioning tool(s). As a specific example, if an AI sectioning tool used the function of header comments for identifying sections, the trusted tool verifies the header comments of the original code supports the sectioning of the AI code sectioning tool. If yes, the AI sectioned code passes evaluation. Code sectioning functions will be described in greater detail with reference to one or more subsequent figures.

When scoring AI sectioned codes, the enhanced code scoring module 228 generates a score for each AI sectioned code that passed evaluation. In an embodiment, the enhanced code scoring module 228 generates the score based on how well the AI sectioned code meets the objectives as established by the parameters as they pertain to code sectioning. As mentioned above, the scoring ranges from a low number to a higher number, where the high number represents that the resulting AI sectioned code exceeded the objectives and a low number represents that the resulting AI sectioned code did not meet any of the objectives, or vice versa with respect to high and low numbers.

In addition, the enhanced code evaluation module 226 and the enhanced code scoring module 228 could evaluate and score, respectively, each section of each of the one or more AI sectioned codes. The enhanced code evaluation module 226 compiles the section evaluations to produce an overall evaluation of an AI sectioned code. Similarly, the enhanced code scoring module compiles the section scores to produce an overall score of an AI sectioned code. The dashboard data processing module 230 updates the code sectioning GUI 236 to illustrate the evaluation and/or scores of sections of the one or more AI section codes and the resulting compiled evaluation and compiled score of each AI sectioned code.

In another embodiment, the enhanced code evaluation module 226 and the enhanced code scoring module 228 are essentially one module that concurrently evaluates and scores the AI sectioned code(s) or the resulting AI enhanced version(s) of code. For scoring an AI sectioned code, the combined module determines how well the trusted section code meets the objectives of the parameters, generates a score for the trusted sectioned code, and evaluates how well the AI sectioned code compares to the trusted AI sectioned code based on the score of the trusted sectioned code.

The code enhancement module 224 receives one or more versions of AI sectioned code and/or one or more versions of sectioned code from the code section module 222. In this instance, an AI sectioned code is code that has been sectioned by one or more AI sectioning tools and/or proprietary AI sectioning tools but has not been evaluated and scored and a sectioned code is code that has been sectioned by one or more AI sectioning tools and/or proprietary AI sectioning tools and has been evaluated and scored.

For each version of AI sectioned code or sectioned code, the code enhancement module 224 selects a set of AI code enhancing tools (as used in this application, a set includes one or more), a set of proprietary AI code enhancing tools, and/or a set of trusted code enhancing tools. The selection may be based on user inputs and/or based on an automated selection process as further discussed with reference to one or more subsequent figures. An AI code enhancing tool generally functions to refactor code, optimize code for hardware efficiencies, accelerate code for software efficiencies, translate code, migrate code, generate new code, modify existing code, and/or simulate code. The various functions enhancing code will be described in greater detail with reference to one or more subsequent figures.

In an embodiment, a proprietary AI code enhancing tool generally functions to refactor code, optimize code for hardware efficiencies, accelerate code for software efficiencies, translate code, migrate code, generate new code, modify existing code, and/or simulate code. In other embodiments, a proprietary AI code enhancing tool functions to augment one or more AI code enhancing tools. For example, a proprietary AI code enhancing tool augments the refactoring function of an AI code enhancing tool. The augmenting includes overruling at least some decisions made by the AI code enhancing tool, added functionality to the AI code enhancing tool, verifying at least sone decisions made by the AI code enhancing tool, further clarification on the enhancing to be performed by the AI code enhancing tool, etc.

In an embodiment, a trusted code enhancing tool generally functions to refactor code, optimize code for hardware efficiencies, accelerate code for software efficiencies, translate code, migrate code, generate new code, modify existing code, and/or simulate code. In other embodiments, a trusted code enhancing tool functions to verify the code enhancements made by one or more AI code enhancing tools, functions to test the code enhancements made by one or more AI code enhancing tools, functions to simulate the code enhancements made by one or more AI code enhancing tools, functions to replicate the code enhancements made by one or more AI code enhancing tools, etc.

Having selected the tools, the code enhancement module 224 uses the selected AI code enhancement tool(s) and/or selected proprietary AI code enhancing tool(s) on an AI sectioned code or a sectioned code in light of the objective of the parameters to produce AI enhanced code. Since code enhancement can include refactoring, optimizing, accelerating, translating, migrating, code generation, code modification, and/or code simulation, there are thousands to millions of combinations for AI enhancement of code. While the code is being enhanced, the dashboard processing module 230 displays and updates the code enhancing GUI 238 to enable the user to monitor the code enhancing and/or to participate by making decisions on code enhancing questions as they may arise.

The enhanced code evaluation module 226 and the enhanced scoring module 228 evaluate and score each version of the AI enhanced code. While evaluating and scoring, the dashboard data processing module 230 displays and updates the evaluation and scoring GUI 240 to enable the user to monitor the evaluation and scoring and/or to participate by making decisions regarding code evaluation and/or scoring questions as they may arise.

When evaluating AI enhanced code(s), the enhanced code evaluation module 226 evaluates each of the AI enhanced codes in light of trusted enhanced code. In an embodiment, the enhanced code evaluation module 226 utilizes one or more selected trusted code enhancing tools to produce the trusted enhanced code. It then compares each of the AI enhanced codes to the trusted enhanced code in light of the parameters. Each AI enhanced code that compares favorably to the trusted enhanced code is deemed to have passed evaluation.

In another embodiment, the enhanced code evaluation module 226 utilizes one or more trusted tools to evaluate an AI enhanced code. For example, a trusted tool interprets the code enhancements of an AI enhanced code to determine validity of the enhancements in light the enhancing functions employed by the AI code sectioning tool(s). As a specific example, if an AI enhancing tool uses refactoring, the trusted tool verifies the refactoring performed by the AI code sectioning tool. If verified, the AI enhanced code passes evaluation. Code enhancement functions will be described in greater detail with reference to one or more subsequent figures.

When scoring AI enhanced codes, the enhanced code scoring module 228 generates a score for each AI enhanced code that passed evaluation. In an embodiment, the enhanced code scoring module 228 generates the score based on how well the AI enhanced code meets the objectives as established by the parameters as they pertain to code enhancing. As mentioned above, the scoring ranges from a low number to a higher number, where the high number represents that the resulting AI enhanced code exceeded the objectives and a low number represents that the resulting AI enhanced code did not meet any of the objectives, or vice versa with respect to high and low numbers.

In addition, the enhanced code evaluation module 226 and the enhanced code scoring module 228 could evaluate and score, respectively, the enhancing performance of each AI enhancing tool. The enhanced code evaluation module 226 compiles the individual AI enhancing tool evaluations to produce an overall evaluation of an AI enhanced code. Similarly, the enhanced code scoring module compiles the individual AI enhancing tool scores to produce an overall score of an AI enhanced code. The dashboard data processing module 230 updates the evaluation and scoring GUI 240 to illustrate the evaluation and/or scores of the one or more AI enhancing tools as they enhanced AI sectioned code or sectioned code and the resulting compiled evaluation and compiled score of each AI enhanced code.

In another embodiment, the enhanced code evaluation module 226 and the enhanced code scoring module 228 are essentially one module that concurrently evaluates and scores the AI enhanced code(s). For scoring an AI enhanced code, the combined module determines how well the trusted enhanced code meets the objectives of the parameters, generates a score for the trusted enhanced code, and evaluates how well the AI enhanced code compares to the trusted enhanced code based on the score of the trusted enhanced code.

When one or more versions of AI enhanced code passes evaluation and has a desirable score, the dashboard data processing module 230 generates the final code GUI 242 for display. The final code GUI lists each version of AI enhanced code that passed evaluation and that has a desirable score, its respective evaluation summary, and its respective score. The final code GUI enables the user to select which listed AI enhanced code to select as the final enhanced code 210 or enables the user to allow the code enhancement system 104 to select the final enhanced code 210. Note that final enhanced code 210 is referring to this iteration of enhancing existing code. Once selected, the final enhanced code becomes existing code that can undergo further enhancement by the code enhancement system 104.

FIG. 8B is a schematic block diagram of another embodiment of a code enhancement system 104 that includes a code input module 220, a code output module 207, the dashboard processing module 230, a code enhancement engine 209, a trusted tool ID (identification) module 211, trusted tool records 213, a trusted tool interface 215, an AI tool interface 221, an AI tool ID module 219, AI tool records 227, a proprietary AI enhancing tool set 229, a proprietary AI enhancing tool module 225, an AI tool evaluation module 233, and an AI tool scoring/rating module 235.

The code input module 220 is operably coupled to provide code for enhancement 202 to the code enhancing engine 209. This may be done in a serial fashion, a parallel fashion, a combination thereof, and/or in a bulk fashion. As used herein, parallel inputting of one or more codes for enhancement is regarding the inputting of the one or more codes, and/or portions thereof, using multiple threads, processes, processing modules, etc. affiliated with the code input module 220; bulk inputting of one or more codes for enhancement is regarding the inputting of one or more codes, and/or portions thereof, using single operation or a series of batch operations to input a large amount of data.

The code input module 220 is further operably coupled to the dashboard processing module 230, which generates a GUI for inputting code for enhancement 202. The GUI enables the user to select the code(s) for enhancement, how to input them (e.g., serial, parallel, in bulk), and where to store them.

As for storing inputted code for enhancement, the code input module 220 further functions as a repository for the code. As a repository for code, the code input module 220 also functions to store enhancement iterations produced by the code enhancing engine 209.

The code output module 207 is operably coupled to the dashboard data processing module 230 and the code enhancing engine 209. The code output module 207 receives one or more versions of AI enhanced code that have passed evaluation and that have a desirable score. The dashboard data processing module 230 generates the final code GUI 242 for display, which lists each version of AI enhanced code that passed evaluation and that has a desirable score, its respective evaluation summary, and its respective score. The final enhanced code 210 is selected from one of the listed versions of AI enhanced code.

The dashboard data processing module 230 further provides one or more GUIs to receiving enhancing purpose parameters 201, code operation parameters 203, and code enhancing selections 205. The enhancing purpose parameters 201 are regarding the motivation to enhance existing code 202. An example list of enhancing purpose parameters 201 is shown in, and discussed with reference to, FIG. 8D.

The code operation parameters 203 are regarding the desired outcoming of enhancing code 202. An example list of code operation parameters 203 is shown in, and discussed with reference to, FIG. 8D. The code enhancing selections 205 are regarding the selection one or more parameters 201 and/or 203, the selection of AI tools, the selection of trusted tools, the selection of proprietary AI tools, the selection of the enhanced code 210, and/or the selections regarding intermediate steps of sectioning code, enhancing code, evaluating code, and/or scoring code. Such selection can be based on user inputs or selected by the code enhancement system 104.

The code enhancing engine 209 includes a plurality of code enhancing engine units, where a code enhancing engine unit includes the code section module 222, the code enhancement module 224, the enhanced code evaluation module 226, and the enhanced code scoring module 228. Each of the code section module 222, the code enhancement module 224, the enhanced code evaluation module 226, and the enhanced code scoring module 228 function generally as discussed with reference to FIG. 8A and as more fully discussed with reference to one or more subsequent figures.

The plurality of code enhancing engine units allow for large scale parallelism that enables the code enhancing engine 209 to generate tens, to hundreds, to thousands, to millions, or more versions of AI enhanced code. As discussed with reference to FIG. 8A, the code enhancing engine 209 uses a set of AI tools, a set of proprietary AI tools, and/or a set of trusted tools to generate, evaluate, and score the versions of AI enhanced code and to select one of them as the outputted enhanced code 210.

The trusted tool ID module 211 coordinates the selection of the set of trusted tools, is operably coupled to store records of trusted tools 213 (e.g., in memory of the analysis computing entity 104), and is operably coupled to a trusted tool interface 215. A record for a trusted tool includes information regarding the functionality of tool, quality of its outcome, security, avoiding IP risks, context & reasoning, pairing with AI tools, typical uses cases for the tool, execution speed, memory storage, CPU usages, parallelism, robustness, portability, clarity, and/or other operational and/or description information. One or more subsequent figures will provide examples of, and further discussion of, records for trusted tools 213.

The trusted tool ID module 211 receives the parameters from the code enhancing engine 209 (or from the dashboard data processing module 230) and interprets the parameters to identify the set of trusted tools to support the code sectioning, code enhancing, code evaluation, and/or code scoring of code 202. The trusted tool ID module 211 retrieves the identified set of trusted tools from a pool of trusted tools 217 via the trusted tool interface 215.

The pool of trusted tools 217 are stored locally and/or on the cloud. As such, the trusted tool interface 215 is a local memory interface and/or a cloud storage interface. A trusted tool may be an open source tool, a publicly available tool, a purchased tool, or a licensed tool.

The AI tool ID module 219 coordinates the selection of the set of AI tools, is operably coupled to store records of AI tools 227 (e.g., in memory of the analysis computing entity 104), and is operably coupled to an AI tool interface 221. A record for an AI tool includes information regarding the functionality of tool, quality of its outcome, security, avoiding IP risks, context & reasoning, pairing with trusted tools, pairing with other AI tools, typical uses cases for the tool, execution speed, memory storage, CPU usages, parallelism, robustness, portability, clarity, and/or other operational and/or description information. One or more subsequent figures will provide examples of, and further discussion of, records for AI tools 227.

The AI tool ID module 219 receives the parameters from the code enhancing engine 209 (or from the dashboard data processing module 230) and interprets the parameters to identify the set of AI tools and/or AI proprietary tools to support the code sectioning, code enhancing, code evaluation, and/or code scoring of code 202. The AI tool ID module 219 retrieves the identified set of AI tools from a pool of AI tools 223 via the AI tool interface 221 and/or receives the set of AI proprietary tools from the proprietary AI enhancing tool set 229.

The pool of AI tools 223 are stored locally and/or on the cloud. As such, the AI tool interface 2221 is a local memory interface and/or a cloud storage interface. An AI tool may be an open source tool, a publicly available tool, a purchased tool, or a licensed tool.

While the code enhancing engine 209 is generating a plurality of versions of AI enhanced code, the AI tool evaluation module 203 is evaluating the performance of the set of AI tools and is evaluating the performance of the set of proprietary AI tools and the AI tool scoring/rating module 235 is scoring the performance of the set of AI tools and is scoring the performance of the set of proprietary AI tools. In general, evaluation is regarding “is the tool performing its function(s) in a reliable manner” and scoring is regarding “how well the tool is performing its intended function(s)”.

The proprietary AI enhancing tool module 225 uses the tool evaluation of the AI tool evaluation module 233 and the tool scoring of the AI tool scoring/rating module 235 to identify gaps, strengths, weaknesses, errors, efficiencies, inefficiencies, etc. of a tool. From this information, the proprietary AI enhancing tool module 225 creates and/or updates a proprietary AI tool to improve the AI enhancing of code 202.

As an example, an enhancement module 224 is using an AI refactoring tool with a priority of making the code more readable and more maintainable without compromising security of the code and without compromising risk of IP issues. For certain types of code (e.g., writing in a particular programming language, for a particular hardware platform, for use with a particular operating system, etc.), the AI refactoring tool performs well at making the code more readable and maintainable but decreases security of the code and/or increases the risk of an IP issue.

In this example, the proprietary AI enhancing tool module 225 generates one or more proprietary tools to work with this particular AI refactoring tool when used the for the certain types of code to address the security of the refactored code and/or to address the IP issue of the refactored code. As a specific example, the proprietary AI enhancing tool module 225 generates a proprietary AI refactoring security tool to improve the security of the refactored code and/or generates a proprietary AI refactoring IP issue tool to reduce the risk of an IP issue.

FIG. 8C is a schematic block diagram of an example of a pool of trusted tools 217 and a pool of AI tools 223. The pool of trusted tools 217 includes a pool of trusted refactoring tools, a pool of trusted optimizing tools, a pool of trusted accelerating tools, a pool of trusted translating tools, a pool of trusted migrating tools, a pool of trusted code generating tools, and a pool of trusted simulating tools. The pool of AI tools 223 includes a pool of AI refactoring tools, a pool of AI optimizing tools, a pool of AI accelerating tools, a pool of AI translating tools, a pool of AI migrating tools, a pool of AI code generating tools, and a pool of AI simulating tools. As used herein, a pool includes one or more tools. See Glossary Section for further definition of the terms used in this figure.

FIG. 8D is a schematic block diagram of an example of purpose parameters and operation parameters. In general, the purpose parameters are the “why” to enhance the code and the operation parameters are the “desired outcome” of enhancing the code. The purpose parameters include translation, migration, update, upgrade, improve SW efficiencies, improve HW efficiencies, expand function, add new code, improve user experience, add new features, improve data management, improve data analysis, improve data integrity, adapt to new technologies, improve user efficiency, improve user productivity, and/or reduce costs.

The operation parameters include quality, security, IP risks, context & reasoning, execution speed, memory storage, CPU usage, parallelism, robustness, portability, clarity, performance, maintainability, scalability, and interoperability. See Glossary Section for further definition of the terms used in this figure.

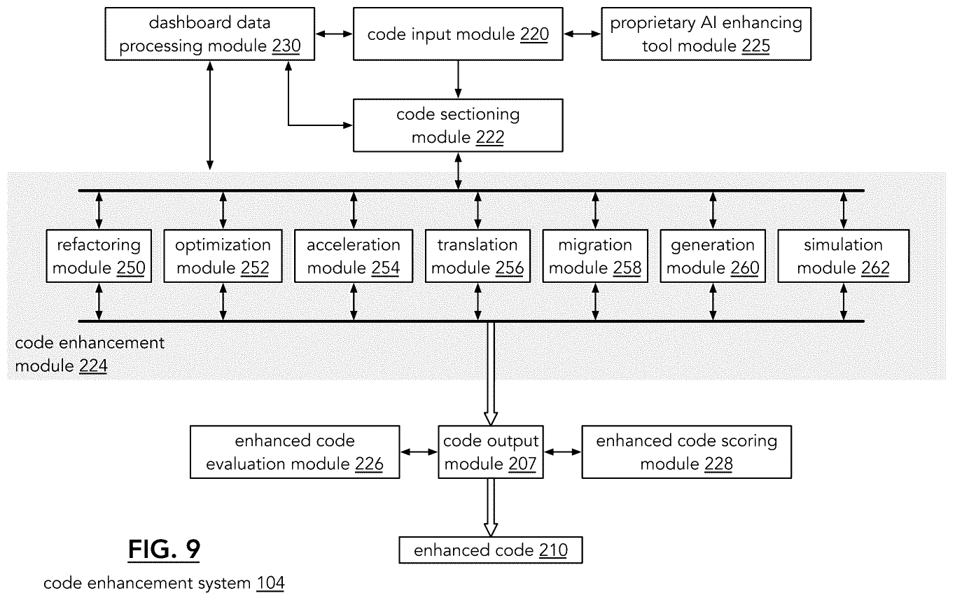

FIG. 9 is a schematic block diagram of another embodiment of a code enhancement system 104 that includes the dashboard data processing module 230, the code input module 220, the proprietary AI enhancing tool module 225, the code sectioning module 222, the code enhancement module 224, the enhanced code evaluation module 226, the code output module 207, and the enhanced code module 228.

The code enhancement module 224 includes one or more of a refactoring module 250, an optimization module 252, an acceleration module 254, a translation module 258, a code generation module 260, and a simulation module 262. The code enhancement module 224 may further include a documentation module (not shown).

In an example of operation, code 202 (not shown) is received by the code input module 220 and sectioned by the coding sectioning module 222. In general, the code sectioning module 222 sections the code 202 into sectioned code. There is a variety of ways to section code as will be discussed in greater detail with reference to one or more subsequent figures. As used herein, code sectioning means divided code into two or more pieces of code in accordance with a code sectioning scheme. A piece of code may be further divided into sub-pieces of code, which may in turn be further divided into sub-sub-pieces of code, and so on.

As a general example, code is divided into snippets (as defined in the glossary section). As another general example, code is divided into sub-routines (as defined in the glossary section). As a further general example, code is divided based on one or more of header comments, functions & methods, object recognition, classes & objects, inheritance, encapsulation, modules & packets, regions, logical separation, configuration files, version control, framework-specific practices, modular recognition, micro service recognition, layer/component recognition, and namespace (each as defined in the glossary section).

The code enhancement module 224 receives the sectioned code and processes it to produce a plurality of AI enhanced codes based on inputted parameters (not shown). There are multitude of ways for the code enhancement module 224 to produce the plurality of AI enhanced codes depending on which of the modules 250-262 are selected. For example, when only the refactoring module 250 is required, it determines the AI refactoring functions it will perform on the sectioned code and in what order based on the inputted parameters. AI refactoring functions include, but are not limited to, extract method, rename variable, inline method, replace temporary with query, move method, move field method, introduce parameter object(s), and replace condition with polymorphism (each as further defined in the glossary section).

As another example, when the only the optimization module 252 is required, it determines the AI optimization functions it will perform on the sectioned code and in what order based on the inputted parameters. The AI optimization functions include, but are not limited to, code profiling in general, code profiling—CPU, code profiling—memory use, code performance in general, code performance—scalability, memory profiling, memory leaks, memory debugging, memory management, memory allocations, memory deadlocks, and excessive memory use (each as further defined in the glossary section).

As another example, when the only the acceleration module 254 is required, it determines the AI acceleration functions it will perform on the sectioned code and in what order based on the inputted parameters. The AI acceleration functions include, but are not limited to, execution time, thread contention, deadlocks, thread utilization, microarchitecture exploration, parallelism, synchronization, hotspot analysis, memory access patterns, performance bottlenecks, excessive memory use, compiler optimization, real time performance, transaction tracing, error tracking, transaction visibility, dynamic baselining, root cause analysis, full stack monitoring, build times, build plugin performance, task execution, and build life cycle analysis (each as further defined in the glossary section).

As another example, when the only the translation module 256 is required, it determines the AI translation functions it will perform on the sectioned code and in what order based on the inputted parameters. The AI translation functions include, but are not limited to, software component translation, management system translation, documentation translation, user interface translation, computer assisted translation, memory translation, spoken language translation, localized automation translation, and integrated development environment translation (each as further defined in the glossary section).

As another example, when the only the migration module 258 is required, it determines the AI migration functions it will perform on the sectioned code and in what order based on the inputted parameters. The AI migration functions include, but are not limited to, cloud migration—single platform, cloud migration—multiple platforms, cloud migration—server, cloud migration—database, cloud migration—virtual machine, cloud migration web application (app), database migration, application migration, and general purpose migration (each as further defined in the glossary section).

As another example, when the only the code generation module 260 is required, it determines the AI code generation functions it will perform on the sectioned code and in what order based on the inputted parameters. The AI code generation functions include, but are not limited to, general code translation, code generation—web app, code generation—API, low code/no code (LCNC) development, LCNC development—mobile app, LCNC development—web app, LCNC development—system integration, LCNC development—business processes, LCNC development—user interface, integrated development environment for code generation, and model driven development each as further defined in the glossary section).

As another example, when the only the simulation module 262 is required, it determines the AI simulation functions it will perform on the sectioned code and in what order based on the inputted parameters. The AI simulations functions include, but are not limited to, system simulation in general, system simulation—multiple domains, system simulation—physical phenomena, network simulation, internet and/or network protocols, hardware in loop simulation, application simulation, embedded system simulation—electronic circuits, and embedded system simulation—mixed signal circuits (each as further defined in the glossary section).

As a further example, when two or more modules 250-262 are required, the required modules coordinate to determine an ordering of the AI functions to be performed on the sectioned code. As a specific example, when the refactoring module 250 and the optimization module 252 are required, each of the modules 250 and 252 determine which of their respective AI functions are to be employed based on the inputted parameters. Having identified the respective AI functions, the modules 250 and 252 coordinate the order of execution of the AI refactoring functions and the AI optimization functions.

In furtherance of above specific example, each module 250 and 252 selects a variety of different groupings of their respective AI functions and coordinate a multiple of different orderings of the AI refactoring functions and the AI optimization functions. These different orderings produce the plurality of AI enhanced codes.

The required modules 250-262 coordinate generating the ordering of the various respective AI functions in a variety of ways. For example, one of the modules is selected as a master module to determine the orderings of the various respective AI functions for all of the required modules. As another example, the modules coordinate in a distributed manner to convolve to the orderings. As a further example, the code enhancement module 224 includes a control module (not shown) that coordinates the ordering of the various respective AI functions and oversees the execution of them.

In addition to a module selecting one more respective AI modules, it may further select one or more proprietary AI functions. For example, the refactoring module 250 selects one or more proprietary AI functions to augment, improve, complement, substantiate, and further enhance the performance of one or more selected AI refactoring functions.

As the code enhancement module 224 generates the plurality of AI enhanced codes, it provides them to the code output module 207. The code output module 207 coordinates with the enhanced code evaluation module 226 to evaluate each of the AI enhanced codes. The code output module 207 also coordinates with the enhanced code scoring module 228 to score each of the AI enhanced codes or to score only the AI enhanced codes that passed the evaluation of the enhanced code evaluation module 226.

If only one of the AI enhanced codes passes evaluation of the enhanced code evaluation module 226 and has a favorable score as produced by the enhanced code scoring module 228, the code output module 207 outputs it as the enhanced code 210. If more than one of the AI enhanced codes passes evaluation of the enhanced code evaluation module 226 and has a favorable score as produced by the enhanced code scoring module 228, the code output module 207 selects one of them as the enhanced code 210.

The code output module 207 may select one of the successfully evaluated and favorably scored AI enhanced codes in a variety of ways. For example, the code output module 207 selects the one with the highest overall score. As another example, the code output module 207 coordinates with the dashboard data processing module 230 to provide a GUI for the user to select one of the successfully evaluated and favorably scored AI enhanced codes. As a further example, the code output module 207 selects the one with the highest weighted score, where the weighting is based on a prioritization of the parameters. As a specific example, assume that the top priorities are memory storage and CPU consumption, then the successfully evaluated and favorably scored AI enhanced codes with the highest combined scores for these two priority parameters is selected.

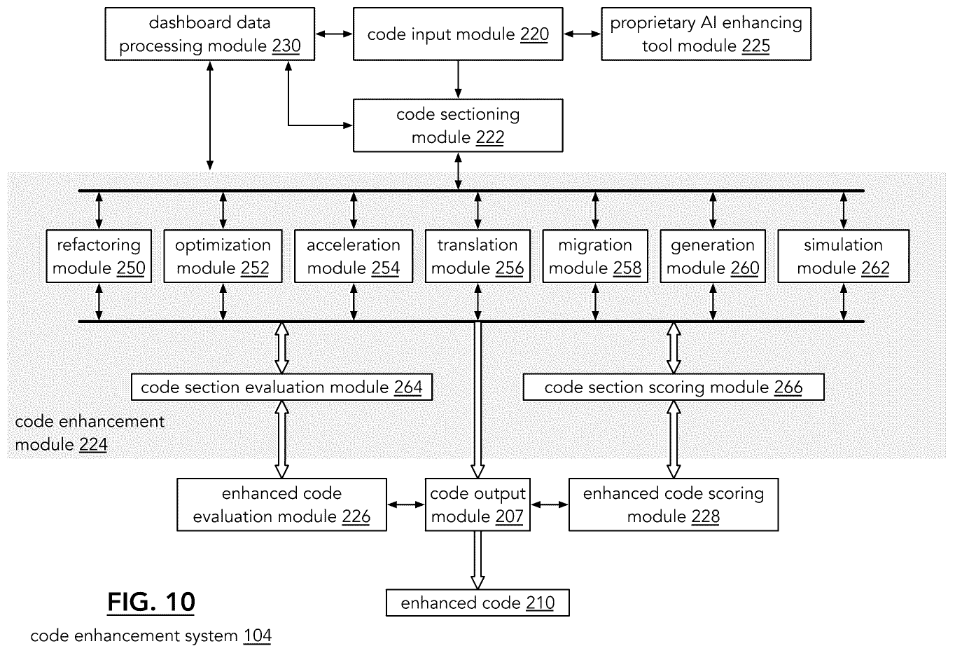

FIG. 10 is a schematic block diagram of another embodiment of a code enhancement system 104 is similar to the embodiment of the system 104 of FIG. 9 with a few differences. In this embodiment, the code enhancement module 224 further includes a code section evaluation module 264 and a code section scoring module 266.

In this embodiment, one or more sections of the sectioned code is individually evaluated and scored as it is being processed by the required modules 250-262. The individual evaluation and scoring may be done in a variety of ways. For example, a section of the sectioned code is evaluated and scored after the ordering of AI functions have been performed on it. As another example, a section of the sectioned code is evaluated and scored after each function of the ordering of AI functions has been performed on it.

In this embodiment, corrections to enhancing of sections of the sectioned code are made prior to outputting an AI enhanced code to the code output module 207. The code output module 207, the enhanced code evaluation module 226, and the enhanced code scoring module 228 functions as discussed in FIG. 9 to produce the enhanced code 210.

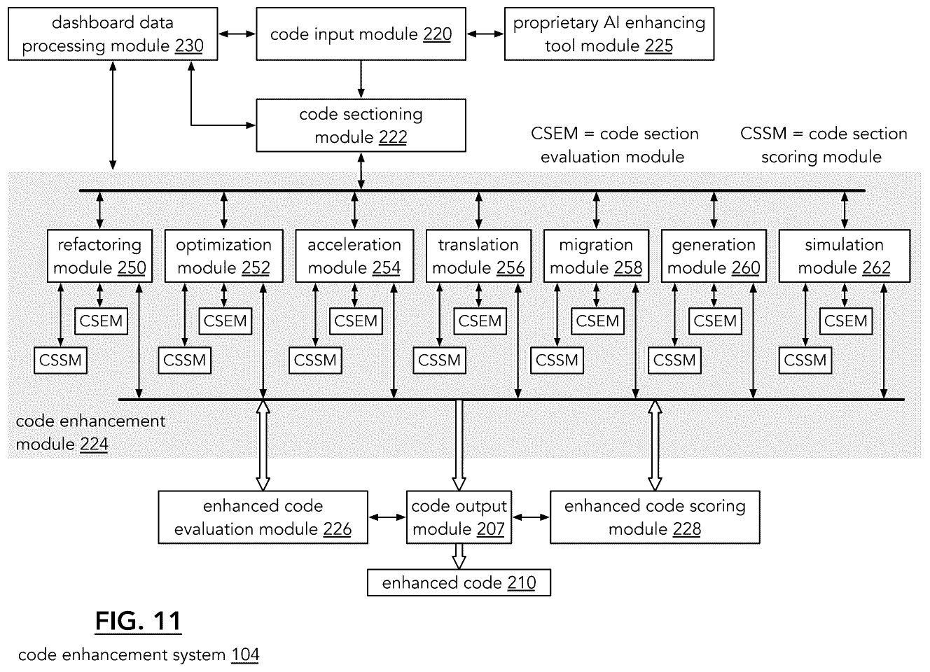

FIG. 11 is a schematic block diagram of another embodiment of a code enhancement system 104 that is similar to the system 104 of FIG. 10 with a few differences. In this embodiment, each module 250-262 has a dedicated code section evaluation module (CSEM) and code section scoring module (CSCM). As such, the dedicated CSEM and CSCM of the refactoring module 250 evaluates and scores one or more codes sections on which refactoring module 250 executed one or more refactoring functions. The dedicated CSEM and CSCM of the other modules 252-262 function in a similar manner for their respective modules.

In this embodiment, the code enhancement module 224 ensures that a section of code is successfully evaluated and has a desired score for a first function of an ordering of AI functions before it is forwarded to a second module for next function of the order. If the section of codes was not successfully evaluated or has a less than desirable score for the first function, the corresponding module has several options. As a first option, the module selects one or more different corresponding functions to perform on the section. As a second option, the module requests a change in one or more parameters. As a third option, the module terminates this particular ordering for the code enhancement system.

When, for example, a refactored section of code does not pass evaluation or as a less than desired score, the refactoring module 250 selects, as a first option, one or more different refactoring functions to perform on the section of code. As another example, the refactoring module 250 requests that one or more parameters be changed. As a further example, the refactoring module 250 terminates this ordering of AI functions for the code enhancement module 224.

While the system 104 as discussed herein is referred to as a code enhancement system, it functions equally well for evaluating and/or scoring code. For example, the system 104 receives an updated version of software and parameters requesting the system to verify a bug fix. If the updated version of software fails evaluation and/or has less than a desirable score, the system 104 can be employed to enhance the updated version of software such that it has a successful evaluation and a desirable score. If the updated version of software has a successful evaluation and a desirable score, then system 104 outputs a favorable response to the evaluation and scoring of the bug fix.

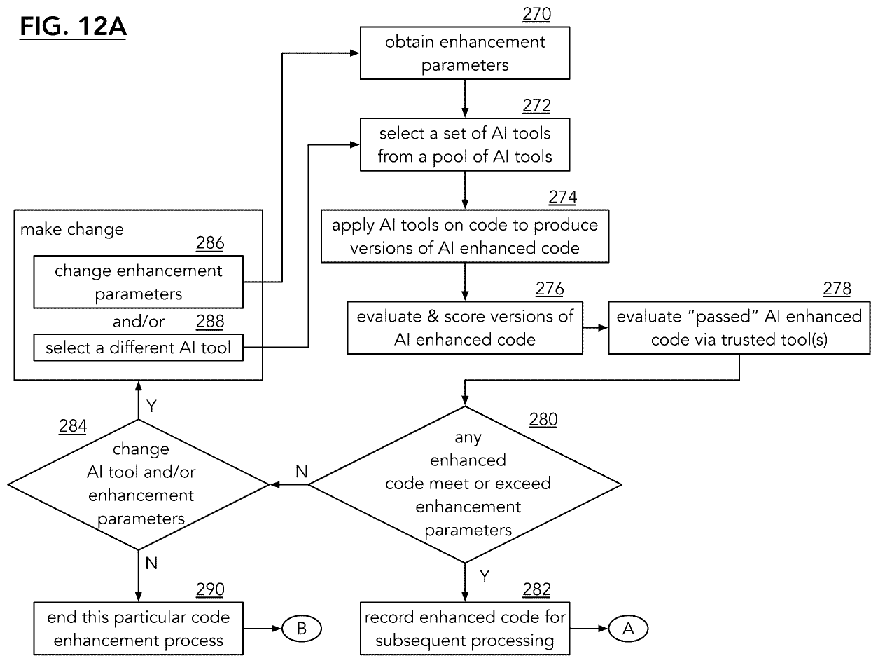

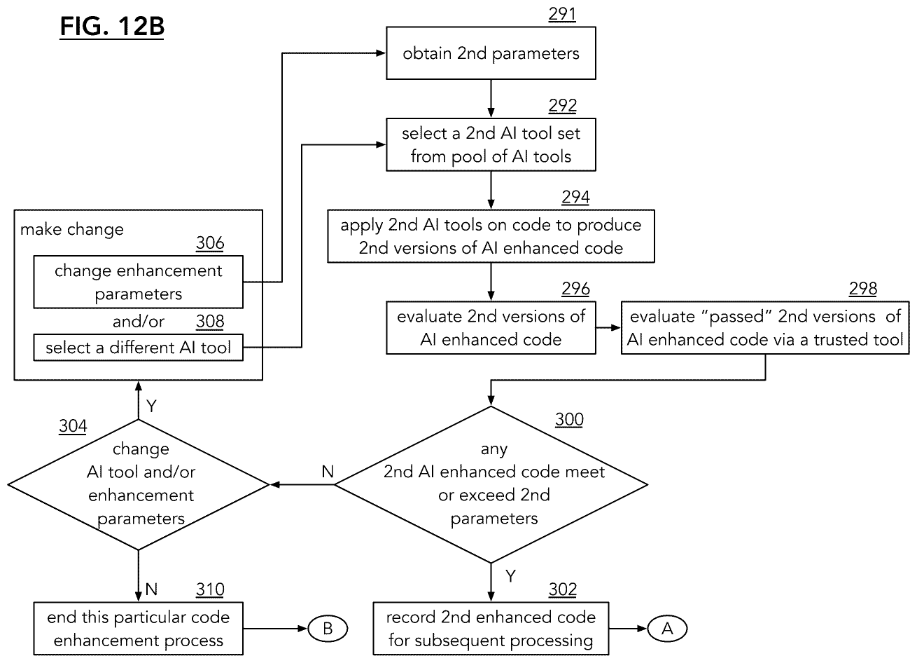

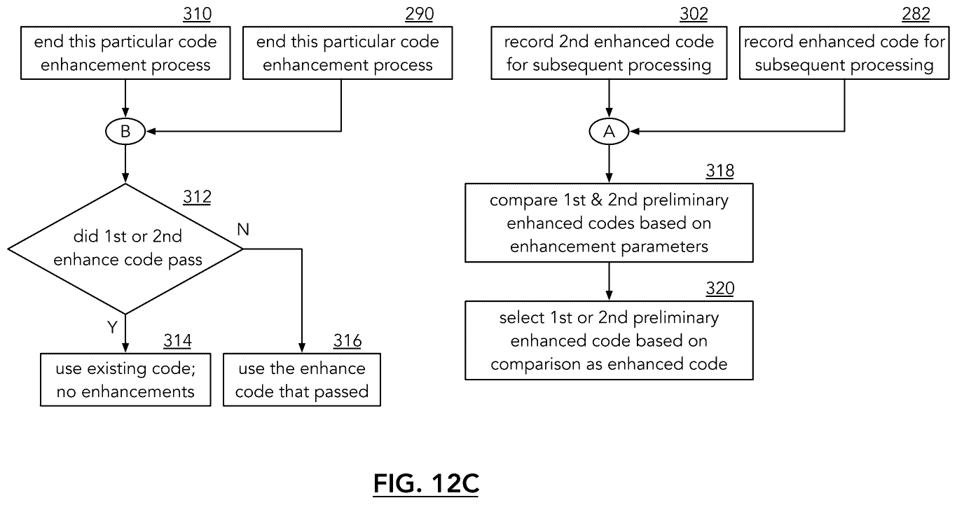

FIGS. 12A-12C are a logic diagram of an embodiment of a method for enhancing code that is performed by the code enhancement system 104. The method begins at step 270 of FIG. 12A where the code enhancement system 104 obtains the parameters regarding enhancing code. The parameters include one or more purpose parameters and/or one or more operation parameters. The code is a software program or portion thereof, where a portion is one or more sections of the code and/or one or more sub-section of a section of code.

The method continues at step 272 where the system 104 selects a set of AI tools from a pool of AI tools based on information regarding the code and based on received parameters. For each function the code sectioning module 222, the refactoring module 250, the optimization module 252, the acceleration module 254, the translation module 256, the migration module 258, the code generation module 260, and the simulation module 262 there is a corresponding pool of AI tools, where a pool includes one or more. For example, the refactoring function of extract method includes a pool of AI extract method tools that can be executed by the refactoring module 250. As another example, the optimization function of memory allocations includes a pool of AI memory allocation tools that can be executed by the optimization module 252.

In addition to selected AI tools for the code sectioning module 222 and for each required module 250-262 of the code enhancement module 224, the system may select one or more proprietary AI tools to support one or more of the selected AI tools. For example, the system selects a proprietary AI tool that improves upon the performance of a selected AI refactoring tool. Further, the system 104 selects one or more trusted tools to assist in the evaluation, scoring, and/or enhancing of code.

The selection of AI tools, proprietary of AI tools, and/or trusted tools may be done automatically by the system 104 and/or by received user selections via one or more GUIs. For example, the system 104 is configured to automatically select the tools based on the inputted parameters. As another example, the system 104 provides a recommend list of tools via a GUI to a user and the user selects the tool from the list via the GUI. As used herein, a GUI further includes an audible interface such that the recommended list of tools and the selection therefrom is done via text-to-audio processing and audio-to-text processing. As further used herein, a GUI further includes an eye tracking interface such that the recommended list of tools and the selection therefrom is done via eye movement.

The method continues at step 274 where the system 104 applies the selected tools on the code, or sections thereof, to produce versions of AI enhanced code. As part of applying the AI tools and/or AI proprietary tools, the system 104 determines an ordering of code section functions and corresponding tools to be executed by code sectioning module 222 to produce one or more versions of AI sectioned code.

As a further part of step 274, the system determines an ordering of code enhancing section functions (e.g., refactoring functions, optimizing functions, accelerating functions, translating functions, migrating functions, code generation functions, and/or code simulation functions) and corresponding tools to be executed by code enhancement module 224 to produce the versions of AI enhanced code from the one or more versions of AI sectioned code.

The method continues at step 276, where the system 104 evaluates and scores the versions of AI enhanced code. The system 104 evaluates and scores each version of AI enhanced code using one or more AI evaluation tools and/or one or more AI scoring tools. In general, the evaluation is determining whether a version of the AI enhanced code meets the inputted parameters (e.g., like a pass/fail test). In general, scoring is regarding how well a version of the AI enhanced code meets the inputted parameters (e.g., a grade). The scoring may be at various levels. For example, the scoring yields an overall score. As another example, the scoring yields an individual score for each parameter. As a further example, the scoring yields a score for each section with respect to the inputted parameters. As yet another example, the scoring yields a score for each section for each parameter of the inputted parameters.

The method continues at step 278, where the system 104 evaluates the “passed” AI enhanced code via one or more trusted tools. In this instance, “passed” refers to a successful evaluation and a favorable score. As previously mentioned, a trusted tool is typically much slower and more reliable than an AI tool. As such, the trusted tool provides a trusted, albeit typically slower, evaluation and/or scoring of a passed AI enhanced code.

The method continues at step 280, where the system 104 determines whether the any of the versions of the AI enhanced code passed the evaluation and/or scoring of the one or more trusted tools. If not, the method continues at step 284, where the system 104 determines whether to change (add, remove, etc.) one or more selected AI tools and/or selected proprietary AI tools and/or to change one or more parameters. If not, the method continues at step 290, where the system 104 ends this particular code enhancement process (e.g., applying an ordered code enhancing function tools on a version of sectioned code) and the method continues at step 312 of FIG. 12C. Note that the decision to change a tool and/or a parameter may be done automatically by the system 104 or based on user selections and/or inputs via a GUI.

If, at step 284, the decision is to change a tool and/or a parameter, the method continues to steps 286 and/or step 288. At step 286, the system 104 changes one or more parameters. At step 288, the system changes one or more AI tools and/or proprietary AI tools. Again, either of these steps may be done automatically and/via user inputs via a GUI. After parameter change is made, the method continues at step 270. After a tool changes only, the method continues at step 272. If both are changed, the method continues at step 270 and, at step 272, with deference to the selection made at step 288.

If, at step 282, there is at least one version of the AI enhanced code that met and/or exceeded the parameters, the method continues at step 282 where the system records each favorable version for subsequent processing. The method continues at step 318 of FIG. 12C.

FIG. 12B illustrates a similar method to that of FIG. 12A, but uses a different set of parameters and can perform in parallel, or serially, with the method of FIG. 12A. The method begins at step 291 where the system receives a second set of parameters (where a set includes one or more). The method continues at step 292, where the system 104 selects a second set of AI tools and/or proprietary AI tools.

The method continues at step 294, where the system 104 applies the AI tools and/or proprietary AI tools on the sectioned code to produce one or more versions of second AI enhanced code. The method continues at step 296, where the system 104 evaluates and scores the versions of the second AI enhanced code. For versions that passed the evaluation and scoring, the method continues at step 298, where the system evaluates and/or scores them using one or more trusted tools (which may be same as used for the method of FIG. 12A or different trusted tools based on the inputted parameters).

The method continues at step 300, where the system 104 determines whether any of the versions of the second AI enhanced code passed the testing and/or scoring of the trusted tools (e.g., met or exceeded the parameters). If not, the method continues at step 304, where the system 104 determines whether to change one or more of the second parameters and/or one or more the second AI tools. If not, the method continues at step 312 of FIG. 12C.

If, at step 304, the system 104 determined to change a second parameter and/or second AI tool, the method proceeds to step 306 and/or 308. At step 306, one or more parameters are changed and at step 308, one or more AI tools are changed. The method continues at step 291 and/or 292.

With reference to FIG. 12C, the method of FIG. 12A continues from step 290 and the method of FIG. 12B continues from step 310 to step 312, where the system 104 determines whether a first version of AI enhanced code or a second version of AI enhanced met or exceeded their respective parameters. If not, then the method continues at step 314, where the system determines to use the existing code since no reliable versions of enhanced code were produced. If yes, then the method continues at step 316, where the system 104 outputs the 1^{st} or 2^{nd} version of AI enhanced code that passed.

The method continues at step 318 from step 282 of FIG. 12A and/or from step 302 of FIG. 12B, where the system compares the first and second versions based on their respective parameters. The method continues at step 320, where the system 104 selects the first or second version based on the comparison.

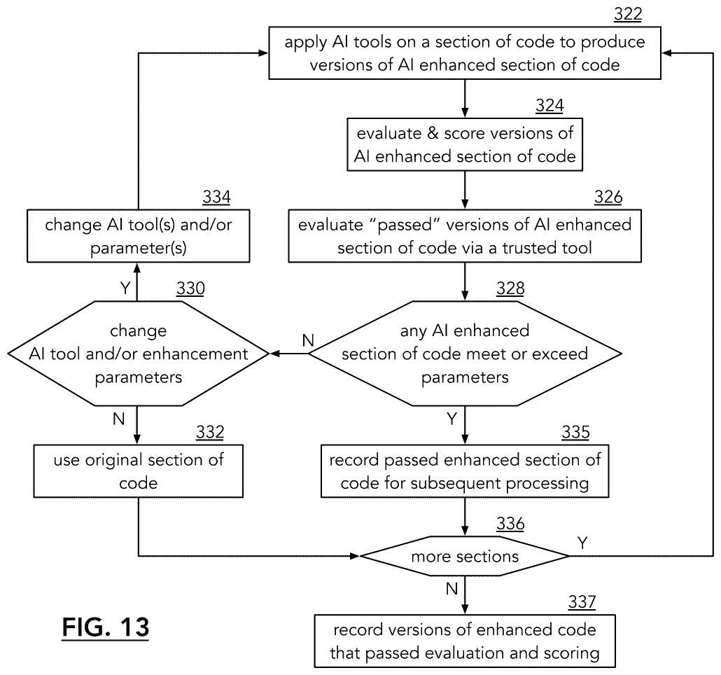

FIG. 13 is a logic diagram of an embodiment of another method for enhancing code that is executed by the code enhancement system 104. This method is comparable to the method of FIGS. 12A-12C but, in this method, the evaluating and scoring is done at the code section level. This method begins at step 322, where the system 104 applies AI tools on a section of code to produce versions of AI enhanced section of code. The method continues at step 324, where the system 104 evaluates and scores the versions of AI enhanced sections of code.

The method continues at step 326, where the system 104 evaluates passed (i.e., had a favorable evaluation and a desired score) versions of AI enhanced section of code via one or more trusted tools. The method continues at step 328, where the system determines whether any of the AI enhanced sections of code meet or exceed parameters based on the evaluation by the trusted tool(s). If yes, the method continues at step 335, where the system 104 records passed enhanced section of code for subsequent processing (e.g., combine with other sections of code to produce one or more versions of enhanced code).

The method continues at step 336, where the system 104 determines where there are more sections of the code to process. If yes, the method loops back to step 322. If not, the method continues at step 337, where the system 104 records versions of enhanced code that passed evaluation and score; one of which will subsequently be selected as the outputted enhanced code 210.

If, at step 328, none of the versions of the AI enhanced sections passed, the method continues at step 330, where the system determines whether to change one or more AI tools and/or to change one or more parameters. If yes, the method continues at step 334, where the system changes one or more AI tools and/or changes one or more parameters. The method then loops back to step 322 where the system applies the changes to the AI tools and/or to the parameters on the section of code.

If, at step 330, the system determines not to change an AI tool and/or a parameter, the method continues at step 332, where the system 104 uses the original code section. The method then continues at step 336.

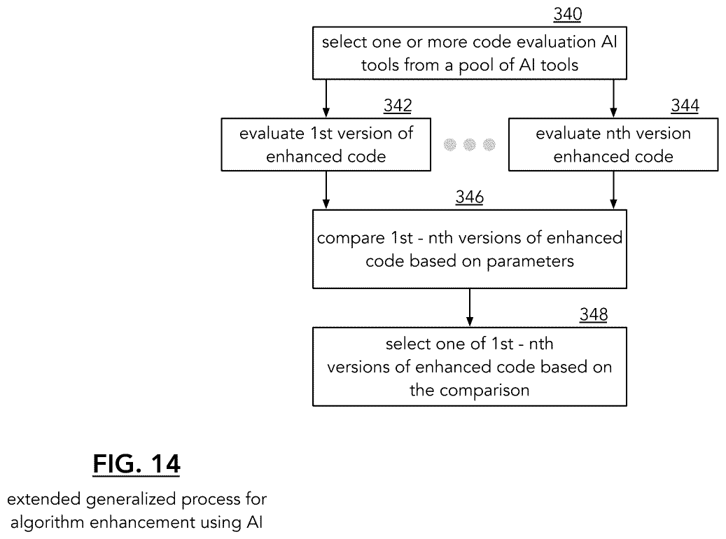

FIG. 14 is a logic diagram of an embodiment of another method for enhancing code that is executed by the code enhancement system 104. This method builds on the methods of FIGS. 12A-13 by further discussing the evaluation of a version of enhanced code or a version of an enhanced section of code. The method begins at step 340, where the system 104 selects one or more AI code evaluation tools from a pool of AI tools. The system may select an AI code evaluation tool in a variety of ways.

For example, the system selects an AI code evaluation tool based on the parameters. As a specific example, when a parameter is regarding improving CPU efficiency, the system selects one or more AI code evaluation tools that can determine the CPU efficiency of code. As another specific example, when a parameter is regarding migration to the cloud, the system selects one or more AI code evaluation tools that can verify the migration of code to a cloud platform. When there are multiple parameters, the system selects AI evaluation tools to verify compliance with each of the parameters.

The method continues at steps 342-344, where the system evaluates the 1^{st} through the n^{th} (where “n” is number equal to or greater than 2) versions of enhanced code using the selected AI evaluation tool(s). Note that the system may use the same set of AI evaluation tools for each of the versions of AI enhanced code or the system may select different sets of AI evaluation tools for different versions of AI enhanced code. The system 104 determines to use different sets of AI evaluation tools based on the AI tools used to create the versions of AI enhanced code. For example, some AI evaluation tools are specifically designed to evaluate enhanced code produced by a specific AI enhancing tool.

The method continues to step 346, where the system 104 compares the evaluations of the 1^{st} through the n^{th} versions of the enhanced code. One or more the 1^{st} through n^{th} versions are selected based on the comparison (e.g., the ones that best meet the parameters). The method continues at step 348, where the system 104 selections one of the selected 1^{st} through n^{th} versions and the outputted enhanced code. To make this selection, the system 104 utilizes one or more trusted tools to evaluate the original code and enhancements thereto. The system selects the one selected 1^{st} through n^{th} versions that best comports to the trusted evaluation.

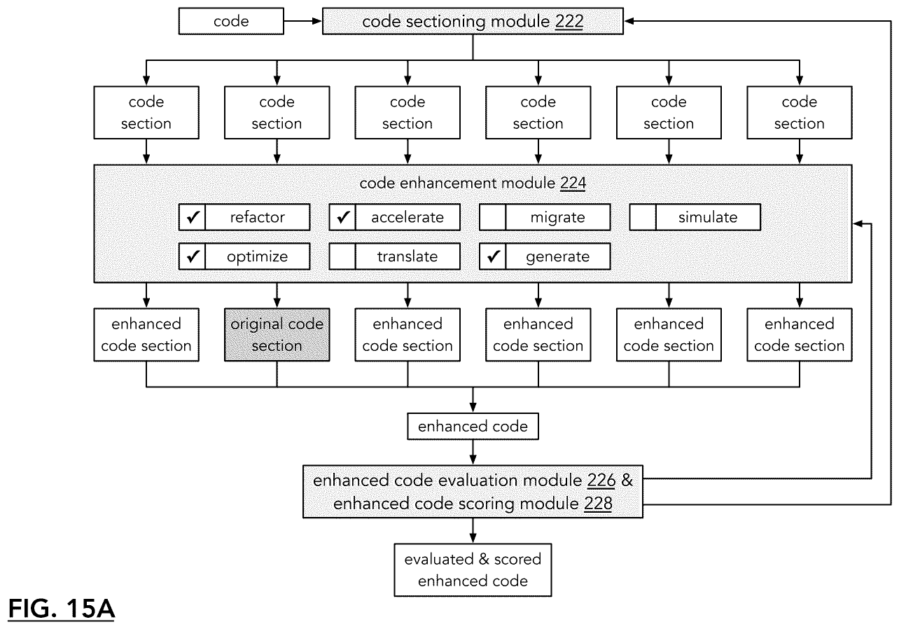

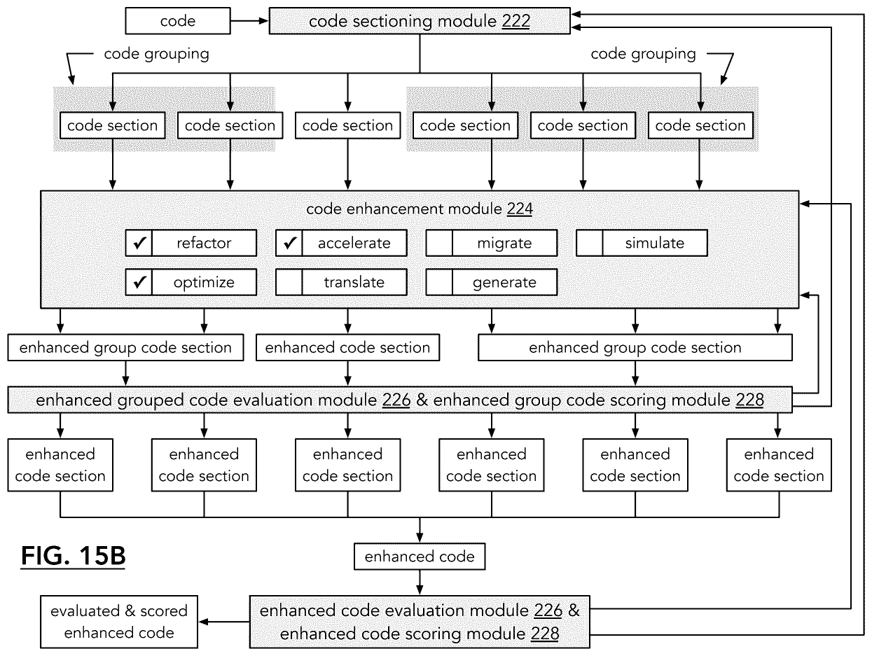

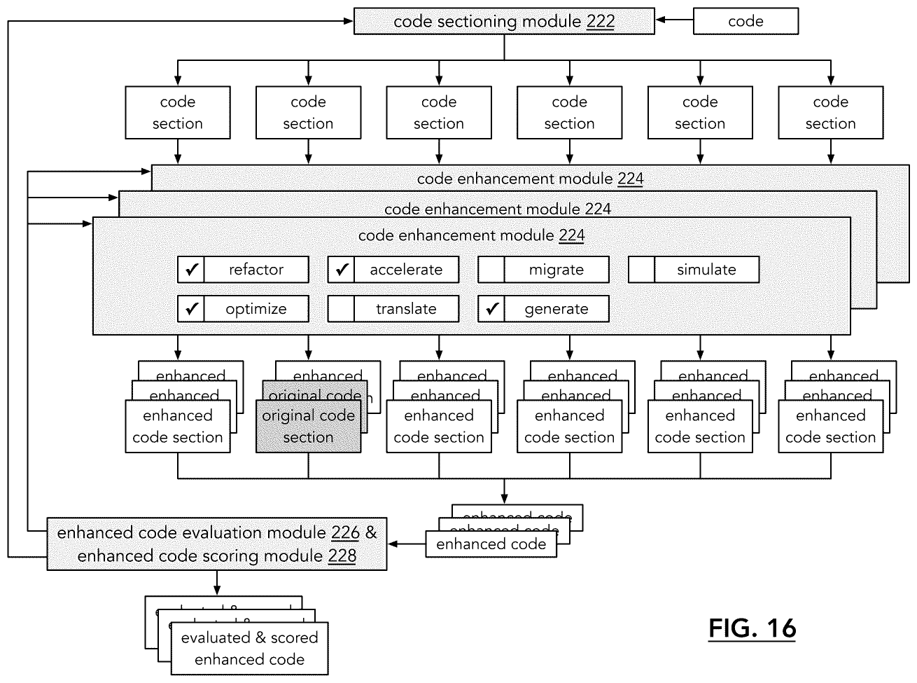

FIG. 15A is a schematic block diagram of an example of code enhancing of the code enhancement system 104. As shown, the coding section module 222 receive code (newly generates and/or existing code) and sections it into a plurality of sections. The code enhancement module 224 receives the plurality of code sections.

In this example, the parameters indicate that the code enhancement module 224 is to refactor, optimize HW usage, and accelerate SW. For each of the received section, the code enhancement module 224 utilizes AI tools and/or proprietary AI tools to refactor, optimize, and/or accelerate to produce AI enhanced code sections. One or more sections of the original code may pass through the code enhancement module without enhancing for a variety of reasons. For example, a code section was identified by a user not to be altered. As another example, the code enhancement module 224 determined not to alter a code section for one or more of a plurality of reasons. Such reasons include, but are not limited to, security concerns, the code section is too short to optimize, the code identifies the code section as not to be altered, etc.

The AI enhanced code sections and any original code sections are combined to produce an AI enhanced code. The enhanced code evaluation module 226 evaluates the AI enhanced code and, if it passes evaluation, the enhanced code scoring module scores it. If the score is at or above a desired level, the system 104 outputs the evaluated and scored enhanced code.

If the AI enhanced code does not pass evaluation and/or has less than a desirable score, the enhanced code evaluation module 226 and/or the enhanced code scoring module 228 provides feedback to the code sectioning module 222 and/or to the code enhancement module 224. When the code sectioning module 222 receives the feedback, it uses the feedback to adjust how it sections the code. When the code enhancement module 224 receives the feedback, it uses the feedback to adjust how it enhances the sections of code. This loop continues until the system produces an acceptable enhanced code or until it determines that the original code does not need enhancing.

FIG. 15B is a schematic block diagram of another example of code enhancing that is similar to the example of FIG. 15A. The difference in this figure is how the code sectioning module 222 sections the code. In this example, the code sectioning module 222 sections the code in sections and sub-sections. As shown, two code sections are in a first group, three code sections are in a second group, and one code section is by itself. In this example, the group is a section and the code sections are sub-sections of the group. As an example, the first group includes two related sub-routines of a routine.

The code enhancement module 224 receives the code sections and corresponding code groupings and functions to enhance not only individual code sections, but the coding groupings as well. The code enhancement module 224 refactors, optimizes, and accelerates the code sections and corresponding code groupings using one or more selected AI tools and/or proprietary AI tools.

In this example, the enhanced code evaluation module 226 and the enhanced code scoring module 228 first evaluate and score the enhanced code groupings. If enhanced groupings have favorable evaluations and acceptable scores, the enhanced code evaluation module 226 and the enhanced code scoring module 228 evaluate the AI enhanced code (i.e., all of the sections recombined to create the AI enhanced code). If an enhanced grouping does not have a favorable evaluation and/or an acceptable score, the enhanced code evaluation module 226 and the enhanced code scoring module 228 provides feedback to the code sectioning module 222 and/or to the code enhancement module 224.

FIG. 16 is a schematic block diagram of another example of code enhancing that is similar to the example of FIG. 15A. In this example, the code enhancement module 224 processes the code sections in parallel using different combinations of AI tools and/or proprietary AI tools to generate multiple versions of enhanced code. The enhanced code evaluation module 226 and the enhanced code scoring module 228 evaluate and score, as discussed above, each version of the enhanced code and identifies each version that has a favorable evaluation and an acceptable score. The system 104 selects one of the identified versions and the enhanced code 210.

If none of the versions of enhanced code have a favorable evaluation and an acceptable score, the enhanced code evaluation module 226 and/or the enhanced code scoring module 228 provide feedback to the code sectioning module 222 and/or to the code enhancement module 224 and the process repeats to generate new versions of enhanced code.

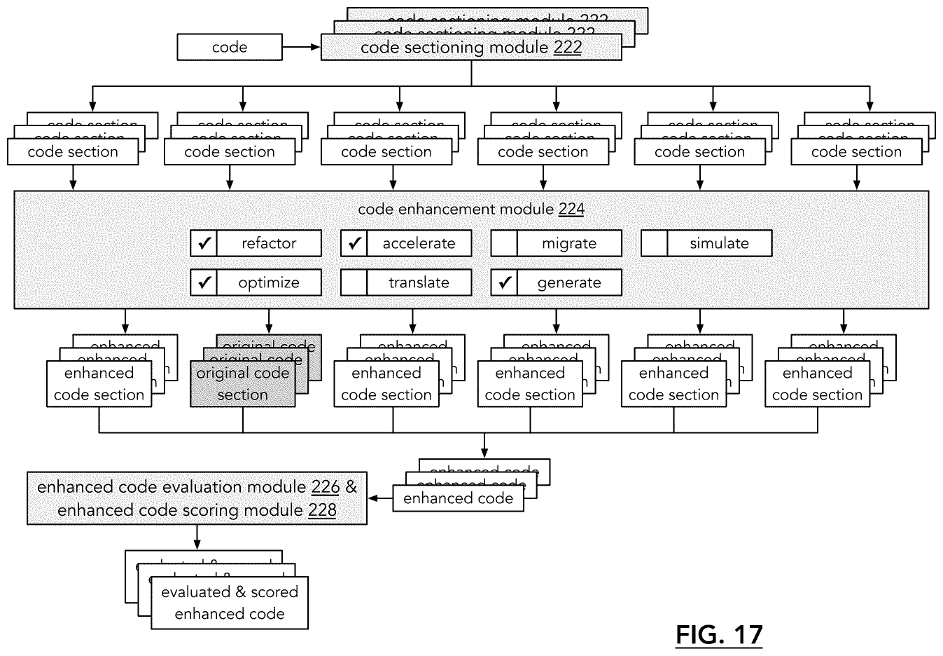

FIG. 17 is a schematic block diagram of another example of code enhancing that is similar to the example of FIG. 15A. In this example, the code sectioning module 222 generates a plurality of different versions of coding sectioning of the code. The code enhancement module 224 applies the same set of selected AI tools and/or proprietary AI tools to the versions of code sectioning to produce a plurality of versions of enhanced code.

The enhanced code evaluation module 226 and the enhanced code scoring module 228 evaluate and score, as discussed above, each version of the enhanced code and identifies each version that has a favorable evaluation and an acceptable score. The system 104 selects one of the identified versions and the enhanced code 210.

If none of the versions of enhanced code have a favorable evaluation and an acceptable score, the enhanced code evaluation module 226 and/or the enhanced code scoring module 228 provide feedback to the code sectioning module 222 and/or to the code enhancement module 224 and the process repeats to generate new versions of enhanced code. Feedback path not shown in this figure.

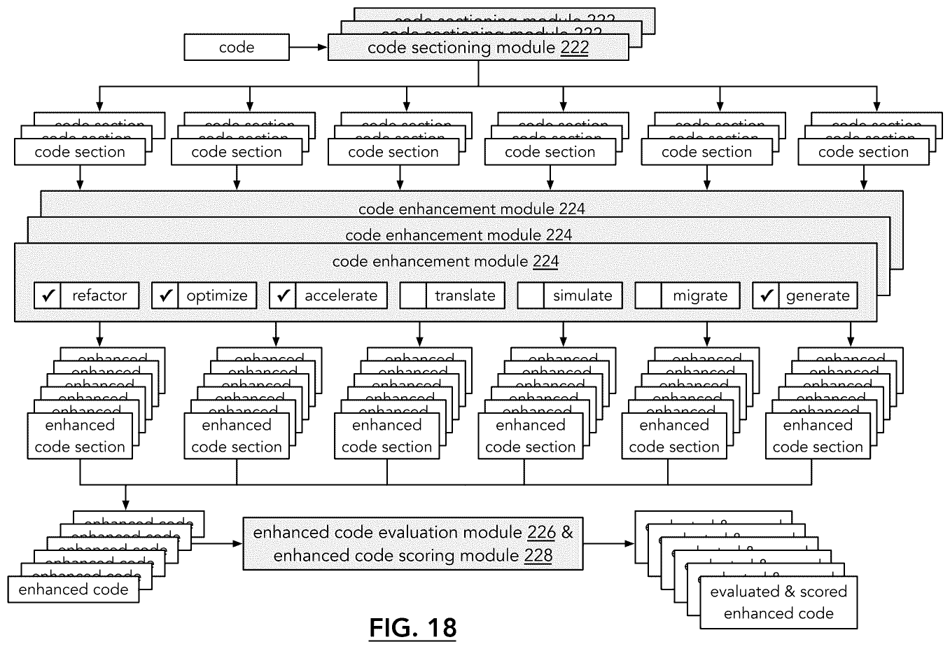

FIG. 18 is a schematic block diagram of another example of code enhancing this is a combination of the examples of FIGS. 16 and 17. As per FIG. 17, the code sectioning module 222 generates a plurality of versions of coding sectioning. As per FIG. 16, the code enhancement module 224 uses different sets of AI tools and/or proprietary AI tools on a code sectioning. In this figure, the code enhancement module 224 applies the different sets of tools to each of the versions of code sectioning to produce a multiple number of versions of enhanced code. The enhanced code evaluation module 226 and the enhanced code scoring module 228 process the versions of enhanced code as previously discussed.

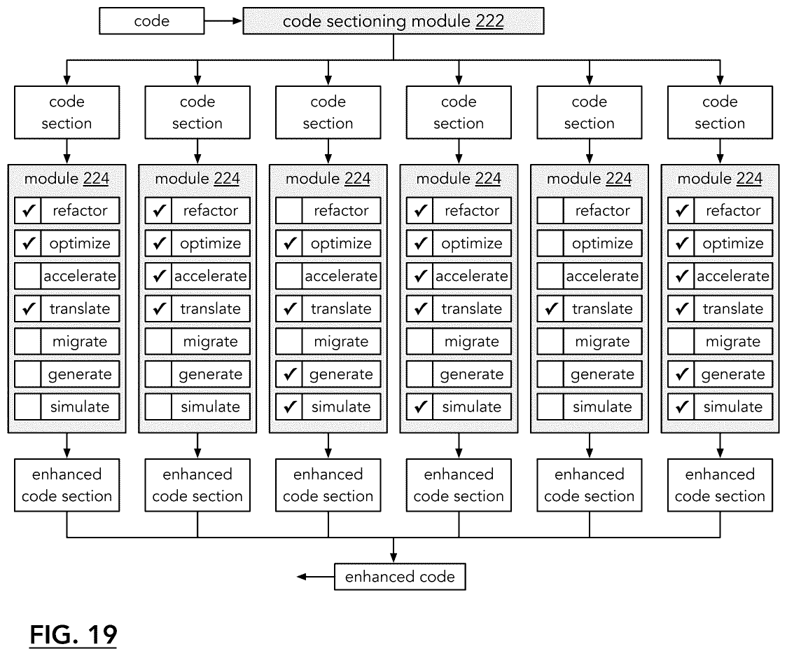

FIG. 19 is a schematic block diagram of another example of code enhancing. In this example, the code sectioning module 222 sections code into a plurality of code sections as previously discussed. This example further illustrates that the code enhancement module 224 is divided into a plurality of sub-modules, each processing a respective code section. Accordingly, each code section can be enhanced using different enhancement factors. For example, the first code section is being enhanced based on the enhancement factors of refactoring, optimizing, and translating; the second code section is being enhanced based on the enhancement factors of refactoring, optimizing, accelerating, and translating; and so on.

The resulting enhanced code sections are combined to produce a version of enhanced code that is evaluated and scored by the code evaluation module 226 and the enhanced code scoring module 228 as previously discussed. Note that a sub-module of the code enhancement module 224 can process enhancement of one or more code sections. Further note that the examples of FIGS. 15A through 19 can be combined in a variety of ways to produce a variety of versions of enhanced code.

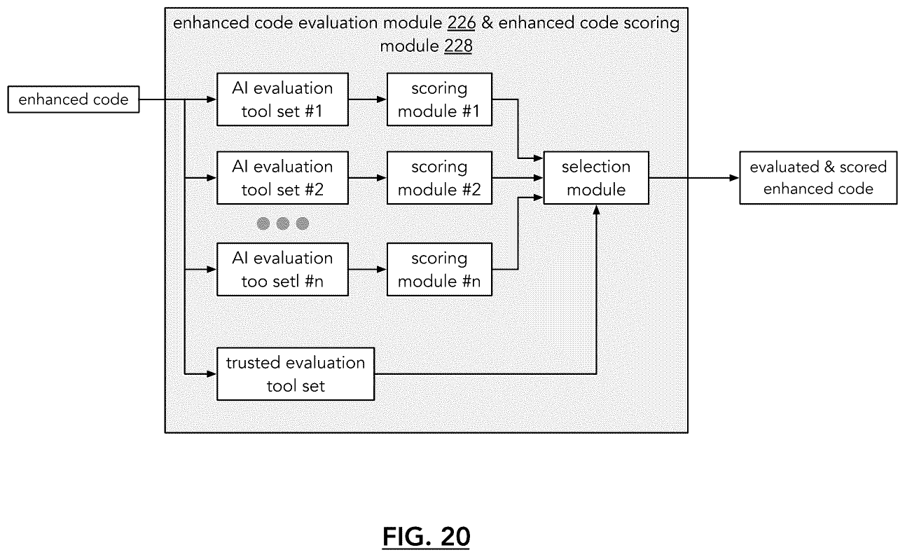

FIG. 20 is a schematic block diagram of an embodiment of a module that embodies an enhanced code evaluation module 226 and an enhanced code scoring module 228. The module includes a plurality of AI evaluation tool sets, a plurality of scoring modules, a trusted evaluation tool set, and a selection module. An evaluation tool set includes one or more AI evaluation tools and/or one or more proprietary AI tools. The particular evaluation tools in a tool set depend on the enhancing function(s) used to produce the enhanced code. For example, if refactoring was used to enhance the code, then the AI evaluation tool set would include one or more AI refactoring evaluation tools and/or one or more proprietary AI refactoring tools.

In an example of operation, each of the AI evaluation tool sets evaluates enhanced code, or an enhanced code section, to produce respective evaluations. For each AI evaluation tool set that has a favorable evaluation of the enhanced code, or enhance code section, the AI evaluation tool set passes the enhanced code, or enhanced code section, to its corresponding scoring module.

The respective scoring modules score the enhanced code, or enhanced code section. For each scoring module that produced an acceptable score, the scoring module provides the enhanced code, or enhanced code section, to the selection module.

The trusted evaluation tool set evaluates the enhanced code, or enhanced code section, to produce a trusted evaluation. The selection modules uses the trusted evaluation to verify the evaluation and scoring of AI evaluation tool sets and scoring module pairs. Having verified that the enhanced code had at least one favorable evaluation and has a corresponding favorable score, it passes the enhanced code as the outputted enhanced code.

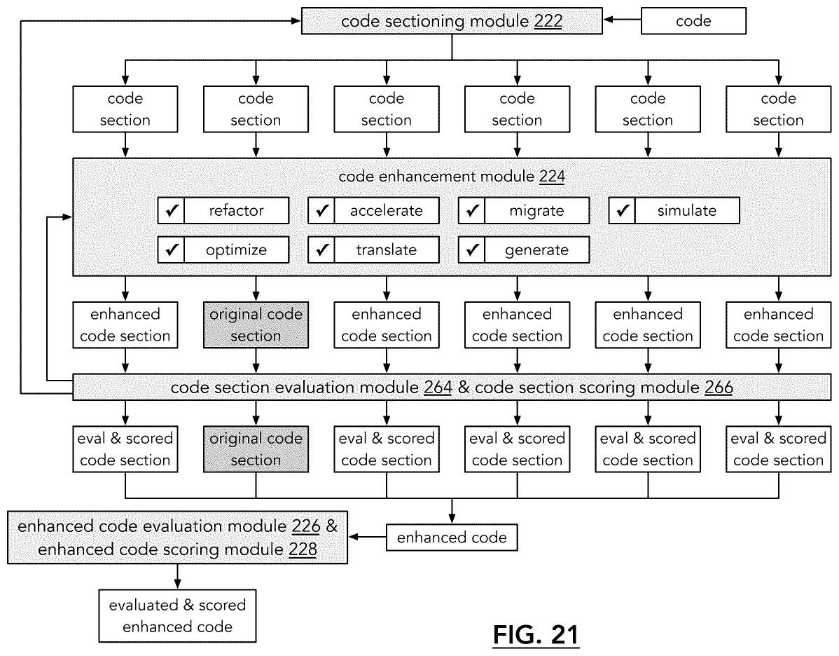

FIG. 21 is a schematic block diagram of another example of code enhancing that is similar to the example of FIG. 15A. In this example, one or more of the AI enhanced codes sections is evaluated and scored by a code section evaluation module 264 and a code section scoring module 266. If an AI enhanced code section has a favorable evaluation and a favorable score, it becomes part of the enhanced code.

If an AI enhanced code section does not have a favorable evaluation and a favorable score, the code section evaluation module 264 and/or the code section scoring module 266 provides feedback to the code sectioning module 222 and/or to the code enhancement module 224. This feedback process continues until the code section obtains a favorable evaluation and favorable score or until the system determines to use the original code section.

When all of the AI enhanced code sections have a favorable evaluation and a favorable score, the enhanced code evaluation module 226 and the enhanced code scoring module 228 evaluate and score the enhanced code as previously discussed. Note that the example of FIG. 21 can be combined with the examples of FIGS. 15B-19 to increase the scale of generating versions of enhanced code. Further note that the code enhancement system 104 is capable of enhancing multiple codes at the same time using one or more of the configurations discussed herein.

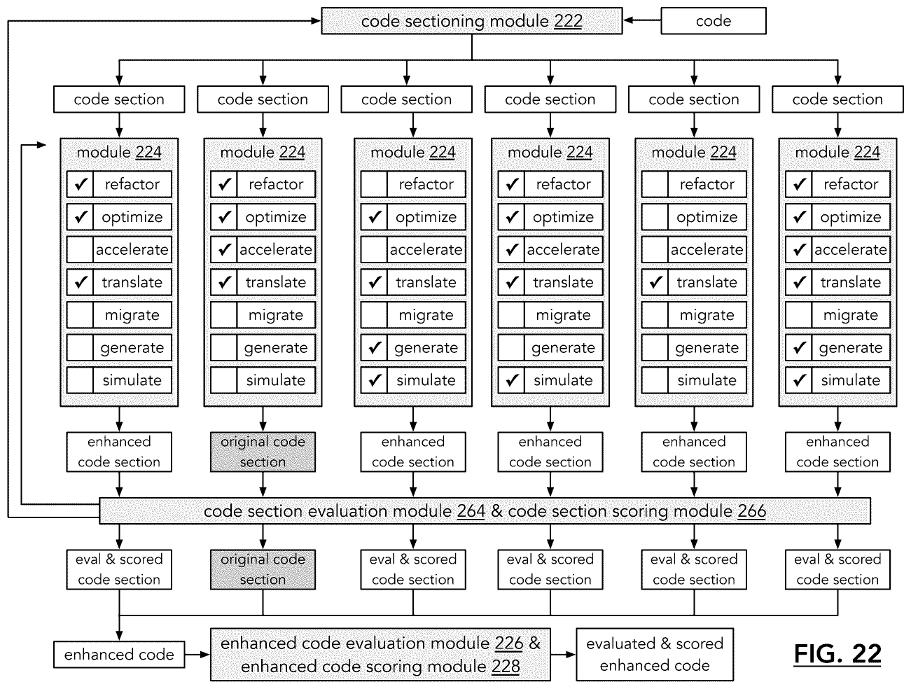

FIG. 22 is a schematic block diagram of another example of code enhancing that is similar to the examples of FIGS. 19 and 21. As in FIG. 19, each code section, or a group of them, is individually enhanced by a corresponding code enhancement sub-module 224 to produce an AI enhanced code section. As in FIG. 21, each AI enhanced code section is evaluated and scored by the code section evaluation module 264 and the code section scoring module 266.

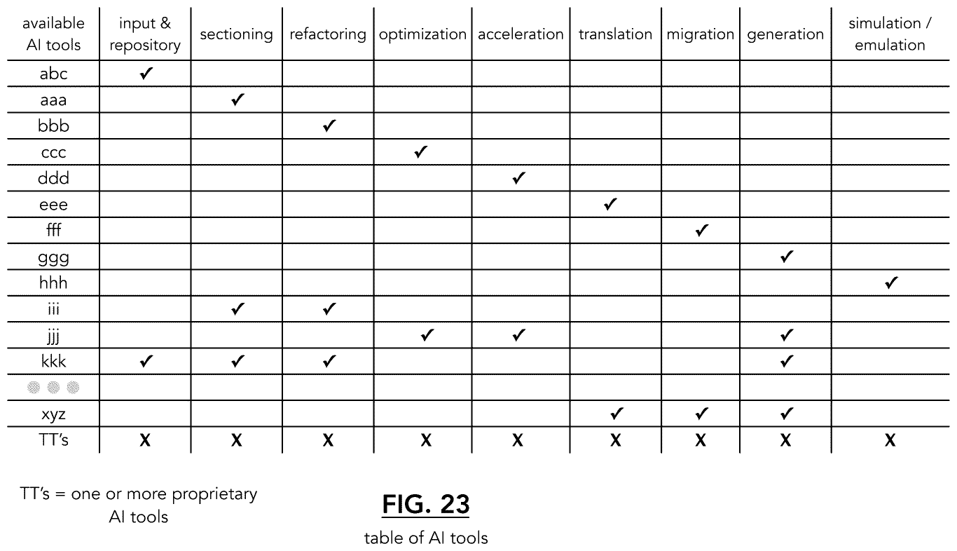

FIG. 23 is a schematic block diagram of an example of a table of artificial intelligence (AI) tools as compiled by the code enhancement system 104. The table includes the name of each AI tool and its corresponding enhancement functions are identified. An AI tool may be capable of supporting multiple enhancement functions. As shown, the enhancing functions include input & repository, sectioning, refactoring, optimalization, acceleration, translation, migration, code generation, simulation/emulation, and could further include documentation.

In this example, AI tools “abc” through “xyz” are publicly available AI tools and, as such, are only being used, evaluating, and scored (or rate) by the code enhancement system 104. The code enhancement system 104 does create its own proprietary AI enhancement tools, which are identified in the table under the name TT's. In the table, check marks are used to indicate that the AI tools performs the corresponding function and an “X” means that the proprietary AI tools performs, supports, and/or augments the corresponding function.

The code enhancement system 104 routinely (e.g., continually, hourly, daily, etc.) updates the table to add new AI tools, the edit information about AI tools in the table, and/or to delete an AI tool from the table. The system 104 may delete an AI tool from the table for a variety of reasons. For example, the AI tool is no longer publicly available. As another example, the system 104 has determined that the AI tool performs poorly. As a further example, the system 104 has found superior AI tools that perform the same enhancing functions.

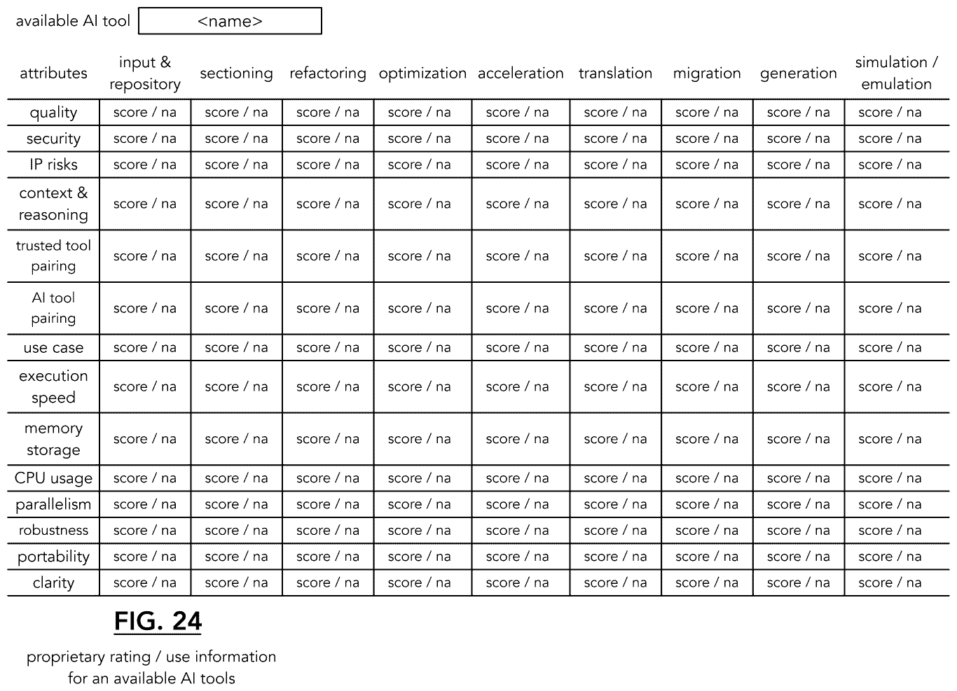

FIG. 24 is a diagram of an example of a table regarding a specific artificial intelligence (AI) tool. The table is identified by the name of the AI tool and it includes a column for attributes (which may include more or less than those shown) and a plurality of columns are for the enhancement functions. As previously discussed, the enhancement functions include input &/or repository, sectioning, refactoring, optimization, acceleration, translation, migration, generation, and simulation/emulation.

The attributes include performance attributes and use attributes. The performance attributes include, but are not limited to, quality, security, IP risk, context & reasoning, execution speed, memory storage, parallelism, robustness, portability, and clarity, which are each further discussed in the glossary section. The use attributes include, but are not limited to, trusted tool pairing, AI tool pairing, and use case. The trusted tool pairing attribute includes a list of trusted tools that have been used to evaluate the performance of this AI tool. It further includes a score for each listed trusted tool, where the score indicates a probability of the AI tool having a favorable comparison with the trusted tool. The probability is based on past comparisons between the AI tool and the trusted tool.

The AI tool pairing attribute includes a list of AI tools that this AI tool has been paired with to enhance code. The pairing may be with one other AI tool or with a group of other AI tools. The AI tool pairing attribute further includes a score for each pairing, where the score indicates a probability of the AI tool and the pairing with other AI tools produces AI enhanced code that has a favorable evaluation and a favorable score. The AI tool pair may further indicate whether the pairing is regarding downstream processing (e.g., other AI tools perform their respective enhancement functions prior to this AI tool), is regarding upstream processing (e.g., this AI tool performs its enhancement function(s) before the other AI tools), and/or is regarding independent processing (e.g., this AI tool and the other AI tools are independent enhancement functions and can be performed without dependency on the outputs produced by the other AI tools).

The use case attribute includes a list of uses of the AI tool. An entry in the list includes information regarding the code for which the AI tool was used. The information includes the type of code (e.g., user application, system application, utility application, operating system, a sub-routine of an application or an operating system, a bug fix for an application or an operating system), the programming language, the platform (e.g., local, cloud, etc.), the parameters regarding enhancing the code, etc. The use case attribute further includes a scoring for each use case, where the score indicates a probability of the enhanced code having a favorable evaluation and a favorable score.

Some AI tools may be specific (e.g., one attribute of one enhancement function), others may be broad (e.g., multiple attributes of multiple enhancement functions), and the remaining are somewhere in between specific and broad. As an example, a first AI tool is regarding the enhancing function of refactoring and its attributes are quality, security, and execution speed. For each of these attributes of refactoring, the code enhancement system 104 scores them each time the AI tool is used. For this example AI tool, the scoring indicates the probability of the AI tool producing a favorable refactoring evaluation and a favorable refactoring score. All other fields in the table for this AI tool would have non-applicable (n/a) indications, which could be represented by the term “n/a” or the like, or the field is empty or blank.

The code enhancement system 104 routinely updates this table and stores it in the AI tools record 227 (of FIG. 8). In addition, the code enhancement system uses the data of this table in creating its proprietary AI tools. For example and with reference to the first AI tool regarding refactoring of the preceding paragraph, assume that the first AI tool has high probability scores for quality and security but a lower probability score for execution speed. The code enhancement system 104 analyzes the first AI tool's operations regarding execution speed to identify inefficiencies and/or inaccuracies with one or more operations. When the code enhancement system 104 identifies an inefficiency and/or inaccuracy, it generates a fix that is incorporated in a proprietary AI tool.

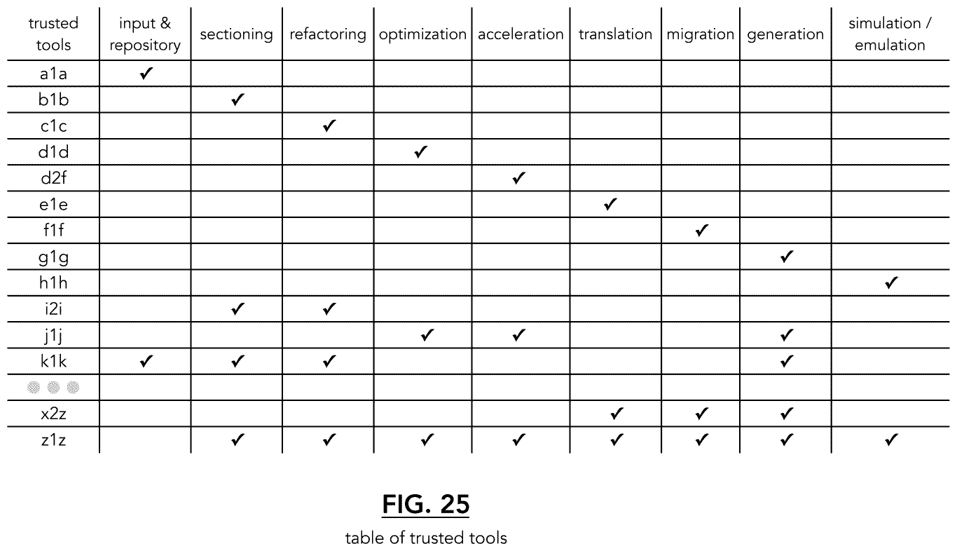

FIG. 25 is a diagram of an example of a table of trusted tools. The table includes a plurality of columns for the name of the trusted tool and for enhancement functions. For a trusted tool, the table indicates which of the enhancement functions it performs. For example, trusted tool bib performs sectioning, trusted tool c1e performs refactoring, and so on.

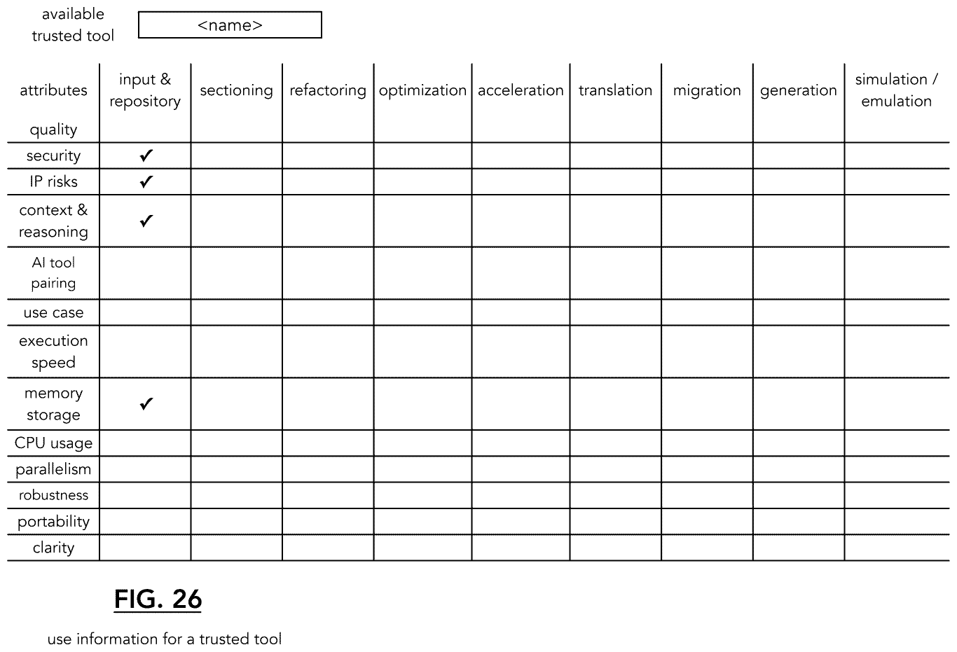

FIG. 26 is a diagram of an example of a table regarding trusted tool. This table is regarding the attributes of a particular trusted tool for the corresponding enhancement functions it performs. This table, like the table of FIG. 24, includes performance attributes and use attributes. In contrast to FIG. 24, which includes a score for each applicable performance attribute, this table just includes a checkmark, or the like, to indicate which performance attributes for which enhancement functions the trusted tool performs. There is no need for a score since the tool is trusted (meaning that it has a reliable and consistent favorable score).

As for the use attributes, the table includes a list of AI tooling pairings and use cases. The list of AI tooling pairings includes the pairings of two or more AI tools for which this particular trusted tool has been used to review the enhanced code, or enhanced code section, produced by the AI tool pairing.

The use case attribute includes a list of uses of the trusted tool. An entry in the list includes information regarding the code for which the trusted tool was used. The information includes the type of code (e.g., user application, system application, utility application, operating system, a sub-routine of an application or an operating system, a bug fix for an application or an operating system), the programming language, the platform (e.g., local, cloud, etc.), the parameters regarding enhancing the code, etc.

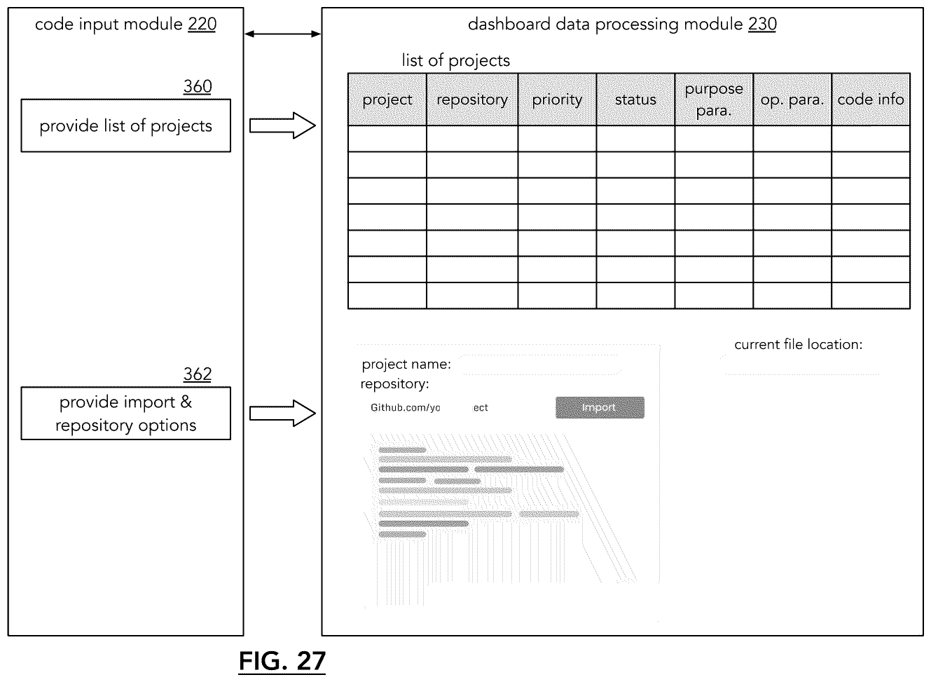

FIG. 27 is a schematic block diagram of an example of a providing a list of projects and selection of a project. In this example, the code input module 220 provides a list of projects 360 (e.g., code to be enhanced, code that has been enhanced, and/or code that is being enhanced) to the dashboard data processing module 230. The list 360 includes a number of code projects, which can become a very large list. Accordingly, the list can be sorted in a variety of ways. For example, by enhancing status (e.g., to be enhanced, being enhanced, has been enhanced), by name, by code type (e.g., user application, utility application, system application, operating system, API, driver, bug fix, etc.), by platform (e.g., software, hardware, cloud, etc.), and/or other sorting criteria.

The dashboard data processing module 230 generates a GUI that provides a graphical representation of the list of projects. In this example, the list is represented as a table. The table includes columns for the project name, the repository storing the code or to store the code, the priority of enhancing the code, the status of enhancing the code, performance parameters, operational parameters, and code information, as defined in the glossary section. The rows correspond to projects and their respective column data.

For each project, some or all of the data may be unknown other than the project name when it is first displayed in the table. With the table being displayed via a GUI, a user can input the data for a particular project. Alternatively, the code enhancement system determines the data and inputs it into the table.

For a code project for which the code has not yet been stored in the desired repository (which may be within the code enhancement system 104, with a collaborative code development repository, a cloud storage location, etc.), the code input module 220 provides import and/or repository options 362 for a listed code project to the dashboard data processing module 230.

The dashboard data processing module 230 generates a GUI to display importing and/or repository options for a listed code project. In an example, a user inputs a project name (e.g., code name) from the list of projects and inputs a repository (e.g., a memory location, a file link, an HTML link, URL link, etc.). The inputting of a project name may be done in a variety of ways. For example, the user selects the project name (e.g., code project name) from the list using a cursor or other selection means. As another example, the user types in the project name. The inputting of repository may be done in a variety of ways. For example, the user types in repository. As another example, the user selects the repository from a dropdown list.

For a new code project (i.e., not already in the list of projects), the code input module 220 provides import and/or repository options 362 for a new code project to the dashboard data processing module 230. The dashboard processing module 230 generates a GUI for entering a new code project into the list of projects. The GUI includes the project name, the repository, and further includes a current file location.

In an example of operation for entering a new project into the list of projects, the user enters a current file location. The code input module 220 attempts to access the code from the current file location via the network connections of the enhancement computing entity 106 that executes the code enhancement system 104. When the code input module 220 successfully accesses the code, a project name is entered, a repository is entered, and an entry is the list of projects is created.

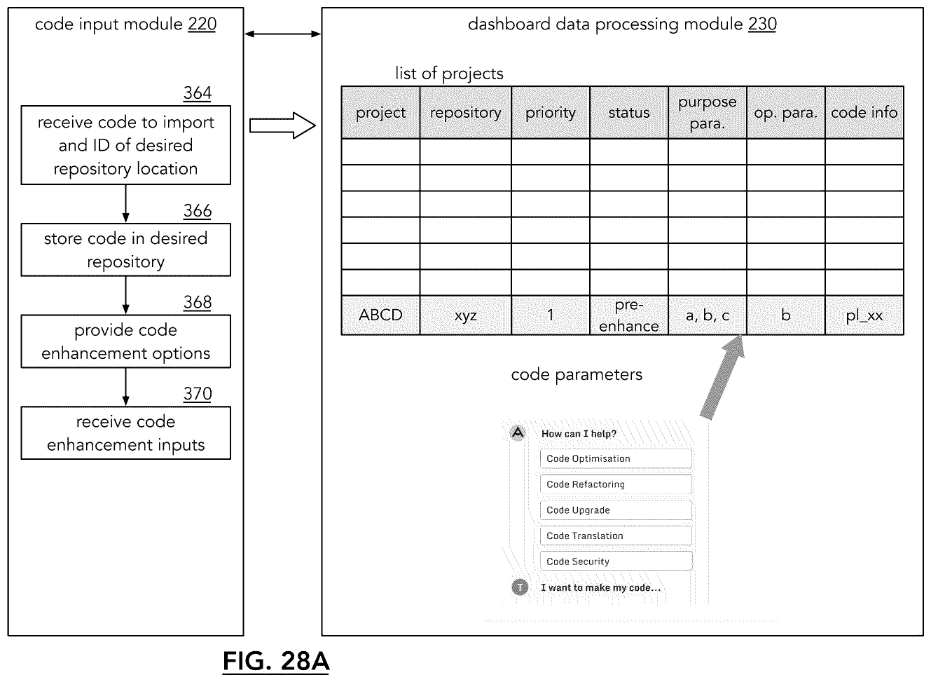

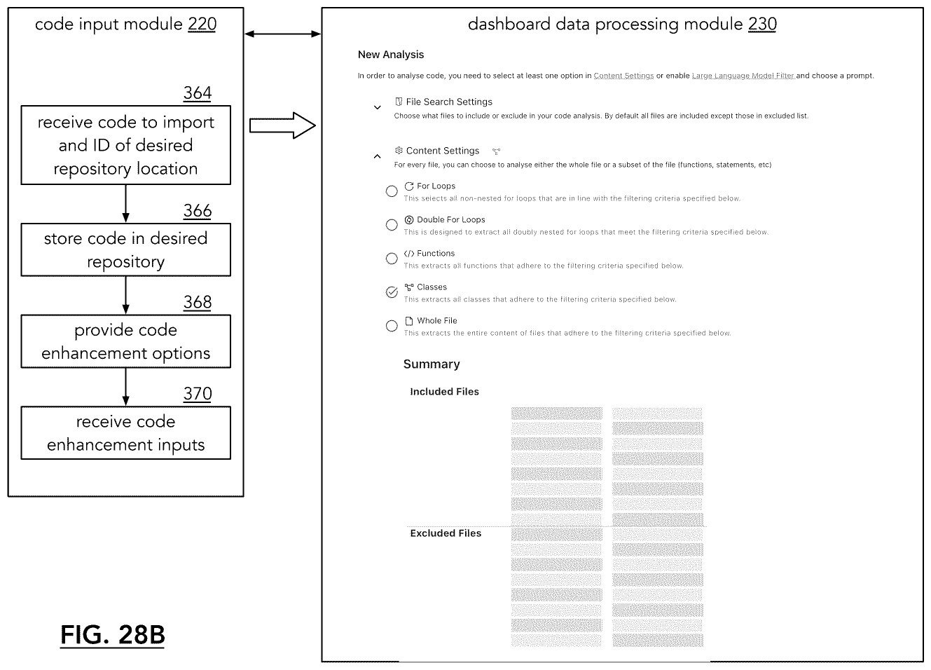

FIG. 28A is a schematic block diagram of an example of a selecting parameters for a particular project. In this example, the code has not yet been stored in the desired repository. As such, the code input module 220, at step 364, receives code to import and the identify (ID) of a desired repository location. The code input module 220, at step 366, stores the code in the desired repository. The dashboard data processing module 230 updates the list to include the desired repository.

The code input module 220, at step 368, provides code enhancement options (e.g., a list of purpose parameters and operation parameters) to the dashboard data processing module 230. The dashboard data processing module 230 generates a GUI for selecting the code enhancement options. In an example, the dashboard data processing module provides a graphical representation of the list of purpose parameters and a list of operation parameters from which the user selects the desired parameters.

The code input module 220, at step 370, receives the code enhancement inputs and adds them to the list of projects. The dashboard data processing module provides a corresponding update to the graphical representation of the list of projects.

In another example, the dashboard data processing module 230 provides a more “user friendly” GUI. This GUI is directed towards a higher level dialog with the user. For example, the GUI provides a question of “how can I help” and provides a list of options as to how the system can help enhance code. As another example, the GUI provides a question regarding “I want to make my code . . . ?” and provides list of options as to what the system can do to the code. The GUI can include further questions such as “What is main reason, or reasons, for enhancing your code?”; “How much improvement do you want as a result of enhancing your code?”; and so on.

The code input module 220, at step 370, receives the answers to the question as code enhancement inputs and interprets the answers to determine the appropriate purpose parameters and the appropriate operation parameters. The code input module 220 may further determine the priority of enhancing the code based on the answers to the questions. The code input module 220 updates the list of projects accordingly. The dashboard data processing module provides a corresponding update to the graphical representation of the list of projects.

FIG. 28B is a schematic block diagram of another example of a selecting parameters for a particular project. In this example, the code input module 220 performs the same steps as in FIG. 28A but the dashboard data processing module 230 provides a different GUI. The GUI includes a new analysis section and a summary section. The new analysis section includes sub-sections for file search settings and content setting that includes sub-sub-sections of for loops, double for loops, functions, classes, and whole file.

The file search settings enable the code enhancement system 104 to find files of code for analysis, where the code may be contained in one or more files. For a code that is contained in more than one file, the code enhancement system identifies each file and determines whether the file is to be included or excluded in the enhancement process. This determination, which may be based on user inputs and/or an automated function, is recorded in the summary section.

The code enhancement system 104 determines, via user input and/or an automated process, the settings for each of sub-sub-sections of for loops, double for loops, functions, classes, and whole file. The code input module 220 records the determinations and the dashboard data processing module may provide a graphical representation thereof. Note that some text of the GUI is intentionally small and may be difficult to read.

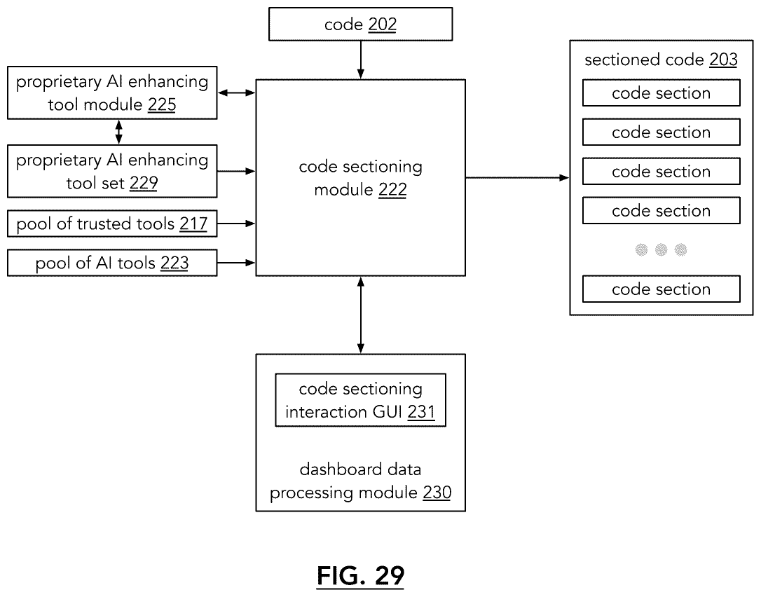

FIG. 29 is a schematic block diagram of an example of operation of a code sectioning module 222, the dashboard data processing module 230, and the proprietary AI enhancing tool module 225. The code section module 221 sections code 202 to produce one or more versions of sectioned code 203 using one or more proprietary AI tools 229, one or more AI tools 223, and/or one or more trusted tools 217.

A version of sectioned code 203 includes a plurality of code sections. In general, a code section is a portion of the code 202. A code section may include one or more code sub-sections, a code sub-section may include one or more code sub-sub-sections. There are a variety of ways to section code as will be described with reference to one or more subsequent figures.

In an example, the code sectioning module 222 uses a combination of AI tools and/or proprietary AI tools to produce a version of the sectioned code 203. In an example, the code sectioning module 222 uses different combinations of AI tools and/or proprietary AI tools to produce a plurality of versions of the sectioned code 203.

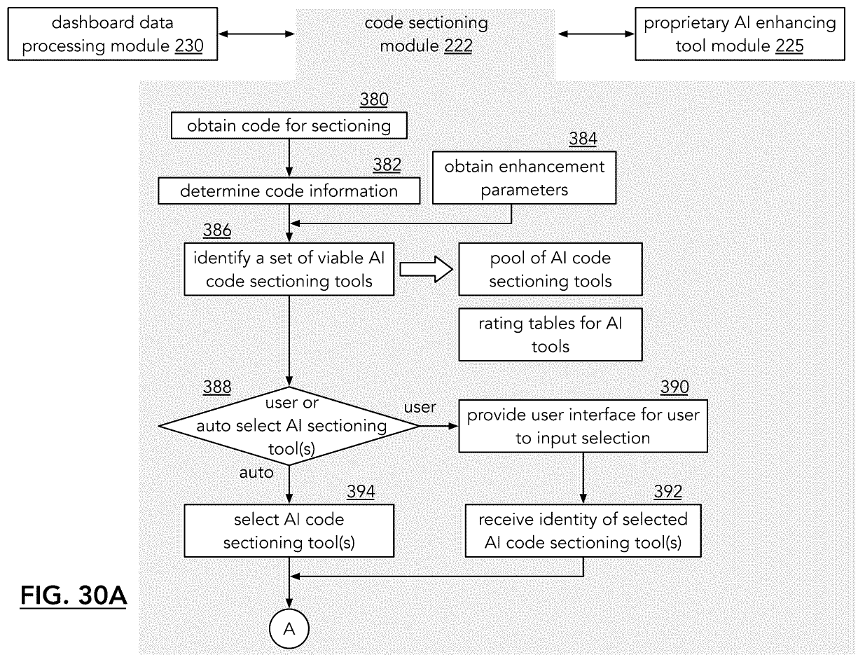

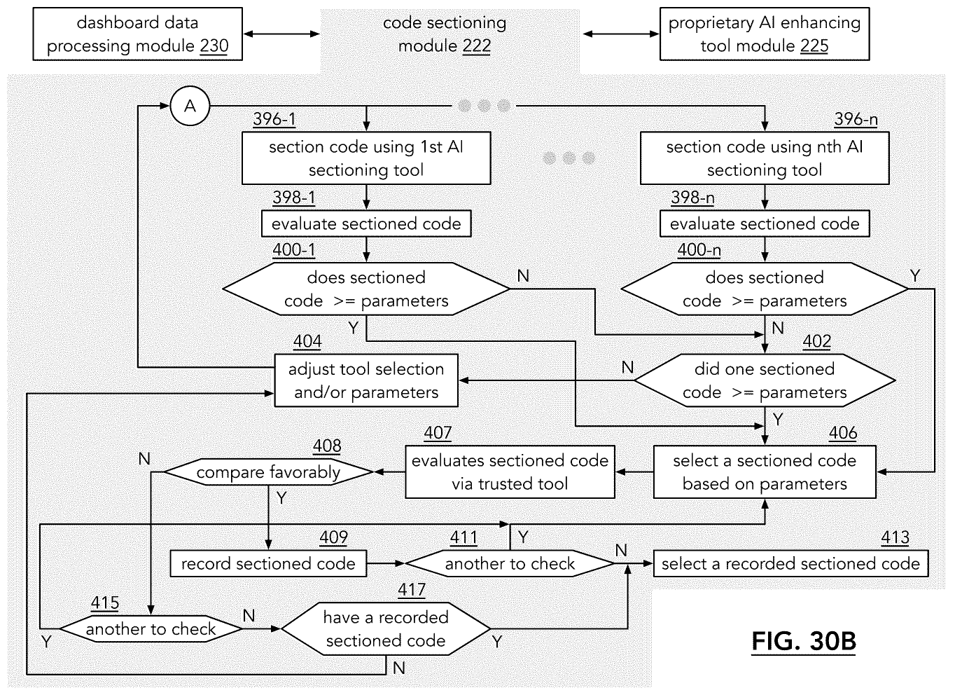

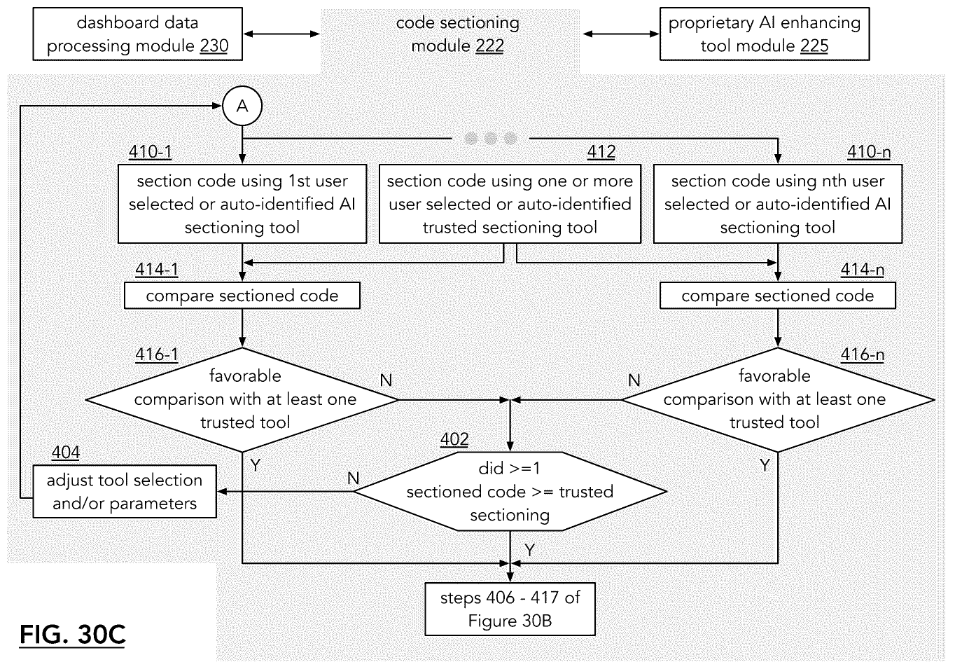

FIGS. 30A-30C are a logic diagram of an embodiment of a method for sectioning code as executed by the code sectioning module 222. The method begins at step 380, where the code sectioning module 222 obtains code for sectioning. The code sectioning module 222 may obtain the code in a variety of ways. For example, the code sectioning module 222 retrieves the code from the repository. As another example, the code sectioning module 222 receives it from the code input module 220 of the code enhancement system 104.

The method continues at step 382, where the code sectioning module 222 determines code information, which is defined in the glossary section. The method continues at step 384, where the code sectioning module 222 obtains enhancement parameters (e.g., purpose parameters and/or operation parameters).

The method continues at step 386, where the code sectioning module 222 identifies a set of viable AI code sectioning tools based on the code information and based on the parameters. The set of viable AI code sectioning tools includes AI tools and/or proprietary AI tools and may further include a set of trusted tools. The code sectioning module 222 identifies the set of viable AI code sectioning tools using the code information, the AI tool records (e.g., tables) 227, and/or the proprietary AI tool records (e.g., tables). If the code sectioning module is including trusted tools in the set of viable tools, the code sectioning module 222 uses the code information and the trusted tool records (e.g., tables).

For example, the code sectioning module 222 creates a use case of the code 202 and, based on the use case, finds AI tools and/or proprietary AI tools that have comparable use cases. As another example, the code sectioning module 222 selects each AI tool and/or proprietary AI tool that is identified as performing code sectioning. As a further example, the code sectioning module 222 selects AI tools and/or proprietary AI tools based on their respective code sectioning attributes and desired attributes for the sectioning of the code 202.

The method continues at step 388, where the code sectioning module 222 determines whether the user or the system is to select the specific AI tools and/or proprietary AI tools (and, when desired, the trusted tools) to use to section the code. When the user has elected to select the specific AI tools via a GUI, or the like, the method continues at step 390, where the code sectioning module 222 provides set of viable AI code sectioning tools to the dashboard data processing module 230, which generates a GUI that enables the user to select from the set of viable AI code sectioning tools. The method continues at step 392, where the code sectioning module 222 receives identity of the selected AI code sections tool(s) from the dashboard data processing module 230. The method continues at step 396-1 through step 396-n of FIG. 30B.

If, at step 388, the system is to auto select the AI code sectioning tools, the method continues at step 388, where the code sectioning module 222 selects one or more AI code sectioning tools. The method continues at step 396-1 through step 396-n of FIG. 30B, where, at step 396-1, the code sectioning module 222 sections the code using a first AI sectioning tool (or first set of AI sectioning tools). If there is only one AI sectioning tool or only one set of AI sectioning tools, the parallel branches of the method with the -n reference number are not executed.

When there are more than one AI sectioning tool or more than one set of AI sectioning tools, the code sectioning module 222, at step 396-2 through -n, sections the code using the second through the nth AI sectioning tool (or nth set of AI sectioning tools) to create versions of sectioned code. Note that a set of AI sectioning tools collaborate to produce a sectioned code.

The method continues at step 398-1 through -2, where the code sectioning module 222 evaluates the versions of sectioned code as produced by the various combination of AI tools. The versions of the AI sectioned code are evaluated using one or more AI code sectioning evaluation tools. The method continues at step 400-1 through 400-n, where the code sectioning module 222 determines, based on the evaluation, whether the AI sectioned code meets or exceeds the parameters.

For each of steps 400-1 through 400—n where the sectioned code did not meet or exceed the parameters, the method continues at step 402, where the code sectioning module 222 determines whether at least one AI version of sectioned code met or exceeded the parameters. If not, the method continues at step 404, where the code sectioning module adjusts the selection of an AI sectioning tool and/or adjusts a parameter. The method repeats at steps 396-1 through 396—n using the adjusted AI tools and/or based on the adjusted parameters.

For each of steps 400-1 through 400—n where the sectioned code did meet or exceed the parameters and for a yes answer to step 402, where the code sectioning module 222 selects one of the AI versions of sectioned code. The method continues at step 407, where the code sectioning module 222 evaluates the sectioned code via a trusted tool.

The method continues at step 408, where the code sectioning module 222 determines whether the evaluation of step 407 was favorable. As an example, a comparison is favorable when the AI sectioned code is substantially identical to the trusted sectioned code. As another example, the comparison is favorable when the trusted tool verifies the methodology and resulting sectioning of the AI version of the sectioned code.

When the comparison of step 408 is favorable, the method continues at step 409, where the code sectioning module records the AI sectioned code as having a successful evaluation. The method continues at step 411, where the code sectioning module 222 determines whether there is another version of AI sectioned code to be evaluated. If yes, the method repeats at step 406. If not, the method continues at step 413, where the code sectioning module 413 selects one of the recorded versions of AI sectioned code to output as the sectioned code.

If, at step 408, the comparison was unfavorable, the method continues at step 415, where the code sectioning module 222 determines whether there is another version of AI sectioned code to be evaluated. If yes, the method repeats at step 406. If no, the method continues at step 417, where the code sectioning module 222 determines whether there is at least one AI sectioned code that has passed evaluation by the trusted tool. If yes, the method continues to step 413. If not, the method repeats at step 404.

FIG. 30C is a logic diagram of an alternative method to the method of FIG. 30B. This method branches from step 392 or step 394 of FIG. 30A. This method includes steps 410-1 through 410—n, where the code sectioning module generates a “n” versions of AI sectioned code using “n” combinations of AI tools and/or AI proprietary tools. At step 412, the code sectioning module 222 sections the code using a trusted tool to produce a trusted sectioned code.

The method continues at steps 414-1 through 414—n, where the code sectioning module compares respective versions of the AI sectioned code to the trusted sectioned code. The method continues at steps 416-1 through 416—n, where the code sectioning module determines which of the comparisons were favorable. In example, a version of AI sectioned code compares favorably to the trusted version of sectioned code when it is sectioned in an identical or near identical manner as the trusted version. As another example, an AI version of sectioned code compares favorably to the trusted version of sectioned code when the trusted tool verifies the AI version of the sectioned code.

For each of the comparisons of steps 416-1 through 416—n that was not favorable, the method continues at step 402, where the code sectioning module 222 determines whether at least one of the versions of AI sectioned code compared favorably to the trusted version. If no, the method continues at step 404, where the code sectioning module adjusts an AI tool and/or a parameter. The method continues at steps 401-1 through 410—n using the adjusted AI tools and/or the adjusted parameters.

For each of the comparisons of steps 416-1 through 416—n that was favorable and for a yes answer to step 402, the method continues by executing steps 406-417 of FIG. 30B.

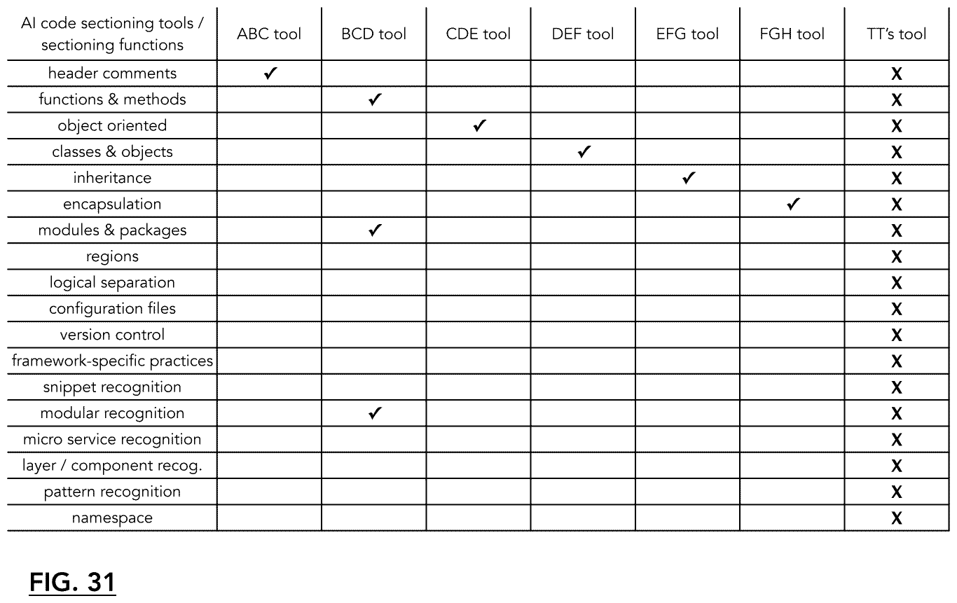

FIG. 31 is a schematic block diagram of an example of a table of AI code sectioning tools. The table includes first column for code sectioning sub-functions and a plurality of AI tool name columns. The code sectioning sub-functions include header comments, functions & methods, object oriented, classes & objects, inheritance, encapsulation, modules & packages, regions, logical separation, configuration files, version control, framework—specific practices, snippet recognition, modular recognition, micro service recognition, layer/component recognition, pattern recognition, and namespace. The code sectioning sub-functions are further described in the glossary section.

In this example, the ABC tool, the BCD tool, the CDE tool, the DEF tool, the EFG tool, and the FGH tool are AI code sectioning tools. The checkmarks indicate which of the code sectioning sub-functions the AI tool performs. The TT's tool is one or more proprietary AI tools. The “X” indicates the code sectioning sub-functions that the proprietary tool(s) support, augment, performs, and/or otherwise enhances the performance of an AI tool, or tools.

The particular code sectioning sub-functions employed to section code can be selected in a variety of ways. For example, the code enhancement system 104 determines the code sectioning sub-functions to be used. As another example, the user selects the code sectioning sub-functions to be used via a GUI. As a further example, the code enhancement system 104 provides a recommended list of code sectioning sub-functions to a user via a GUI and, via the GUI, the user picks and chooses from the list.

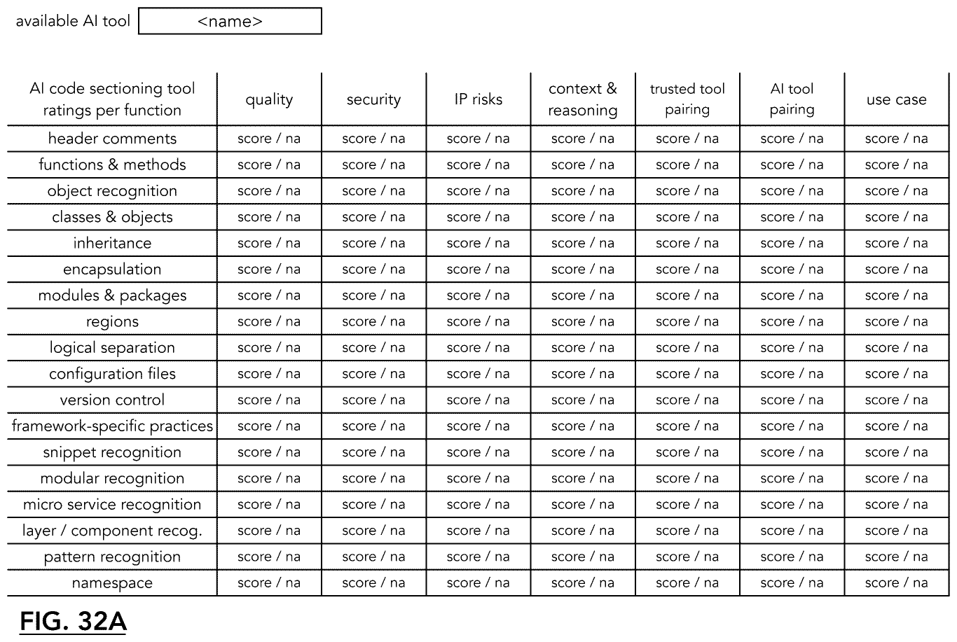

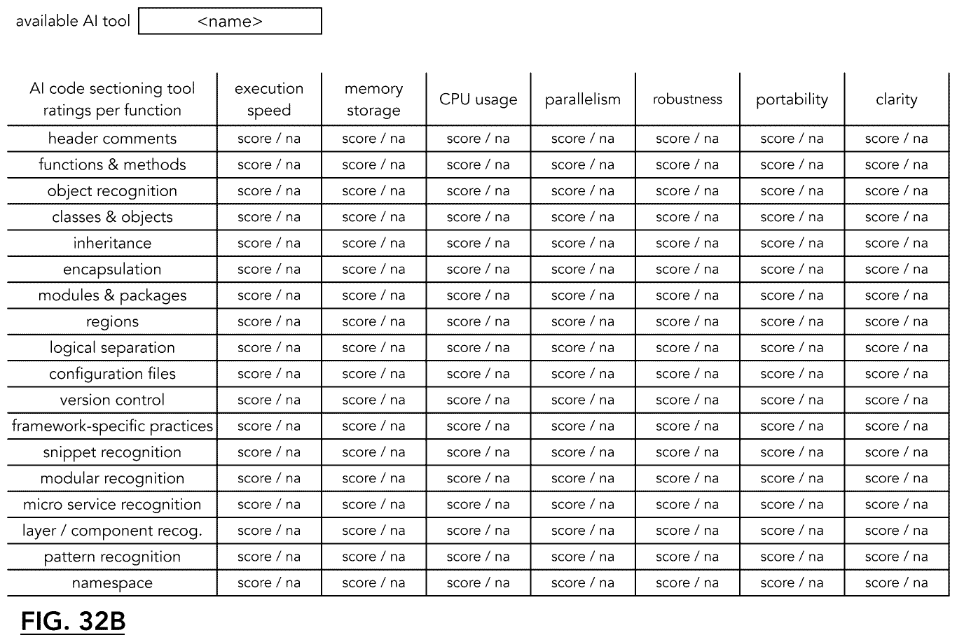

FIGS. 32A and 32B are a schematic block diagram of an example of a table regarding an AI code sectioning tool. The table includes a first column for the code sectioning sub-functions and a plurality of columns for attributes of code sectioning. The attributes include performance attributes and use attributes. The use attributes includes trusted tool pairing, AI tool pairing, and use case. These use attributes were previously discussed.

The performance attributes includes quality, security, IP risks, context & reasoning, execution speed, memory storage, CPU usage, parallelism, robustness, portability, and clarity. Each of these performance attributes are further discussed in the glossary section. The system 104 scores each applicable code sectioning sub-function of the AI tool. The score indicates a probability of the AI tool's execution of the code sectioning sub-function having a favorable comparison with the trusted tool execution of, and/or analyzing of, the code sectioning sub-function. The probability is based on past comparisons between the AI tool and the trusted tool.

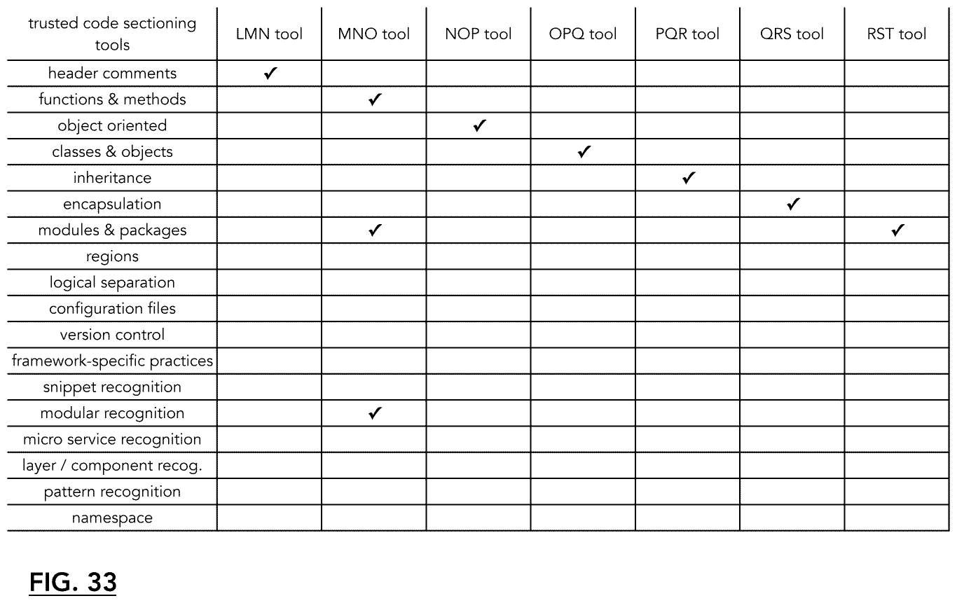

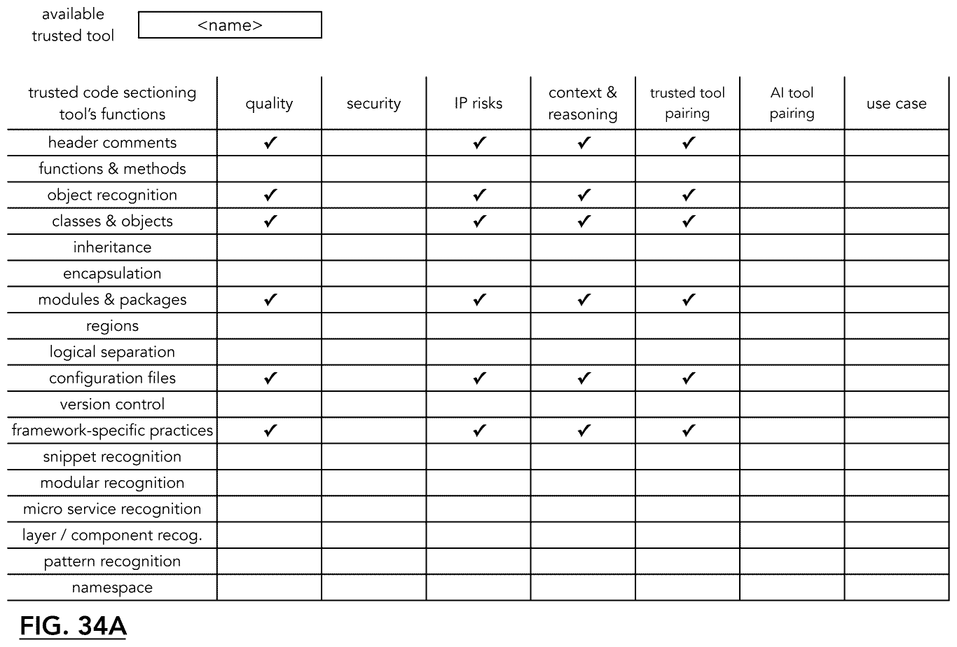

FIG. 33 is a schematic block diagram of an example of a table of trusted code sectioning tools. The table includes a first column for the code sectioning sub-functions and a plurality of columns for the name of various trusted code sectioning tools. The checkmarks indicate which code sectioning sub-function a trusted tool performs.

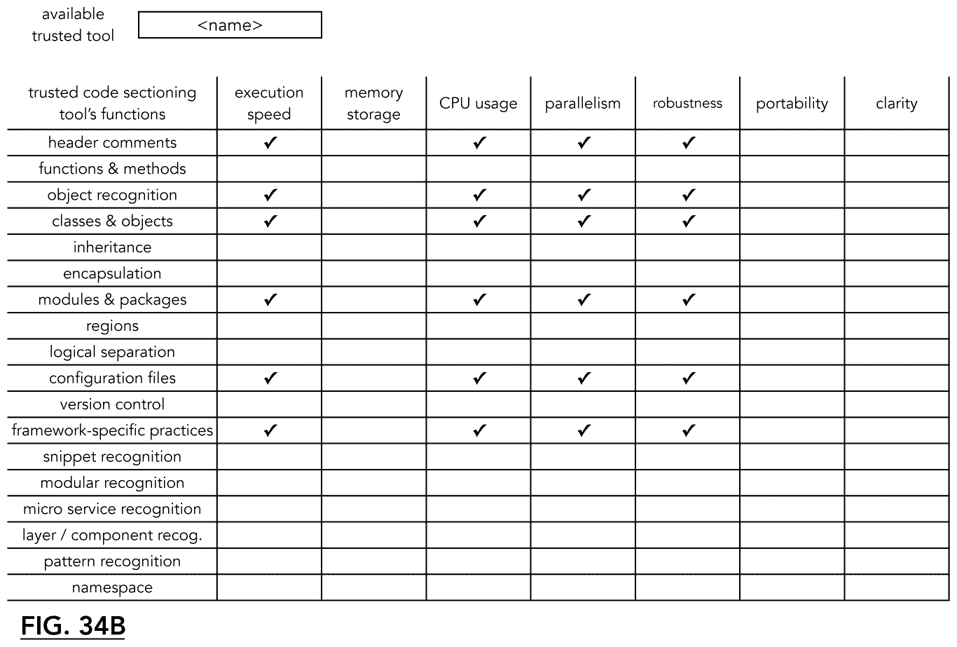

FIGS. 34A and 34B are a schematic block diagram of an example of a table regarding a trusted code sectioning tool. The table includes a first column for the code sectioning sub-functions and a plurality of columns for attributes of code sectioning. The attributes include performance attributes and use attributes. The use attributes includes trusted tool pairing, AI tool pairing, and use case. These use attributes were previously discussed.

The performance attributes includes quality, security, IP risks, context & reasoning, execution speed, memory storage, CPU usage, parallelism, robustness, portability, and clarity. Each of these performance attributes are further discussed in the glossary section. The system 104 scores each applicable code sectioning sub-function of the AI tool. The checkmarks indicate which attributes are applicable to corresponding code sectioning sub-functions. Note that no score is needed since this is a trusted tool and would have, if scored, a very favorable score.

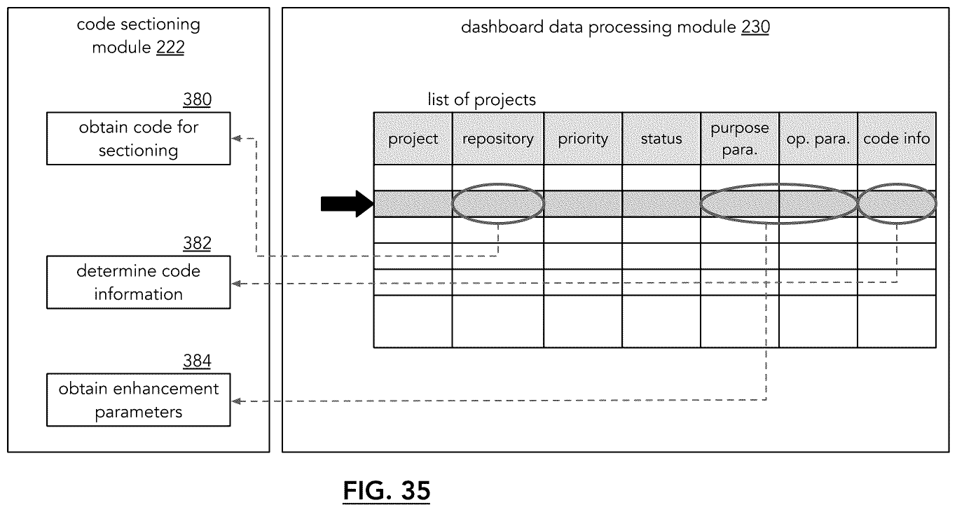

FIG. 35 is a schematic block diagram of an example of the code sectioning module 222 obtaining code for sectioning and obtaining information regarding the sectioning via the dashboard data processing module 230. As shown, the dashboard data processing module 230 providing a list of projects via a GUI. Via the GUI, a user selects a project as illustrated by the arrow. From the selected project, the code sectioning module 222, at step 380, obtains the code, which may be done in a variety of ways. For example, the code sectioning module 222 retrieves the code from a storage location based on the information in the repository field of the table. As another example, the user, via the GUI, drags and drops the code for the code sectioning module 222.

At step 382, the code sectioning module 222 determines the code information relevant for sectioning the code. In this example, the code sectioning module 222 pulls the relevant code sectioning information from the table. If the code information regarding sectioning is incomplete, the code sectioning module 222 queries the user via the GUI to obtain further code information. Alternatively, the code sectioning module 222 interprets the code to determine the further code information.

At step 384, the code sectioning module 222 obtains enhancement parameters from the purpose parameter field and/or the operation parameter field. If the parameters regarding sectioning are incomplete, the code sectioning module 222 queries the user via the GUI to obtain further parameters. Alternatively, the code sectioning module 222 interprets the code to determine the further parameters.

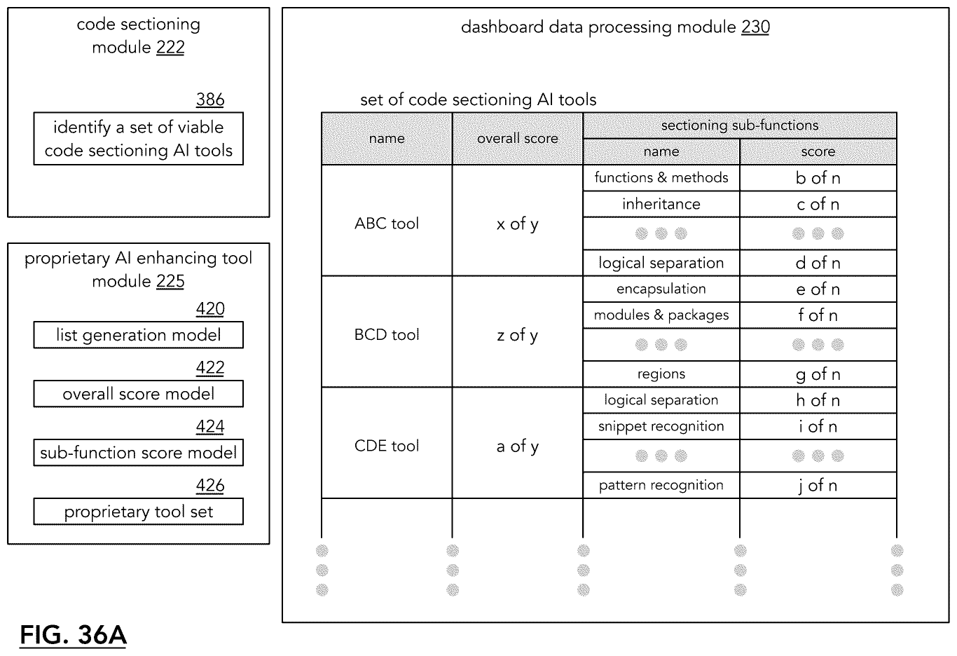

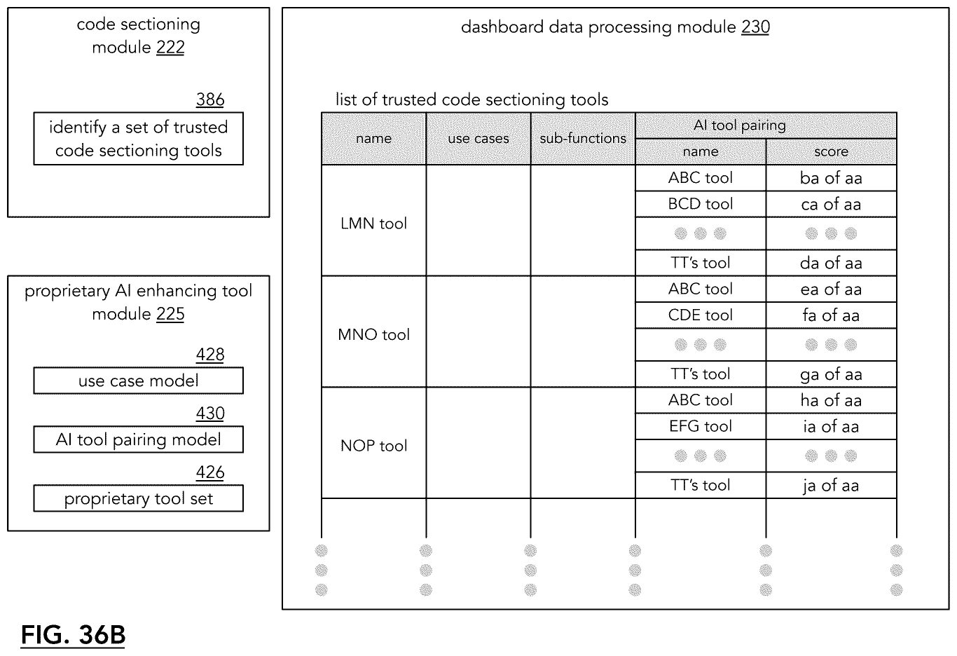

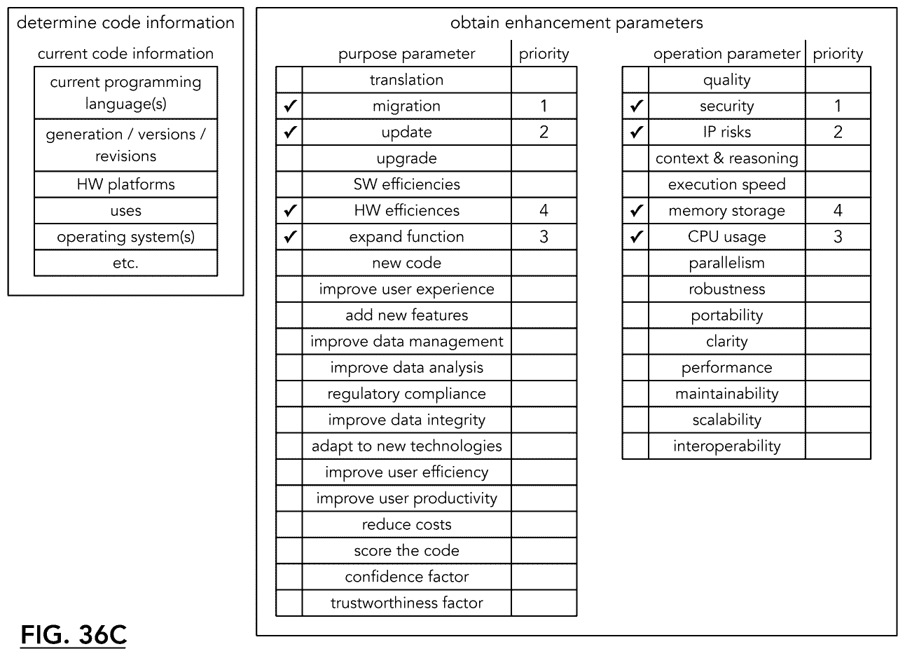

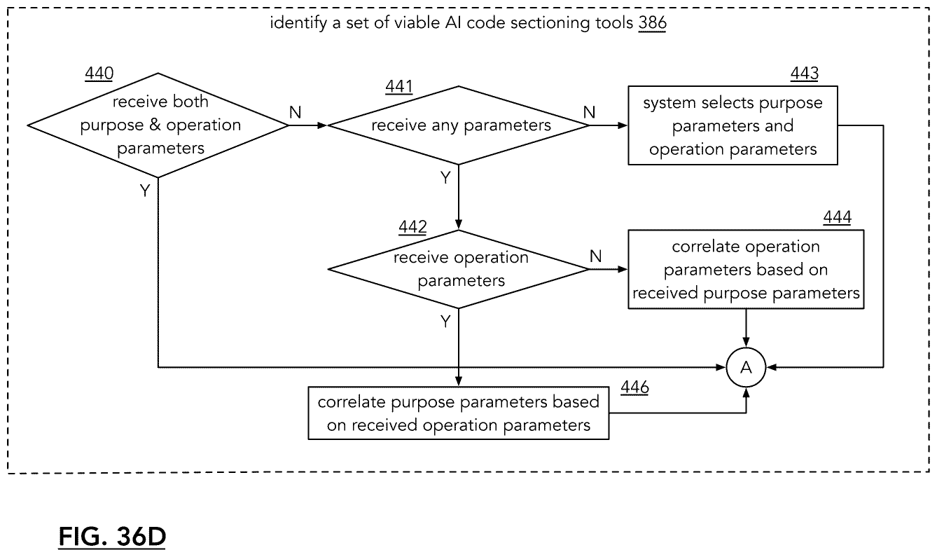

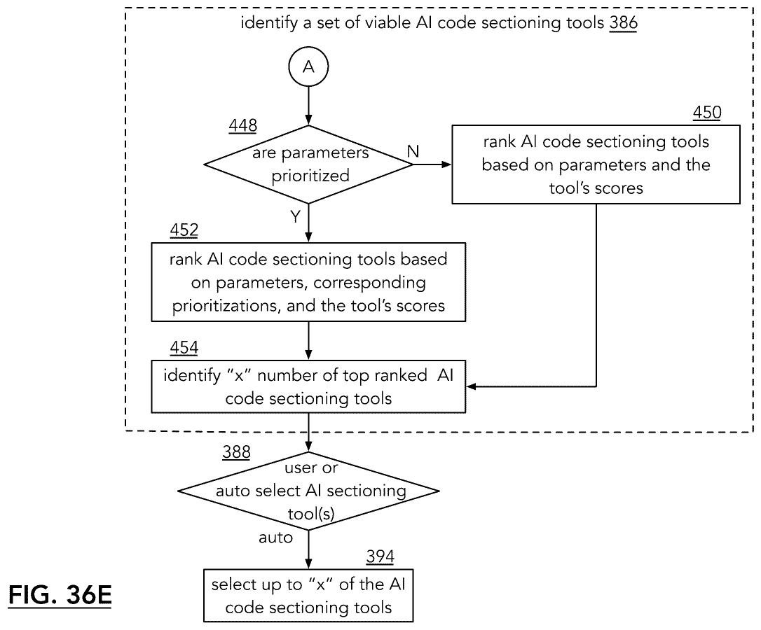

FIGS. 36A-36E are schematic block diagrams of an example of selecting tools for sectioning code. In FIG. 36A, the code sectioning module 222, in step 386, identifies a set of viable AI code sectioning tools for user selection. The dashboard data processing module 230 generates a graphical representation of the set of viable AI code sectioning tools. In this example, the graphical representation is a table, which includes columns for the name of the AI tools (AI tools and/proprietary AI tools), the tools overall score, and the tool's code sectioning sub-functions. The code sectioning sub-function column is divided into two columns: one for the name of the sub-function and another for the sub-functions score.

The table can be organized in a variety of ways. For example, the table can be organized alphabetically. As another example, the table is organized based on the overall score. As a further example, the table is organized by sub-functions.

The information contained in the table can be selectable and is based on the information shown in the table is a subset of data from the tables of FIG. 31-32B. Accordingly, the user can select what information from the tables of FIG. 31-32B should be included in the table regarding the set of viable code sectioning AI tools.

The information in the table allows the user to make general selections (e.g., use all listed tools or to select one or more tools) and/or to make specific selections (e.g., particular sub-functions of particular code sectioning AI tools). In addition, the user can select an ordering of code sectioning AI tools to use and/or an ordering of code sectioning sub-functions to use. Further, the user can select a grouping of code sectioning AI tools to be used and/or a grouping of code sectioning sub-functions to be used. Alternatively, the user can have the code sectioning module 222 make the selections.

The proprietary AI enhancing tool module 225 monitors the functioning of the code sectioning module 222 and of the dashboard data processing module 230. The proprietary AI enhancing tool module 225 uses the monitoring to create and/or update models (e.g., one or more of large language model, decision tress and random forests, support vector machines, Bayesian models, linear and logistic regression, k-nearest neighbors, cluster algorithms, reinforcement learning models, dimensionality reduction models, natural language processing, Markov models, autoregressive modules, and deep learning models).

For example, the proprietary AI enhancing tool module 225 monitors the code sectioning module 222 identifying the AI tools to include the set of viable AI code sectioning tools to create and/or update one or more list generation models 420 regarding code sectioning AI tools. As another example, the proprietary AI enhancing tool module 225 monitors the creation, modifications, etc. of the overall scores of a code sectioning AI tools to create and/or update one or more overall score models 442 regarding code sectioning AI tools. As a further example, the proprietary AI enhancing tool module 225 monitors creation, modifications, etc. of the scores of the AI tool's sub-functions to create and/or update one or more sub-function score models 424.

The proprietary AI enhancing tool module 225 uses one or more models as a proprietary AI tool, to enhance an existing proprietary AI tool 426, and/or to create a proprietary code sectioning AI tool 426. For example, the proprietary AI enhancing tool module 225 creates a proprietary AI code sectioning tool that enables the code sectioning module 222 to improve its identification of viable code sectioning AI tools.

In FIG. 36B, the code sectioning module 222 is identifying a list of trusted code sectioning tools as part of step 386. The code sectioning module 222 provides the list to the dashboard data processing module 230, which creates a graphical representation of the list (e.g., a table). The table includes one or more of a column for the name of the trusted code sectioning tool, a column for uses cases, a column for sub-functions of the corresponding tool, and a column for AI tool pairing. The column for AI tool pairing is divided into two sub-columns: one for the AI tool name and the other for the AI tool's overall score. The user may select one or more trusted tools via the GUI and/or one or more code sectioning sub-functions thereof.

The proprietary AI enhancing tool module 225 monitors the identifying of the set of trusted code sectioning tools and the selections thereof. The proprietary AI enhancing tool module 225 uses the monitoring to create and/or update one or more use case models 428 and/or one or more AI tool pairing models 430. The proprietary AI enhancing tool module 225 uses one or more models 428, 430 as a proprietary AI tool, to enhance an existing proprietary AI tool 426, and/or to create a proprietary code sectioning AI tool 426.

FIG. 36C illustrates an example of determined code information and an example of obtaining enhancement parameters. In this example, the determined code information includes the current programming language, or languages, of a code; the code's generation, version, and/or revision levels; the code's hardware (HW) platforms, the code's uses, the operating system(s) of the code; and/or other code information.

The enhancement parameters include purpose parameters and operation parameters. The purpose parameters include, but are not limited to, translation, migration, update, upgrade, improve software (SW) efficiencies, improve hardware (HW) efficiencies, expand functionality of code, add new code to existing code, improve user experience, add new features to existing code, improve data management, improved data analysis, adherence to regulatory requirements, improve data integrity, adapt to new technologies, improve user efficiency, improve user productivity, reduce costs from manufacturer and/or user, score the code with respect to one or more operation parameters, generate a confidence factor for the code (e.g., the code will execute reliably), and generate a trustworthiness factor for the code (e.g., the code will execute securely, it will not cause data loss, and/or it will not compromise data integrity).

A user, via a GUI, can select one or more of the purpose parameters via a checkmark or other identifying GUI signaling. In addition, the user can ascribe priority levels to the selected purpose parameters via the GUI. A priority level may be used more than once. For example, the user ascribes the same priority value to migration and to update. If priority data is not entered, the code enhancement system 104 determines a priority for each selected parameter, which may be the same priority level, different priority levels, or a combination thereof.

Examples of the operational parameters include, but are not limited to, quality, security, mitigating IP (intellectual property) risk, context and reasoning, improve execution speed, reduce memory storage, reduce CPU (central processing unit) usages, increasing parallelism, improve robustness, improve portability, improve clarity, improve performance, improve maintainability, improve scalability, and improve interoperability.

A user, via a GUI, can select one or more of the operation parameters via a checkmark or other identifying GUI signaling. In addition, the user can ascribe priority levels to the selected operation parameters via the GUI. A priority level may be used more than once. For example, the user ascribes the same priority value to memory storage and to CPU usage. If priority data is not entered, the code enhancement system 104 determines a priority for each selected parameter, which may be the same priority level, different priority levels, or a combination thereof.

The code enhancement system 104 uses the selected parameters and corresponding priorities to organize the AI tools, the proprietary AI tools, and/or the trusted tools for sectioning code, enhancing sectioned code, evaluating enhanced code, and/or scoring enhanced code. The system 104 further the uses the selected parameters and corresponding priorities to create a plurality of tool use configurations to produce multiple versions of sectioned code, multiple versions of enhanced code, and/or multiple ways to evaluate enhanced code.

FIG. 36D is a logic diagram of a sub-method for identifying the set of viable AI code sectioning tools of step 386 as performed by the code sectioning module 222. The sub-method begins at step 440, where the code sectioning module 222 determines whether it has received both purpose parameters and operation parameters. If yes, the sub-method continues at steps 396-1 through 396—n of FIG. 30B.

If the answer to step 440 is no, the sub-method continues at step 441, where the code sectioning module 222 determines whether it has received any parameters. If not, the sub-method continues at step 443, where the system 104 selects one or more purpose parameters and one or more operation parameters for the code. The sub-method then continues at steps 396-1 through 396—n of FIG. 30B.

If the answer to step 441 is yes, the sub-method continues at step 442, where the code sectioning module 222 determines whether the system has received operation parameters. If yes, the sub-method continues at step 446, where the system selects one or more purpose parameters that correlate with the selected operation parameter(s). The sub-method then continues at steps 396-1 through 396—n of FIG. 30B.

If the answer to step 442 is no, the sub-method continues at step 444, where the system selects one or more operation parameters that correlate with the selected purpose parameter(s). The sub-method then continues at steps 396-1 through 396—n of FIG. 30B.

The correlation of a purpose parameter and an operation parameter may be determined in a variety of ways. For example, the correlation is predetermined, such as HW efficiencies correlate with memory storge and CPU execution time. As another example, the correlation is based on historical selection of purpose parameters and operation parameters. As another example, the correlation is determined based on the code information. As specific example, code of a particular programming language typically includes the purpose parameter of translate and the operation parameters of quality, security, clarity, and scalability.

While the present sub-method illustrates a correlation between one or more purpose parameters and one or more operation parameter, the code enhancement system 104 can enhance code based on one or more purpose parameters or one or more operation parameters. As such, the system 104 does not require a selection of at least one purpose parameter and a selection of at least one operation parameter; a selection of at least one parameter will suffice.

FIG. 36E is a logic diagram of a sub-method that branches from step 392 or 394 of FIG. 30A. This sub-method includes steps 448-454 for identifying the set of viable AI code sectioning tools of step 386. The method also illustrates further functioning of steps 388 and 394 of FIG. 30B.

The sub-method begins at step 448, where the code sectioning module 222 determines whether the parameters are prioritized. If not, the method continues at step 450, where the code sectioning module 222 ranks AI code section tools based on the parameters and the AI tools' overall and/or sub-function scores. The sub-method continues at step 454, where the code sectioning module 222 identifies “x” number of top ranked AI code sectioning tools, where “x” is a number equal to or greater than 1.

If the answer to step 448 was yes, the sub-method continues at step 452 where the code sectioning system ranks AI code sectioning tools based on the parameters, the corresponding priorities, and the tool's overall score and/or its sub-function scores. The method continues at step 382, where the code sectioning module 222 continues at step 454. When, at step 388, the code sectioning AI tools are to be automatically selected, the method continues at step 394, where the code sectioning system automatically selects up to “x” number of code sectioning AI tools.

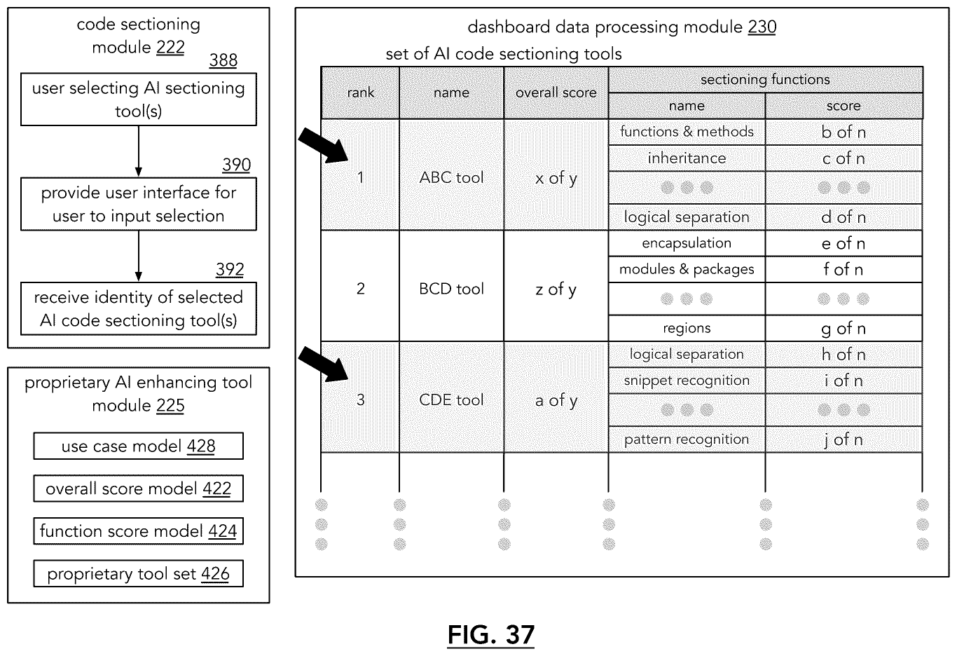

FIG. 37 is a schematic block diagram of an example of obtaining code for selecting one or more sectioned codes. In this example, the code sectioning module 222 is performing the steps 388-392 of FIG. 30A and the dashboard data processing module 230 is providing a corresponding GUI. At step 388, it was determined that the user would select the code sectioning AI tools. At step 390, the code sectioning module 222 provides a set of viable AI code sectioning tools to the dashboard data processing module 230.

The dashboard data processing module 230 generates a graphical representation of the set of viable AI code sectioning tools and a generates a corresponding GUI. The user selects one or more of the tools via the GUI (e.g., place and click a cursor on the row of a tool). The code sectioning module 222 receives the selection of one or more code sectioning AI tools from the dashboard data processing module 230.

The proprietary AI enhancing tool module 225 gathers information regarding the selection of the tools by the user. The newly gathered information is used in combination with previously gathered information to create and/or update one or more use case models 428, one or more overall score models 422, one or more sub-function score models 424, and/or to create and/or update one or more proprietary AI tools 426.

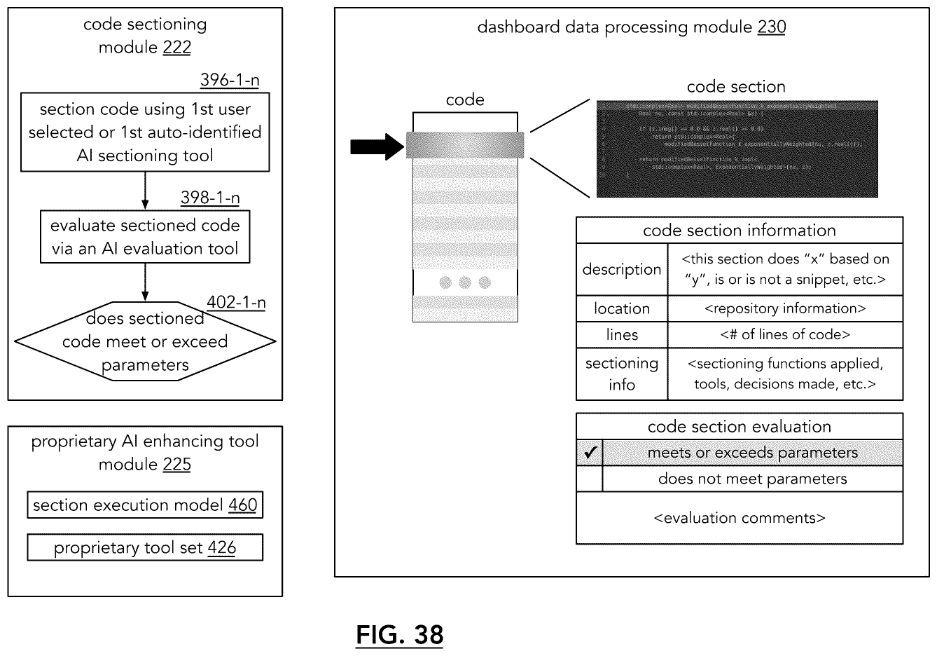

FIG. 38 is a schematic block diagram of an example of evaluating one or more selected sectioned codes. In this example, the code sectioning module 222 is executing steps 396-1 through -n, steps 398-1 through -n, and steps 402-1 through -n of FIG. 30B. The dashboard data processing module 230 generates a graphical representation for the sectioning of code in a variety of ways. For example, the graphical representation includes representations for multiple versions of code sectioning.

As another example, as shown, the graphical representation includes the graphical representation of a version of code sectioning. The sections of the code are graphically illustrated, and at least some of them are graphically selectable via the GUI. When a code section is selected, its lines of code are shown in a window. In addition, information regarding the section is shown, which includes a description of the section, the location of the section, number of lines of code, and/or other sectioning information.

The graphical representation further includes a code evaluation section, which indicates whether the code section meets or exceeds the parameters or it does not. If another code section is selected, similar graphical data is produced by the dashboard data processing module 230.

When no code section is selected, the dashboard data processing module 230 provides a graphical representation regarding the sectioned code as a whole. In an example, the graphical representation includes information regarding the code, its sectioning, and whether as a whole it met or exceeded the parameters or it did not.

The proprietary AI enhancing tool module 225 gathers information regarding the execution of code sectioning. The newly gathered information is used in combination with previously gathered information to create and/or update one or more section execution models 460 and/or to create and/or update one or more proprietary AI tools 426.

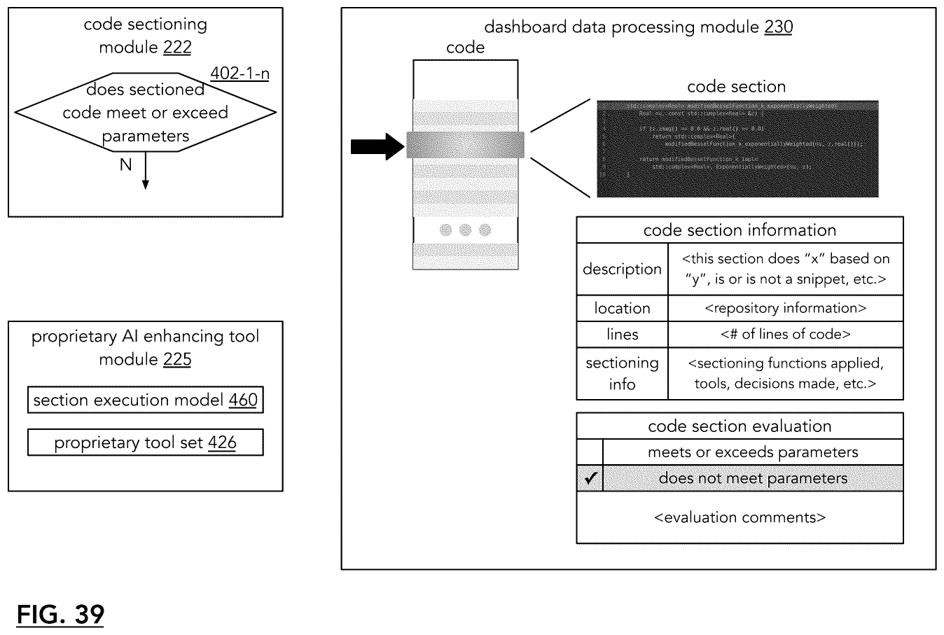

FIG. 39 is a schematic block diagram of another example of evaluating one or more selected sectioned codes. This example is similar to the example of FIG. 38 with the difference being that the selected code section does not meet the parameters. The code section evaluation table further includes one or more comments regarding the code section failing to meet the parameters. The comment section could further include a suggestion regarding a fix (e.g., select a specific code sectioning tool, change a parameter, select a specific proprietary AI code sectioning tool, etc.).

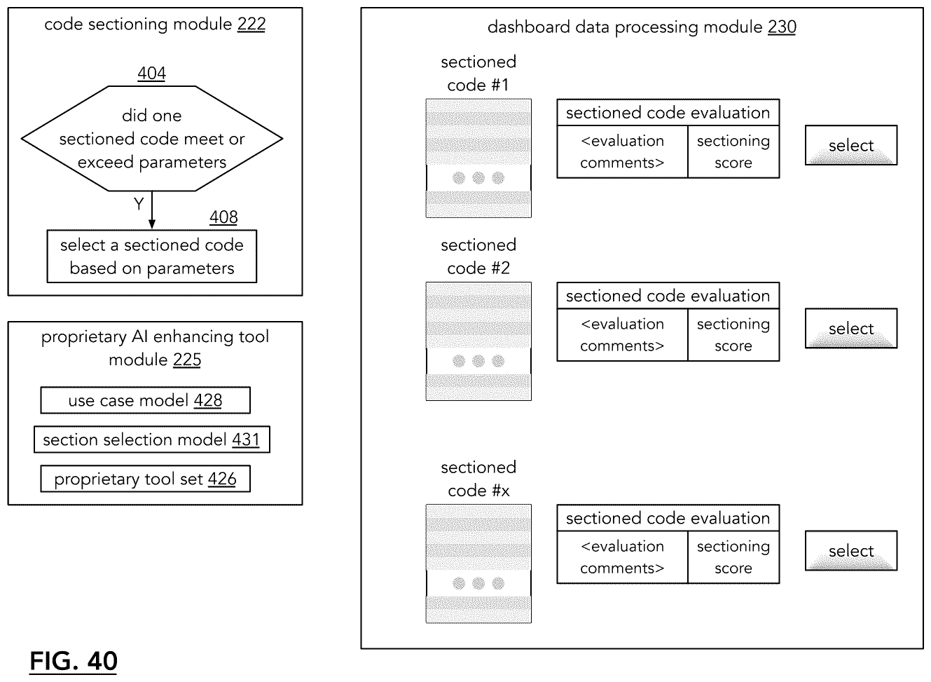

FIG. 40 is a schematic block diagram of another example of evaluating one or more selected sectioned codes. In this example, the code sectioning module 222 is executing steps 404 and 408 of FIG. 30B. When one or more sectioned codes meets or exceeds the parameters at step 404, the code sectioning module 222 selects a sectioned code based on the parameters at step 408.

The dashboard data processing module 230 supports the selection of a sectioned code by generating a graphical representation of each sectioned code that met or exceeded the parameters, the corresponding section evaluation data (which includes how well it performed with respect to the parameters), and a corresponding select button. Via a GUI, a user selects one of the sectioned codes, which is conveyed by the dashboard data processing module to the code sectioning module 222.

The proprietary AI enhancing tool module 225 gathers information regarding the number of versions of sectioned code that met or exceeded the parameters, the corresponding sectioned code evaluation data, and the selection of a particular sectioned code. The newly gathered information is used in combination with previously gathered information to create and/or update one or more use case models 428, one or more code selection models 431, and/or to create and/or update one or more proprietary AI tools 426.

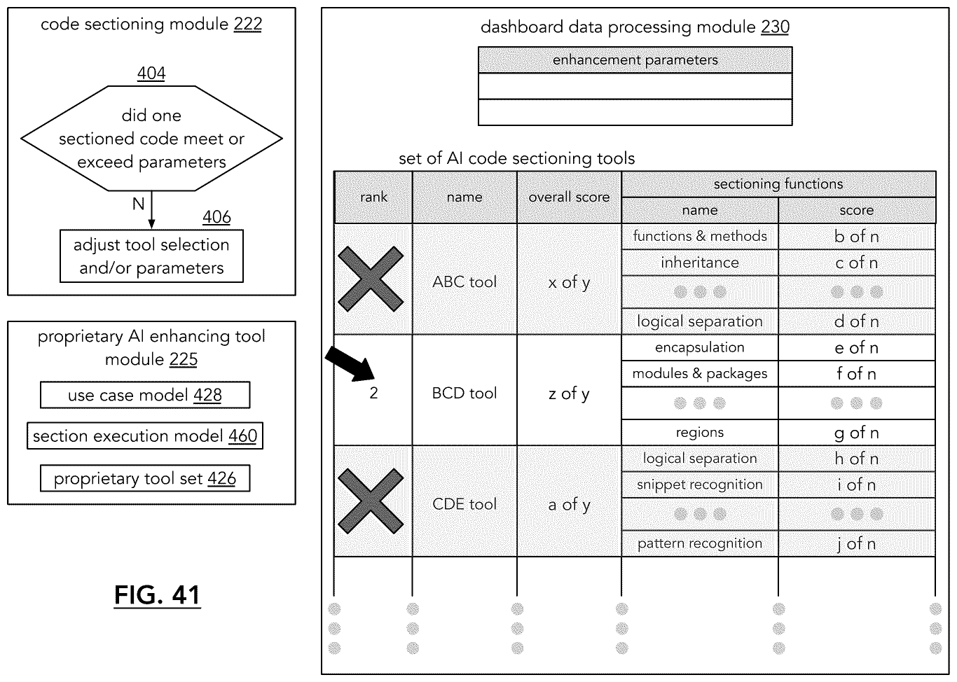

FIG. 41 is a schematic block diagram of an example of selecting one or more new tools for sectioning code. In this example, the code sectioning module 222 is executing steps 404 and 406 of FIG. 30B. When none of the sectioned codes meets the parameters at step 404, the code sectioning module 222 adjusts a code sectioning tool selection and/or a parameter at step 406.

The dashboard data processing module 230 supports the adjustment of a code sectioning AI tool and/or the adjusting of a parameter by generating a graphical representation of the enhancement parameters and the table regarding the set of viable AI code sectioning tools. The graphical representation of the enhancement parameters (shown in a simplified manner) lists the purpose parameters, the operation parameters, the previous selections thereof, and the previous prioritizations thereof.

The user, via a GUI provided by the dashboard data processing module 230, modifies the selection and/or priority of one or more purpose parameter and/or one or more operation parameters. The modification of a parameter includes selecting a previously unselected parameter, deleting the selection of a previously selected parameter, and/or changing the priority of a previously selected parameter.

The table of the set of viable AI code sectioning tools lists the tools as discussed with reference to FIG. 37. If the user did not change a parameter, then one or more of the previously selected AI tools is barred from a current selection as represented by the large X. In this example, the user selects AI code sectioning tool named BCD for subsequent sectioning of the code.

The proprietary AI enhancing tool module 225 gathers information regarding the number of versions of sectioned code that did not meet the parameters, the corresponding sectioned code evaluation data, and the adjusting of an AI tool and/or adjusting of a parameter. The newly gathered information is used in combination with previously gathered information to create and/or update one or more use case models 428, one or more code selection models 431, and/or to create and/or update one or more proprietary AI tools 426.

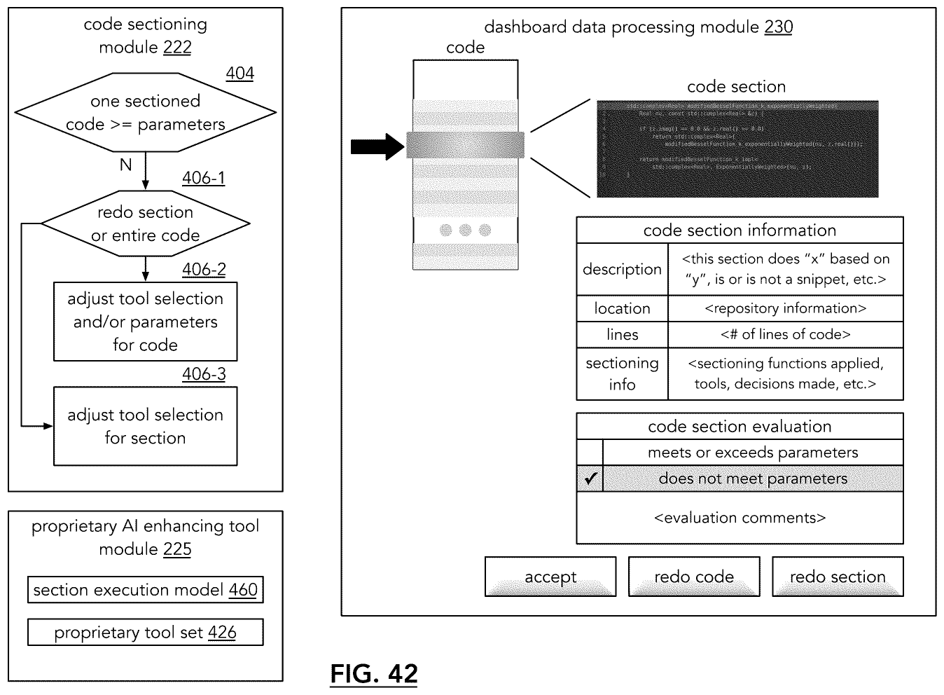

FIG. 42 is a schematic block diagram of an example of determining whether to re-section at least a portion of code. In this example, the code sectioning module 222 is executing steps 404 of FIG. 30B regarding an individual section of code. For this individual section of code, the code sectioning module 222 further executes steps 406-1 through 406-3 when the individual section of code did not meet the parameters.

At step 406-1, the code sectioning module 222 determines whether to redo the sectioning of the individual section of code or redo the sectioning of the entire code. The code sectioning module may make such a determination in a variety of ways. For example, the code sectioning module 222 determines to redo the individual section of code when its evaluation and/or score were just below expectable levels and the code section module 222 identifies an additional AI sectioning tool and/or proprietary AI sectioning tool that, when applied to the individual section of code, has a high probability of yielding a favorable evaluation and/or a favorable score.

When the code sectioning module 222 determines to redo the individual section of code, the method continues at step 406-3, where the code sectioning module 222 adjusts the tool section of this individual section. When the code sectioning module 222 determines to redo the entire code, the method continues at step 406-2, where the code sectioning module 222 adjusts the AI tools and/or one or more parameters.

The dashboard data processing module 230 generates a graphical representation of the steps performed by the code sectioning module 222, which is similar to the graphical representation of FIG. 39. This example further includes selection buttons (or other GUI selection mechanism) of accept, redo code, and redo section. Accordingly, the accept button instructs the code sectioning module 222 to accept the individual section of code even though it did not meet the parameters; the redo code button instructs the code sectioning module 222 to re-section the code based on adjusted tools and/or adjusted parameters; and the redo section instructs the code sectioning module 222 to re-section the individual section of code based on adjusted tools.

The proprietary AI enhancing tool module 225 gathers information regarding the individual section of code that did not meet the parameters, and the selection to redo sectioning of the entire code, redo sectioning of the individual section of code, or accepting the individual section of code even though it did not meet the parameters. The newly gathered information is used in combination with previously gathered information to create and/or update one or more code sectioning execution models 428, and/or to create and/or update one or more proprietary AI tools 426.

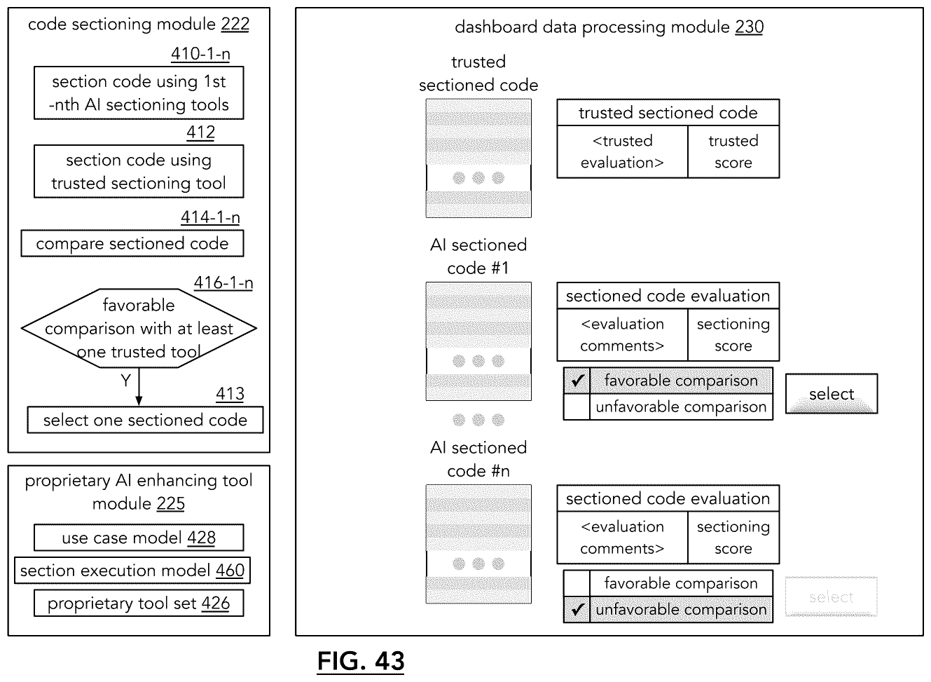

FIG. 43 is a schematic block diagram of another example of evaluating one or more sectioned codes. In this example, the code sectioning module 222 is executing steps 410-1 through -n, 412, 414-1 through -n, and 416-1 through -n, of FIG. 30C and 413 of FIG. 30B. At step 412, the code sectioning module 222 sections code using one or more trusted tools to produce trusted sectioned code. The dashboard data processing module 230 generates a graphical representation of the trusted code and corresponding trusted sectioned code information. If the code sectioning module 222 generates more than one trusted sectioned code, the dashboard data processing module 230 would generate a graphical representation for each version the trusted sectioned code and its corresponding information.

At steps 410-1 through -n, the code sectioning module 222 uses different combinations of AI code sectioning tools and/or proprietary AI code sectioning tools to generate multiple versions of AI sectioned code. The dashboard data processing module 230 generates a graphical representation for each version of the AI sectioned code and its corresponding information.

At steps 416-1 through -n, the code sectioning module 222 compares each version of the AI sectioned code with the trusted sectioned code. The code sectioning module 222 provides favorable comparison information to the dashboard data processing module 230 for each favorable comparison. The dashboard data processing module 230 provides a checkmark in the favorable comparison section of the corresponding sectioned code evaluation information and enables a GUI section button.

The code sectioning module 222 provides unfavorable comparison information to the dashboard data processing module 230 for each unfavorable comparison. The dashboard data processing module 230 provides a checkmark in the unfavorable comparison section of the corresponding sectioned code evaluation information and does not enable a GUI section button (shown grayed out).

At step 413, the code sectioning module 222 receives from the dashboard data processing module 230 an indication of which AI sectioned code with a favorable comparison was selected via a GUI select button. The code sectioning module 222 passes the selected sectioned code to the code enhancement module 224. Note that the user can select more than one version of AI sectioned code with a favorable comparison. In this instance, the codes sectioning module provides the selected versions of the AI sectioned code to the code enhancement module 224.

The proprietary AI enhancing tool module 225 gathers information regarding the generation of the trusted sectioned code, the generation of the versions of AI sectioned code, the comparison thereof, and the selection of one or more versions of AI sectioned code. The newly gathered information is used in combination with previously gathered information to create and/or update one or more use case models 428, to create and/or update one or more code sectioning execution models 460, and/or to create and/or update one or more proprietary AI tools 426.

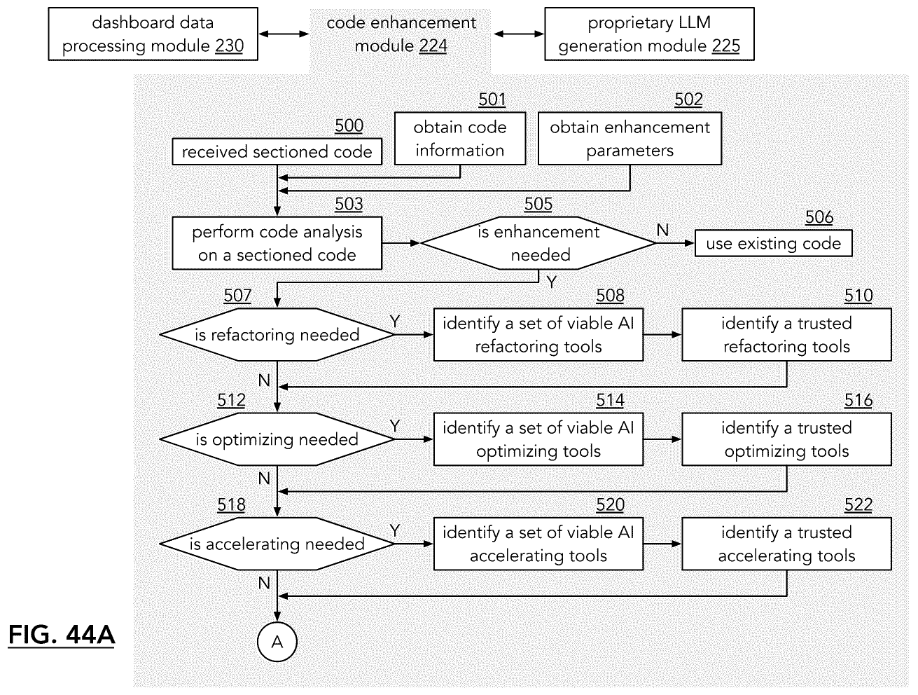

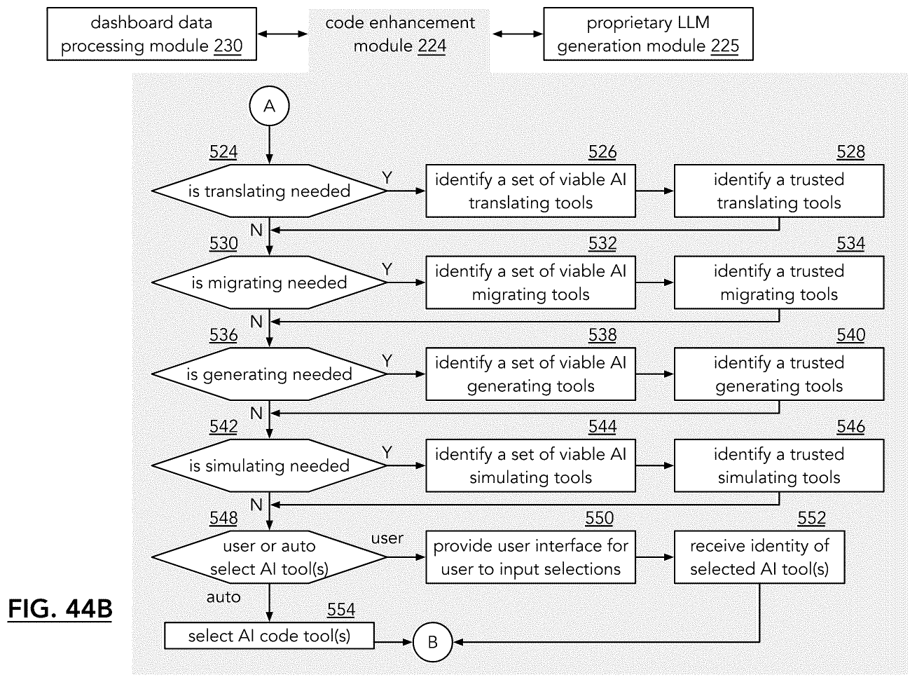

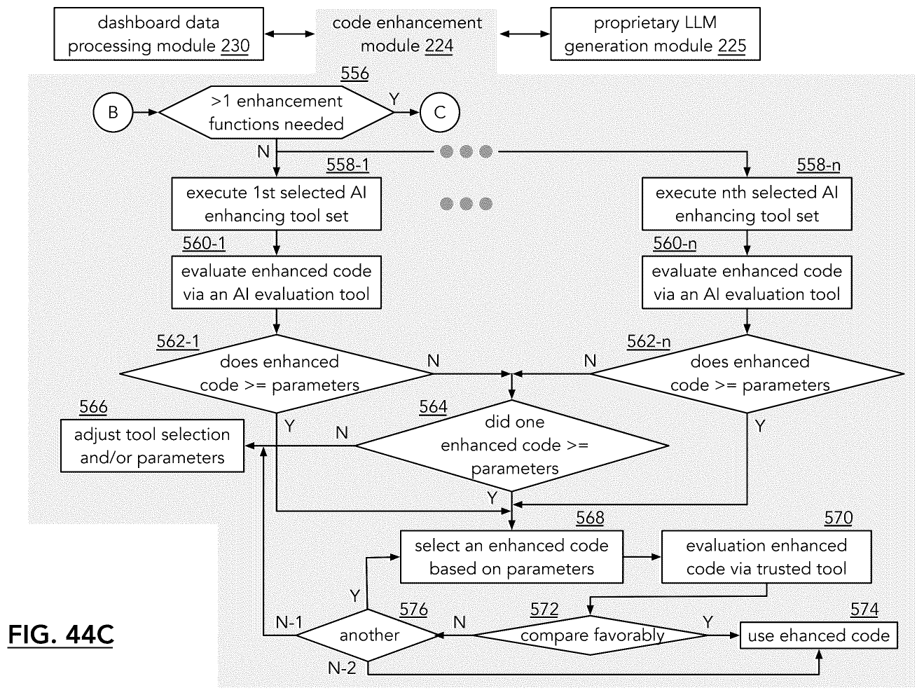

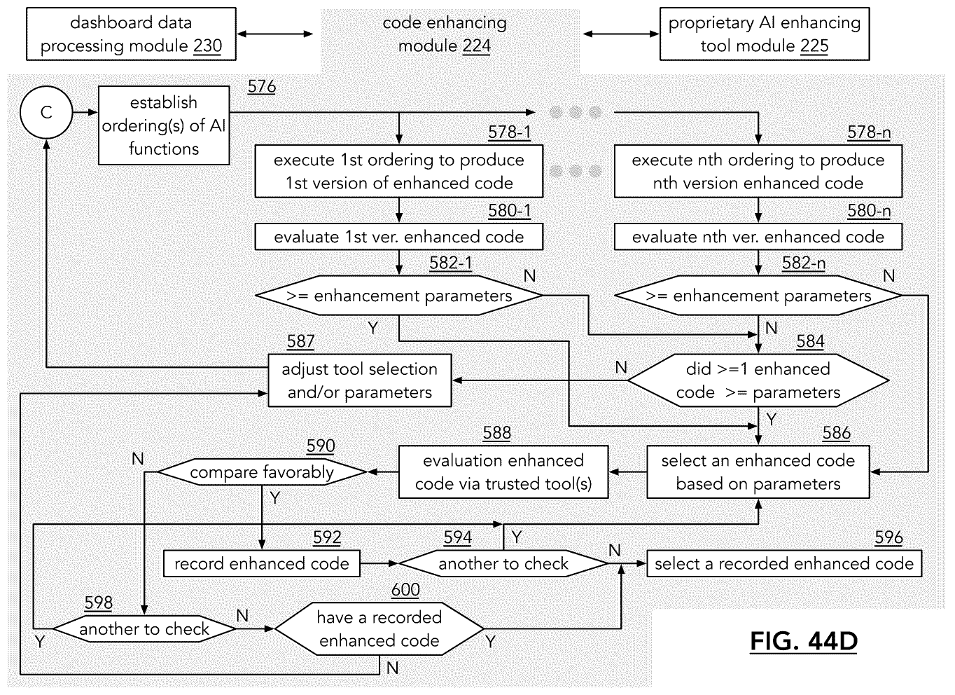

FIGS. 44A-44D are a logic diagram of an embodiment of a method for enhancing sectioned code that is executed by a code enhancement module 224. The method begins at steps 500, 501, and 502 of FIG. 44A. At step 500, the code enhancement module 224 receives one or more versions of sectioned code. At step 501, the code enhancement module 224 receives the code information for each version of sectioned code. At step 502, the code enhancement module 224 obtains the enhancement parameters (e.g., one or more purpose parameters and/or one or more operation parameters).

The method continues at step 503, where the code enhancement module 224 performs code analysis on each version of sectioned code. The analysis includes an evaluation with respect to the parameters and/or generating a score with respect to the parameters. In general, an evaluation is regarding whether a version of sectioned code meets the parameters and scoring of a version of sectioned code is how well it meets the parameters. The evaluation may be performed by the enhanced code evaluation module 226 and/or the scoring may be performed by the enhanced code scoring module 228.

The method continues at step 505, where the code enhancement module 224 determines whether a version of sectioned code needs enhancing (i.e., did not have a favorable evaluation and/or did not have a favorable score). For a version of sectioned code that does not need enhancing, the method continues at step 506, where the code enhancement module 224 uses the existing code for this version of sectioned code.

For each version of sectioned code that does need enhancing, the method continues at step 507, where the code enhancement module 224 determines whether any of the versions of sectioned code need refactoring. The code enhancement module 224 determines whether refactoring is needed based on the parameters. For example, when one or more of the following parameters is bolded, refactoring is needed: translation, migration, update, upgrade, improve software efficiencies, improve hardware efficiencies, expand functionality of code, add new code to existing code, improve user experience, add new features to existing code, improve data management, improved data analysis, adherence to regulatory requirements, improve data integrity, adapt to new technologies, improve user efficiency, improve user productivity, reduce costs from manufacturer and/or user, score the code with respect to one or more operation parameters, generate a confidence factor for the code, generate a trustworthiness factor for the code, quality, security, mitigating IP risk, context and reasoning, improve execution speed, reduce memory storage, reduce CPU usages, increasing parallelism, improve robustness, improve portability, improve clarity, improve performance, improve maintainability, improve scalability, and improve interoperability.

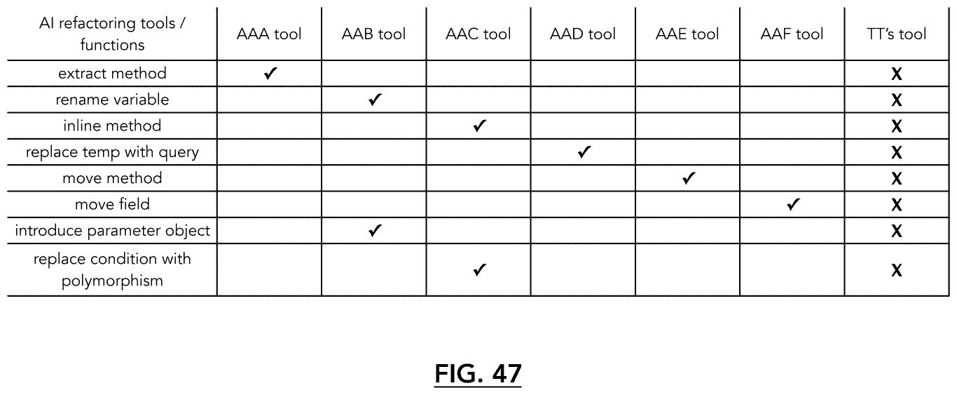

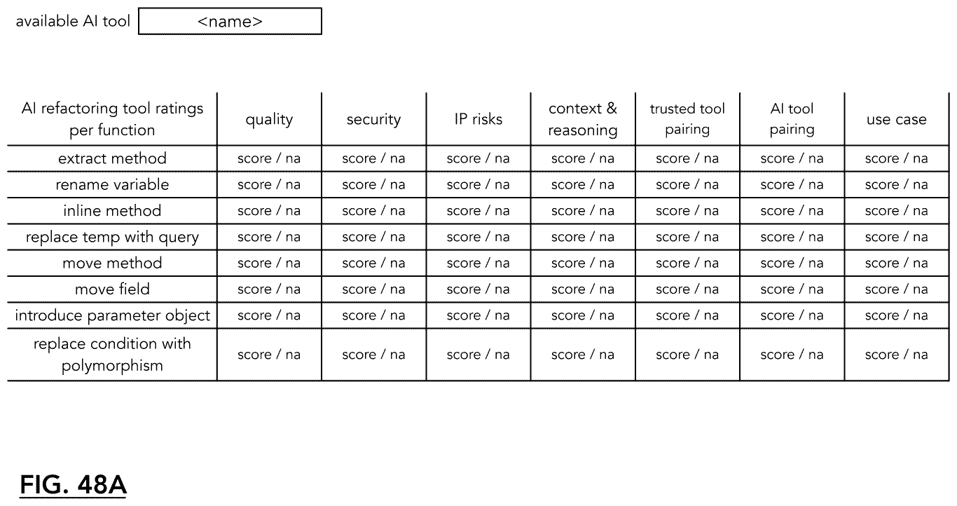

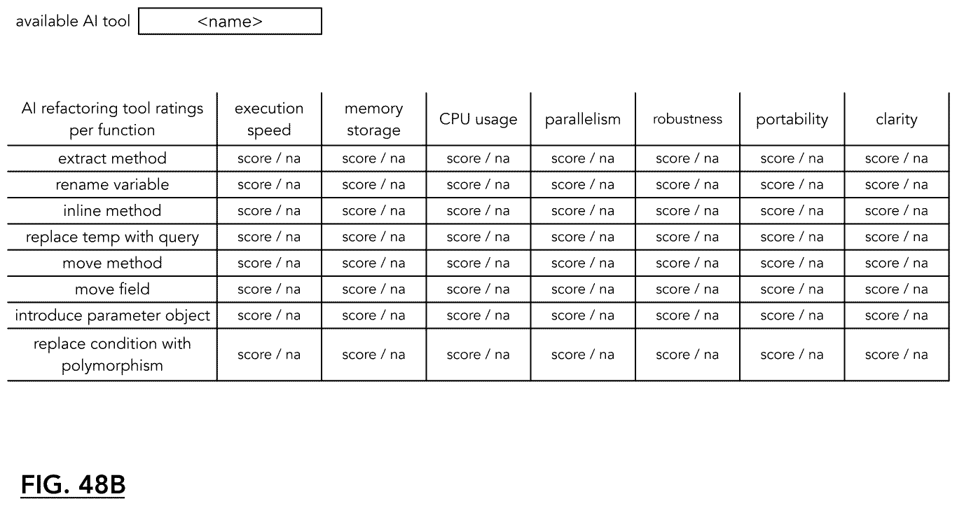

When refactoring is needed, the method continues at step 508, where the code enhancement module 224 identifies a set of viable AI refactoring tools. The code enhancement module 224 identifies the set of viable AI refactoring tools using the code information, the AI tool records (e.g., tables) 227, and/or the proprietary AI tool records (e.g., tables). The AI refactoring tool tables are further discussed with reference to FIGS. 47-48B.

The method continues at step 510, where the code enhancement module 224 identifies one or more trusted refactoring tools using the code information and trusted tool records (e.g., tables). The trusted refactoring tool tables are further discussed with reference to FIGS. 47-48B.

When refactoring is not needed or after step 510, the method continues at step 512, where the code enhancement module 224 determines whether any of the versions of sectioned code need optimizing. The code enhancement module 224 determines whether optimizing is needed based on the parameters. For example, when one or more of the following parameters is bolded, optimizing is needed: translation, migration, update, upgrade, improve software efficiencies, improve hardware efficiencies, expand functionality of code, add new code to existing code, improve user experience, add new features to existing code, improve data management, improved data analysis, adherence to regulatory requirements, improve data integrity, adapt to new technologies, improve user efficiency, improve user productivity, reduce costs from manufacturer and/or user, score the code with respect to one or more operation parameters, generate a confidence factor for the code, generate a trustworthiness factor for the code, quality, security, mitigating IP risk, context and reasoning, improve execution speed, reduce memory storage, reduce CPU usages, increasing parallelism, improve robustness, improve portability, improve clarity, improve performance, improve maintainability, improve scalability, and improve interoperability.

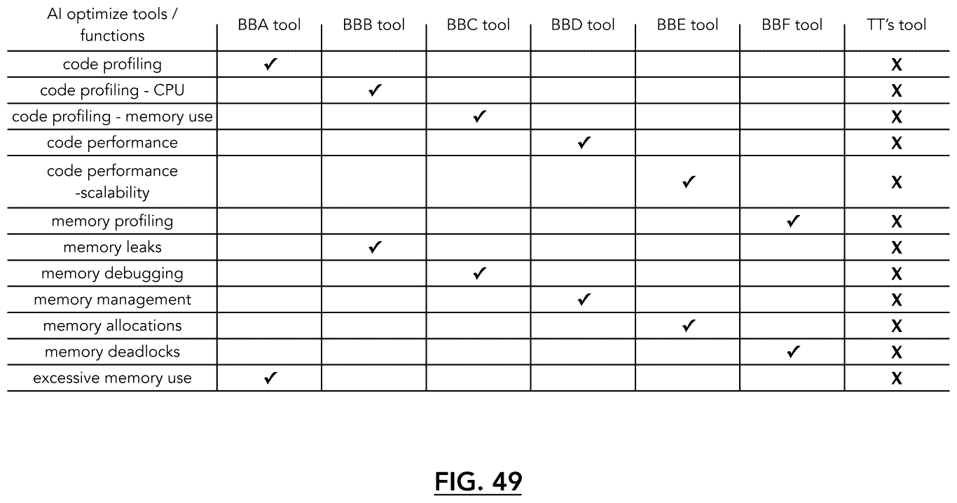

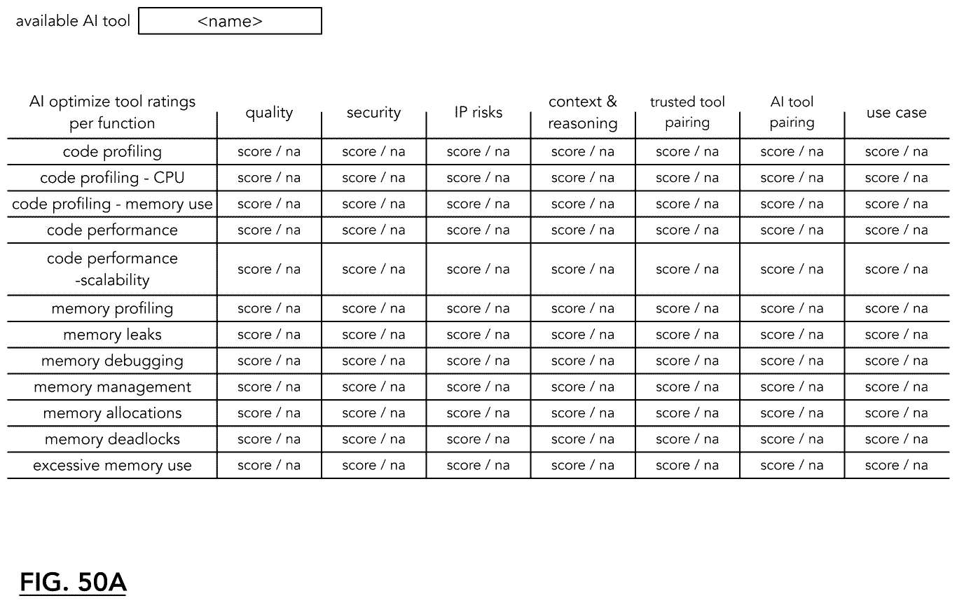

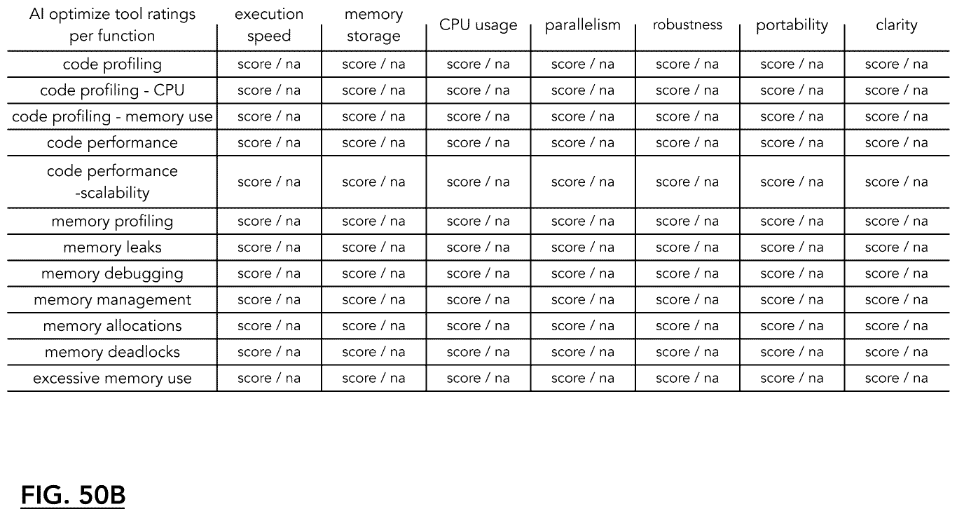

When optimizing is needed, the method continues at step 514, where the code enhancement module 224 identifies a set of viable AI optimizing tools. The code enhancement module 224 identifies the set of viable AI optimizing tools using the code information, the AI tool records (e.g., tables) 227, and/or the proprietary AI tool records (e.g., tables). The AI optimizing tool tables are further discussed with reference to FIGS. 49-50B.

The method continues at step 516, where the code enhancement module 224 identifies one or more trusted optimizing tools using the code information and trusted tool records (e.g., tables). The trusted optimizing tool tables are further discussed with reference to FIGS. 49-50B.

When optimizing is not needed or after step 516, the method continues at step 518, where the code enhancement module 224 determines whether any of the versions of sectioned code need accelerating. The code enhancement module 224 determines whether accelerating is needed based on the parameters. For example, when one or more of the following parameters is bolded, accelerating is needed: translation, migration, update, upgrade, improve software efficiencies, improve hardware efficiencies, expand functionality of code, add new code to existing code, improve user experience, add new features to existing code, improve data management, improved data analysis, adherence to regulatory requirements, improve data integrity, adapt to new technologies, improve user efficiency, improve user productivity, reduce costs from manufacturer and/or user, score the code with respect to one or more operation parameters, generate a confidence factor for the code, generate a trustworthiness factor for the code, quality, security, mitigating IP risk, context and reasoning, improve execution speed, reduce memory storage, reduce CPU usages, increasing parallelism, improve robustness, improve portability, improve clarity, improve performance, improve maintainability, improve scalability, and improve interoperability.

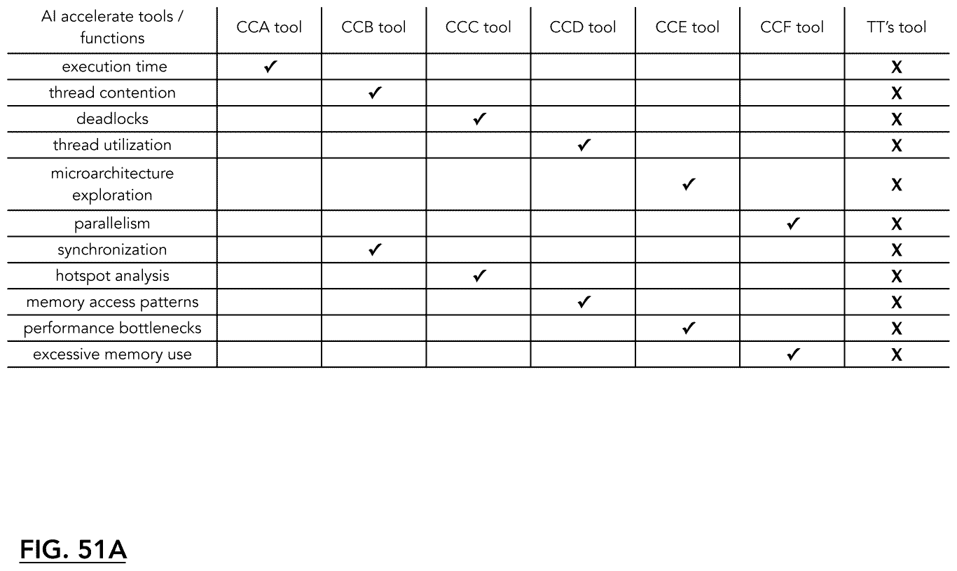

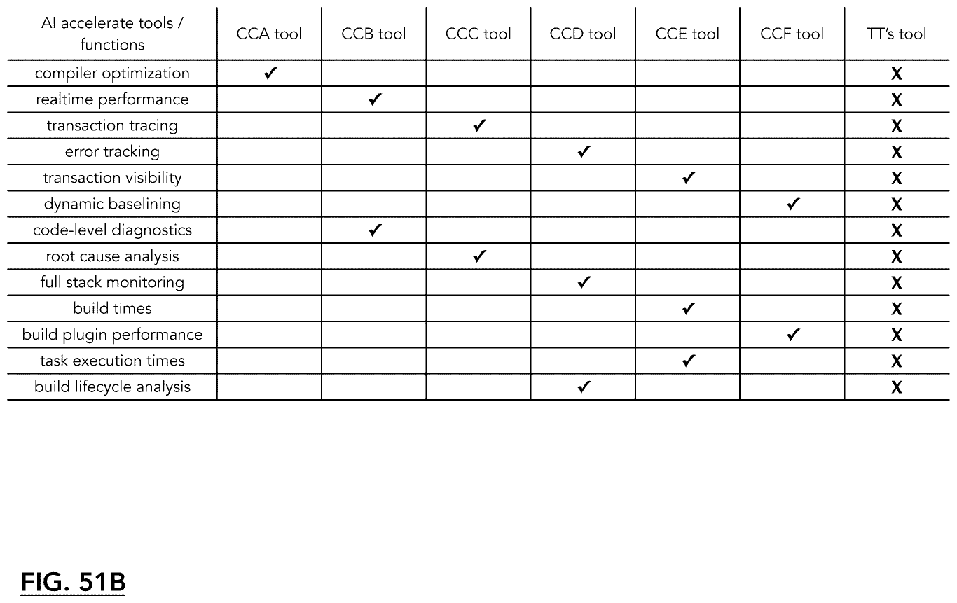

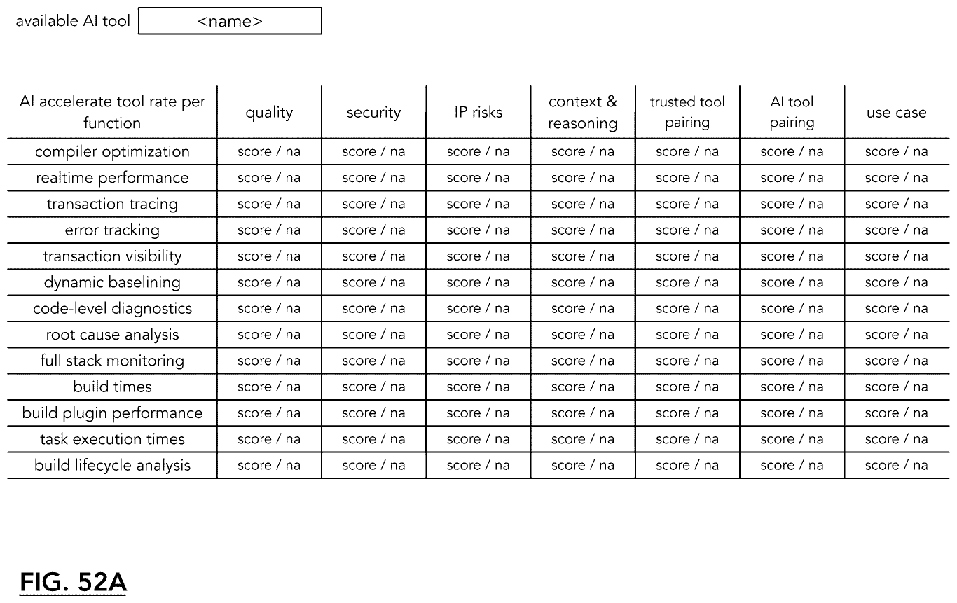

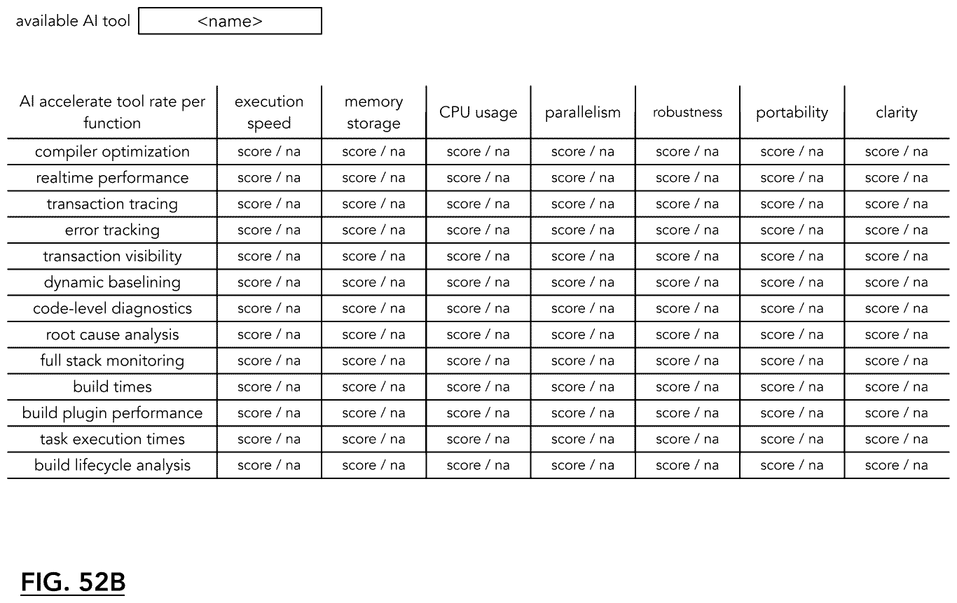

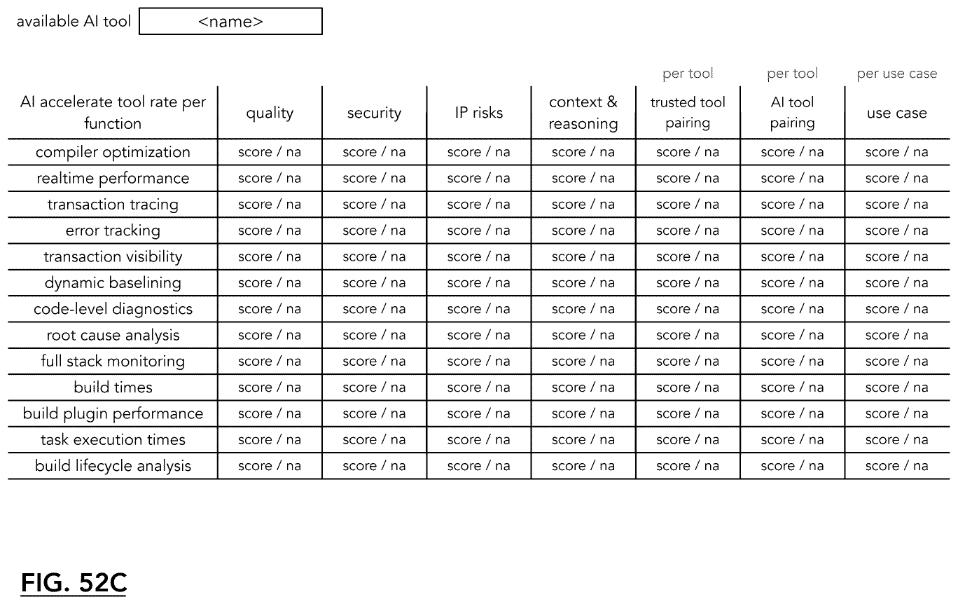

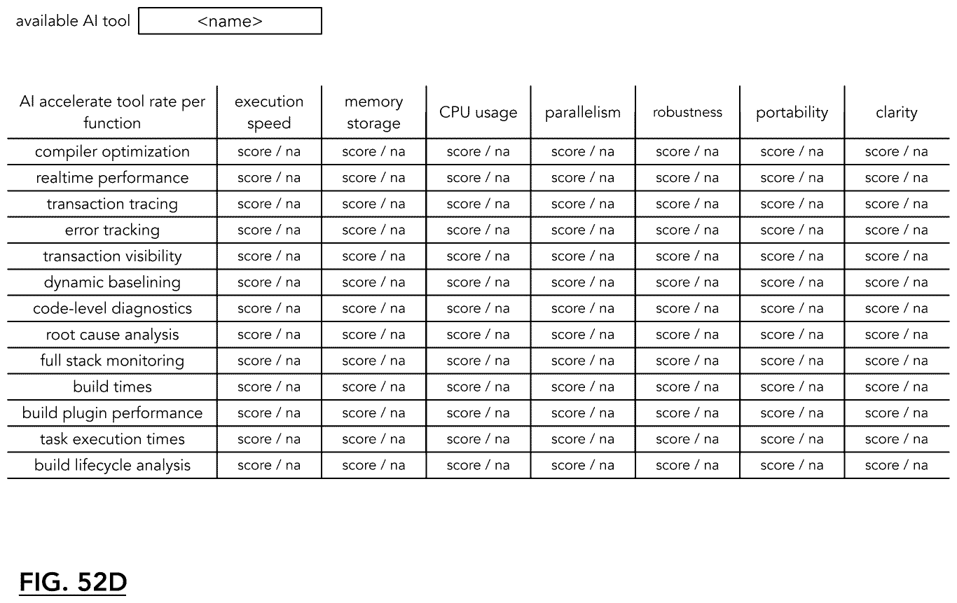

When accelerating is needed, the method continues at step 520, where the code enhancement module 224 identifies a set of viable AI accelerating tools. The code enhancement module 224 identifies the set of viable AI accelerating tools using the code information, the AI tool records (e.g., tables) 227, and/or the proprietary AI tool records (e.g., tables). The AI accelerating tool tables are further discussed with reference to FIGS. 51A-52D.

The method continues at step 522, where the code enhancement module 224 identifies one or more trusted accelerating tools using the code information and trusted tool records (e.g., tables). The trusted accelerating tool tables are further discussed with reference to FIGS. 51A-52D.

When accelerating is not needed or after step 522, the method continues at step 524 of FIG. 44B, where the code enhancement module 224 determines whether any of the versions of sectioned code need translating (e.g., programming language spoken language, etc.). The code enhancement module 224 determines whether translating is needed based on the parameters. For example, when one or more of the following parameters is bolded, translating is needed: translation, migration, update, upgrade, improve software efficiencies, improve hardware efficiencies, expand functionality of code, add new code to existing code, improve user experience, add new features to existing code, improve data management, improved data analysis, adherence to regulatory requirements, improve data integrity, adapt to new technologies, improve user efficiency, improve user productivity, reduce costs from manufacturer and/or user, score the code with respect to one or more operation parameters, generate a confidence factor for the code, generate a trustworthiness factor for the code, quality, security, mitigating IP risk, context and reasoning, improve execution speed, reduce memory storage, reduce CPU usages, increasing parallelism, improve robustness, improve portability, improve clarity, improve performance, improve maintainability, improve scalability, and improve interoperability.

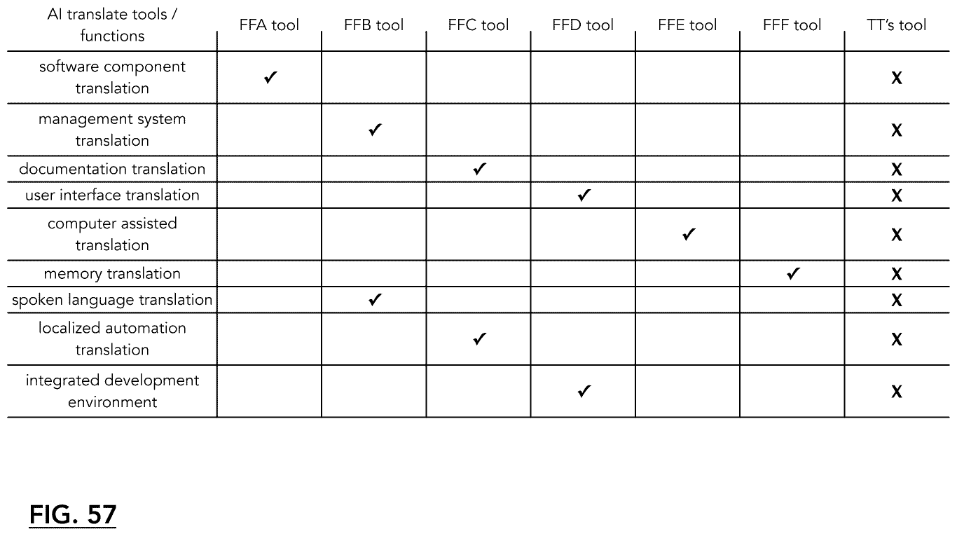

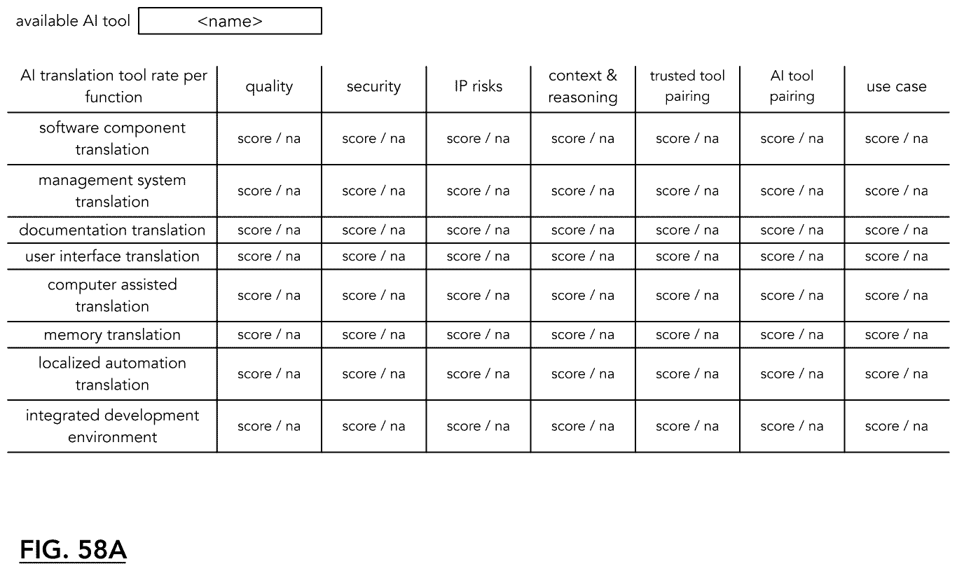

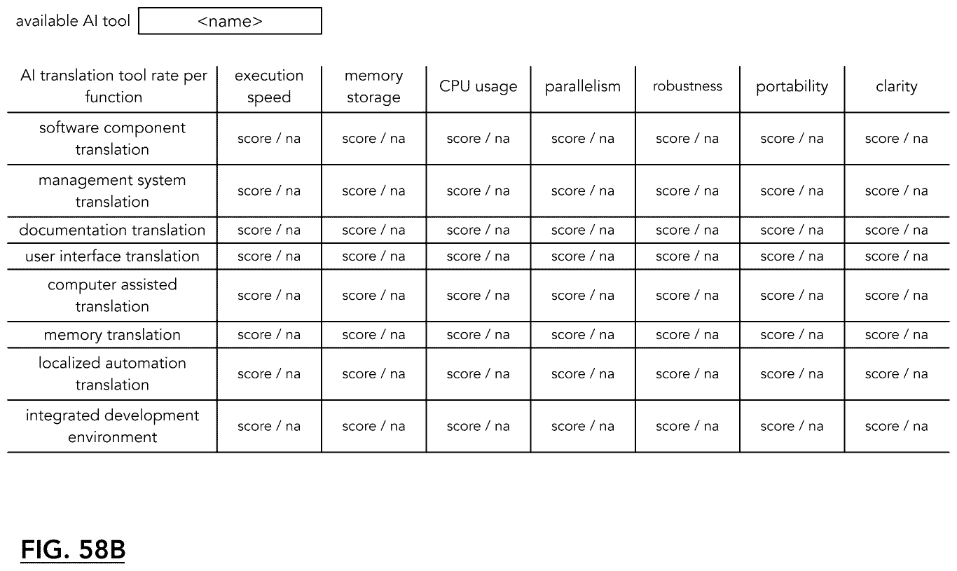

When translating is needed, the method continues at step 526, where the code enhancement module 224 identifies a set of viable AI translating tools. The code enhancement module 224 identifies the set of viable AI translating tools using the code information, the AI tool records (e.g., tables) 227, and/or the proprietary AI tool records (e.g., tables). The AI translating tool tables are further discussed with reference to FIGS. 57-58B.

The method continues at step 528, where the code enhancement module 224 identifies one or more trusted translating tools using the code information and trusted tool records (e.g., tables). The trusted translating tool tables are further discussed with reference to FIGS. 57-58B.

When translating is not needed or after step 528, the method continues at step 530, where the code enhancement module 224 determines whether any of the versions of sectioned code need migrating (e.g., to the cloud, to a different HW and/or SW platform, etc.). The code enhancement module 224 determines whether migrating is needed based on the parameters. For example, when one or more of the following parameters is bolded, translating is needed: translation, migration, update, upgrade, improve software efficiencies, improve hardware efficiencies, expand functionality of code, add new code to existing code, improve user experience, add new features to existing code, improve data management, improved data analysis, adherence to regulatory requirements, improve data integrity, adapt to new technologies, improve user efficiency, improve user productivity, reduce costs from manufacturer and/or user, score the code with respect to one or more operation parameters, generate a confidence factor for the code, generate a trustworthiness factor for the code, quality, security, mitigating IP risk, context and reasoning, improve execution speed, reduce memory storage, reduce CPU usages, increasing parallelism, improve robustness, improve portability, improve clarity, improve performance, improve maintainability, improve scalability, and improve interoperability.

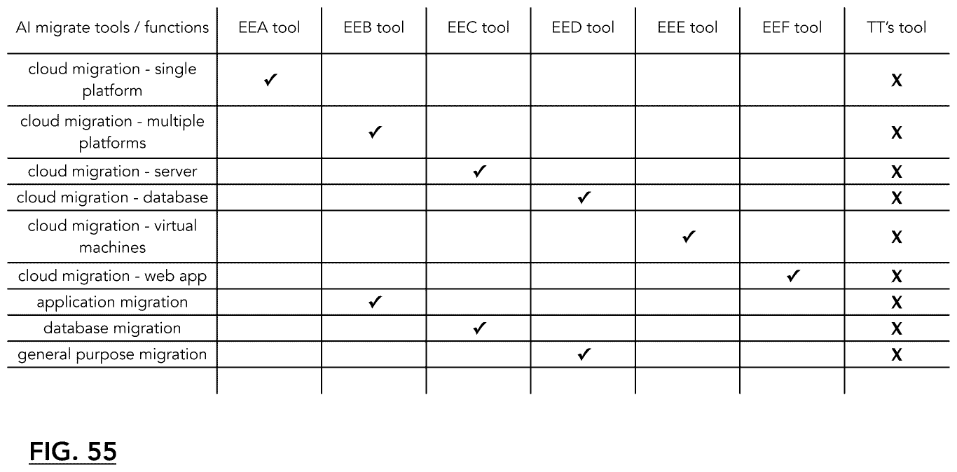

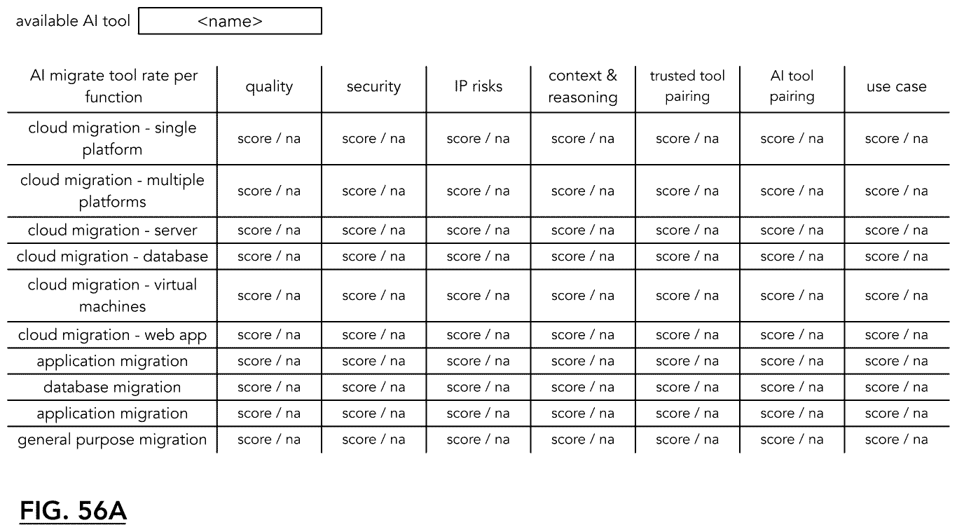

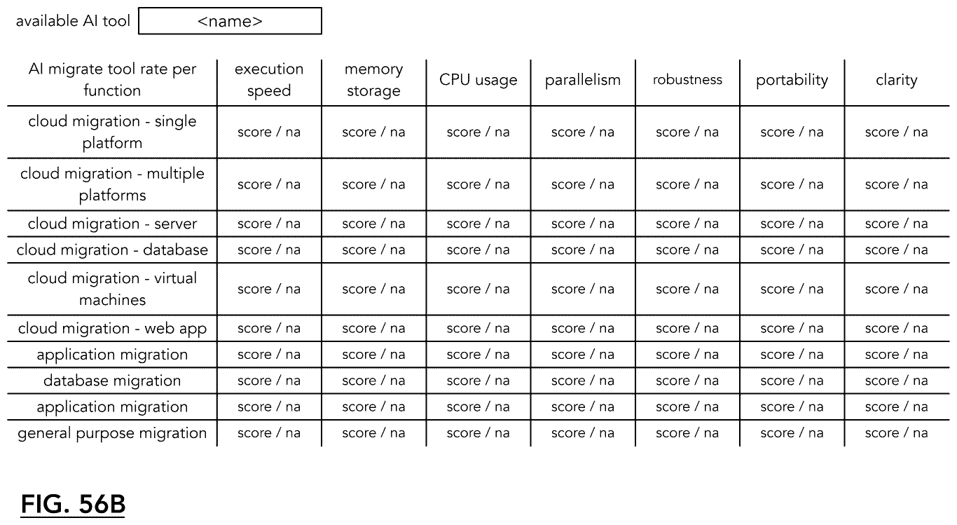

When migrating is needed, the method continues at step 532, where the code enhancement module 224 identifies a set of viable AI migrating tools. The code enhancement module 224 identifies the set of viable AI migrating tools using the code information, the AI tool records (e.g., tables) 227, and/or the proprietary AI tool records (e.g., tables). The AI migrating tool tables are further discussed with reference to FIGS. 55-56B.

The method continues at step 534, where the code enhancement module 224 identifies one or more trusted migrating tools using the code information and trusted tool records (e.g., tables). The trusted migrating tool tables are further discussed with reference to FIGS. 55-56B.

When migrating is not needed or after step 534, the method continues at step 536, where the code enhancement module 224 determines whether any of the versions of sectioned code need code generating. The code enhancement module 224 determines whether code generating is needed based on the parameters. For example, when one or more of the following parameters is bolded, code generating is needed: translation, migration, update, upgrade, improve software efficiencies, improve hardware efficiencies, expand functionality of code, add new code to existing code, improve user experience, add new features to existing code, improve data management, improved data analysis, adherence to regulatory requirements, improve data integrity, adapt to new technologies, improve user efficiency, improve user productivity, reduce costs from manufacturer and/or user, score the code with respect to one or more operation parameters, generate a confidence factor for the code, generate a trustworthiness factor for the code, quality, security, mitigating IP risk, context and reasoning, improve execution speed, reduce memory storage, reduce CPU usages, increasing parallelism, improve robustness, improve portability, improve clarity, improve performance, improve maintainability, improve scalability, and improve interoperability.

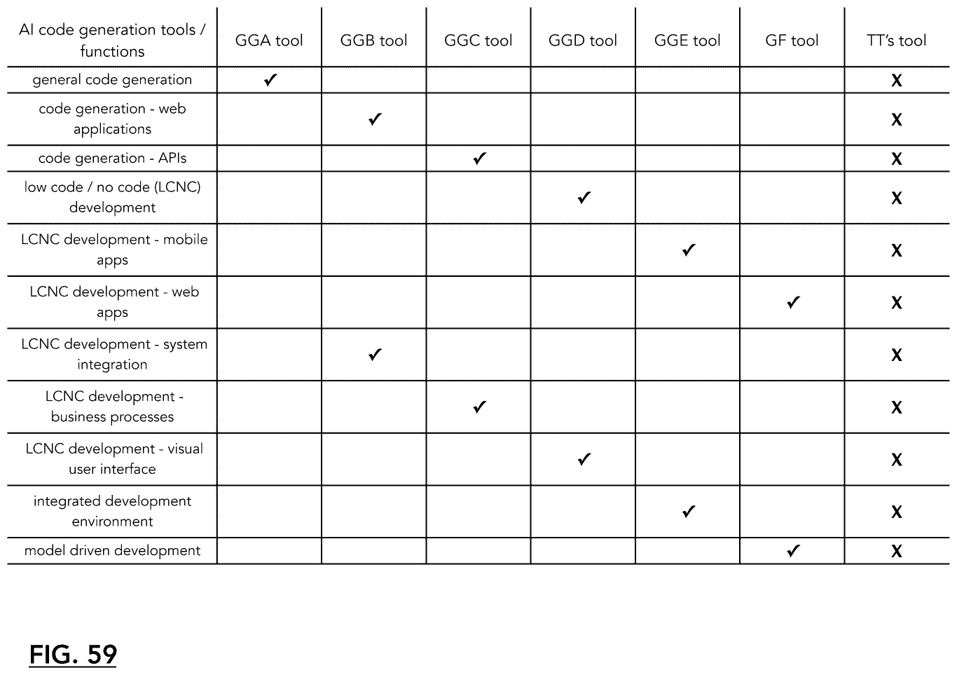

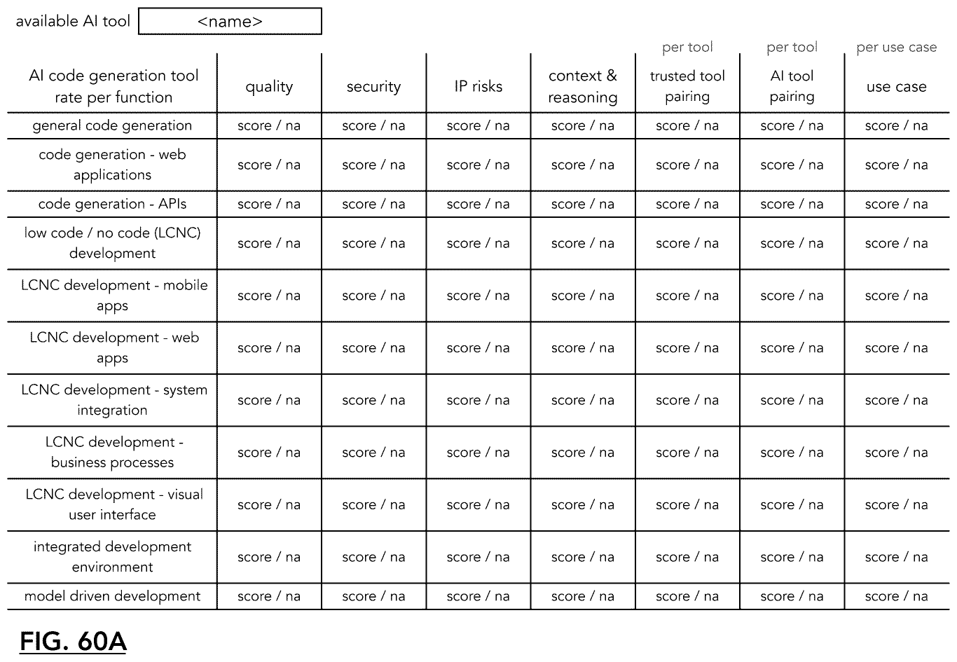

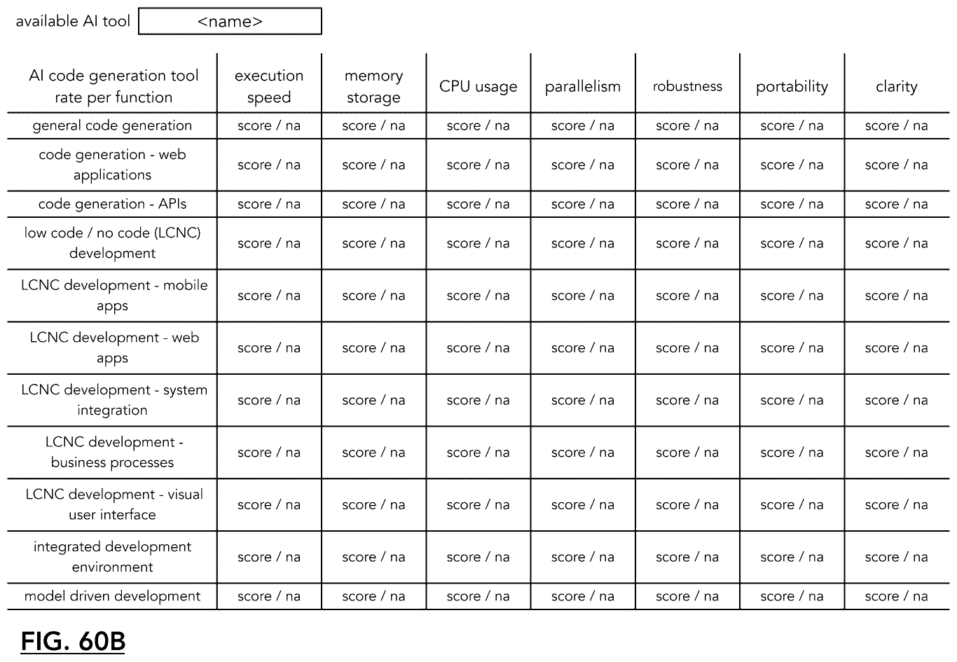

When code generating is needed, the method continues at step 538, where the code enhancement module 224 identifies a set of viable AI code generating tools. The code enhancement module 224 identifies the set of viable AI code generating tools using the code information, the AI tool records (e.g., tables) 227, and/or the proprietary AI tool records (e.g., tables). The AI code generating tool tables are further discussed with reference to FIGS. 59-60B.

The method continues at step 540, where the code enhancement module 224 identifies one or more trusted code generating tools using the code information and trusted tool records (e.g., tables). The trusted code generating tool tables are further discussed with reference to FIGS. 59-60B.

When code generating is not needed or after step 540, the method continues at step 542, where the code enhancement module 224 determines whether any of the versions of sectioned code need simulating (e.g., use simulation models of circuits, HW platforms, SW platforms, etc.). The code enhancement module 224 determines whether simulating is needed based on the parameters. For example, when one or more of the following parameters is bolded, simulating is needed: translation, migration, update, upgrade, improve software efficiencies, improve hardware efficiencies, expand functionality of code, add new code to existing code, improve user experience, add new features to existing code, improve data management, improved data analysis, adherence to regulatory requirements, improve data integrity, adapt to new technologies, improve user efficiency, improve user productivity, reduce costs from manufacturer and/or user, score the code with respect to one or more operation parameters, generate a confidence factor for the code, generate a trustworthiness factor for the code, quality, security, mitigating IP risk, context and reasoning, improve execution speed, reduce memory storage, reduce CPU usages, increasing parallelism, improve robustness, improve portability, improve clarity, improve performance, improve maintainability, improve scalability, and improve interoperability.

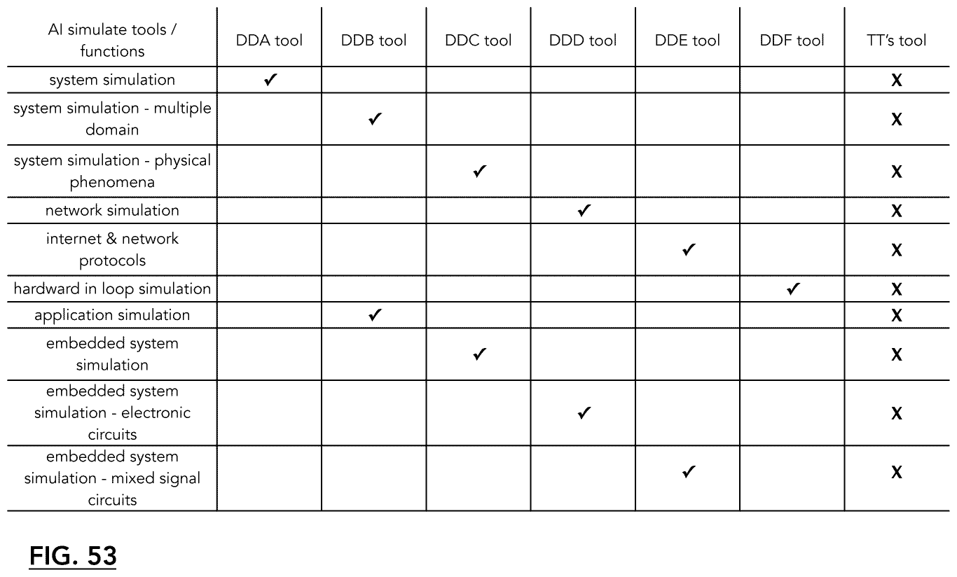

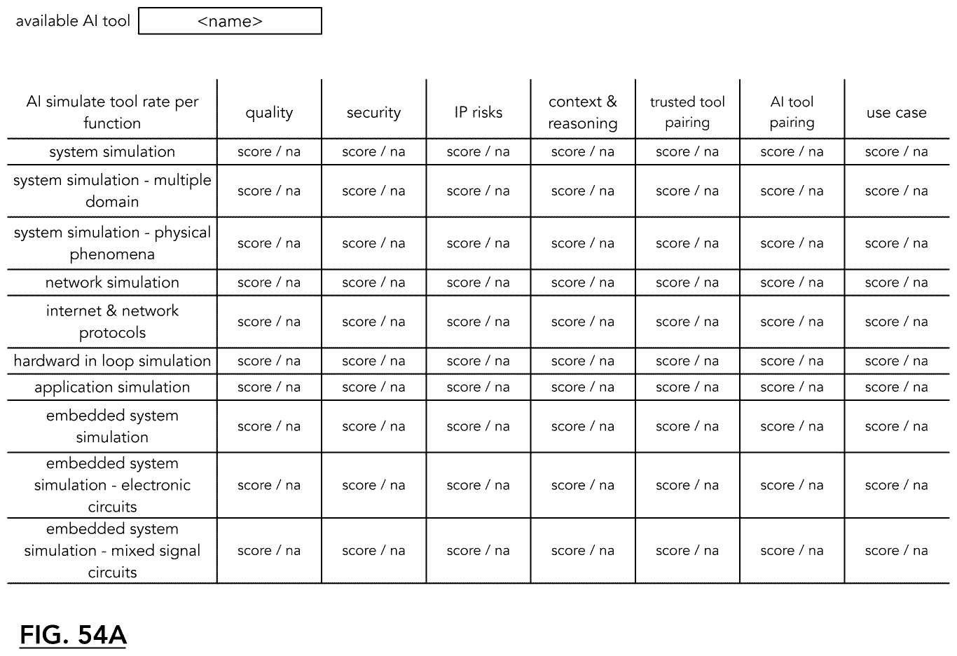

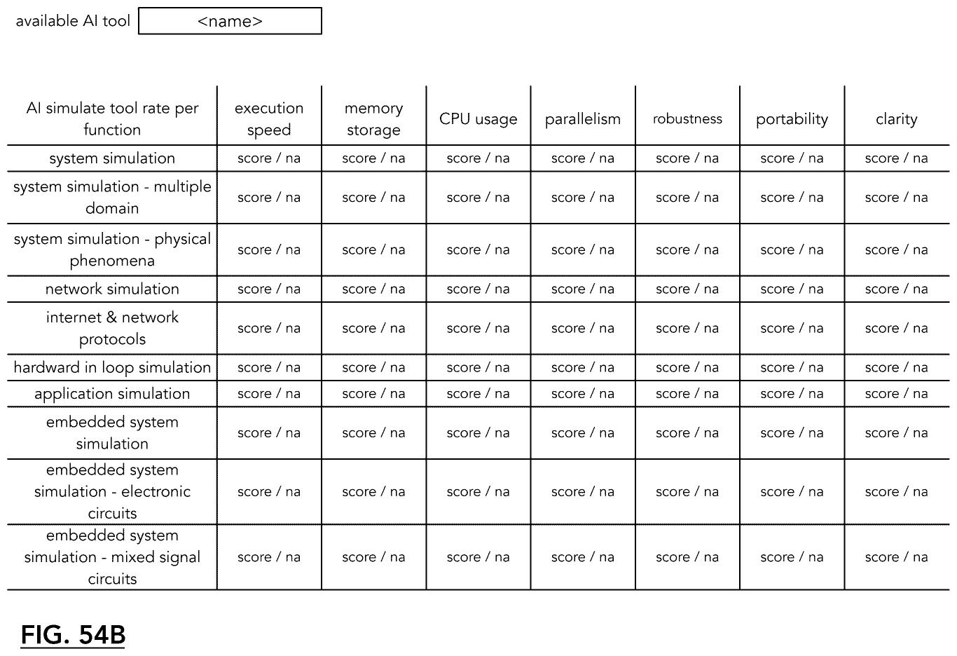

When simulating is needed, the method continues at step 544, where the code enhancement module 224 identifies a set of viable AI simulating tools. The code enhancement module 224 identifies the set of viable AI simulating tools using the code information, the AI tool records (e.g., tables) 227, and/or the proprietary AI tool records (e.g., tables). The AI simulating tool tables are further discussed with reference to FIGS. 53-54B.

The method continues at step 546, where the code enhancement module 224 identifies one or more trusted simulating tools using the code information and trusted tool records (e.g., tables). The trusted simulating tool tables are further discussed with reference to FIGS. 53-54B.

When simulating is not needed or after step 546, the method continues at step 548, where the code enhancement module 224 determines whether the tools (AI, proprietary AI, and/or trusted) are to be selected by a user or by the code enhancement system 104. When, at step 548, the system is to auto select the AI code sectioning tools, the method continues at step 544, where the code enhancement module 224 selects one or more AI code enhancing tools. The method then continues to step 556 of FIG. 44C.

When, at step 548, the user has elected to select the tools via a GUI, or the like, the method continues at step 550, where the code enhancement module 224 provides set of viable AI code enhancing tools to the dashboard data processing module 230, which generates a GUI that enables the user to select from the set of viable AI code enhancing tools. The set of AI code enhancing tools includes one or more AI refactoring tools, one or more AI optimizing tools, one or more accelerating tools, one or more AI translating tools, one or more AI migrating tools, one or more AI code generating tools, and/or one or more AI simulating tools. The set of AI viable AI code enhancing tools may further include AI proprietary code enhancing tools. The code enhancement module 224 may further generate a set of viable trusted code enhancing tools that is provided to the dashboard data processing module 230.

The method continues at step 552, where the code enhancement module 224 receives identify of selected AI code enhancing tools from the dashboard data processing module 230. The method continues at step 556 of FIG. 44C, where the code enhancement module 224 determines whether more than one enhancement function is needed; where an enhancement function is one of refactoring, optimizing, accelerating, translating, migrating, code generating, or simulating. For example, when only refactoring is needed, the answer to step 556 is no.

When the answer to step 556 is no, the method continues at steps 558-1 through 558—n, where the code enhancement module 224 executes “n” selected AI code enhancing tool sets on the sectioned code to produce a plurality of versions of enhanced code. As used herein, a set includes one or more tools and, for this method, “n” is a number equal to or greater than 1. When “n” is greater than 1, each AI code enhancing tool set includes at least one different tool than other sets.

The method continues at steps 560-1 through 560-n, where the code enhancement module 224 evaluates the versions of enhanced code produced by the ‘n’ sets of AI code enhancing tools. The code enhancement module 224 may evaluation the versions of enhanced code in a variety of ways. For example, the code enhancement module 224 evaluates a version of the enhanced code to determine whether it met or exceeded the selected parameters using one or more AI code evaluation tools. As another example, the code enhancement module 224 evaluates a section of enhanced code to determine whether the section meets or exceeds the selected parameters using one or more AI code evaluation tools.

An AI code evaluation tool performs one or more evaluation functions from a list of evaluation functions. The list includes, but is not limited to, requirements traceability, code review and/or inspection, static code analysis, dynamic code analysis, unit testing, integration testing, system testing, acceptance testing, model-based testing, compliance checklists, behavior-driven development, compliance audits, regression testing, performance and load testing, security testing, usability testing, fuzz testing, compliance testing, configuration and change management, code metrics and complexity analysis, test-driven development, code linting, code coverage analysis, mutation testing, and documentation review. These evaluation functions are further discussed in the glossary section.

The code enhancement module 224 may further evaluate the versions of enhanced code that had a favorable AI code enhancement evaluation by generating a score for the evaluation (e.g., how much did the version of enhanced code exceed the selected parameters). For scoring, the code enhancement module 224 using a proprietary AI scoring tool and/or the enhanced code scoring module 238.

The method continues at steps 562-1 through 562-n, where the code enhancement module 224 determines whether the versions of enhanced code meet or exceed the selected parameters based on the corresponding evaluation of steps 560-1 through 560-n. When the code enhancement module 224 evaluates sections and, for a version of enhanced code, the code enhancement module 224 determines whether to use the original section (i.e., unenhanced), to change the AI enhancing tool set for the section and again attempt to enhance the section, or to indicate that this particular version of code did not meet the selected parameters.

When a version of code meets or exceeds the selected parameters, the method continues at step 568, where the code enhancement module 224 selects a version of enhanced code based on the parameters. For example, the code enhancement module 224 selects the version of code that best meets the parameters based on the AI code evaluation of steps 560 and 562.

The method continues at step 570, where the code enhancement module 224 and/or the enhanced code evaluation module 226 evaluates the selected enhanced code using a trusted code evaluation tool set (e.g., one or more trusted code evaluation tools). The trusted code evaluation tool set performs one or more evaluation functions from the list of evaluation functions to evaluate the selected code.

The method continues at step 572, where the code enhancement module 224 and/or the enhanced code evaluation module 226 determines whether the selected code compares favorably to the selected parameters. For example, a favorable comparison indicates that the selected code meets or exceeds the selected parameters. In addition, the code enhancement module 224 and/or the enhanced code scoring module 228 determines a score for the selected code regarding how well it meets the selected parameters and the favorable comparison further includes the selected code having a favorable score.

For a selected code that has a favorable comparison, the method continues at step 574, where the code enhancement module 224 indicates that the selected code could be used as the resulting enhanced code. If only one version of the enhanced code had a favorable comparison at step 572, then it is the resulting enhanced code. If more than one version of the enhanced code had a favorable comparison at step 572, then the code enhancement module 224 selects one of them to be the resulting enhanced code.

The code enhancement module 224 may select the resulting enhanced code from the multiple versions in a variety of ways. For example, the code enhancement module 224 selects the version with the highest overall score. As another example, the code enhancement module 224 selects the version with the highest score for the top priority selected parameters. As another example, the code enhancement module 224 receives a user input for the selection of the resulting enhanced version.

When the comparison was unfavorable at step 572, the method continues at step 576, where the code enhancement module 224 determines whether this is another version of AI enhanced code to be evaluated by the trusted tool set. If not and there are no versions of AI enhanced code that had a favorable comparison with the trusted tool set, then the method continues at step 566, where the code enhancement module 224 adjusts the AI code enhancing tool sets and/or adjusts the parameters and method repeats at step 503 of FIG. 44A.

When, at steps 562-1 through 562-n, a version of AI enhanced code did not meet the parameters at it corresponding step 560-1 through 560-n, the method continues at step 564 where the code enhancement module 224 determines whether any version of AI enhanced code met the parameters. If yes, the method continues at step 568. If no, the method continues at step 566.

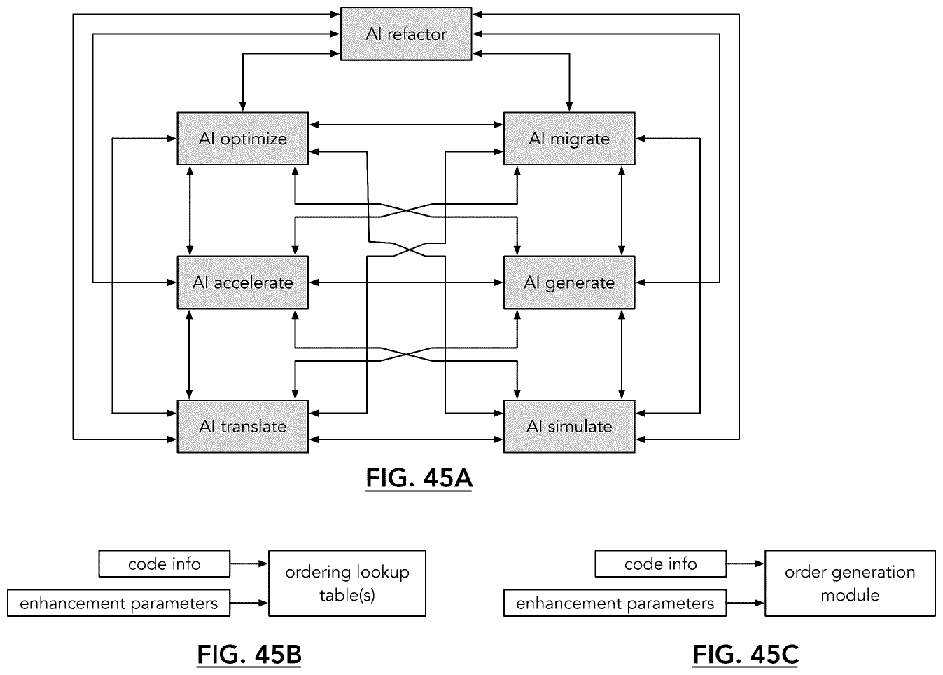

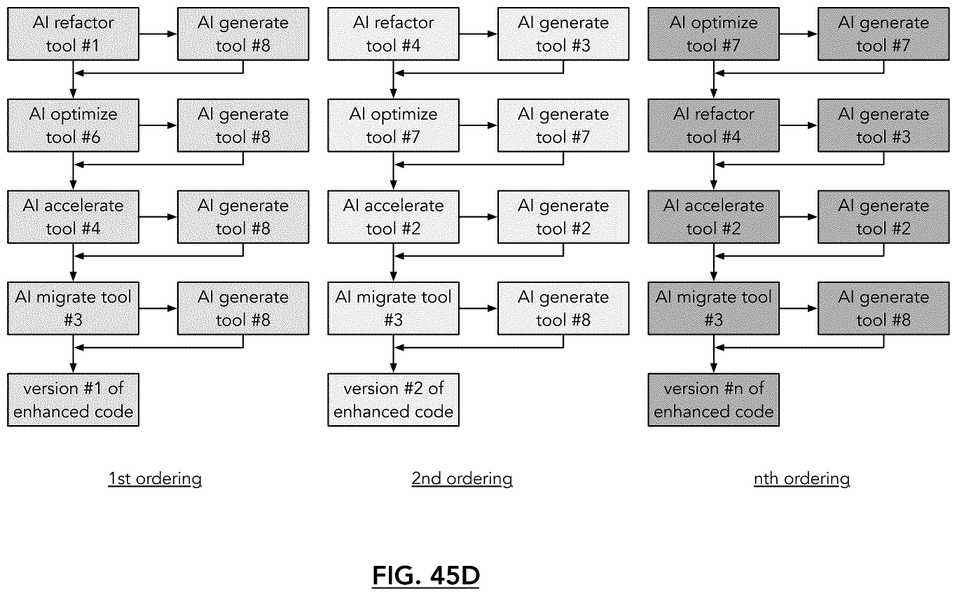

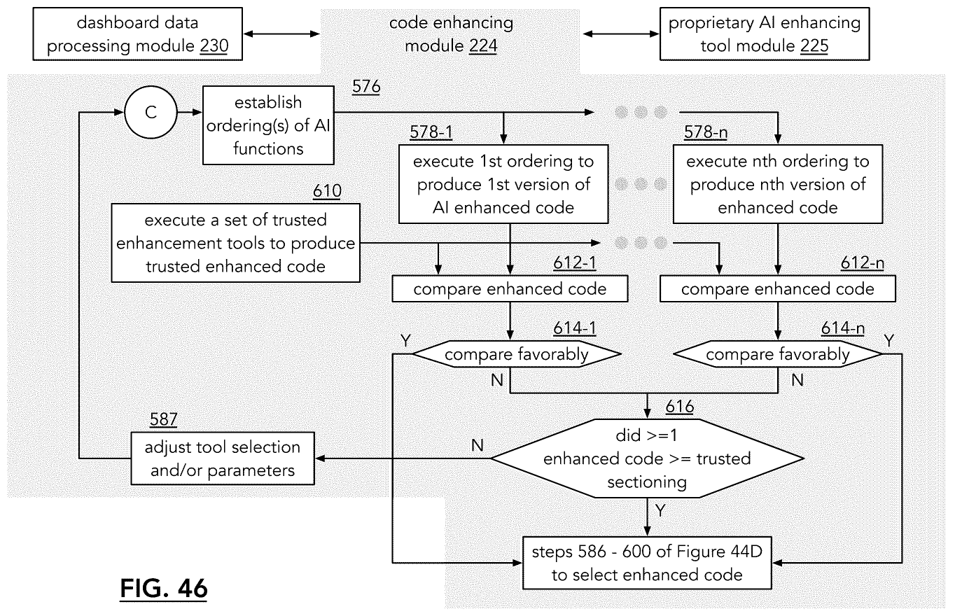

When, at step 556, the code enhancement module 224 determines that more than one enhancement function is needed, the method continues to step 576 of FIG. 44D where the code enhancement module 224 establishes an ordering, or orderings, of execution of the AI code enhancement functions (e.g., refactoring, optimizing, accelerating, translating, migrating, code generating, and simulating). Various examples and further discussion of ordering execution of the AI code enhancement functions is provided below with reference to FIGS. 45A-45D.

As an example of ordering, refactoring, accelerating, and translating are the AI code enhancing functions to be performed. For this example, further assume that two AI refactoring tools have been selected, three AI accelerating tools have been selected, and two AI translating tools have been selected. There are six high level ordering options of the enhancing functions (refactoring, accelerating, and translating), (refactoring, translating, and accelerating), (accelerating, refactoring, and translating), (accelerating, translating, and refactoring), (translating, refactoring, and accelerating), and (translating, accelerating, and refactoring).

For each enhancing function, selected tools may be performed in parallel, in serial, and/or a serial-parallel combination. As a specific example, for the two AI refactoring tools, there are three execution ordering options: tool one then tool two in a serial manner, tool two then tool one in a serial manner, or both in parallel. The two AI translating tools have the same three execution ordering options. The three AI accelerating tools have six serial combinations, one full parallel combination, and two serial-parallel combinations. As such, for this example, there are 6*3*3*9=486 ordering options. Any number of them may be used by the code enhancement module 224 to create versions of AI enhanced code. Further, during the generation of a version of AI enhanced code, the ordering of the code enhancing functions, and/or ordering of the tool may be changed multiple times. For example, a section of code may have unique ordering of code enhancing functions and tools than one or more other sections.

The method continues at steps 578-1 through 578-n, where the code enhancement module 224 executes “n” orderings of code enhancement functions and AI code enhancing tools to produce “n” versions of AI enhanced code. The method continues at steps 580-1 through 580-n, where the code enhancement module 224 evaluates the “n” versions of AI enhanced code using AI code evaluation tools. Steps 580-1 through -n are similar to steps 560-1 through 560—n of FIG. 44C.

The method continues at steps 582-1 through 582—n, where the code enhancement module 224 determines which of the “n” versions of AI enhanced code meets or exceeds the selected parameters. Steps 582-1 through 582-2 are similar to steps 562-1 through 562—n of FIG. 44C.

When a version of code meets or exceeds the selected parameters, the method continues at step 586, where the code enhancement module 224 selects a version of enhanced code based on the parameters. For example, the code enhancement module 224 selects the version of code that best meets the parameters based on the AI code evaluation of steps 580 and 582.

The method continues at step 588, where the code enhancement module 224 and/or the enhanced code evaluation module 226 evaluates the selected enhanced code using a trusted code evaluation tool set (e.g., one or more trusted code evaluation tools). The trusted code evaluation tool set performs one or more evaluation functions from the list of evaluation functions to evaluate the selected code.

The method continues at step 590, where the code enhancement module 224 and/or the enhanced code evaluation module 226 determines whether the selected code compares favorably to the selected parameters. For example, a favorable comparison indicates that the selected code meets or exceeds the selected parameters. In addition, the code enhancement module 224 and/or the enhanced code scoring module 228 determines a score for the selected code regarding how well it meets the selected parameters and the favorable comparison further includes the selected code having a favorable score.

For a selected code that has a favorable comparison, the method continues at step 592, where the code enhancement module 224 records that the selected code could be used as the resulting enhanced code. The method continues at step 594, where the code enhancement module 224 determines whether there is another version of AI enhanced code to evaluate with respect to the trusted tool set. If not, the method continues at step 596, where the code enhancement module 224 selects one of the recorded versions of AI enhanced code as the outputted enhanced code.

If, at step 596, only one version of the enhanced code had a favorable comparison at step 572, then it is the resulting enhanced code. If more than one version of the enhanced code had a favorable comparison at step 572, then the code enhancement module 224 selects one of them to be the resulting enhanced code.

The code enhancement module 224 may select the resulting enhanced code from the multiple versions in a variety of ways. For example, the code enhancement module 224 selects the version with the highest overall score. As another example, the code enhancement module 224 selects the version with the highest score for the top priority selected parameters. As another example, the code enhancement module 224 receives a user input for the selection of the resulting enhanced version.

When the comparison was unfavorable at step 590, the method continues at step 598, where the code enhancement module 224 determines whether this is another version of AI enhanced code to be evaluated by the trusted tool set. If not, the method continues at step 600, where the code enhancement module 224 determines whether this at least one recorded version of AI enhanced code that had a favorable evaluation with respect to the trusted tool set. If yes, the method continues at step 596.

When the answer to step 600 is no, the method continues at step 587, where the code enhancement module 224 adjusts the AI code enhancing tool sets and/or adjusts the parameters and method repeats at step 503 of FIG. 44A.

When, at steps 582-1 through 582-n, a version of AI enhanced code did not meet the parameters at it corresponding step 580-1 through 580-n, the method continues at step 584 where the code enhancement module 224 determines whether any version of AI enhanced code met the parameters. If yes, the method continues at step 586. If no, the method continues at step 587.

FIGS. 45A-45D are diagrams of examples of ordering code enhancing categories for enhancing code. FIG. 45A illustrates each code enhancing function (refactor, optimize, accelerate, translate, migrate, code generate, and simulate) as a state in state diagram. Each of the states are connected such that, from a state, the ordering can proceed to any of the other states.

FIG. 45B illustrates a schematic block diagram of an embodiment for establishing the ordering of code enhancing functions using a look up table. With the code information and selected enhancement parameters as inputs, the lookup table determines an ordering. An ordering may include one state with no state transitions or it may include all seven states with hundreds or more state transitions.

For example, for a code that is being translated from one programming language to another, the translate state is selected and it does not transition to another state. As another example, for code that is being substantially enhanced, the states of refactor, optimize, accelerate, migrate, generate, and simulate are selected and includes scores of state transitions between the states as the code is enhanced.

FIG. 45C illustrates a schematic block diagram of an embodiment for establishing the ordering of code enhancing functions using an order generation module. The order generation module receives the code information and selected enhancement parameters as inputs, and, based on the inputs, determines one or more orderings. For example, the order generation module learns from previous orderings for like code enhancements and creates a similar order for a code to be enhanced.

FIG. 45D illustrates a few examples of state diagrams of orderings. In a first ordering, AI refactoring tool #1 is used in an initial state. The state diagram transitions from the initial state to a state in which AI generate tool #8 is used and to a state in which AI optimize tool #6 is used. The state in which AI generate tool #8 is used transitions to the state in which AI optimize tool #6 is used. The triggers for the state transitions are based on the particular tool completing its function on the code as a whole, on a portion of the code (e.g., a group of sections), or on a section of the code.

The state in which AI optimize tool #6 is used transitions to a new state in which the AI generate tool #8 is used and to a state in which AI accelerate tool #4 is used. The state transitions continue until the final state is reached in which a first version of enhanced code is produced.

In a second ordering example, the AI code enhancing functions are in the same order as the first example but the AI tools are different. The state diagram transitions from the initial state in which the AI refactor tool #4 is used to the final state in which a second version of enhanced code is produced.

In a third ordering example, the AI code enhancing tools are the same as in the second ordering example but the AI code enhancing functions are in a different order. The state diagram transitions from the initial state in which the AI optimize tool #7 is used to the final state in which a n^{th} version of enhanced code is produced.

FIG. 46 is a logic diagram of an embodiment of a method for using ordered categories to enhance sectioned code, which is an alternative method to that of FIG. 44D. This method begins at step 576 of FIG. 44D, where the code enhancement module 224 establishing one or more orderings of code enhancing functions and/or AI code enhancing tools. The method continues at steps 578-1 through 578—n of FIG. 44D, where the code enhancement module 224 executed “n” orderings of functions and/or tools to produce “n” versions of AI enhanced code.

The method continues at step 610, where the code enhancement module 224 executes a set of trusted code enhancement tools on the code to produce trusted enhanced code. The method continues at steps 612-1 through 612—n, where the code enhancement module 224 compares the trusted enhanced code with the “n” versions of AI enhanced code. The comparison may be done in a variety of ways. For example, the versions of AI enhanced code is compared line by line with the trusted enhanced code. As another example, one or more trusted evaluation tools are used to produce an evaluation for the trusted enhanced code and evaluations for the versions of AI enhanced code, where the evaluations are compared.

The method continues at steps 614-1 through 614-n, where the code enhancement module 224 determines whether the comparisons of steps 612-1 through 612—n were favorable or not. For example, a favorable comparison occurs when the evaluation of a version of AI enhanced code met or exceeded the evaluation of the trusted enhanced code. If yes, the method continues at steps 586-600 of FIG. 44D.

For an unfavorable comparison at one or more of steps 614-1 through 614-n, the method continues at step 616 where the code enhancement module 224 determines where at least one version of the AI enhanced code compared favorably to the trusted enhanced code. If yes, the method continues at steps 586-600 of FIG. 44D. If no, the method continues at step 587 of FIG. 44D.

FIG. 47 is a schematic block diagram of an example of a table of AI refactoring tools. The table includes a plurality of columns. The first is for refactoring sub-functions and the remaining columns are for the names of the AI refactoring tools and/or proprietary AI refactoring tools. The refactoring sub-functions include, but are not limited to, extract method, rename variable, inline method, replace temporary (temp) with query, move method, move field, introduce parameter object, and replace condition with polymorphism. Each of these sub-functions are discussed in greater detail in the glossary section.

Checkmarks in the table indicate that a particular tool performs the particular sub-function. For example, tool AAA performs the sub-function of extract method, tool AAB performs the sub-functions of rename variable and introduce parameter object, and so on. The “X” for the propriety AI refactoring tool(s) indicates that the tool enhances, augments, supports, edits, and/or performs the corresponding sub-function. Note that the trusted refactoring tools would have a similar table.

FIGS. 48A and 48B are a schematic block diagram of an example of a table regarding an AI refactoring tool. The table includes a first column for the refactoring sub-functions and a plurality of columns for attributes of refactoring code. The attributes include performance attributes and use attributes. The use attributes includes trusted tool pairing, AI tool pairing, and use case. These use attributes were previously discussed.

The performance attributes includes quality, security, IP risks, context & reasoning, execution speed, memory storage, CPU usage, parallelism, robustness, portability, and clarity. Each of these performance attributes are further discussed in the glossary section. The system 104 scores each applicable refactoring sub-function of the AI tool. The score indicates a probability of the AI tool's execution of the refactoring sub-function having a favorable comparison with the trusted tool execution of, and/or analyzing of, the refactoring sub-function. The probability is based on past comparisons between the AI tool and the trusted tool.

A trusted refactoring tool would have a similar table with the exception of not having an attribute/sub-function score. The trusted refactoring tool table would include a check mark instead of a score for applicable attribute/sub-functions.

FIG. 49 is a schematic block diagram of an example of a table of AI optimizing tools. The table includes a plurality of columns. The first is for optimizing sub-functions and the remaining columns are for the names of the AI optimizing tools and/or proprietary AI optimizing tools. The optimizing sub-functions include, but are not limited to, code profiling, code profiling—CPU, code profiling—memory, code performance, code performance—scalability, memory profiling, memory leaks, memory debugging, memory management, memory allocations, memory deadlocks, and excessive memory use. Each of these sub-functions are discussed in greater detail in the glossary section.

Checkmarks in the table indicate that a particular tool performs the particular sub-function. For example, tool BBA performs the sub-functions of code profiling and excessive memory use, tool BBB performs the sub-functions of code profiling-CPU and memory leaks, and so on. The “X” for the propriety AI optimizing tool(s) indicates that the tool enhances, augments, supports, edits, and/or performs the corresponding sub-function. Note that the trusted optimizing tools would have a similar table.

FIGS. 50A and 50B are a schematic block diagram of an example of a table regarding an AI optimizing tool. The table includes a first column for the optimizing sub-functions and a plurality of columns for attributes of optimizing code. The attributes include performance attributes and use attributes. The use attributes includes trusted tool pairing, AI tool pairing, and use case. These use attributes were previously discussed.

The performance attributes includes quality, security, IP risks, context & reasoning, execution speed, memory storage, CPU usage, parallelism, robustness, portability, and clarity. Each of these performance attributes are further discussed in the glossary section. The system 104 scores each applicable optimizing sub-function of the AI tool. The score indicates a probability of the AI tool's execution of the optimizing sub-function having a favorable comparison with the trusted tool execution of, and/or analyzing of, the optimizing sub-function. The probability is based on past comparisons between the AI tool and the trusted tool.

A trusted optimizing tool would have a similar table with the exception of not having an attribute/sub-function score. The trusted optimizing tool table would include a check mark instead of a score for applicable attribute/sub-functions.

FIGS. 51A and 51B are schematic block diagrams of an example of a table of AI accelerating tools. The table includes a plurality of columns. The first is for accelerating sub-functions and the remaining columns are for the names of the AI accelerating tools and/or proprietary AI accelerating tools. The accelerating sub-functions include, but are not limited to, execution time, thread contention, deadlocks, thread utilization, microarchitecture exploration, parallelism, synchronization, hotspot analysis, memory access patterns, performance bottlenecks, excessive memory use, compiler optimization, real time performance, transaction tracking, error tracking, transaction visibility, dynamic baselining, code-level diagnostics, root cause analysis, full stack monitoring, build times, build plugin performance, task execution times, and build life cycle analysis. Each of these sub-functions are discussed in greater detail in the glossary section.

Checkmarks in the table indicate that a particular tool performs the particular sub-function. For example, tool CCA performs the sub-functions of execution time and compiler optimization, tool CCB performs the sub-functions of thread contention and real time performance, and so on. The “X” for the propriety AI accelerating tool(s) indicates that the tool enhances, augments, supports, edits, and/or performs the corresponding sub-function. Note that the trusted accelerating tools would have a similar table.

FIGS. 52A and 50D are a schematic block diagram of an example of a table regarding an AI accelerating tool. The table includes a first column for the accelerating sub-functions and a plurality of columns for attributes of accelerating code. The attributes include performance attributes and use attributes. The use attributes includes trusted tool pairing, AI tool pairing, and use case. These use attributes were previously discussed.

The performance attributes includes quality, security, IP risks, context & reasoning, execution speed, memory storage, CPU usage, parallelism, robustness, portability, and clarity. Each of these performance attributes are further discussed in the glossary section. The system 104 scores each applicable accelerating sub-function of the AI tool. The score indicates a probability of the AI tool's execution of the accelerating sub-function having a favorable comparison with the trusted tool execution of, and/or analyzing of, the accelerating sub-function. The probability is based on past comparisons between the AI tool and the trusted tool.

A trusted accelerating tool would have a similar table with the exception of not having an attribute/sub-function score. The trusted accelerating tool table would include a check mark instead of a score for applicable attribute/sub-functions.

FIG. 53 is a schematic block diagram of an example of a table of AI simulating tools. The table includes a plurality of columns. The first is for simulating sub-functions and the remaining columns are for the names of the AI simulating tools and/or proprietary AI simulating tools. The simulating sub-functions include, but are not limited to, system simulation, system simulation—multiple domains, system simulation—physical phenomena, network simulation, internet & network protocols, hardware in loop simulations, application simulation, embedded system simulation, embedded system simulation—electronic circuits, and embedded system simulation—mixed signal circuits. Each of these sub-functions are discussed in greater detail in the glossary section.

Checkmarks in the table indicate that a particular tool performs the particular sub-function. For example, tool DDA performs the sub-function of system simulation, tool DDB performs the sub-function of system simulation—multiple domains, and so on. The “X” for the propriety AI simulating tool(s) indicates that the tool enhances, augments, supports, edits, and/or performs the corresponding sub-function. Note that the trusted simulating tools would have a similar table.

FIGS. 54A and 54B are a schematic block diagram of an example of a table regarding an AI simulating tool. The table includes a first column for the simulating sub-functions and a plurality of columns for attributes of simulating code. The attributes include performance attributes and use attributes. The use attributes includes trusted tool pairing, AI tool pairing, and use case. These use attributes were previously discussed.

The performance attributes includes quality, security, IP risks, context & reasoning, execution speed, memory storage, CPU usage, parallelism, robustness, portability, and clarity. Each of these performance attributes are further discussed in the glossary section. The system 104 scores each applicable simulating sub-function of the AI tool. The score indicates a probability of the AI tool's execution of the simulating sub-function having a favorable comparison with the trusted tool execution of, and/or analyzing of, the simulating sub-function. The probability is based on past comparisons between the AI tool and the trusted tool.

A trusted simulating tool would have a similar table with the exception of not having an attribute/sub-function score. The trusted simulating tool table would include a check mark instead of a score for applicable attribute/sub-functions.

FIG. 55 is a schematic block diagram of an example of a table of AI migrating tools. The table includes a plurality of columns. The first is for migrating sub-functions and the remaining columns are for the names of the AI migrating tools and/or proprietary AI migrating tools. The migrating sub-functions include, but are not limited to, cloud migration—single platform, cloud migration—multiple platforms, cloud migration—server, cloud migration—database, cloud migration—virtual machine, cloud migration—web application (app), application migration, database migration, and general purpose migration. Each of these sub-functions are discussed in greater detail in the glossary section.

Checkmarks in the table indicate that a particular tool performs the particular sub-function. For example, tool EEA performs the sub-function of cloud migration—single platform, tool EEB performs the sub-function of cloud migration—multiple platforms, and so on. The “X” for the propriety AI migrating tool(s) indicates that the tool enhances, augments, supports, edits, and/or performs the corresponding sub-function. Note that the trusted migrating tools would have a similar table.

FIGS. 56A and 56B are a schematic block diagram of an example of a table regarding an AI migrating tool. The table includes a first column for the migrating sub-functions and a plurality of columns for attributes of migrating code. The attributes include performance attributes and use attributes. The use attributes includes trusted tool pairing, AI tool pairing, and use case. These use attributes were previously discussed.

The performance attributes includes quality, security, IP risks, context & reasoning, execution speed, memory storage, CPU usage, parallelism, robustness, portability, and clarity. Each of these performance attributes are further discussed in the glossary section. The system 104 scores each applicable migrating sub-function of the AI tool. The score indicates a probability of the AI tool's execution of the migrating sub-function having a favorable comparison with the trusted tool execution of, and/or analyzing of, the migrating sub-function. The probability is based on past comparisons between the AI tool and the trusted tool.

A trusted migrating tool would have a similar table with the exception of not having an attribute/sub-function score. The trusted migrating tool table would include a check mark instead of a score for applicable attribute/sub-functions.

FIG. 57 is a schematic block diagram of an example of a table of AI translating tools. The table includes a plurality of columns. The first is for translating sub-functions and the remaining columns are for the names of the AI translating tools and/or proprietary AI translating tools. The translating sub-functions include, but are not limited to, software component translation, management system translation, document translation, user interface translation, computer assisted translation, memory translation, spoken language translation, localized automation translation, and integrated development environment translation. Each of these sub-functions are discussed in greater detail in the glossary section.

Checkmarks in the table indicate that a particular tool performs the particular sub-function. For example, tool FFA performs the sub-function of software component translation, tool FFB performs the sub-function of management system translation, and so on. The “X” for the propriety AI translating tool(s) indicates that the tool enhances, augments, supports, edits, and/or performs the corresponding sub-function. Note that the trusted translating tools would have a similar table.

FIGS. 58A and 58B are a schematic block diagram of an example of a table regarding an AI translating tool. The table includes a first column for the translating sub-functions and a plurality of columns for attributes of translating code. The attributes include performance attributes and use attributes. The use attributes includes trusted tool pairing, AI tool pairing, and use case. These use attributes were previously discussed.

The performance attributes includes quality, security, IP risks, context & reasoning, execution speed, memory storage, CPU usage, parallelism, robustness, portability, and clarity. Each of these performance attributes are further discussed in the glossary section. The system 104 scores each applicable translating sub-function of the AI tool. The score indicates a probability of the AI tool's execution of the translating sub-function having a favorable comparison with the trusted tool execution of, and/or analyzing of, the translating sub-function. The probability is based on past comparisons between the AI tool and the trusted tool.

A trusted translating tool would have a similar table with the exception of not having an attribute/sub-function score. The trusted translating tool table would include a check mark instead of a score for applicable attribute/sub-functions.

FIG. 59 is a schematic block diagram of an example of a table of AI code generating tools. The table includes a plurality of columns. The first is for code generating sub-functions and the remaining columns are for the names of the AI code generating tools and/or proprietary AI code generating tools. The code generating sub-functions include, but are not limited to, general code generation, code generation—web application, code generation—API, low code//no code (LCNC) development, LCNC development—mobile app, LCNC development—web app, LCNC development—system integration, LCNC development—business processes, LCNC development—visual user interface, integrated development environment for code generation, and model driven development. Each of these sub-functions are discussed in greater detail in the glossary section.

Checkmarks in the table indicate that a particular tool performs the particular sub-function. For example, tool GGA performs the sub-function of general code generation, tool GGB performs the sub-function of code generation—web application, and so on. The “X” for the propriety AI LCNC development—tool(s) indicates that the tool enhances, augments, supports, edits, and/or performs the corresponding sub-function. Note that the trusted LCNC development—tools would have a similar table.

FIGS. 60A and 60B are a schematic block diagram of an example of a table regarding an AI code generating tool. The table includes a first column for the code generating sub-functions and a plurality of columns for attributes of code generating code. The attributes include performance attributes and use attributes. The use attributes includes trusted tool pairing, AI tool pairing, and use case. These use attributes were previously discussed.

The performance attributes includes quality, security, IP risks, context & reasoning, execution speed, memory storage, CPU usage, parallelism, robustness, portability, and clarity. Each of these performance attributes are further discussed in the glossary section. The system 104 scores each applicable code generating sub-function of the AI tool. The score indicates a probability of the AI tool's execution of the code generating sub-function having a favorable comparison with the trusted tool execution of, and/or analyzing of, the code generating sub-function. The probability is based on past comparisons between the AI tool and the trusted tool.

A trusted code generating tool would have a similar table with the exception of not having an attribute/sub-function score. The trusted code generating tool table would include a check mark instead of a score for applicable attribute/sub-functions.

The code enhancement system 104 routinely (e.g., continually, hourly, daily, etc.) updates the tables of FIGS. 47 through 60B to add new AI tools, to edit information (e.g., sub-functions, attribute performance, scoring, etc.) about AI tools in the table, and/or to delete an AI tool from the table. The system 104 may delete an AI tool from the table for a variety of reasons. For example, the AI tool is no longer publicly available. As another example, the system 104 has determined that the AI tool performs poorly. As a further example, the system 104 has found superior AI tools that perform the same enhancing functions.

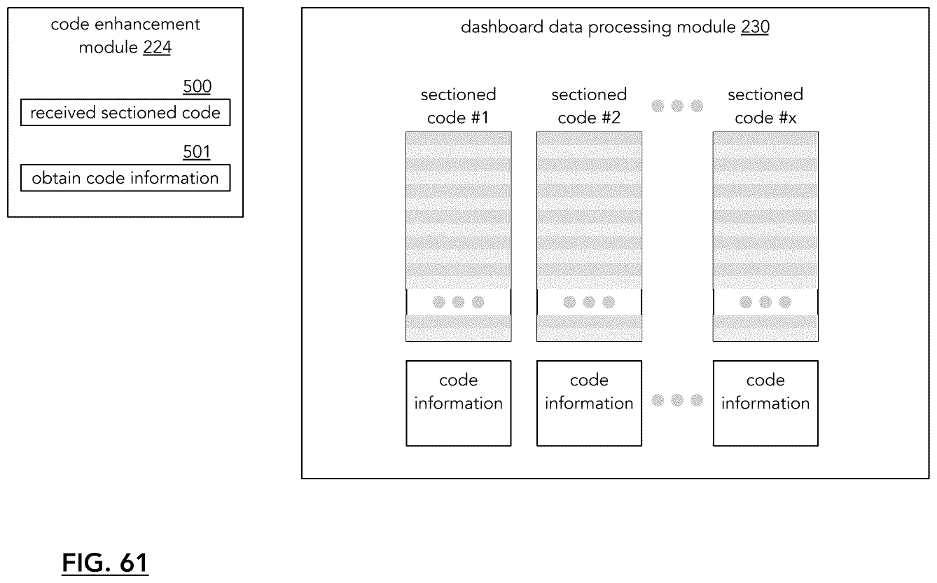

FIG. 61 is a schematic block diagram of an example of receiving sectioned code and corresponding code information. In this example, the code enhancement module 224 is processing steps 500 and 501 of FIG. 44A, where it receives one or more versions of sectioned code and code information. In one instance, the code information is based on the original code and, thus, is the same for each version of sectioned code. In another instance, the code information of the original code is augmented with information regarding the code sectioning, thus there are multiple versions of code information. The dashboard data processing module 230 generates a graphical representation of the received versions of sectioned code and of the code information (shown as individual version.

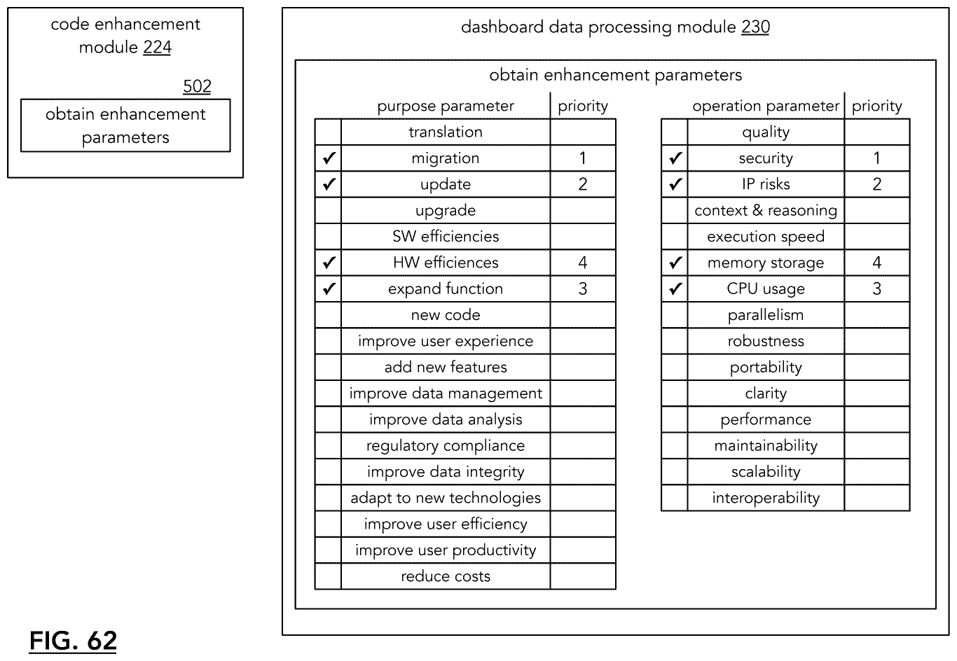

FIG. 62 is a schematic block diagram of an example of obtaining enhancement parameters. In this example, the code enhancement module 224 is processing step 502 of FIG. 44A to obtain enhancement parameters. The enhancement parameters include purpose parameters and operation parameters.

The purpose parameters include, but are not limited to, translation, migration, update, upgrade, improve software (SW) efficiencies, improve hardware (HW) efficiencies, expand functionality of code, add new code to existing code, improve user experience, add new features to existing code, improve data management, improved data analysis, adherence to regulatory requirements, improve data integrity, adapt to new technologies, improve user efficiency, improve user productivity, reduce costs from manufacturer and/or user, score the code with respect to one or more operation parameters, generate a confidence factor for the code (e.g., the code will execute reliably), and generate a trustworthiness factor for the code (e.g., the code will execute securely, it will not cause data loss, and/or it will not compromise data integrity).

A user, via a GUI generated by the dashboard data processing module 230, can select one or more of the purpose parameters via a checkmark or other identifying GUI signaling. In addition, the user can ascribe priority levels to the selected purpose parameters via the GUI. A priority level may be used more than once. For example, the user ascribes the same priority value to migration and to update. If priority data is not entered, the code enhancement system 104 determines a priority for each selected parameter, which may be the same priority level, different priority levels, or a combination thereof.

Examples of the operational parameters include, but are not limited to, quality, security, mitigating IP (intellectual property) risk, context and reasoning, improve execution speed, reduce memory storage, reduce CPU (central processing unit) usages, increasing parallelism, improve robustness, improve portability, improve clarity, improve performance, improve maintainability, improve scalability, and improve interoperability.

A user, via the GUI, can select one or more of the operation parameters via a checkmark or other identifying GUI signaling. In addition, the user can ascribe priority levels to the selected operation parameters via the GUI. A priority level may be used more than once. For example, the user ascribes the same priority value to memory storage and to CPU usage. If priority data is not entered, the code enhancement system 104 determines a priority for each selected parameter, which may be the same priority level, different priority levels, or a combination thereof.

The code enhancement module 224 uses the selected parameters and corresponding priorities to identify AI tools, proprietary AI tools, and/or trusted tools for enhancing sectioned code. The code enhancement module 224 further the uses the selected parameters and corresponding priorities to create a plurality of orderings of code enhancing sub-functions and/or the selected tools.

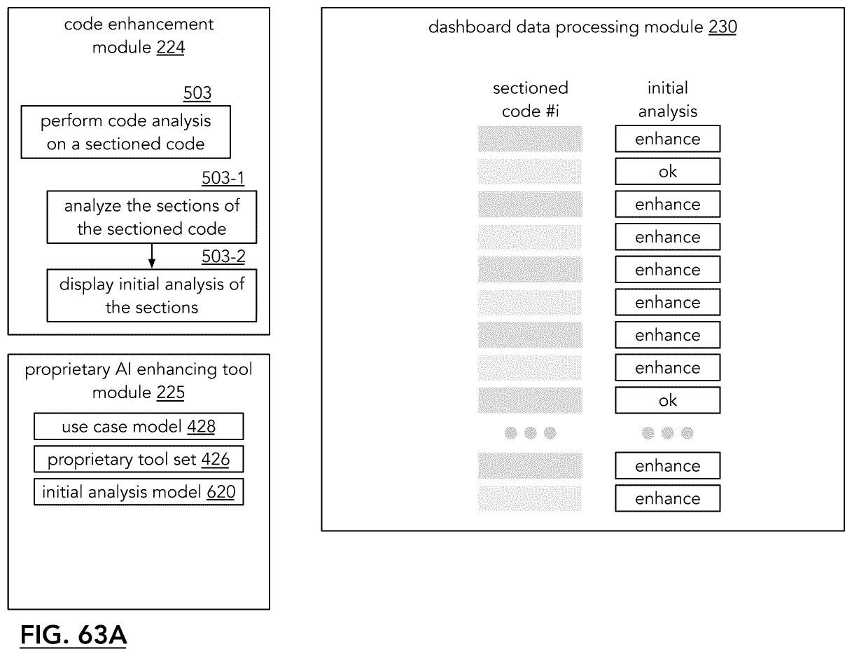

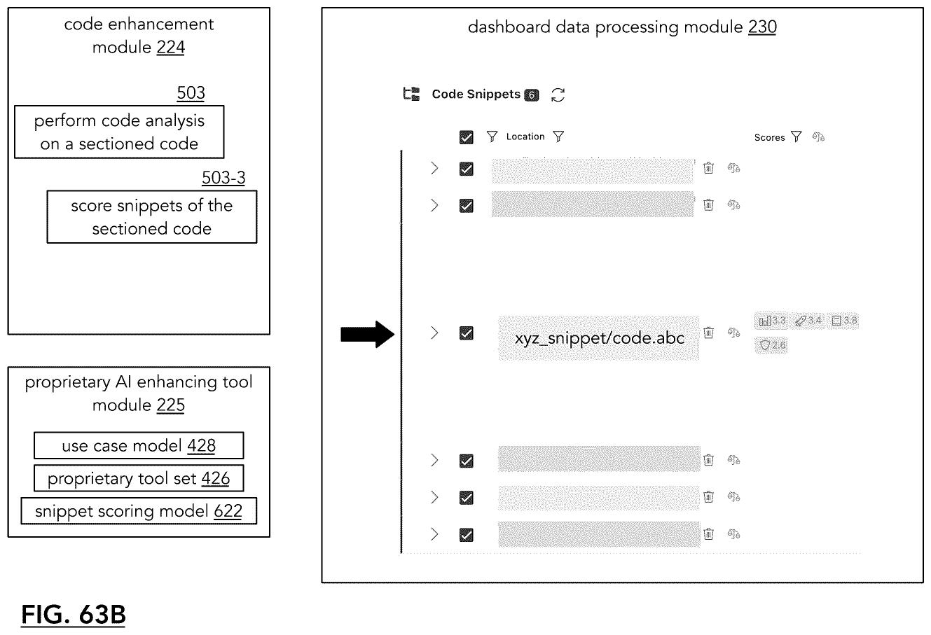

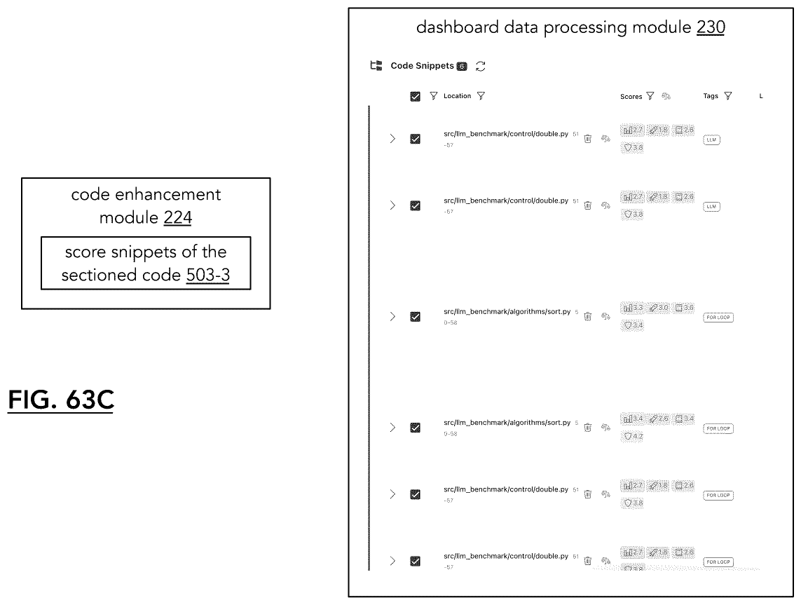

FIG. 63A is a schematic block diagram of an example of performing code analysis. In this example, the code enhancement module 224 is executing step 503 of FIG. 44A, which is perform code analysis on a sectioned code. As shown, step 503 includes two sub-steps: 503-1 and 503-2. At step 503-1, the code enhancement module 224 analyzes the sections of code to determine which of them could be enhanced. At step 503-2, the code enhancement module 224 coordinates with the dashboard data processing module 230 to display the initial analysis of the sections.

The dashboard data processing module 230 generates a graphical representation of the sectioned code and the corresponding initial analysis. As shown, some code sections have an initial analysis of “enhance” and others have an initial analysis of “ok”. The initial analysis of “enhance” indicates that the code enhancement module 224 should try to enhance the section. The initial analysis of “ok” indicates that the original section does not need enhancing.

The proprietary AI enhancing tool module 225 gathers information regarding the initial analysis of the sections of the code. The newly gathered information is used in combination with previously gathered information to create and/or update one or more use case models 428, one or more initial analysis models 620, and/or to create and/or update one or more proprietary AI tools 426.

FIG. 63B is a schematic block diagram of another example of performing code analysis. In this example, the code enhancement module 224 is executing step 503 of FIG. 44A, which is perform code analysis on a sectioned code. As shown, step 503 includes the sub-step 503-3. At step 503-3, the code enhancement module 224 analyzes the sections of code for snippets and scores them as the initial analysis. The code enhancement module 224 coordinates with the dashboard data processing module 230 to display the scoring of snippets.

The dashboard data processing module 230 generates a graphical representation of the scoring of snippets. For a highlighted snippet (highlighted via the arrow), the graphical representation includes the snippet's name and/or repository information, one or more scores regarding the snippet's fulfillment of the selected enhancement parameters. When a score is below a desired value, the snippet is flagged for enhancing.

The proprietary AI enhancing tool module 225 gathers information regarding the initial analysis of snippets. The newly gathered information is used in combination with previously gathered information to create and/or update one or more use case models 428, one or more snippet scoring models 622, and/or to create and/or update one or more proprietary AI tools 426.

FIG. 63C is a schematic block diagram of an example of scoring code snippets that is similar to FIG. 63B. In this example, each snippet is listed by name and/or repository location and each has one or more scores.

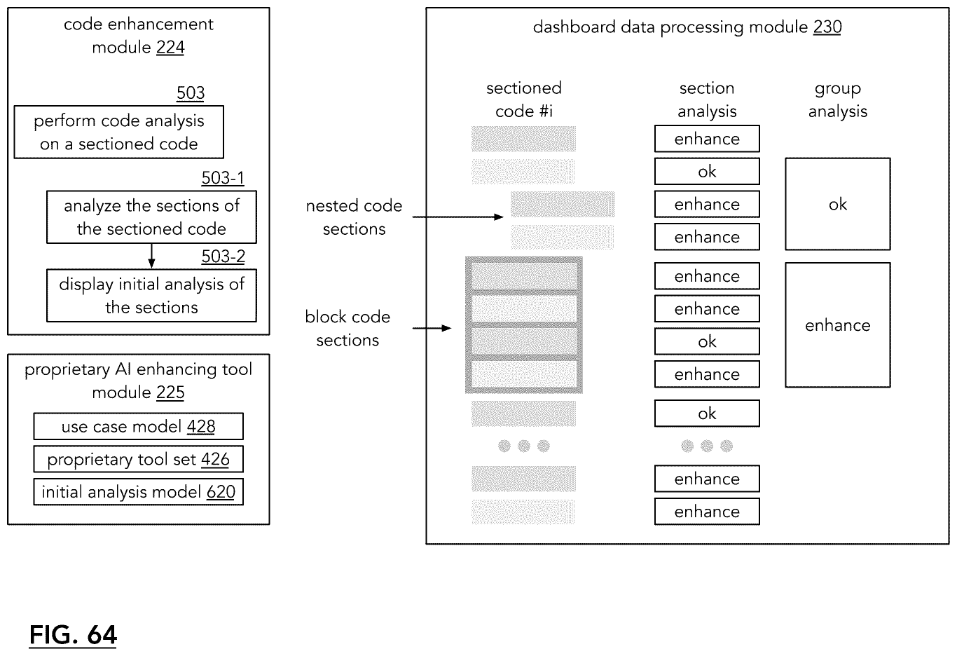

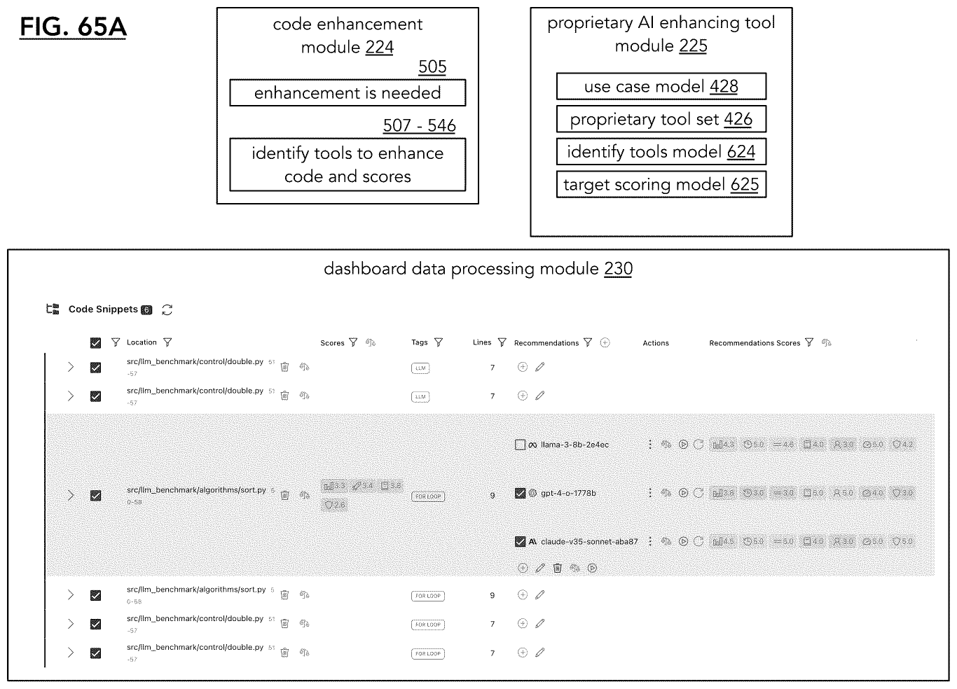

FIG. 64 is a schematic block diagram of an example of performing code analysis on nested and/or grouped code sections. In this example, the code enhancement module 224 is executing step 503 of FIG. 44A, which is perform code analysis on a sectioned code, where the sectioned code includes individual sections of code and grouped sections of code. As shown, step 503 includes two sub-steps: 503-1 and 503-2. At step 503-1, the code enhancement module 224 analyzes the sections of code to determine which of them could be enhanced. At step 503-2, the code enhancement module 224 coordinates with the dashboard data processing module 230 to display the initial analysis of the sections.

The dashboard data processing module 230 generates a graphical representation of the sections of code, the grouping of sections of code, and the corresponding initial analysis. As shown, each code section has an initial analysis of “enhance” or “ok”. The grouping of code is shown as nested code sections or as a block of code sections. In either case, there is an interdependency of the code sections of a grouping of code sections. Each grouping of code sections has its own initial analysis.

In this example, the nested group of code sections have individual initial analysis of ok, enhance, and enhance. The nested group has an initial analysis of ok. The collective initial analysis of the nest group indicates that, as a group, it does not need enhancing; it already meets or exceeds the selected parameters. As such, the code enhancement module 224 has a choice of enhancing the individual code sections of the nested group or not enhancing them. In part, the decision will be based on how well the nested group meets the selected parameters.

This example further includes the block group of code sections have individual initial analysis of enhance, enhance, ok, and enhance. The block group has an initial analysis of enhance. The collective initial analysis of the nest group indicates that, as a group, it needs enhancing even though one of the code sections does not.

The proprietary AI enhancing tool module 225 gathers information regarding the initial analysis of the sections of the code and the groups of code sections. The newly gathered information is used in combination with previously gathered information to create and/or update one or more use case models 428, one or more initial analysis models 620, and/or to create and/or update one or more proprietary AI tools 426.

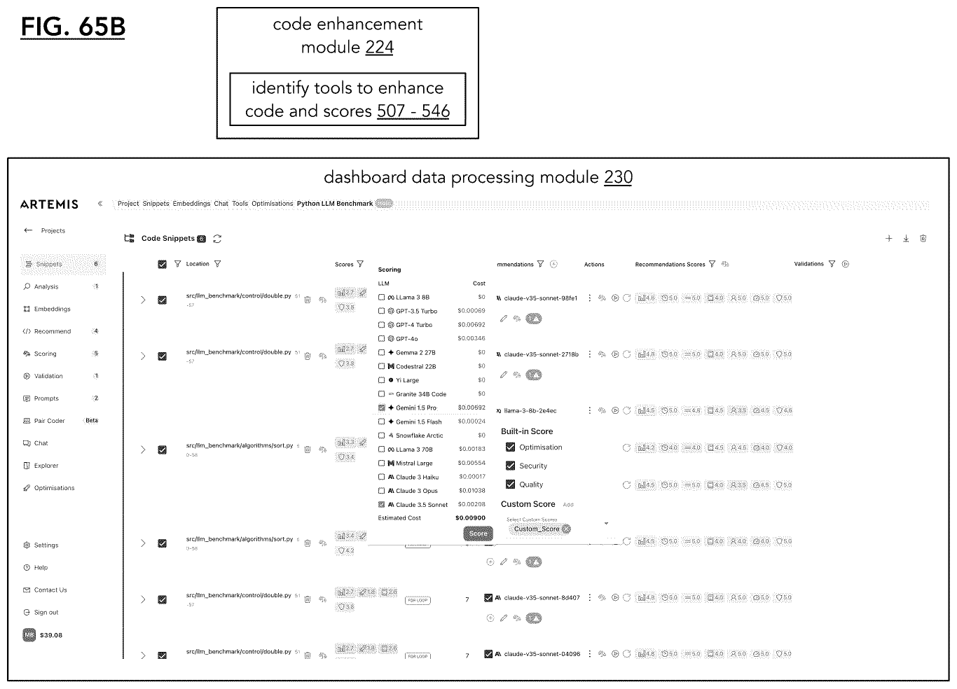

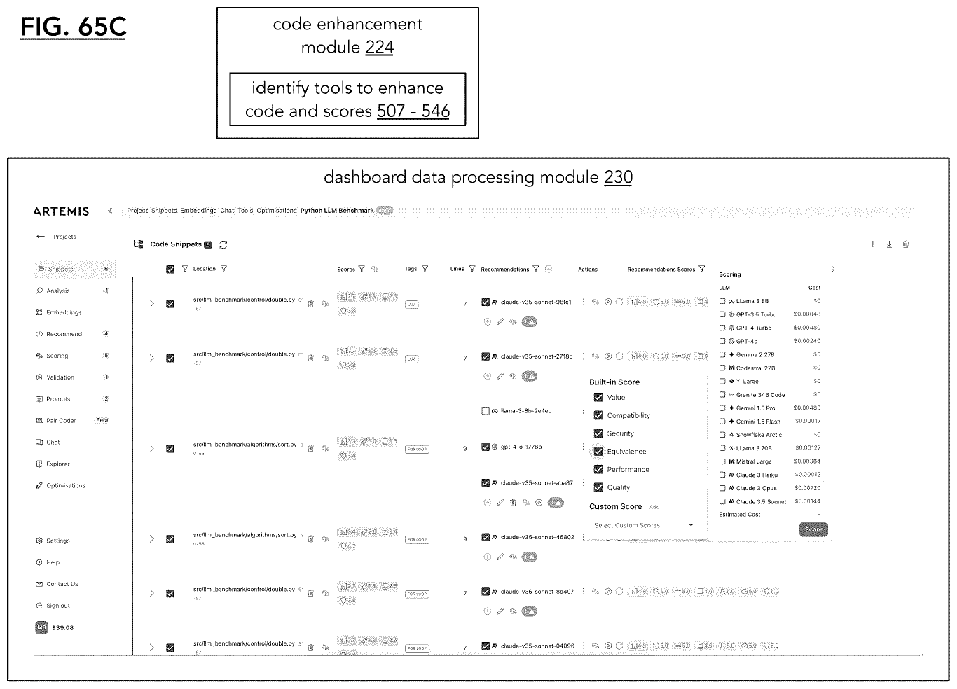

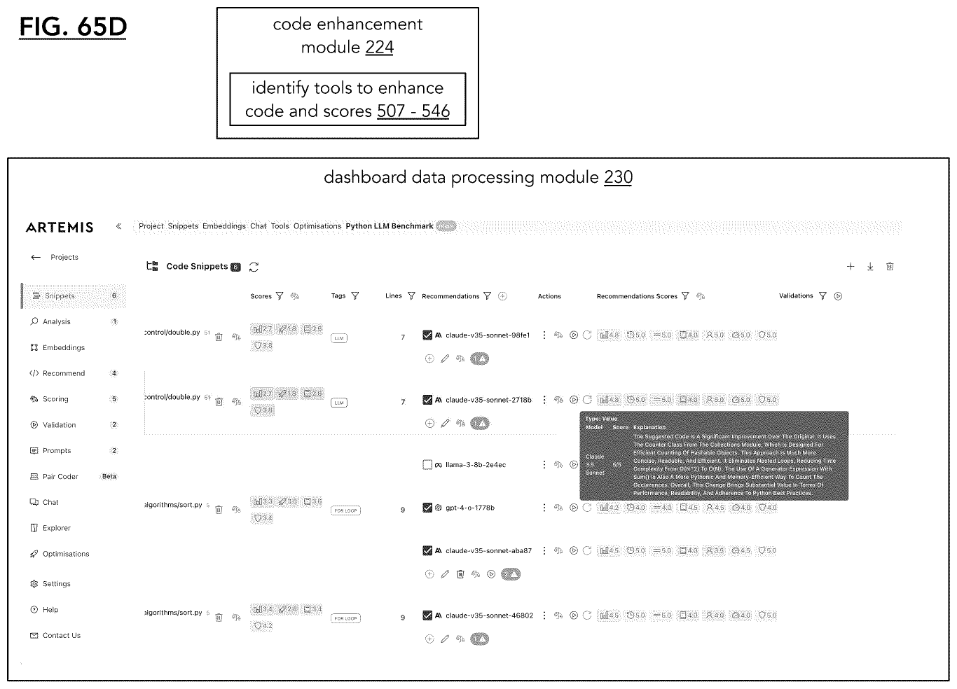

FIG. 65A is a schematic block diagram of an example of identifying tools for enhancement. In this example, the code enhancement module 224 is executing step 505 of FIG. 44A and steps 507-546 of FIGS. 44A and 44B. At step 505, the code enhancement module 224 determines whether enhancement is needed for at least one code section. When it is, the code enhancement module 224 executes steps 507-546 to identify the AI code enhancing tools, proprietary AI code enhancing tools, and/or trusted code, where the AI and/or proprietary AI code enhancing tools will be used to produce versions of AI enhanced code.

The dashboard data processing module 230 generates a graphical representation for the suggested AI tools to be applied to enhance the sections of code. In addition, the graphical representation includes a current score for at least sone of the code sections, tags regarding the types of AI tools to use, and a targeted score for the enhanced code section. As an alternative or in addition, the dashboard data processing module 230 generates a graphical representation for the suggested AI tools to be applied to enhance multiple codes, the tags, and the targeted scores.

The proprietary AI enhancing tool module 225 gathers information regarding the graphical representation of suggested AI tools and the corresponding selections thereof. The newly gathered information is used in combination with previously gathered information to create and/or update one or more use case models 428, one or more tool identification models 624, one or more target scoring models 625, and/or to create and/or update one or more proprietary AI tools 426.

FIG. 65B is a schematic block diagram of another example of identifying tools and scoring options for enhancement that is similar to the example of FIG. 65A. In this example, the graphical representation produced by the dashboard data processing module 230 includes more detail than the example of FIG. 65A. In this example, the graphical representation includes a drop down list of scoring LLMs that can be selected and their associated costs. The graphical representation also includes a list of built-in scoring options and/or an option for custom scoring.

FIG. 65C is a schematic block diagram of another example of identifying tools and scoring options for enhancement that is similar to the example of FIG. 65B. This example includes different options for built-in scoring.

FIG. 65D is a schematic block diagram of another example of identifying tools and scoring options for enhancement that is similar to the example of FIG. 65B. This example includes an explanation of an AI tool, its benefits, and excepted code enhancement outcomes.

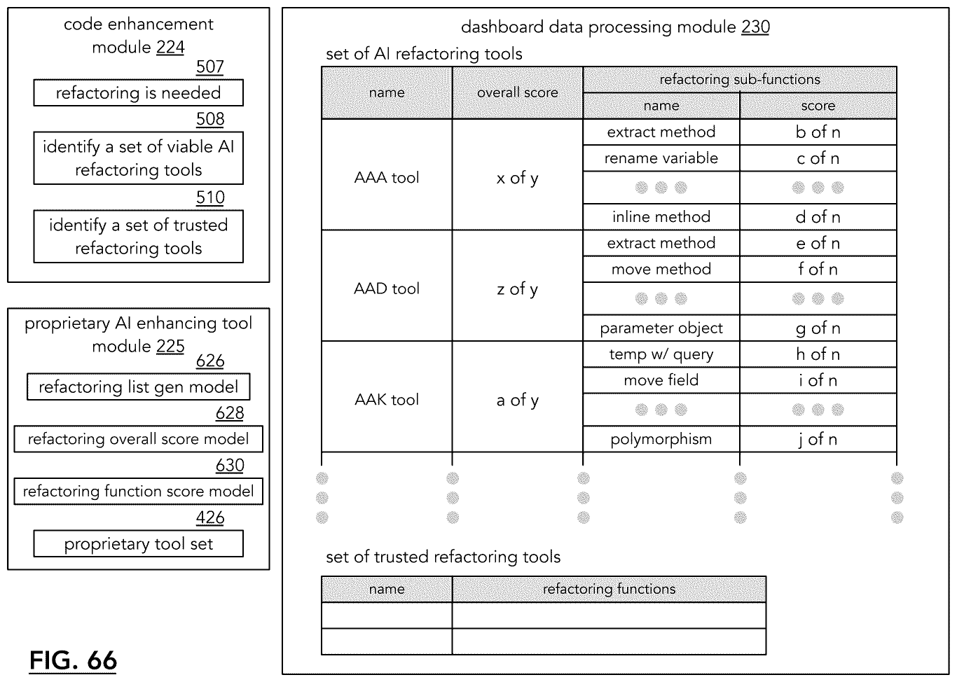

FIG. 66 is a schematic block diagram of an example of listing refactoring tools. In this example, the code enhancement module 224 is executing steps 507, 508, and 510 of FIG. 44A. At step 507, the code enhancement module 224 has determined that refactoring is needed. At step 508, the code enhancement module 224 identifies a set of viable AI and/or proprietary AI refactoring tools. At step 510, the code enhancement module 224 identifies a set of trusted refactoring tools. The code enhancement module 224 coordinates with the dashboard data processing module 230 to display the list of viable AI and/or proprietary AI refactoring tools and the list of trusted refactoring tools.

The dashboard data processing module 230 generates a graphical representation of the list of viable AI and/or proprietary AI refactoring tools. For each tool, the graphical representation includes the name of the tool, its overall score, the refactoring sub-functions it performs, and scores for the refactoring sub-functions. The dashboard data processing module 230 further generates a graphical representation of the list of trusted refactoring tools. The graphical representation is part of a GUI, which allows a user to selection one or more of the tools.

The proprietary AI enhancing tool module 225 gathers information regarding the list of viable AI and/or proprietary AI refactoring tools and the list of trusted refactoring tools. The newly gathered information is used in combination with previously gathered information to create and/or update one or more refactoring list generation models 626, one or more refactoring overall score models 628, one or more refactoring sub-function score models 630, and/or to create and/or update one or more proprietary AI tools 426.

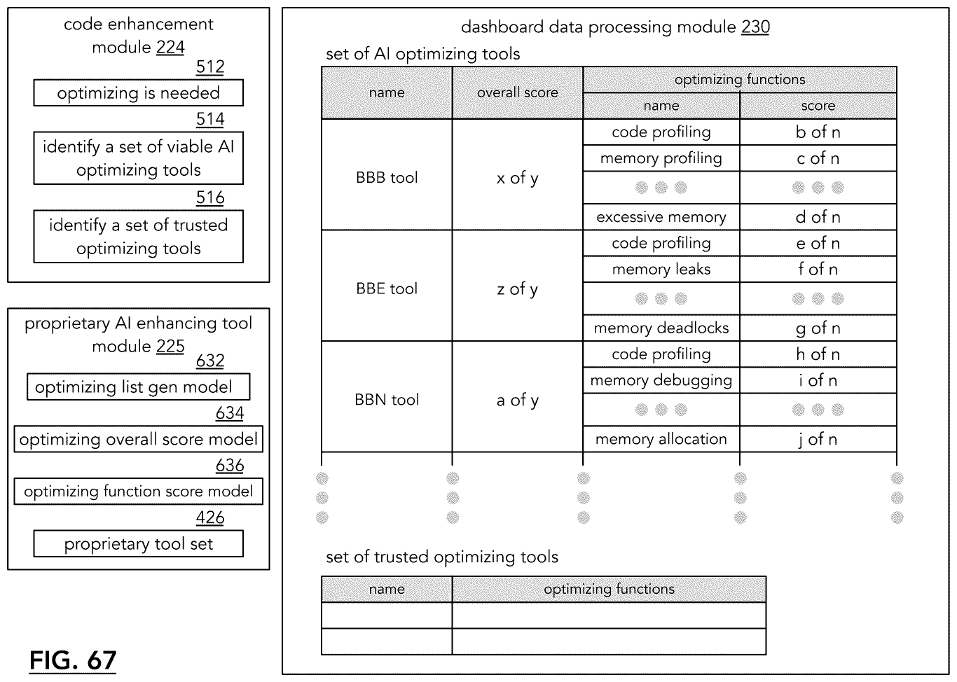

FIG. 67 is a schematic block diagram of an example of listing optimizing tools. In this example, the code enhancement module 224 is executing steps 512, 514, and 516 of FIG. 44A. At step 512, the code enhancement module 224 has determined that optimizing is needed. At step 514, the code enhancement module 224 identifies a set of viable AI and/or proprietary AI optimizing tools. At step 516, the code enhancement module 224 identifies a set of trusted optimizing tools. The code enhancement module 224 coordinates with the dashboard data processing module 230 to display the list of viable AI and/or proprietary AI optimizing tools and the list of trusted optimizing tools.

The dashboard data processing module 230 generates a graphical representation of the list of viable AI and/or proprietary AI optimizing tools. For each tool, the graphical representation includes the name of the tool, its overall score, the optimizing sub-functions it performs, and scores for the optimizing sub-functions. The dashboard data processing module 230 further generates a graphical representation of the list of trusted optimizing tools. The graphical representation is part of a GUI, which allows a user to selection one or more of the tools.

The proprietary AI enhancing tool module 225 gathers information regarding the list of viable AI and/or proprietary AI optimizing tools and the list of trusted optimizing tools. The newly gathered information is used in combination with previously gathered information to create and/or update one or more optimizing list generation models 632, one or more optimizing overall score models 634, one or more optimizing sub-function score models 636, and/or to create and/or update one or more proprietary AI tools 426.

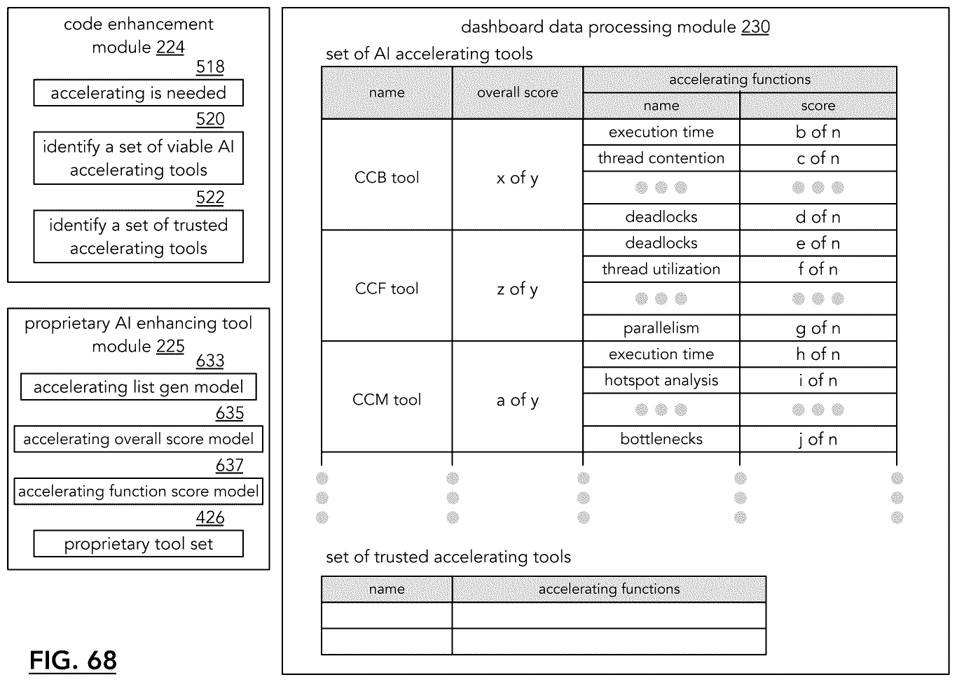

FIG. 68 is a schematic block diagram of an example of listing accelerating tools. In this example, the code enhancement module 224 is executing steps 518, 520, and 522 of FIG. 44A. At step 518, the code enhancement module 224 has determined that accelerating is needed. At step 520, the code enhancement module 224 identifies a set of viable AI and/or proprietary AI accelerating tools. At step 522, the code enhancement module 224 identifies a set of trusted accelerating tools. The code enhancement module 224 coordinates with the dashboard data processing module 230 to display the list of viable AI and/or proprietary AI accelerating tools and the list of trusted accelerating tools.

The dashboard data processing module 230 generates a graphical representation of the list of viable AI and/or proprietary AI accelerating tools. For each tool, the graphical representation includes the name of the tool, its overall score, the accelerating sub-functions it performs, and scores for the accelerating sub-functions. The dashboard data processing module 230 further generates a graphical representation of the list of trusted accelerating tools. The graphical representation is part of a GUI, which allows a user to selection one or more of the tools.

The proprietary AI enhancing tool module 225 gathers information regarding the list of viable AI and/or proprietary AI accelerating tools and the list of trusted accelerating tools. The newly gathered information is used in combination with previously gathered information to create and/or update one or more accelerating list generation models 633, one or more accelerating overall score models 635, one or more accelerating sub-function score models 637, and/or to create and/or update one or more proprietary AI tools 426.

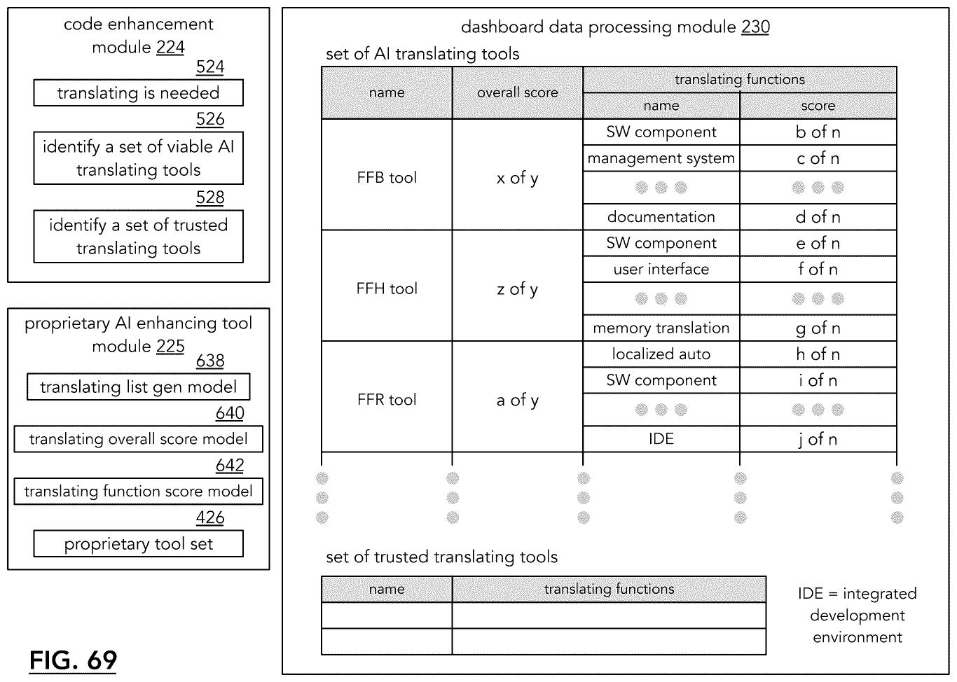

FIG. 69 is a schematic block diagram of an example of listing translating tools. In this example, the code enhancement module 224 is executing steps 524, 526, and 528 of FIG. 44B. At step 524, the code enhancement module 224 has determined that translating is needed. At step 526, the code enhancement module 224 identifies a set of viable AI and/or proprietary AI translating tools. At step 528, the code enhancement module 224 identifies a set of trusted translating tools. The code enhancement module 224 coordinates with the dashboard data processing module 230 to display the list of viable AI and/or proprietary AI translating tools and the list of trusted translating tools.

The dashboard data processing module 230 generates a graphical representation of the list of viable AI and/or proprietary AI translating tools. For each tool, the graphical representation includes the name of the tool, its overall score, the translating sub-functions it performs, and scores for the translating sub-functions. The dashboard data processing module 230 further generates a graphical representation of the list of trusted translating tools. The graphical representation is part of a GUI, which allows a user to selection one or more of the tools.

The proprietary AI enhancing tool module 225 gathers information regarding the list of viable AI and/or proprietary AI translating tools and the list of trusted translating tools. The newly gathered information is used in combination with previously gathered information to create and/or update one or more translating list generation models 638, one or more translating overall score models 640, one or more translating sub-function score models 642, and/or to create and/or update one or more proprietary AI tools 426.

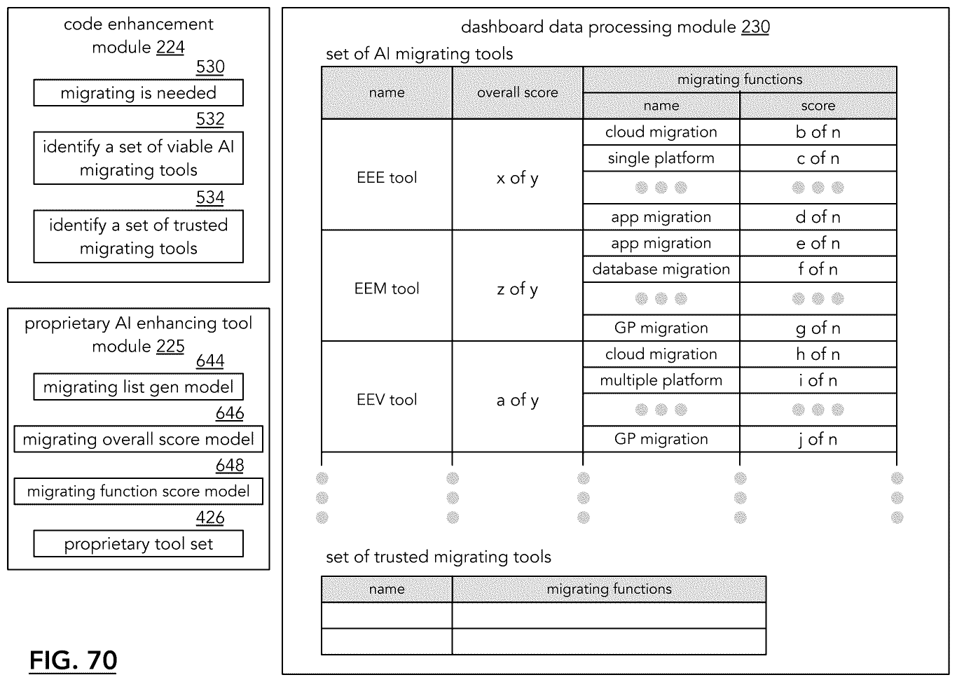

FIG. 70 is a schematic block diagram of an example of listing migrating tools. In this example, the code enhancement module 224 is executing steps 530, 532, and 534 of FIG. 44B. At step 530, the code enhancement module 224 has determined that migrating is needed. At step 532, the code enhancement module 224 identifies a set of viable AI and/or proprietary AI migrating tools. At step 534, the code enhancement module 224 identifies a set of trusted migrating tools. The code enhancement module 224 coordinates with the dashboard data processing module 230 to display the list of viable AI and/or proprietary AI migrating tools and the list of trusted migrating tools.

The dashboard data processing module 230 generates a graphical representation of the list of viable AI and/or proprietary AI migrating tools. For each tool, the graphical representation includes the name of the tool, its overall score, the migrating sub-functions it performs, and scores for the migrating sub-functions. The dashboard data processing module 230 further generates a graphical representation of the list of trusted migrating tools. The graphical representation is part of a GUI, which allows a user to selection one or more of the tools.

The proprietary AI enhancing tool module 225 gathers information regarding the list of viable AI and/or proprietary AI migrating tools and the list of trusted migrating tools. The newly gathered information is used in combination with previously gathered information to create and/or update one or more migrating list generation models 644, one or more migrating overall score models 646, one or more migrating sub-function score models 648, and/or to create and/or update one or more proprietary AI tools 426.

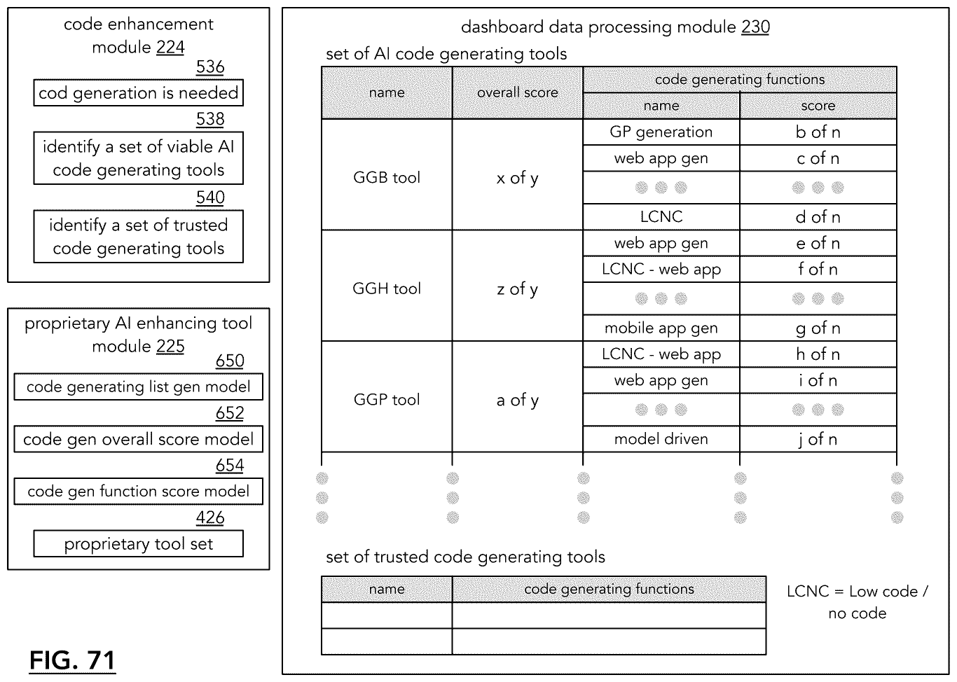

FIG. 71 is a schematic block diagram of an example of listing code generating tools. In this example, the code enhancement module 224 is executing steps 536, 538, and 540 of FIG. 44B. At step 536, the code enhancement module 224 has determined that code generating is needed. At step 538, the code enhancement module 224 identifies a set of viable AI and/or proprietary AI code generating tools. At step 540, the code enhancement module 224 identifies a set of trusted code generating tools. The code enhancement module 224 coordinates with the dashboard data processing module 230 to display the list of viable AI and/or proprietary AI code generating tools and the list of trusted code generating tools.

The dashboard data processing module 230 generates a graphical representation of the list of viable AI and/or proprietary AI code generating tools. For each tool, the graphical representation includes the name of the tool, its overall score, the code generating sub-functions it performs, and scores for the code generating sub-functions. The dashboard data processing module 230 further generates a graphical representation of the list of trusted code generating tools. The graphical representation is part of a GUI, which allows a user to selection one or more of the tools.

The proprietary AI enhancing tool module 225 gathers information regarding the list of viable AI and/or proprietary AI code generating tools and the list of trusted code generating tools. The newly gathered information is used in combination with previously gathered information to create and/or update one or more code generating list generation models 650, one or more code generating overall score models 652, one or more code generating sub-function score models 654, and/or to create and/or update one or more proprietary AI tools 426.

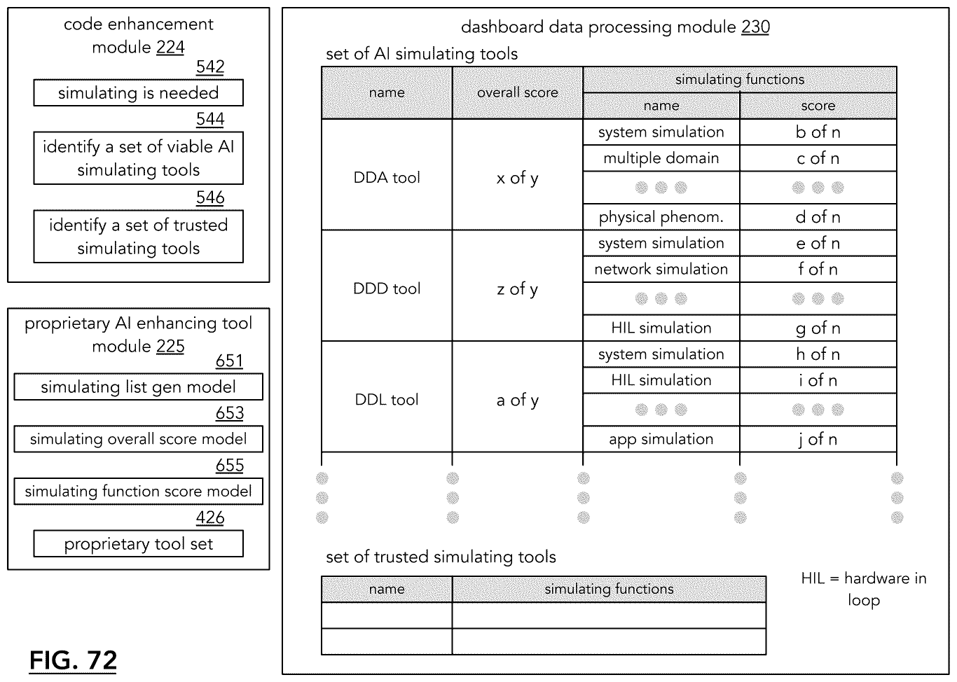

FIG. 72 is a schematic block diagram of an example of listing simulating tools. In this example, the code enhancement module 224 is executing steps 542, 544, and 546 of FIG. 44B. At step 542, the code enhancement module 224 has determined that simulating is needed. At step 544, the code enhancement module 224 identifies a set of viable AI and/or proprietary AI simulating tools. At step 546, the code enhancement module 224 identifies a set of trusted simulating tools. The code enhancement module 224 coordinates with the dashboard data processing module 230 to display the list of viable AI and/or proprietary AI simulating tools and the list of trusted simulating tools.

The dashboard data processing module 230 generates a graphical representation of the list of viable AI and/or proprietary AI v tools. For each tool, the graphical representation includes the name of the tool, its overall score, the simulating sub-functions it performs, and scores for the simulating sub-functions. The dashboard data processing module 230 further generates a graphical representation of the list of trusted simulating tools. The graphical representation is part of a GUI, which allows a user to selection one or more of the tools.

The proprietary AI enhancing tool module 225 gathers information regarding the list of viable AI and/or proprietary AI simulating tools and the list of trusted simulating tools. The newly gathered information is used in combination with previously gathered information to create and/or update one or more simulating list generation models 651, one or more simulating overall score models 653, one or more simulating sub-function score models 655, and/or to create and/or update one or more proprietary AI tools 426.

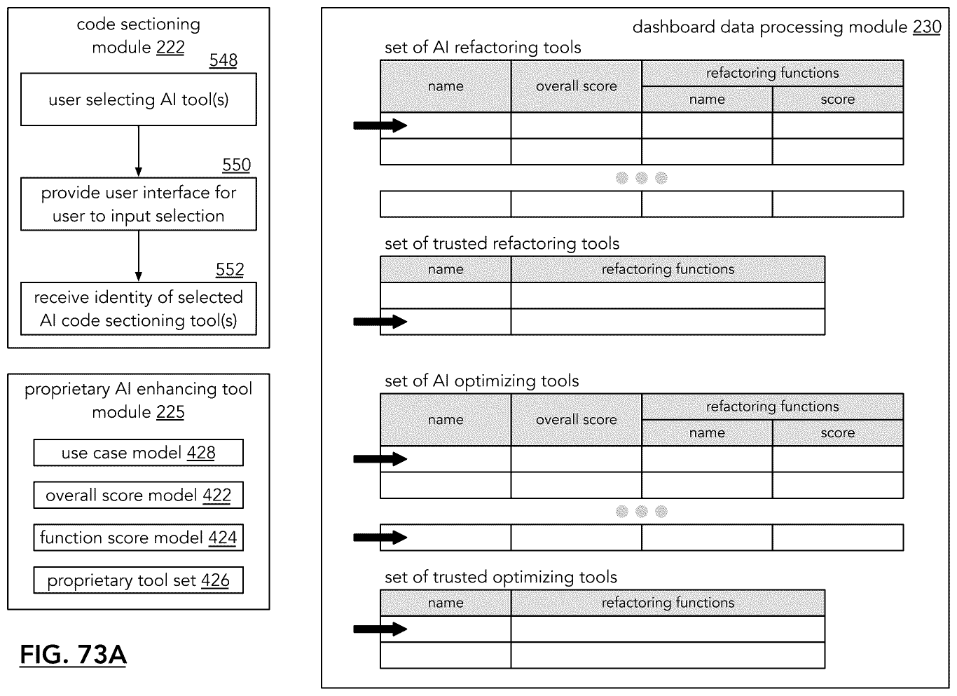

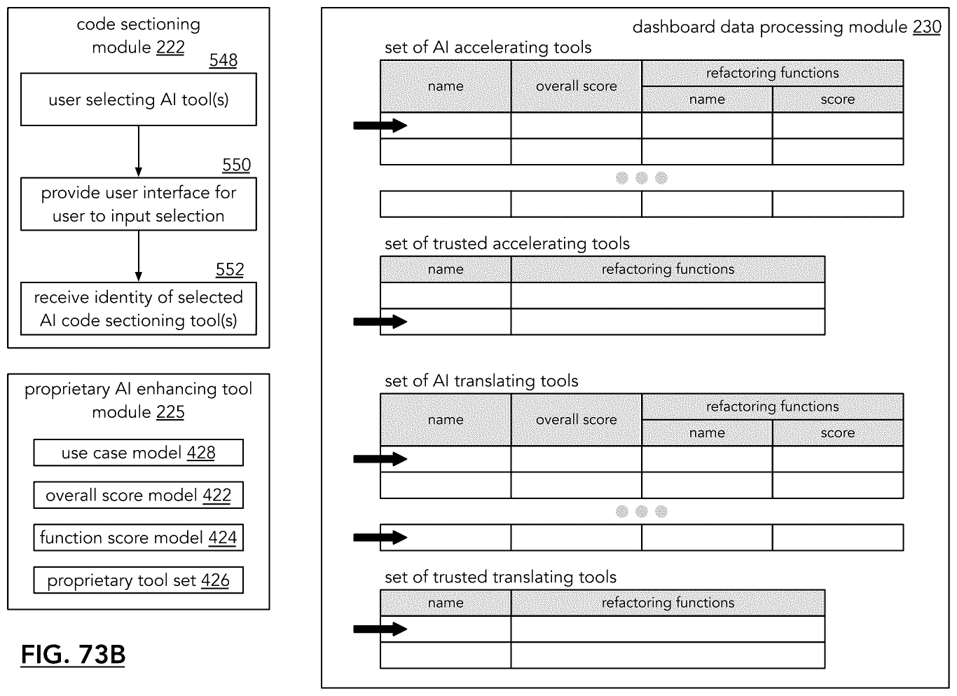

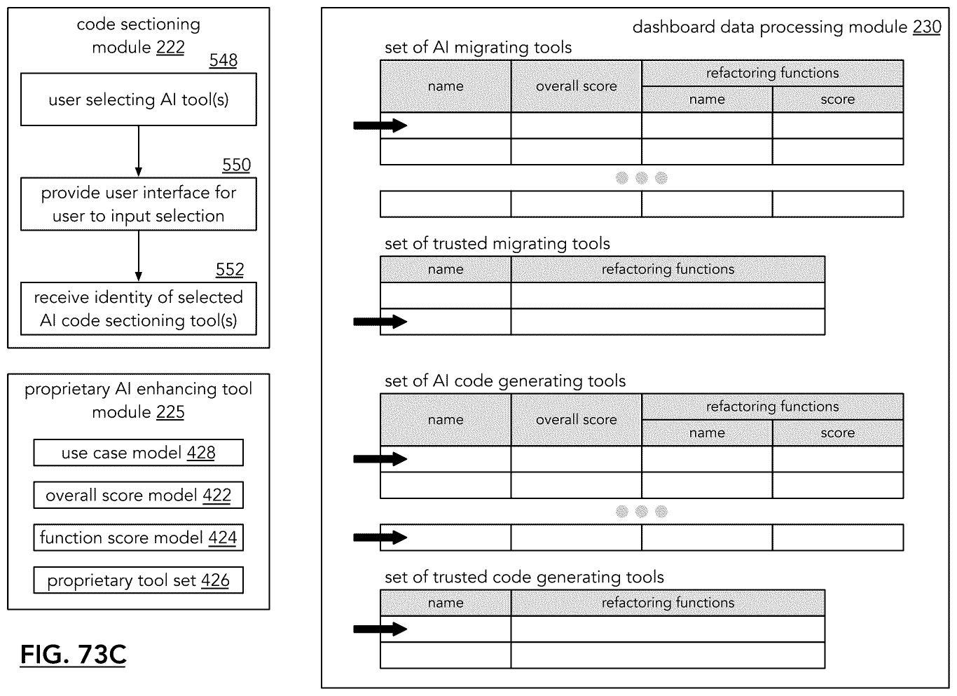

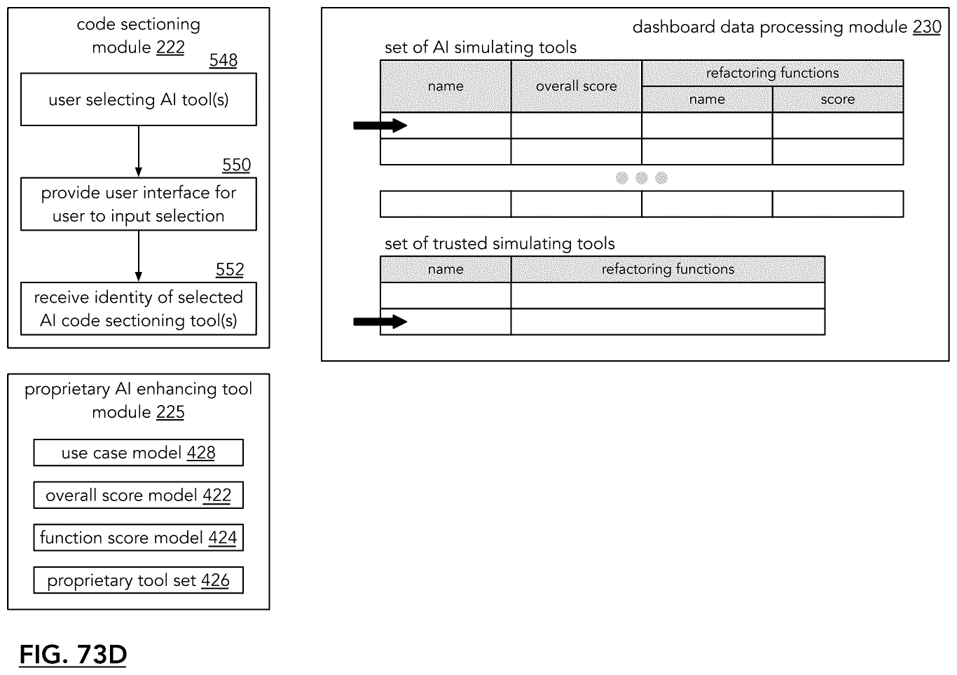

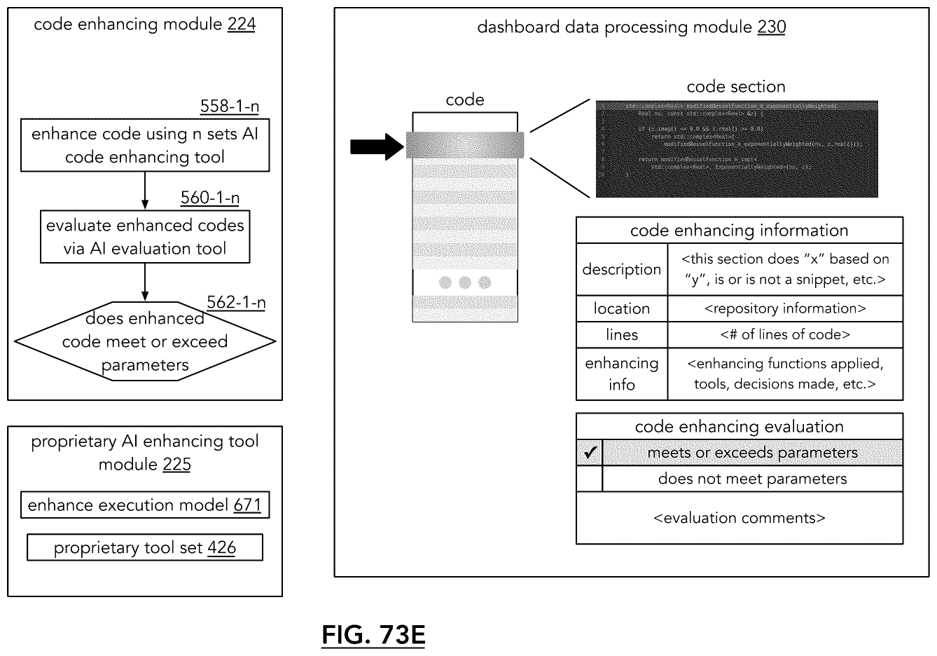

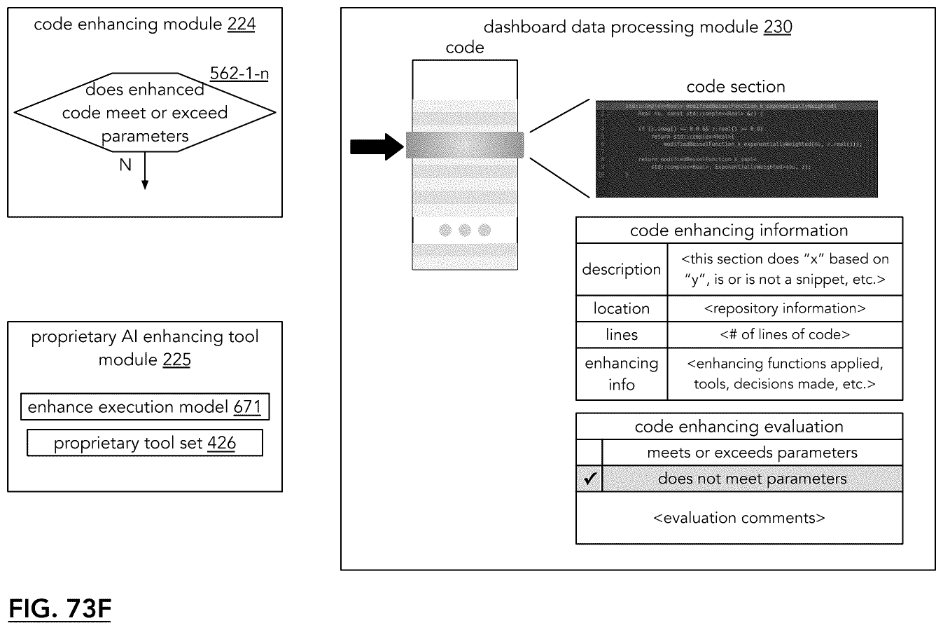

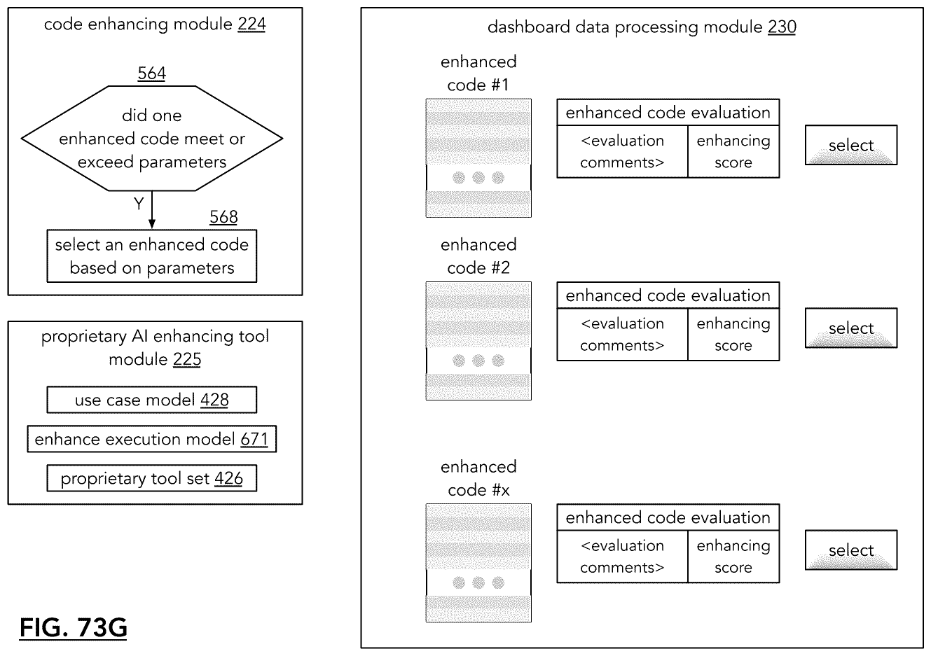

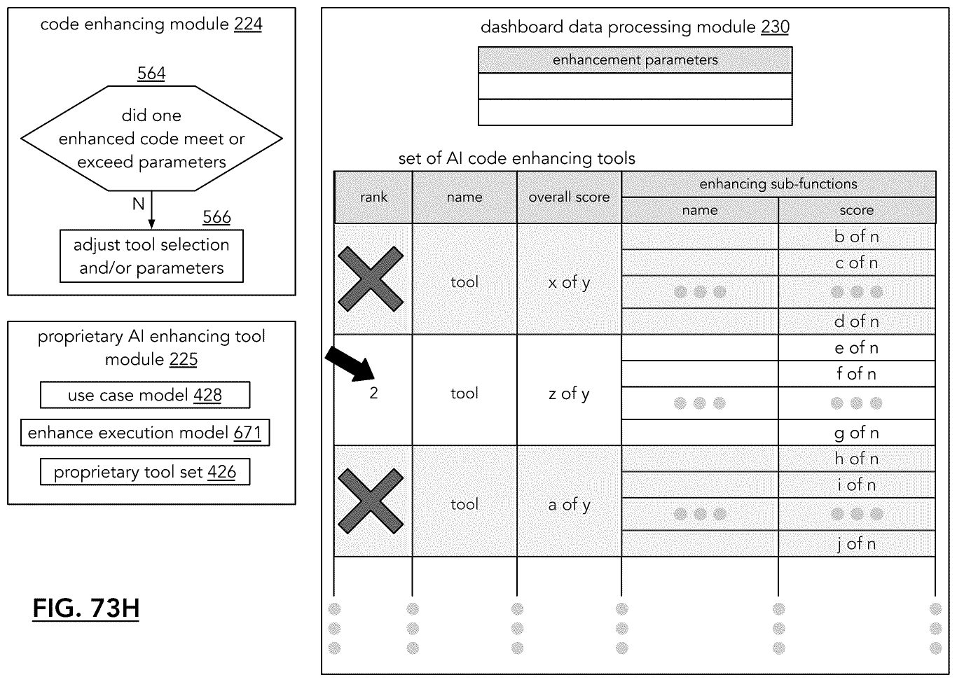

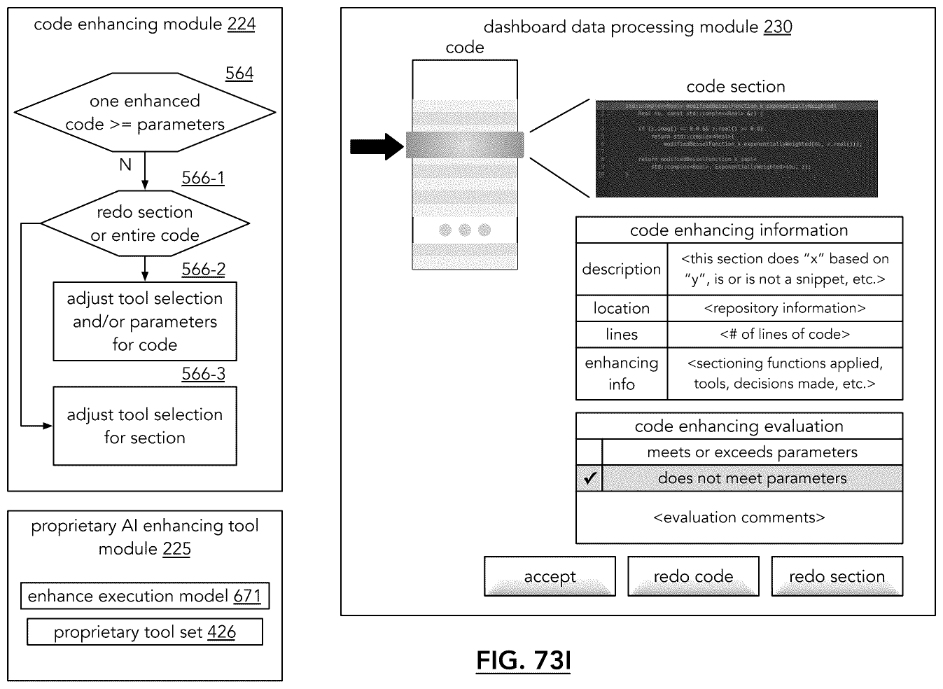

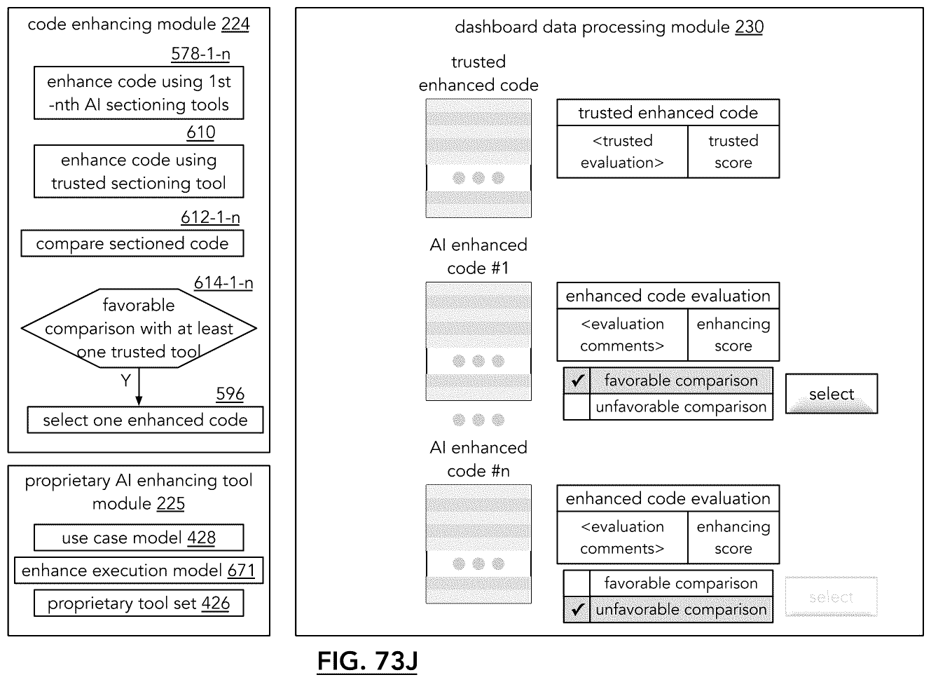

FIGS. 73A-73F are schematic block diagram of an example of selecting tools for enhancing sectioned code. In FIG. 73A, the code enhancement module 224 is executing steps 548, 550, and 552 of FIG. 44B. At step 548, the code enhancement module 224 determines that the user will be selected the AI and/or proprietary AI code enhancing tools. At step 550, the code enhancement module 224 coordinates with the dashboard data processing module 230 to provide a user interface (e.g., GUI) that enables the user to select the AI and/or proprietary AI code enhancing tools and to further select the trusted code enhancing tools.

The dashboard data processing module 230 generates a graphical representation of the list of viable AI and/or proprietary AI code enhancing tools and the list of viable trusted code enhancing tools. In FIG. 73A, the graphical representations includes a list of viable AI and/or proprietary AI refactoring tools, a list of viable trusted refactoring tools, a list of viable AI and/or proprietary AI optimizing tools, and a list of trusted optimizing tools. The user, via the GUI, selects one or more tools from one or more of lists as indicated by the arrows. The selection of tools is provided by the dashboard data processing module 230 to the code enhancement module 224 at step 552.

The proprietary AI enhancing tool module 225 gathers information regarding the selections from the list of viable AI and/or proprietary AI code enhancing tools and the list of trusted code enhancing tools. The newly gathered information is used in combination with previously gathered information to create and/or update one or more use case models 428, one or more overall score models 422, one or more sub-function score models 424, and/or to create and/or update one or more proprietary AI tools 426.

In FIG. 73B, the code enhancement module 224 is executing steps 548, 550, and 552 as in FIG. 73A. In this example, the dashboard data processing module 230 is generating graphical representations for a list of viable AI and/or proprietary AI accelerating tools, a list of viable trusted accelerating tools, a list of viable AI and/or proprietary AI translating tools, and a list of trusted translating tools. The user, via the GUI, selects one or more tools from one or more of lists as indicated by the arrows. The selection of tools is provided by the dashboard data processing module 230 to the code enhancement module 224 at step 552.

The proprietary AI enhancing tool module 225 gathers information regarding the selections from the list of viable AI and/or proprietary AI code enhancing tools and the list of trusted code enhancing tools. The newly gathered information is used in combination with previously gathered information to create and/or update one or more use case models 428, one or more overall score models 422, one or more sub-function score models 424, and/or to create and/or update one or more proprietary AI tools 426.

In FIG. 73C, the code enhancement module 224 is executing steps 548, 550, and 552 as in FIG. 73A. In this example, the dashboard data processing module 230 is generating graphical representations for a list of viable AI and/or proprietary AI migrating tools, a list of viable trusted migrating tools, a list of viable AI and/or proprietary AI code generating tools, and a list of trusted code generating tools. The user, via the GUI, selects one or more tools from one or more of lists as indicated by the arrows. The selection of tools is provided by the dashboard data processing module 230 to the code enhancement module 224 at step 552.

The proprietary AI enhancing tool module 225 gathers information regarding the selections from the list of viable AI and/or proprietary AI code enhancing tools and the list of trusted code enhancing tools. The newly gathered information is used in combination with previously gathered information to create and/or update one or more use case models 428, one or more overall score models 422, one or more sub-function score models 424, and/or to create and/or update one or more proprietary AI tools 426.

In FIG. 73D, the code enhancement module 224 is executing steps 548, 550, and 552 as in FIG. 73A. In this example, the dashboard data processing module 230 is generating graphical representations for a list of viable AI and/or proprietary AI simulating tools and a list of viable trusted simulating tools. The user, via the GUI, selects one or more tools from one or more of lists as indicated by the arrows. The selection of tools is provided by the dashboard data processing module 230 to the code enhancement module 224 at step 552.

The proprietary AI enhancing tool module 225 gathers information regarding the selections from the list of viable AI and/or proprietary AI code enhancing tools and the list of trusted code enhancing tools. The newly gathered information is used in combination with previously gathered information to create and/or update one or more use case models 428, one or more overall score models 422, one or more sub-function score models 424, and/or to create and/or update one or more proprietary AI tools 426.

In FIG. 73E, the code enhancement module 224 is executing steps 558-1 through -n, steps 560-1 through -n, and steps 562-1 through -n of FIG. 44C. The dashboard data processing module 230 generates a graphical representation for the sectioning of code in a variety of ways. For example, the graphical representation includes representations for multiple versions of code sectioning.

As another example, as shown, the graphical representation includes the graphical representation of a version of enhanced code. The sections of the enhanced code are graphically illustrated, and at least some of them are graphically selectable via the GUI. When a code section is selected, its lines of code are shown in a window. In addition, information regarding the section is shown, which includes a description of the section, the location of the section, number of lines of code, and/or other enhancing information.

The graphical representation further includes a code enhancing evaluation section, which indicates whether the code section meets or exceeds the parameters or it does not. If another code section is selected, similar graphical data is produced by the dashboard data processing module 230.

When no code section is selected, the dashboard data processing module 230 provides a graphical representation regarding the enhanced code as a whole. In an example, the graphical representation includes information regarding the code, its enhancing, and whether as a whole it met or exceeded the parameters or it did not.

The proprietary AI enhancing tool module 225 gathers information regarding the execution of code sectioning. The newly gathered information is used in combination with previously gathered information to create and/or update one or more enhance execution models 671 and/or to create and/or update one or more proprietary AI tools 426.

The example of FIG. 73F is similar to the example of FIG. 73E with the difference being that the selected code section does not meet the parameters. The code enhancing evaluation table further includes one or more comments regarding the code enhancing failure to meet the parameters. The comment section could further include a suggestion regarding a fix (e.g., select a specific code enhancing tool, change a parameter, select a specific proprietary AI code enhancing tool, etc.).

FIG. 73G is a schematic block diagram of another example of evaluating one or more enhanced codes. In this example, the code enhancement module 224 is executing steps 564 and 568 of FIG. 44C. When one or more enhanced codes meets or exceeds the parameters at step 568, the code enhancement module 224 selects an enhanced code based on the parameters at step 568.

The dashboard data processing module 230 supports the selection of an enhanced code by generating a graphical representation of each enhanced code that met or exceeded the parameters, the corresponding enhanced evaluation data (which includes how well it performed with respect to the parameters), and a corresponding select button. Via a GUI, a user selects one of the enhanced codes, which is conveyed by the dashboard data processing module to the code enhancement module 224.

The proprietary AI enhancing tool module 225 gathers information regarding the number of versions of enhanced code that met or exceeded the parameters, the corresponding enhanced code evaluation data, and the selection of a particular enhanced code. The newly gathered information is used in combination with previously gathered information to create and/or update one or more use case models 428, one or more enhance execution models 671, and/or to create and/or update one or more proprietary AI tools 426.

FIG. 73H is a schematic block diagram of an example of selecting one or more new tools for enhancing code. In this example, the code enhancement module 224 is executing steps 564 and 566 of FIG. 44C. When none of the enhanced codes meets the parameters at step 564, the code enhancement module 224 adjusts a code enhancing tool selection and/or a parameter at step 566.

The dashboard data processing module 230 supports the adjustment of a code enhancing AI tool and/or the adjusting of a parameter by generating a graphical representation of the enhancement parameters and the table regarding the set of viable AI code enhancing tools. The graphical representation of the enhancement parameters (shown in a simplified manner) lists the purpose parameters, the operation parameters, the previous selections thereof, and the previous prioritizations thereof.

The user, via a GUI provided by the dashboard data processing module 230, modifies the selection and/or priority of one or more purpose parameter and/or one or more operation parameters. The modification of a parameter includes selecting a previously unselected parameter, deleting the selection of a previously selected parameter, and/or changing the priority of a previously selected parameter.

The table of the set of viable AI code enhancing tools lists the tools as discussed with reference to FIGS. 73A-73D. If the user did not change a parameter, then one or more of the previously selected AI tools is barred from a current selection as represented by the large X. In this example, the user selects the second AI code enhancing tool for subsequent enhancing of the code.

The proprietary AI enhancing tool module 225 gathers information regarding the number of versions of enhanced code that did not meet the parameters, the corresponding enhanced code evaluation data, and the adjusting of an AI tool and/or adjusting of a parameter. The newly gathered information is used in combination with previously gathered information to create and/or update one or more use case models 428, one or more enhance execution models 671, and/or to create and/or update one or more proprietary AI tools 426.

FIG. 73I is a schematic block diagram of an example of determining whether to re-enhance at least a portion of code. In this example, the code enhancement module 224 is executing steps 564 of FIG. 564 regarding an individual section of enhanced code. For this individual section of enhanced code, the code enhancement module 224 further executes steps 566-1 through 566-3 when the individual section of enhanced code did not meet the parameters.

At step 566-1, the code enhancement module 224 determines whether to redo the enhancing of the individual section of enhanced code or redo the enhancing of the entire enhanced code. The code enhancement module 224 may make such a determination in a variety of ways. For example, the code enhancement module 224 determines to redo the individual section of enhanced code when its evaluation and/or score were just below expectable levels and the code enhancement module 224 identifies an additional AI enhancing tool and/or proprietary AI enhancing tool that, when applied to the individual section of enhanced code, has a high probability of yielding a favorable evaluation and/or a favorable score.

When the code enhancement module 224 determines to redo the individual section of enhanced code, the method continues at step 566-3, where the code enhancement module 224 adjusts the tool section of this individual enhanced code section. When the code enhancement module 224 determines to redo the entire enhanced code, the method continues at step 566-2, where the code enhancement module 224 adjusts the AI tools and/or one or more parameters.

The dashboard data processing module 230 generates a graphical representation of the steps performed by the code enhancement module 224, which is similar to the graphical representation of FIGS. 73E and 73F. This example further includes selection buttons (or other GUI selection mechanism) of accept, redo code, and redo section. Accordingly, the accept button instructs the code enhancement module 224 to accept the individual section of enhanced code even though it did not meet the parameters; the redo code button instructs the code enhancement module 224 to re-enhance the enhanced code based on adjusted tools and/or adjusted parameters; and the redo section instructs the code enhancement module 224 to re-enhance the individual section of enhanced code based on adjusted tools.

The proprietary AI enhancing tool module 225 gathers information regarding the individual section of enhanced code that did not meet the parameters, and the selection to redo enhancing of the entire code, redo enhancing of the individual section of enhanced code, or accepting the individual section of enhanced code even though it did not meet the parameters. The newly gathered information is used in combination with previously gathered information to create and/or update one or more enhance execution models 671, and/or to create and/or update one or more proprietary AI tools 426.

FIG. 73J is a schematic block diagram of another example of evaluating one or more enhanced codes. In this example, the code enhancement module 224 is executing steps 578-1 through -n, 610, 612-1 through -n, and 614-1 through -n, of FIG. 46 and 596 of FIG. 44D. At step 610, the code enhancement module 224 enhances code using one or more trusted tools to produce trusted enhanced code. The dashboard data processing module 230 generates a graphical representation of the trusted enhanced code and corresponding trusted enhanced code information. If the code enhancement module 224 generates more than one trusted enhanced code, the dashboard data processing module 230 would generate a graphical representation for each version the trusted enhanced code and its corresponding information.

At steps 578-1 through -n, the code enhancement module 224 uses different combinations of AI code enhancing tools and/or proprietary AI code enhancing tools to generate multiple versions of AI enhanced code. The dashboard data processing module 230 generates a graphical representation for each version the AI enhanced code and its corresponding information.

At steps 612-1 through -n, the code enhancement module 224 compares each version of the AI enhanced code with the trusted enhanced code. The code enhancement module 224 provides favorable comparison information to the dashboard data processing module 230 for each favorable comparison. The dashboard data processing module 230 provides a checkmark in the favorable comparison section of the corresponding enhanced code evaluation information and enables a GUI section button.

The code enhancement module 224 provides unfavorable comparison information to the dashboard data processing module 230 for each unfavorable comparison. The dashboard data processing module 230 provides a checkmark in the unfavorable comparison section of the corresponding enhanced code evaluation information and does not enable a GUI section button (shown grayed out).

At step 596, the code enhancement module 224 receives from the dashboard data processing module 230 an indication of which AI enhanced code with a favorable comparison was selected via a GUI select button. Note that the user can select more than one version of AI enhanced code with a favorable comparison.

The proprietary AI enhancing tool module 225 gathers information regarding the generation of the trusted enhanced code, the generation of the versions of AI enhanced code, the comparison thereof, and the selection of one or more versions of AI enhanced code. The newly gathered information is used in combination with previously gathered information to create and/or update one or more use case models 428, to create and/or update one or more enhance execution models 671, and/or to create and/or update one or more proprietary AI tools 426.

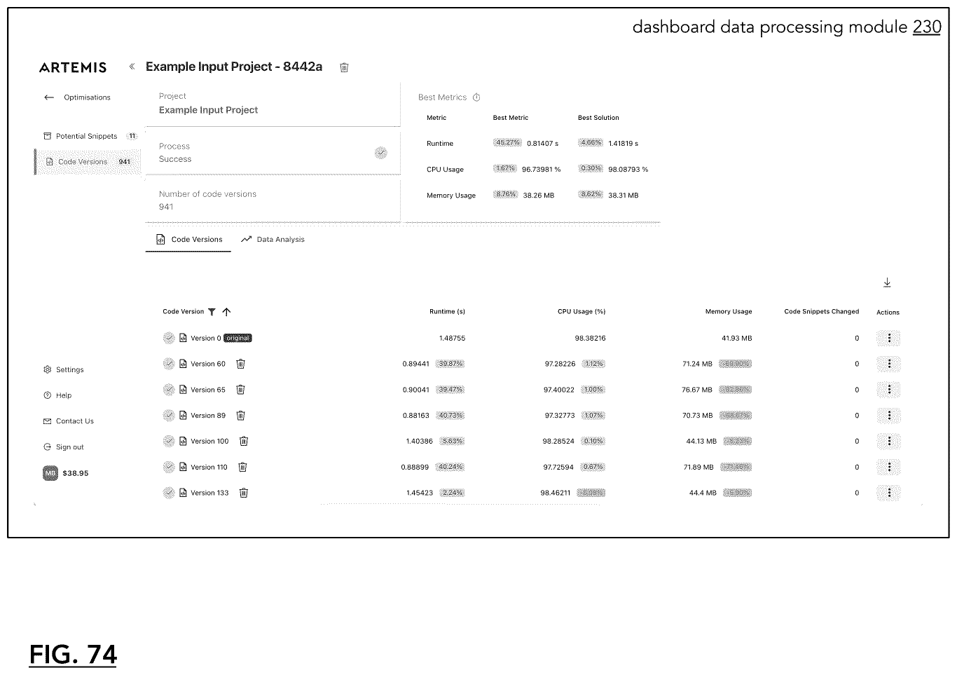

FIG. 74 is a schematic block diagram of an example of an optimization page with various enhanced code versions. In this example, the dashboard data processing module 230 generates a graphical representation for code that is to be enhanced. The graphical representation includes information regarding the original code and its performance data and information for multiple versions of enhanced code it their respective performance data. The graphical representation further includes a comparison of the original code's performance data with the performance data of the versions of enhanced code.

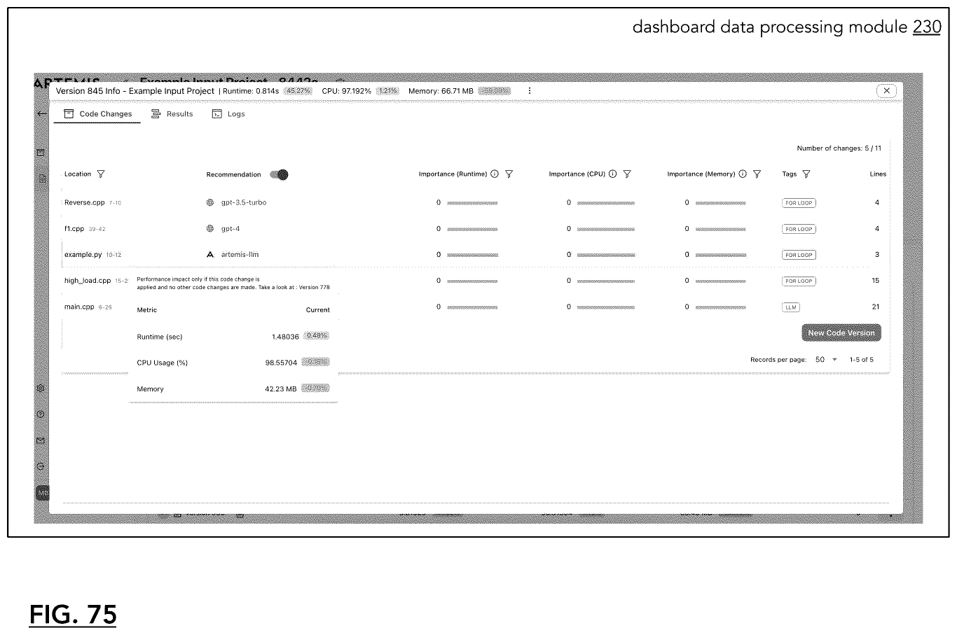

FIG. 75 is a schematic block diagram of an example of an optimized enhanced code version. In this example, the dashboard data processing module 230 generates a graphical representation for several codes that are to be enhanced. The graphical representation includes selected parameters and target values therefor. The graphical representation further includes one or more recommendations for enhancing the codes and includes related code information.

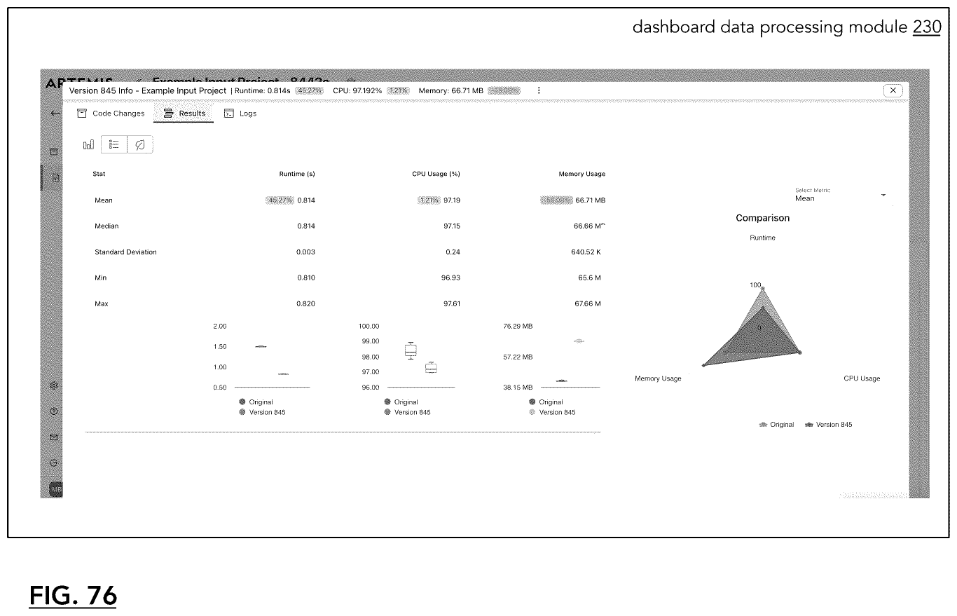

FIG. 76 is a schematic block diagram of an example of a comparison of an optimized enhanced code version with the original code version. In this example, the dashboard data processing module 230 generates a graphical representation of performance data for an enhanced code. The graphical representation further includes a comparison of the original code's performance data with the performance data of the enhanced code.

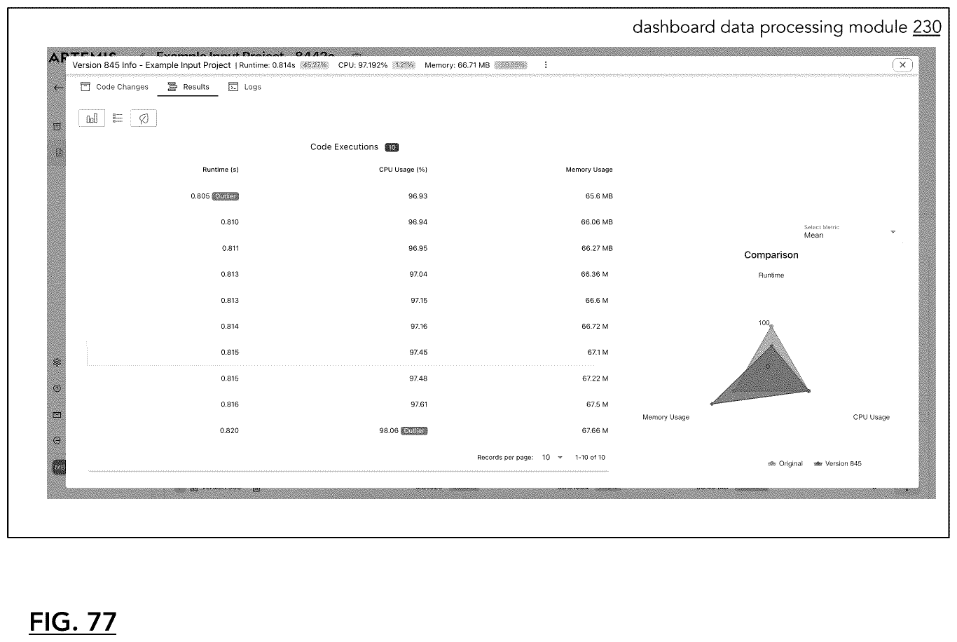

FIG. 77 is a schematic block diagram of an example of an optimization comparison with multiple runs of an enhanced code version. In this example, the dashboard data processing module 230 generates a graphical representation of performance data for an enhanced code. The graphical representation further includes a comparison of the original code's performance data with the performance data of the enhanced code.

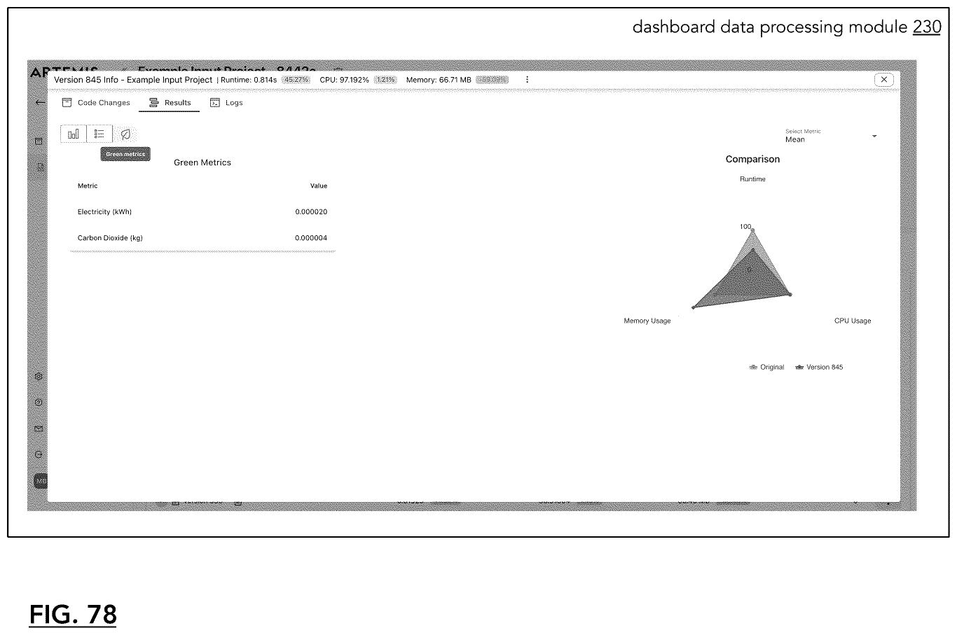

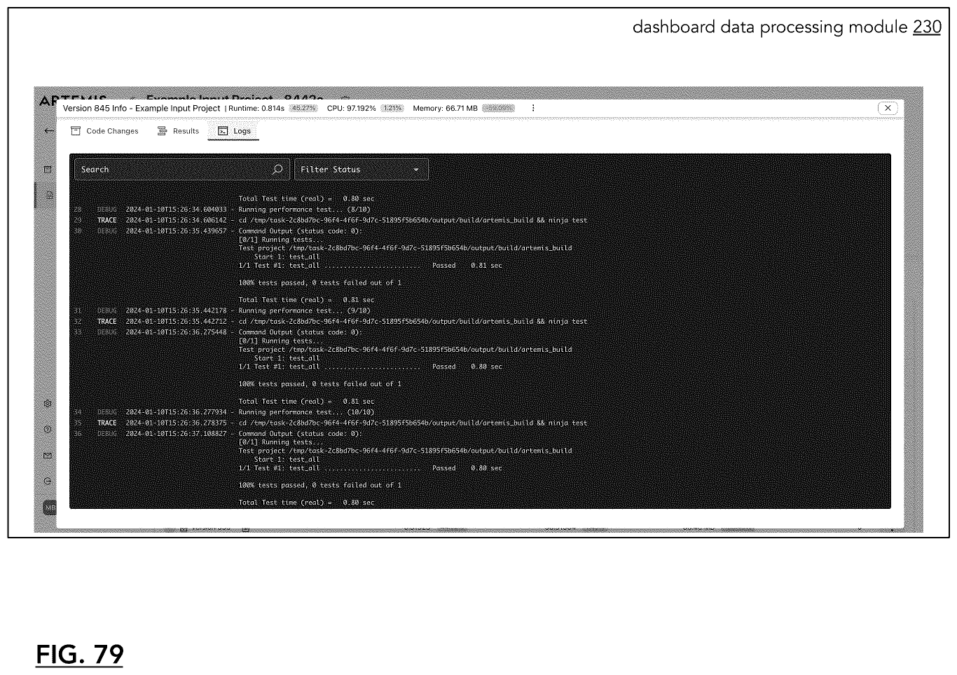

FIG. 78 is a schematic block diagram of an example of a comparison of an optimized enhanced code version with respect to green metrics. In this example, the dashboard data processing module 230 generates a graphical representation of performance data for an enhanced code. The graphical representation further includes a comparison of the original code's performance data with the performance data of the enhanced code.

FIG. 79 is a schematic block diagram of an example of an optimization log of enhancing code.

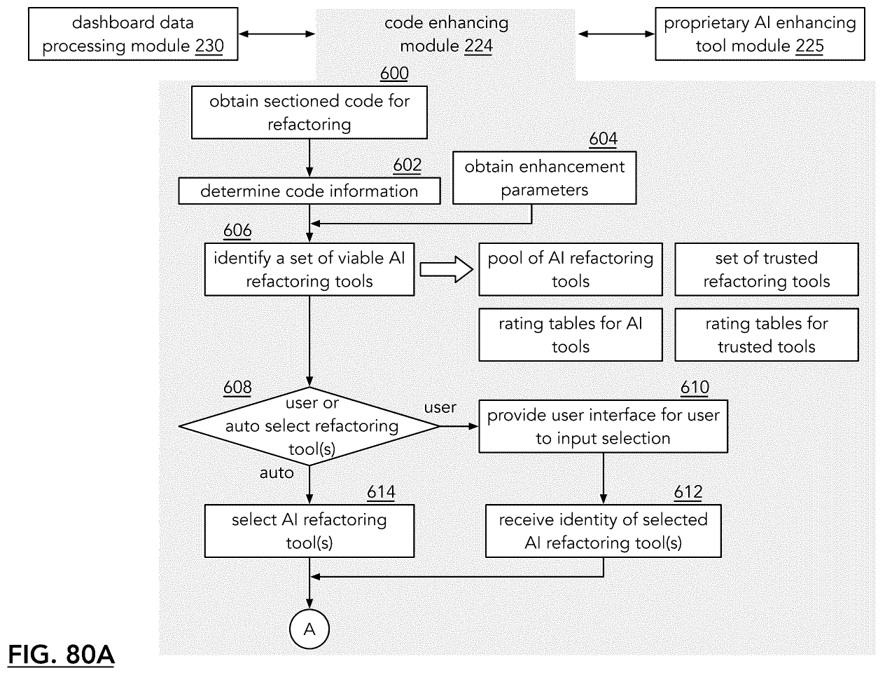

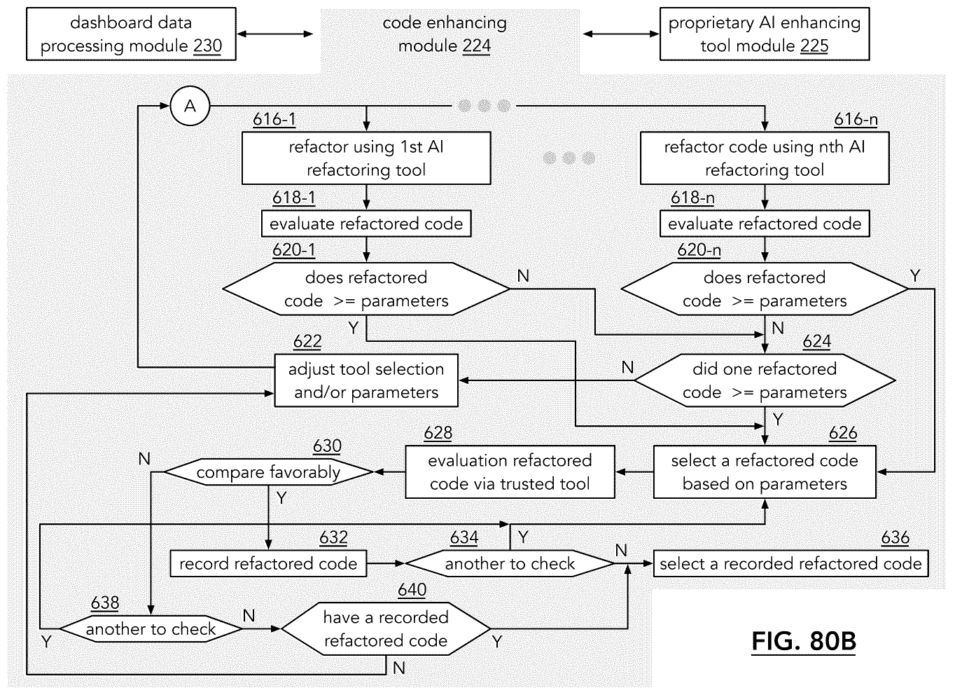

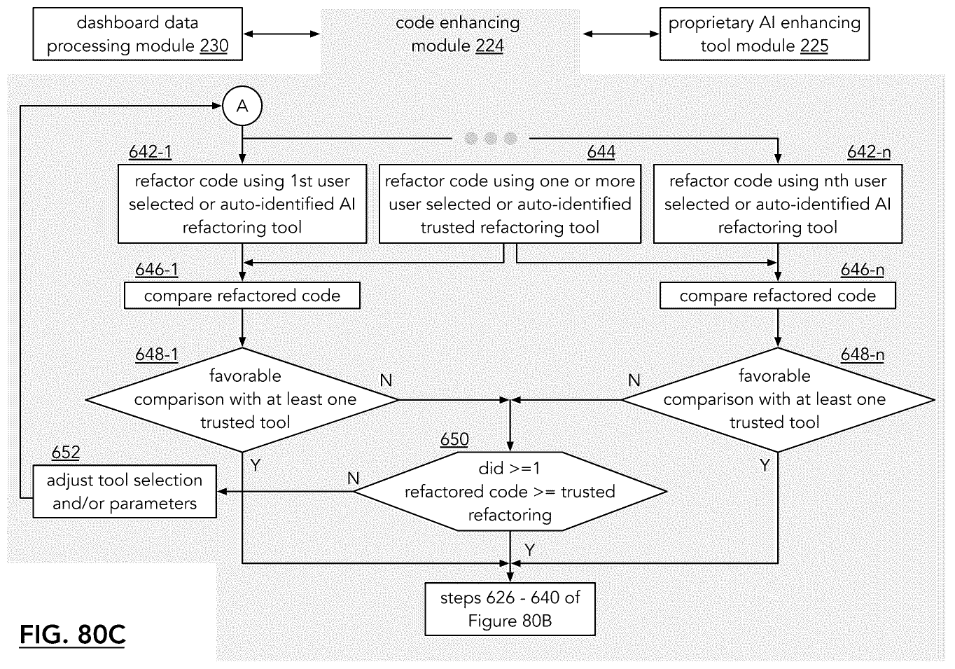

FIGS. 80A-80C are a logic diagram of an embodiment of a method for refactoring code. The method begins at step 600 of FIG. 80A, where the code enhancement module 224 obtains sectioned code for refactoring. The code enhancement module 224 may obtain the sectioned code in a variety of ways. For example, the code enhancement module 224 retrieves the sectioned code from the repository. As another example, the code enhancement module 224 receives it from the code sectioning module 222 of the code enhancement system 104.

The method continues at step 602, where the code enhancement module 224 determines code information, which is defined in the glossary section. The method continues at step 604, where the code enhancement module 224 obtains enhancement parameters (e.g., purpose parameters and/or operation parameters).

The method continues at step 606, where the code enhancement module 224 identifies a set of viable AI code refactoring tools based on the code information and based on the parameters. The set of viable AI code refactoring tools includes AI tools and/or proprietary AI tools and may further include a set of trusted tools. The code enhancement module 224 identifies the set of viable AI code refactoring tools using the code information, the AI tool records (e.g., tables) 227, and/or the proprietary AI tool records (e.g., tables). If the code enhancement module 224 is including trusted tools in the set of viable tools, the code enhancement module 224 uses the code information and the trusted tool records (e.g., tables) to identify trusted tools.

For example, the code enhancement module 224 creates a use case of the code 202 and, based on the use case, finds AI tools and/or proprietary AI tools that have comparable use cases. As another example, the code enhancement module 224 selects each AI tool and/or proprietary AI tool that is identified as performing code refactoring. As a further example, the code enhancement module 224 selects AI tools and/or proprietary AI tools based on their respective code refactoring attributes and desired attributes for the refactoring of the code 202.

The method continues at step 608, where the code enhancement module 224 determines whether the user or the system is to select the specific AI tools and/or proprietary AI tools (and, when desired, the trusted tools) to use to refactor the code. When the user has elected to select the specific AI tools via a GUI, or the like, the method continues at step 610, where the code enhancement module 224 provides set of viable AI code refactoring tools to the dashboard data processing module 230, which generates a GUI that enables the user to select from the set of viable AI code refactoring tools. The method continues at step 612, where the code enhancement module 224 receives identity of the selected AI code refactoring tool(s) from the dashboard data processing module 230. The method continues at step 616-1 through step 616-n of FIG. 80B.

If, at step 608, the system is to auto select the AI code refactoring tools, the method continues at step 614, where the code enhancement module 224 selects one or more AI code refactoring tools. The method continues at step 616-1 through step 616-n of FIG. 80B, where, at step 616-1, the code enhancement module 224 refactors the code using a first AI refactoring tool (or first set of AI refactoring tools). If there is only one AI refactoring tool or only one set of AI refactoring tools, the parallel branches of the method with the -n reference number are not executed.

When there are more than one AI refactoring tool or more than one set of AI refactoring tools, the code enhancement module 224, at step 616-2 through -n, refactors the code using the second through the nth AI refactoring tool (or nth set of AI refactoring tools) to create versions of refactored code. Note that a set of AI refactoring tools collaborates to produce a version of the refactored code.

The method continues at step 618-1 through -n, where the code enhancement module 224 evaluates the versions of refactored code as produced by the various combination of AI tools. The versions of the AI refactored code are evaluated using one or more AI code refactoring evaluation tools. The method continues at step 620-1 through 620—n, where the code enhancement module 224 determines, based on the evaluation, whether the AI refactored code meets or exceeds the parameters.

For each of steps 620-1 through 620—n where the refactored code did not meet or exceed the parameters, the method continues at step 624, where the code enhancement module 224 determines whether at least one AI version of refactored code met or exceeded the parameters. If not, the method continues at step 622, where the code enhancement module 224 adjusts the selection of an AI refactoring tool and/or adjusts a parameter. The method repeats at steps 616-1 through 616—n using the adjusted AI tools and/or based on the adjusted parameters.

For each of steps 620-1 through 620—n where the refactored code did meet or exceed the parameters and for a yes answer to step 624, the code enhancement module 224 selects one of the AI versions of refactored code at step 626. The method continues at step 628, where the code enhancement module 224 evaluates the refactored code via a trusted tool.

The method continues at step 630, where the code enhancement module 224 determines whether the evaluation of step 628 was favorable. As an example, a comparison is favorable when the AI refactored code is substantially identical to the trusted refactored code. As another example, the comparison is favorable when the trusted tool verifies the methodology and resulting refactoring of the AI version of the refactored code.

When the comparison of step 630 is favorable, the method continues at step 632, where the code enhancement module 224 records the AI refactored code as having a successful evaluation. The method continues at step 634, where the code enhancement module 224 determines whether there is another version of AI refactored code to be evaluated. If yes, the method repeats at step 626. If not, the method continues at step 636, where the code enhancement module 224 selects one of the recorded versions of AI refactored code to output as the refactored code.

If, at step 630, the comparison was unfavorable, the method continues at step 638, where the code enhancement module 224 determines whether there is another version of AI refactored code to be evaluated. If yes, the method repeats at step 626. If no, the method continues at step 640, where the code enhancement module 224 determines whether there is at least one AI refactored code that has passed evaluation by the trusted tool. If yes, the method continues to step 636. If not, the method repeats at step 622.

FIG. 80C is a logic diagram of an alternative method to the method of FIG. 80B. This method branches from step 612 or step 614 of FIG. 80A. This method includes steps 642-1 through 642—n, where the code enhancement module 224 generates “n” versions of AI refactored code using “n” combinations of AI tools and/or AI proprietary tools. At step 644, the code enhancement module 224 refactors the code using a trusted tool to produce a trusted refactored code.

The method continues at steps 646-1 through 646—n, where the code enhancement module 224 compares respective versions of the AI refactored code to the trusted refactored code. The method continues at steps 648-1 through 648—n, where the code enhancement module 224 determines which of the comparisons were favorable. In example, a version of AI refactored code compares favorably to the trusted version of refactored code when it is refactored in an identical or near identical manner as the trusted version. As another example, an AI version of refactored code compares favorably to the trusted version of refactored code when the trusted tool verifies the AI version of the refactored code.

For each of the comparisons of steps 648-1 through 648—n that was not favorable, the method continues at step 650, where the code enhancement module 224 determines whether at least one of the versions of AI refactored code compared favorably to the trusted version. If no, the method continues at step 652, where the code enhancement module 224 adjusts an AI tool and/or a parameter. The method continues at steps 642-1 through 642—n using the adjusted AI tools and/or the adjusted parameters.

For each of the comparisons of steps 648-1 through 648—n that was favorable and for a yes answer to step 650, the method continues by executing steps 626-640 of FIG. 80B.

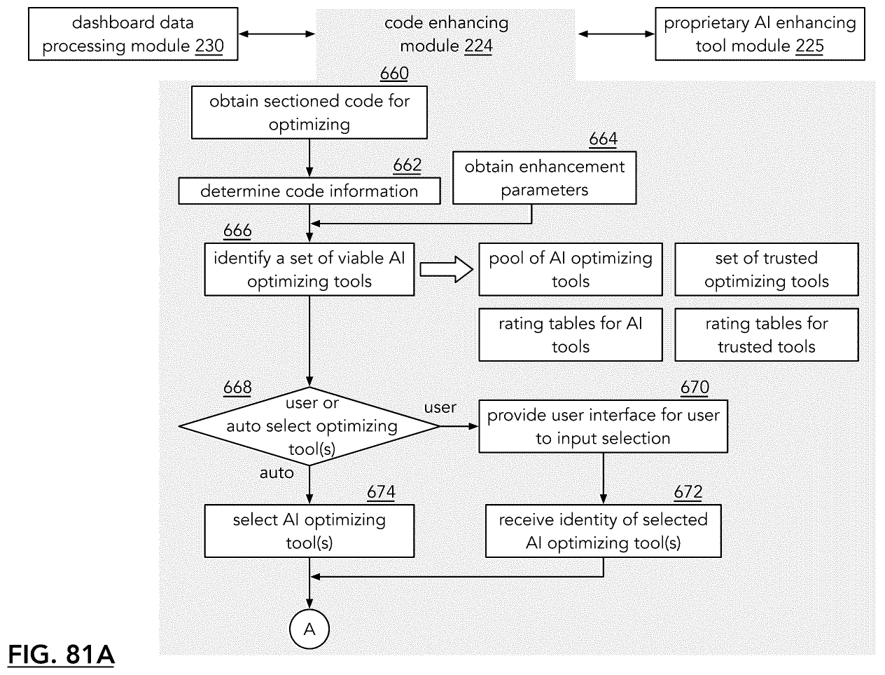

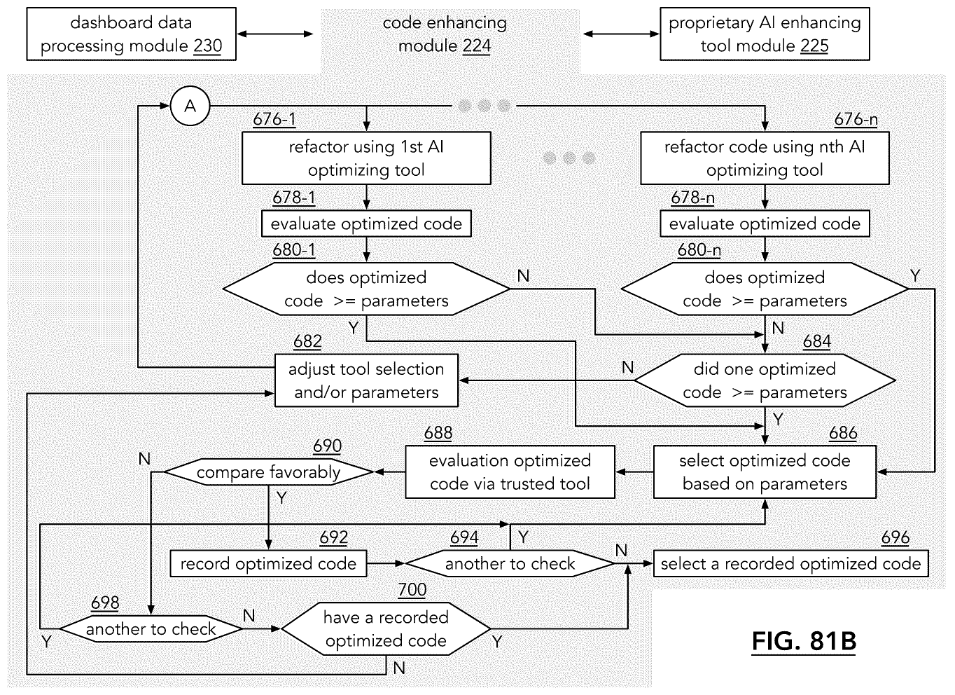

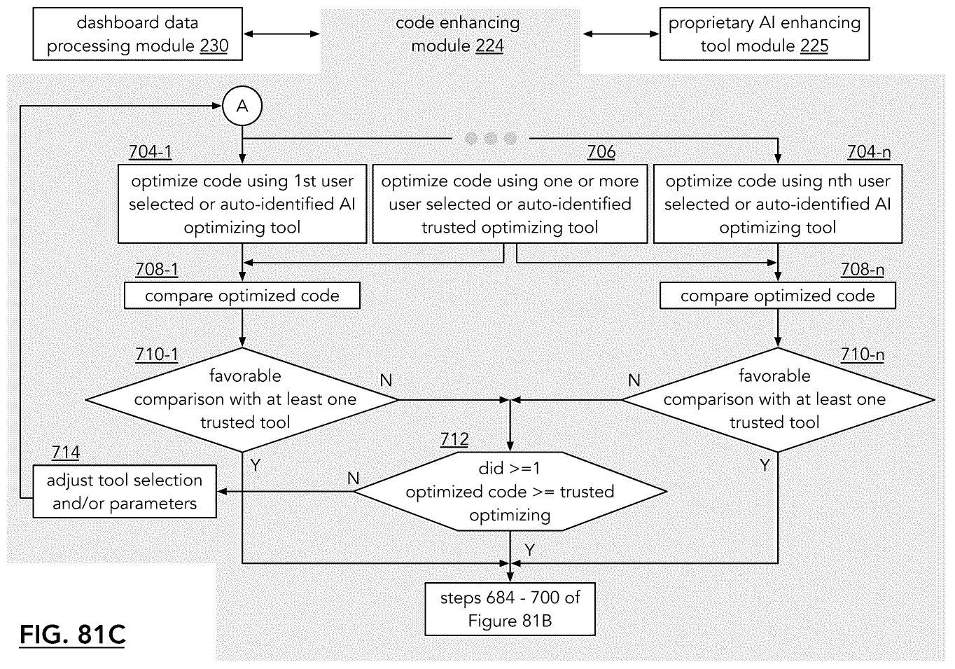

FIGS. 81A-81C are a logic diagram of an embodiment of a method for optimizing code. The method begins at step 660 of FIG. 81A, where the code enhancement module 224 obtains sectioned code for optimizing. The code enhancement module 224 may obtain the sectioned code in a variety of ways. For example, the code enhancement module 224 retrieves the sectioned code from the repository. As another example, the code enhancement module 224 receives it from the code sectioning module 222 of the code enhancement system 104.

The method continues at step 662, where the code enhancement module 224 determines code information, which is defined in the glossary section. The method continues at step 664, where the code enhancement module 224 obtains enhancement parameters (e.g., purpose parameters and/or operation parameters).

The method continues at step 666, where the code enhancement module 224 identifies a set of viable AI code optimizing tools based on the code information and based on the parameters. The set of viable AI code optimizing tools includes AI tools and/or proprietary AI tools and may further include a set of trusted tools. The code enhancement module 224 identifies the set of viable AI code optimizing tools using the code information, the AI tool records (e.g., tables) 227, and/or the proprietary AI tool records (e.g., tables). If the code enhancement module 224 is including trusted tools in the set of viable tools, the code enhancement module 224 uses the code information and the trusted tool records (e.g., tables) to identify trusted tools.

For example, the code enhancement module 224 creates a use case of the code 202 and, based on the use case, finds AI tools and/or proprietary AI tools that have comparable use cases. As another example, the code enhancement module 224 selects each AI tool and/or proprietary AI tool that is identified as performing code optimizing. As a further example, the code enhancement module 224 selects AI tools and/or proprietary AI tools based on their respective code optimizing attributes and desired attributes for the optimizing of the code 202.

The method continues at step 668, where the code enhancement module 224 determines whether the user or the system is to select the specific AI tools and/or proprietary AI tools (and, when desired, the trusted tools) to use to optimize the code. When the user has elected to select the specific AI tools via a GUI, or the like, the method continues at step 670, where the code enhancement module 224 provides set of viable AI code optimizing tools to the dashboard data processing module 230, which generates a GUI that enables the user to select from the set of viable AI code optimizing tools. The method continues at step 672, where the code enhancement module 224 receives identity of the selected AI code optimizing tool(s) from the dashboard data processing module 230. The method continues at step 676-1 through step 676-n of FIG. 81B.

If, at step 668, the system is to auto select the AI code optimizing tools, the method continues at step 674, where the code enhancement module 224 selects one or more AI code optimizing tools. The method continues at step 676-1 through step 676-n of FIG. 81B, where, at step 676-1, the code enhancement module 224 optimizes the code using a first AI optimizing tool (or first set of AI optimizing tools). If there is only one AI optimizing tool or only one set of AI optimizing tools, the parallel branches of the method with the -n reference number are not executed.

When there are more than one AI optimizing tool or more than one set of AI optimizing tools, the code enhancement module 224, at step 676-2 through -n, optimizes the code using the second through the nth AI optimizing tool (or nth set of AI optimizing tools) to create versions of optimized code. Note that a set of AI optimizing tools collaborates to produce a version of the optimized code.

The method continues at step 678-1 through -n, where the code enhancement module 224 evaluates the versions of optimized code as produced by the various combination of AI tools. The versions of the AI optimized code are evaluated using one or more AI code optimizing evaluation tools. The method continues at step 680-1 through 680—n, where the code enhancement module 224 determines, based on the evaluation, whether the AI optimized code meets or exceeds the parameters.

For each of steps 680-1 through 680—n where the optimized code did not meet or exceed the parameters, the method continues at step 684, where the code enhancement module 224 determines whether at least one AI version of optimized code met or exceeded the parameters. If not, the method continues at step 682, where the code enhancement module 224 adjusts the selection of an AI optimizing tool and/or adjusts a parameter. The method repeats at steps 676-1 through 676—n using the adjusted AI tools and/or based on the adjusted parameters.

For each of steps 680-1 through 680—n where the optimized code did meet or exceed the parameters and for a yes answer to step 684, the code enhancement module 224 selects one of the AI versions of optimized code at step 686. The method continues at step 688, where the code enhancement module 224 evaluates the optimized code via a trusted tool.

The method continues at step 690, where the code enhancement module 224 determines whether the evaluation of step 688 was favorable. As an example, a comparison is favorable when the AI optimized code is substantially identical to the trusted optimized code. As another example, the comparison is favorable when the trusted tool verifies the methodology and resulting optimizing of the AI version of the optimized code.

When the comparison of step 690 is favorable, the method continues at step 692, where the code enhancement module 224 records the AI optimized code as having a successful evaluation. The method continues at step 694, where the code enhancement module 224 determines whether there is another version of AI optimized code to be evaluated. If yes, the method repeats at step 686. If not, the method continues at step 696, where the code enhancement module 224 selects one of the recorded versions of AI optimized code to output as the optimized code.

If, at step 690, the comparison was unfavorable, the method continues at step 698, where the code enhancement module 224 determines whether there is another version of AI optimized code to be evaluated. If yes, the method repeats at step 686. If no, the method continues at step 700, where the code enhancement module 224 determines whether there is at least one AI optimized code that has passed evaluation by the trusted tool. If yes, the method continues to step 696. If not, the method repeats at step 682.

FIG. 81C is a logic diagram of an alternative method to the method of FIG. 81B. This method branches from step 662 or step 664 of FIG. 81A. This method includes steps 704-1 through 704—n, where the code enhancement module 224 generates “n” versions of AI optimized code using “n” combinations of AI tools and/or AI proprietary tools. At step 706, the code enhancement module 224 optimizes the code using a trusted tool to produce a trusted optimized code.

The method continues at steps 708-1 through 708—n, where the code enhancement module 224 compares respective versions of the AI optimized code to the trusted optimized code. The method continues at steps 710-1 through 710—n, where the code enhancement module 224 determines which of the comparisons were favorable. In example, a version of AI optimized code compares favorably to the trusted version of optimized code when it is optimized in an identical or near identical manner as the trusted version. As another example, an AI version of optimized code compares favorably to the trusted version of optimized code when the trusted tool verifies the AI version of the optimized code.

For each of the comparisons of steps 710-1 through 710—n that was not favorable, the method continues at step 712, where the code enhancement module 224 determines whether at least one of the versions of AI optimized code compared favorably to the trusted version. If no, the method continues at step 714, where the code enhancement module 224 adjusts an AI tool and/or a parameter. The method continues at steps 704-1 through 704—n using the adjusted AI tools and/or the adjusted parameters.

For each of the comparisons of steps 710-1 through 710—n that was favorable and for a yes answer to step 712, the method continues by executing steps 684-700 of FIG. 81B.

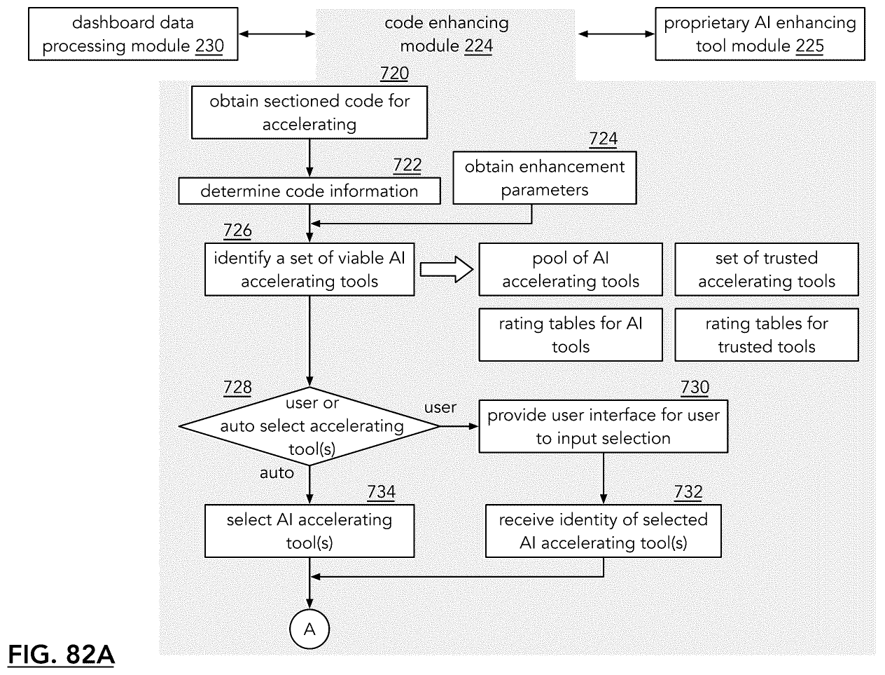

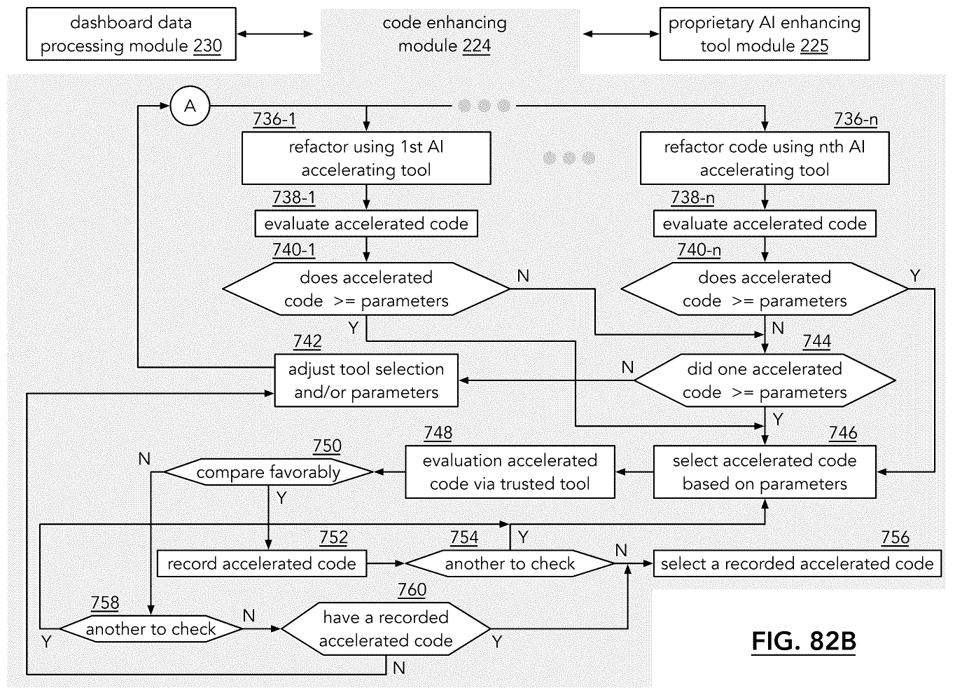

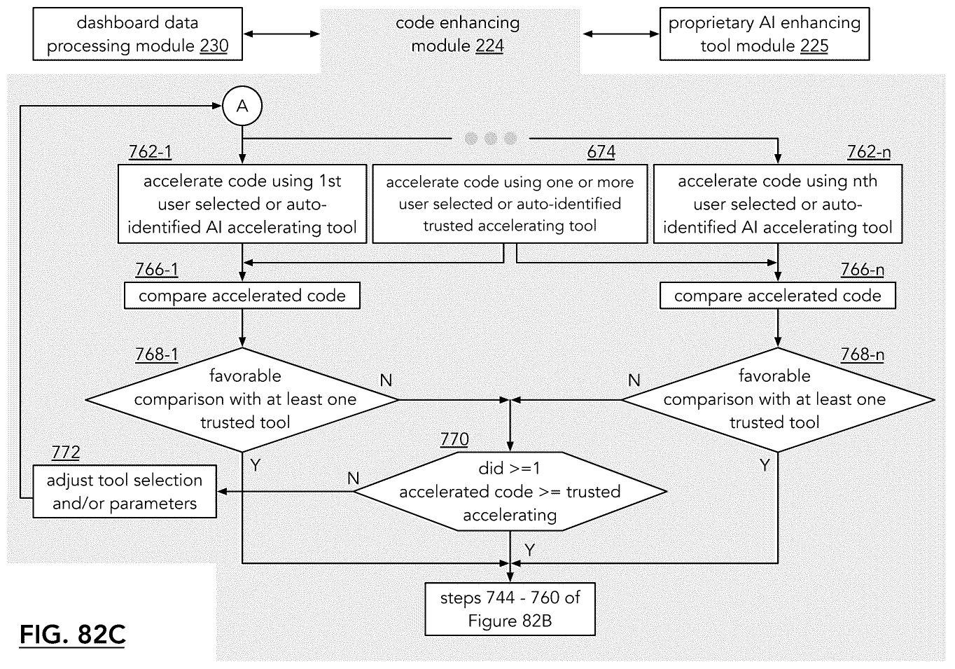

FIGS. 82A-82C are a logic diagram of an embodiment of a method for accelerating code. The method begins at step 720 of FIG. 82A, where the code enhancement module 224 obtains sectioned code for accelerating. The code enhancement module 224 may obtain the sectioned code in a variety of ways. For example, the code enhancement module 224 retrieves the sectioned code from the repository. As another example, the code enhancement module 224 receives it from the code sectioning module 222 of the code enhancement system 104.

The method continues at step 722, where the code enhancement module 224 determines code information, which is defined in the glossary section. The method continues at step 724, where the code enhancement module 224 obtains enhancement parameters (e.g., purpose parameters and/or operation parameters).

The method continues at step 726, where the code enhancement module 224 identifies a set of viable AI code accelerating tools based on the code information and based on the parameters. The set of viable AI code accelerating tools includes AI tools and/or proprietary AI tools and may further include a set of trusted tools. The code enhancement module 224 identifies the set of viable AI code accelerating tools using the code information, the AI tool records (e.g., tables) 227, and/or the proprietary AI tool records (e.g., tables). If the code enhancement module 224 is including trusted tools in the set of viable tools, the code enhancement module 224 uses the code information and the trusted tool records (e.g., tables) to identify trusted tools.

For example, the code enhancement module 224 creates a use case of the code 202 and, based on the use case, finds AI tools and/or proprietary AI tools that have comparable use cases. As another example, the code enhancement module 224 selects each AI tool and/or proprietary AI tool that is identified as performing code accelerating. As a further example, the code enhancement module 224 selects AI tools and/or proprietary AI tools based on their respective code accelerating attributes and desired attributes for the accelerating of the code 202.

The method continues at step 728, where the code enhancement module 224 determines whether the user or the system is to select the specific AI tools and/or proprietary AI tools (and, when desired, the trusted tools) to use to accelerate the code. When the user has elected to select the specific AI tools via a GUI, or the like, the method continues at step 730, where the code enhancement module 224 provides set of viable AI code accelerating tools to the dashboard data processing module 230, which generates a GUI that enables the user to select from the set of viable AI code accelerating tools. The method continues at step 732, where the code enhancement module 224 receives identity of the selected AI code accelerating tool(s) from the dashboard data processing module 230. The method continues at step 736-1 through step 736-n of FIG. 82B.

If, at step 728, the system is to auto select the AI code accelerating tools, the method continues at step 734, where the code enhancement module 224 selects one or more AI code accelerating tools. The method continues at step 736-1 through step 736-n of FIG. 82B, where, at step 736-1, the code enhancement module 224 accelerates the code using a first AI accelerating tool (or first set of AI accelerating tools). If there is only one AI accelerating tool or only one set of AI accelerating tools, the parallel branches of the method with the -n reference number are not executed.

When there are more than one AI accelerating tools or more than one set of AI accelerating tools, the code enhancement module 224, at step 736-2 through -n, accelerates the code using the second through the nth AI accelerating tool (or nth set of AI accelerating tools) to create versions of accelerated code. Note that a set of AI accelerating tools collaborates to produce a version of the accelerated code.

The method continues at step 738-1 through -n, where the code enhancement module 224 evaluates the versions of accelerated code as produced by the various combination of AI tools. The versions of the AI accelerated code are evaluated using one or more AI code accelerating evaluation tools. The method continues at step 740-1 through 740—n, where the code enhancement module 224 determines, based on the evaluation, whether the AI accelerated code meets or exceeds the parameters.

For each of steps 740-1 through 740—n where the accelerated code did not meet or exceed the parameters, the method continues at step 744, where the code enhancement module 224 determines whether at least one AI version of accelerated code met or exceeded the parameters. If not, the method continues at step 742, where the code enhancement module 224 adjusts the selection of an AI accelerating tool and/or adjusts a parameter. The method repeats at steps 736-1 through 736—n using the adjusted AI tools and/or based on the adjusted parameters.

For each of steps 740-1 through 740—n where the accelerated code did meet or exceed the parameters and for a yes answer to step 744, the code enhancement module 224 selects one of the AI versions of accelerated code at step 746. The method continues at step 748, where the code enhancement module 224 evaluates the accelerated code via a trusted tool.

The method continues at step 750, where the code enhancement module 224 determines whether the evaluation of step 748 was favorable. As an example, a comparison is favorable when the AI accelerated code is substantially identical to the trusted accelerated code. As another example, the comparison is favorable when the trusted tool verifies the methodology and resulting accelerating of the AI version of the accelerated code.

When the comparison of step 750 is favorable, the method continues at step 752, where the code enhancement module 224 records the AI accelerated code as having a successful evaluation. The method continues at step 754, where the code enhancement module 224 determines whether there is another version of AI accelerated code to be evaluated. If yes, the method repeats at step 746. If not, the method continues at step 756, where the code enhancement module 224 selects one of the recorded versions of AI accelerated code to output as the accelerated code.

If, at step 750, the comparison was unfavorable, the method continues at step 758, where the code enhancement module 224 determines whether there is another version of AI accelerated code to be evaluated. If yes, the method repeats at step 746. If no, the method continues at step 760, where the code enhancement module 224 determines whether there is at least one AI accelerated code that has passed evaluation by the trusted tool. If yes, the method continues to step 756. If not, the method repeats at step 742.

FIG. 82C is a logic diagram of an alternative method to the method of FIG. 82B. This method branches from step 732 or step 734 of FIG. 82A. This method includes steps 762-1 through 762—n, where the code enhancement module 224 generates “n” versions of AI accelerated code using “n” combinations of AI tools and/or AI proprietary tools. At step 764, the code enhancement module 224 accelerates the code using a trusted tool to produce a trusted accelerated code.

The method continues at steps 766-1 through 766—n, where the code enhancement module 224 compares respective versions of the AI accelerated code to the trusted accelerated code. The method continues at steps 768-1 through 768—n, where the code enhancement module 224 determines which of the comparisons were favorable. In an example, a version of AI accelerated code compares favorably to the trusted version of accelerated code when it is accelerated in an identical or near identical manner as the trusted version. As another example, an AI version of accelerated code compares favorably to the trusted version of accelerated code when the trusted tool verifies the AI version of the accelerated code.

For each of the comparisons of steps 768-1 through 768—n that was not favorable, the method continues at step 770, where the code enhancement module 224 determines whether at least one of the versions of AI accelerated code compared favorably to the trusted version. If no, the method continues at step 772, where the code enhancement module 224 adjusts an AI tool and/or a parameter. The method continues at steps 762-1 through 762—n using the adjusted AI tools and/or the adjusted parameters.

For each of the comparisons of steps 768-1 through 768—n that was favorable and for a yes answer to step 770, the method continues by executing steps 744-760 of FIG. 82B.

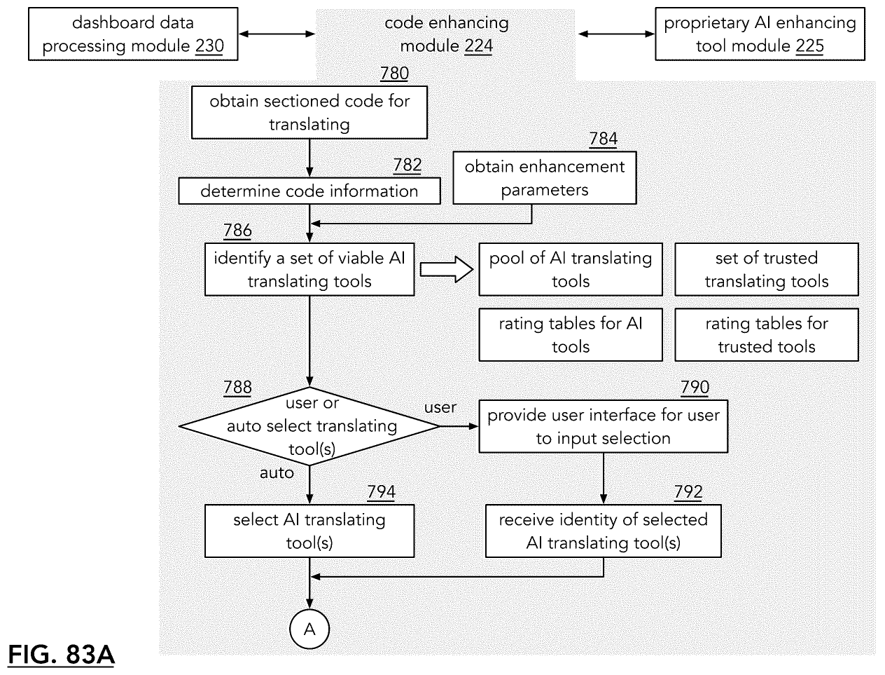

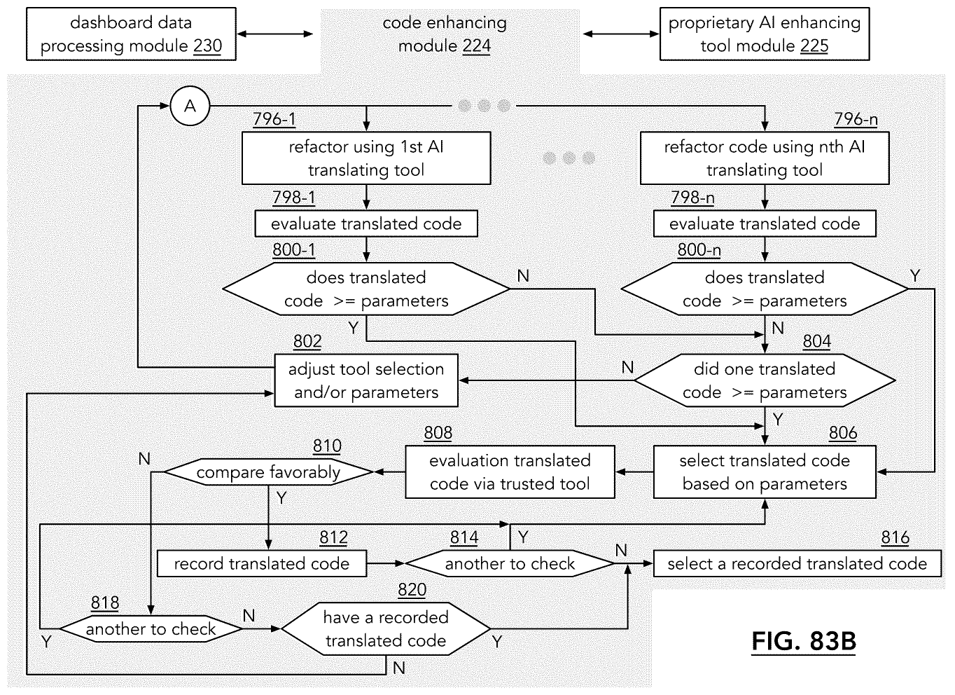

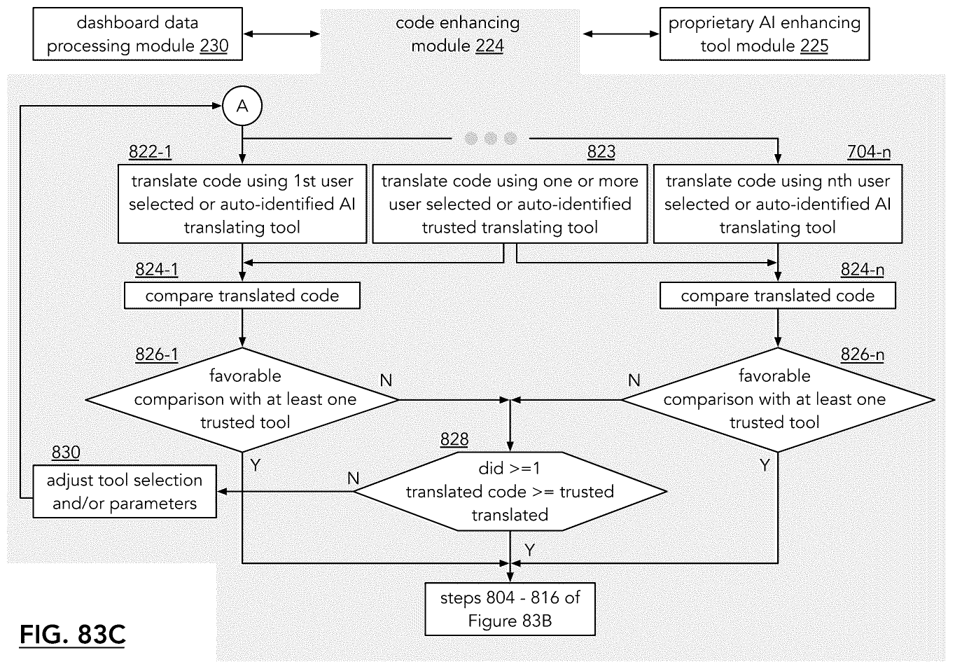

FIGS. 83A-83C are a logic diagram of an embodiment of a method for translating code. The method begins at step 780 of FIG. 83A, where the code enhancement module 224 obtains sectioned code for translating. The code enhancement module 224 may obtain the sectioned code in a variety of ways. For example, the code enhancement module 224 retrieves the sectioned code from the repository. As another example, the code enhancement module 224 receives it from the code sectioning module 222 of the code enhancement system 104.

The method continues at step 782, where the code enhancement module 224 determines code information, which is defined in the glossary section. The method continues at step 784, where the code enhancement module 224 obtains enhancement parameters (e.g., purpose parameters and/or operation parameters).

The method continues at step 786, where the code enhancement module 224 identifies a set of viable AI code translating tools based on the code information and based on the parameters. The set of viable AI code translating tools includes AI tools and/or proprietary AI tools and may further include a set of trusted tools. The code enhancement module 224 identifies the set of viable AI code translating tools using the code information, the AI tool records (e.g., tables) 227, and/or the proprietary AI tool records (e.g., tables). If the code enhancement module 224 is including trusted tools in the set of viable tools, the code enhancement module 224 uses the code information and the trusted tool records (e.g., tables) to identify trusted tools.

For example, the code enhancement module 224 creates a use case of the code 202 and, based on the use case, finds AI tools and/or proprietary AI tools that have comparable use cases. As another example, the code enhancement module 224 selects each AI tool and/or proprietary AI tool that is identified as performing code translating. As a further example, the code enhancement module 224 selects AI tools and/or proprietary AI tools based on their respective code translating attributes and desired attributes for the translating of the code 202.

The method continues at step 788, where the code enhancement module 224 determines whether the user or the system is to select the specific AI tools and/or proprietary AI tools (and, when desired, the trusted tools) to use to translate the code. When the user has elected to select the specific AI tools via a GUI, or the like, the method continues at step 790, where the code enhancement module 224 provides set of viable AI code translating tools to the dashboard data processing module 230, which generates a GUI that enables the user to select from the set of viable AI code translating tools. The method continues at step 792, where the code enhancement module 224 receives identity of the selected AI code translating tool(s) from the dashboard data processing module 230. The method continues at step 796-1 through step 796-n of FIG. 83B.

If, at step 788, the system is to auto select the AI code translating tools, the method continues at step 794, where the code enhancement module 224 selects one or more AI code translating tools. The method continues at step 796-1 through step 796-n of FIG. 83B, where, at step 796-1, the code enhancement module 224 translates the code using a first AI translating tool (or first set of AI translating tools). If there is only one AI translating tool or only one set of AI translating tools, the parallel branches of the method with the -n reference number are not executed.

When there are more than one AI translating tool or more than one set of AI translating tools, the code enhancement module 224, at step 796-2 through -n, translates the code using the second through the nth AI translating tool (or nth set of AI translating tools) to create versions of translated code. Note that a set of AI translating tools collaborates to produce a version of the translated code.

The method continues at step 798-1 through -n, where the code enhancement module 224 evaluates the versions of translated code as produced by the various combination of AI tools. The versions of the AI translated code are evaluated using one or more AI code translating evaluation tools. The method continues at step 800-1 through 800—n, where the code enhancement module 224 determines, based on the evaluation, whether the AI translated code meets or exceeds the parameters.

For each of steps 800-1 through 800—n where the translated code did not meet or exceed the parameters, the method continues at step 804, where the code enhancement module 224 determines whether at least one AI version of translated code met or exceeded the parameters. If not, the method continues at step 802, where the code enhancement module 224 adjusts the selection of an AI translating tool and/or adjusts a parameter. The method repeats at steps 796-1 through 796—n using the adjusted AI tools and/or based on the adjusted parameters.

For each of steps 800-1 through 800—n where the translated code did meet or exceed the parameters and for a yes answer to step 804, the code enhancement module 224 selects one of the AI versions of translated code at step 806. The method continues at step 808, where the code enhancement module 224 evaluates the translated code via a trusted tool.

The method continues at step 810, where the code enhancement module 224 determines whether the evaluation of step 808 was favorable. As an example, a comparison is favorable when the AI translated code is substantially identical to the trusted translated code. As another example, the comparison is favorable when the trusted tool verifies the methodology and resulting translating of the AI version of the translated code.

When the comparison of step 810 is favorable, the method continues at step 812, where the code enhancement module 224 records the AI translated code as having a successful evaluation. The method continues at step 814, where the code enhancement module 224 determines whether there is another version of AI translated code to be evaluated. If yes, the method repeats at step 806. If not, the method continues at step 816, where the code enhancement module 224 selects one of the recorded versions of AI translated code to output as the translated code.

If, at step 810, the comparison was unfavorable, the method continues at step 818, where the code enhancement module 224 determines whether there is another version of AI translated code to be evaluated. If yes, the method repeats at step 806. If no, the method continues at step 820, where the code enhancement module 224 determines whether there is at least one AI translated code that has passed evaluation by the trusted tool. If yes, the method continues to step 816. If not, the method repeats at step 802.

FIG. 83C is a logic diagram of an alternative method to the method of FIG. 83B. This method branches from step 792 or step 794 of FIG. 83A. This method includes steps 822-1 through 822—n, where the code enhancement module 224 generates “n” versions of AI translated code using “n” combinations of AI tools and/or AI proprietary tools. At step 823, the code enhancement module 224 translates the code using a trusted tool to produce a trusted translated code.

The method continues at steps 824-1 through 824—n, where the code enhancement module 224 compares respective versions of the AI translated code to the trusted translated code. The method continues at steps 826-1 through 826—n, where the code enhancement module 224 determines which of the comparisons were favorable. In an example, a version of AI translated code compares favorably to the trusted version of translated code when it is translated in an identical or near identical manner as the trusted version. As another example, an AI version of translated code compares favorably to the trusted version of translated code when the trusted tool verifies the AI version of the translated code.

For each of the comparisons of steps 826-1 through 826—n that was not favorable, the method continues at step 828, where the code enhancement module 224 determines whether at least one of the versions of AI translated code compared favorably to the trusted version. If no, the method continues at step 830, where the code enhancement module 224 adjusts an AI tool and/or a parameter. The method continues at steps 822-1 through 822—n using the adjusted AI tools and/or the adjusted parameters.

For each of the comparisons of steps 826-1 through 826—n that was favorable and for a yes answer to step 828, the method continues by executing steps 804-816 of FIG. 83B.

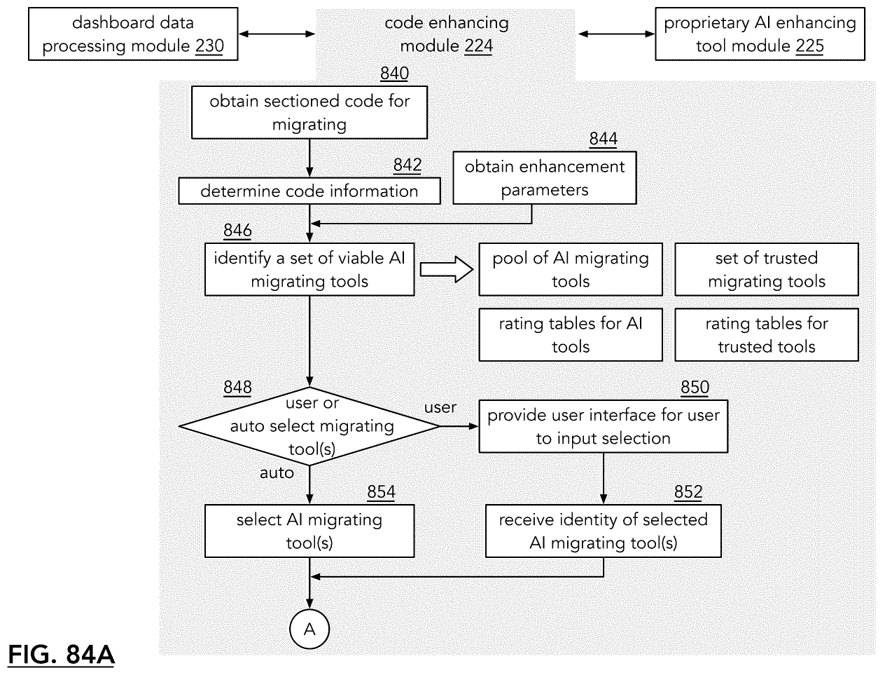

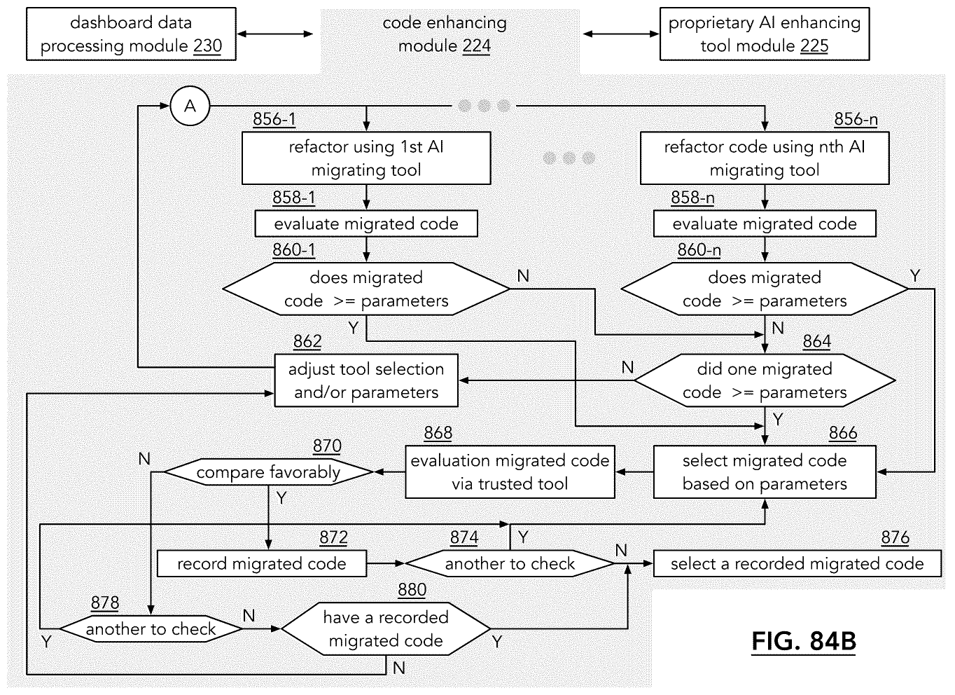

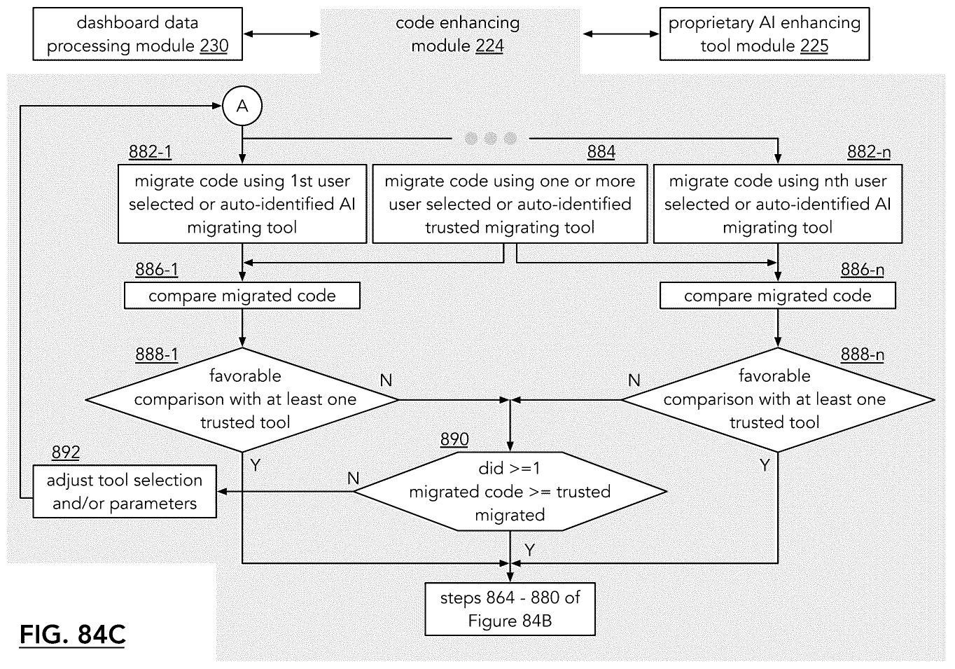

FIGS. 84A-84C are a logic diagram of an embodiment of a method for migrating code. The method begins at step 840 of FIG. 84A, where the code enhancement module 224 obtains sectioned code for migrating. The code enhancement module 224 may obtain the sectioned code in a variety of ways. For example, the code enhancement module 224 retrieves the sectioned code from the repository. As another example, the code enhancement module 224 receives it from the code sectioning module 222 of the code enhancement system 104.

The method continues at step 842, where the code enhancement module 224 determines code information, which is defined in the glossary section. The method continues at step 844, where the code enhancement module 224 obtains enhancement parameters (e.g., purpose parameters and/or operation parameters).

The method continues at step 846, where the code enhancement module 224 identifies a set of viable AI code migrating tools based on the code information and based on the parameters. The set of viable AI code migrating tools includes AI tools and/or proprietary AI tools and may further include a set of trusted tools. The code enhancement module 224 identifies the set of viable AI code migrating tools using the code information, the AI tool records (e.g., tables) 227, and/or the proprietary AI tool records (e.g., tables). If the code enhancement module 224 is including trusted tools in the set of viable tools, the code enhancement module 224 uses the code information and the trusted tool records (e.g., tables) to identify trusted tools.

For example, the code enhancement module 224 creates a use case of the code 202 and, based on the use case, finds AI tools and/or proprietary AI tools that have comparable use cases. As another example, the code enhancement module 224 selects each AI tool and/or proprietary AI tool that is identified as performing code migrating. As a further example, the code enhancement module 224 selects AI tools and/or proprietary AI tools based on their respective code migrating attributes and desired attributes for the migrating of the code 202.

The method continues at step 848, where the code enhancement module 224 determines whether the user or the system is to select the specific AI tools and/or proprietary AI tools (and, when desired, the trusted tools) to use to migrate the code. When the user has elected to select the specific AI tools via a GUI, or the like, the method continues at step 850, where the code enhancement module 224 provides set of viable AI code migrating tools to the dashboard data processing module 230, which generates a GUI that enables the user to select from the set of viable AI code migrating tools. The method continues at step 852, where the code enhancement module 224 receives identity of the selected AI code migrating tool(s) from the dashboard data processing module 230. The method continues at step 856-1 through step 856-n of FIG. 84B.

If, at step 848, the system is to auto select the AI code migrating tools, the method continues at step 854, where the code enhancement module 224 selects one or more AI code migrating tools. The method continues at step 856-1 through step 856-n of FIG. 84B, where, at step 856-1, the code enhancement module 224 migrates the code using a first AI migrating tool (or first set of AI migrating tools). If there is only one AI migrating tool or only one set of AI migrating tools, the parallel branches of the method with the -n reference number are not executed.

When there are more than one AI migrating tool or more than one set of AI migrating tools, the code enhancement module 224, at step 856-2 through -n, migrates the code using the second through the nth AI migrating tool (or nth set of AI migrating tools) to create versions of migrated code. Note that a set of AI migrating tools collaborates to produce a version of the migrated code.

The method continues at step 858-1 through -n, where the code enhancement module 224 evaluates the versions of migrated code as produced by the various combination of AI tools. The versions of the AI migrated code are evaluated using one or more AI code migrating evaluation tools. The method continues at step 860-1 through 860—n, where the code enhancement module 224 determines, based on the evaluation, whether the AI migrated code meets or exceeds the parameters.

For each of steps 860-1 through 860—n where the migrated code did not meet or exceed the parameters, the method continues at step 864, where the code enhancement module 224 determines whether at least one AI version of migrated code met or exceeded the parameters. If not, the method continues at step 862, where the code enhancement module 224 adjusts the selection of an AI migrating tool and/or adjusts a parameter. The method repeats at steps 856-1 through 856—n using the adjusted AI tools and/or based on the adjusted parameters.

For each of steps 860-1 through 860—n where the migrated code did meet or exceed the parameters and for a yes answer to step 864, the code enhancement module 224 selects one of the AI versions of migrated code at step 866. The method continues at step 868, where the code enhancement module 224 evaluates the migrated code via a trusted tool.

The method continues at step 870, where the code enhancement module 224 determines whether the evaluation of step 868 was favorable. As an example, a comparison is favorable when the AI migrated code is substantially identical to the trusted migrated code. As another example, the comparison is favorable when the trusted tool verifies the methodology and resulting migrating of the AI version of the migrated code.

When the comparison of step 870 is favorable, the method continues at step 872, where the code enhancement module 224 records the AI migrated code as having a successful evaluation. The method continues at step 874, where the code enhancement module 224 determines whether there is another version of AI migrated code to be evaluated. If yes, the method repeats at step 866. If not, the method continues at step 876, where the code enhancement module 224 selects one of the recorded versions of AI migrated code to output as the migrated code.

If, at step 870, the comparison was unfavorable, the method continues at step 878, where the code enhancement module 224 determines whether there is another version of AI migrated code to be evaluated. If yes, the method repeats at step 866. If no, the method continues at step 880, where the code enhancement module 224 determines whether there is at least one AI migrated code that has passed evaluation by the trusted tool. If yes, the method continues to step 876. If not, the method repeats at step 862.

FIG. 84C is a logic diagram of an alternative method to the method of FIG. 84B. This method branches from step 852 or step 854 of FIG. 84A. This method includes steps 882-1 through 882—n, where the code enhancement module 224 generates “n” versions of AI migrated code using “n” combinations of AI tools and/or AI proprietary tools. At step 884, the code enhancement module 224 migrates the code using a trusted tool to produce a trusted migrated code.

The method continues at steps 886-1 through 886—n, where the code enhancement module 224 compares respective versions of the AI migrated code to the trusted migrated code. The method continues at steps 888-1 through 888—n, where the code enhancement module 224 determines which of the comparisons were favorable. In an example, a version of AI migrated code compares favorably to the trusted version of migrated code when it is migrated in an identical or near identical manner as the trusted version. As another example, an AI version of migrated code compares favorably to the trusted version of migrated code when the trusted tool verifies the AI version of the migrated code.

For each of the comparisons of steps 888-1 through 888—n that was not favorable, the method continues at step 890, where the code enhancement module 224 determines whether at least one of the versions of AI migrated code compared favorably to the trusted version. If no, the method continues at step 892, where the code enhancement module 224 adjusts an AI tool and/or a parameter. The method continues at steps 882-1 through 882—n using the adjusted AI tools and/or the adjusted parameters.

For each of the comparisons of steps 888-1 through 888—n that was favorable and for a yes answer to step 890, the method continues by executing steps 864-880 of FIG. 84B.

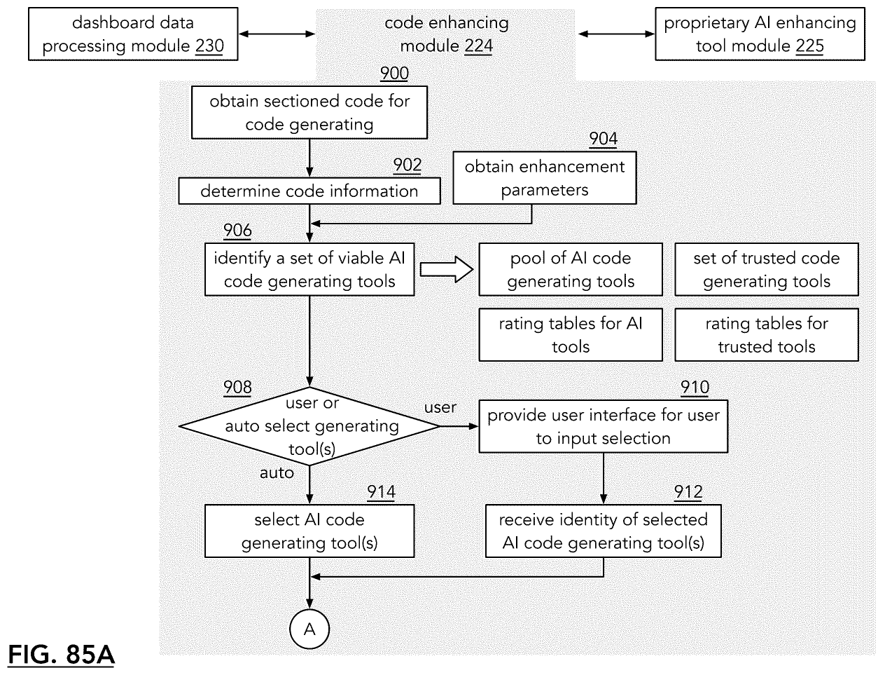

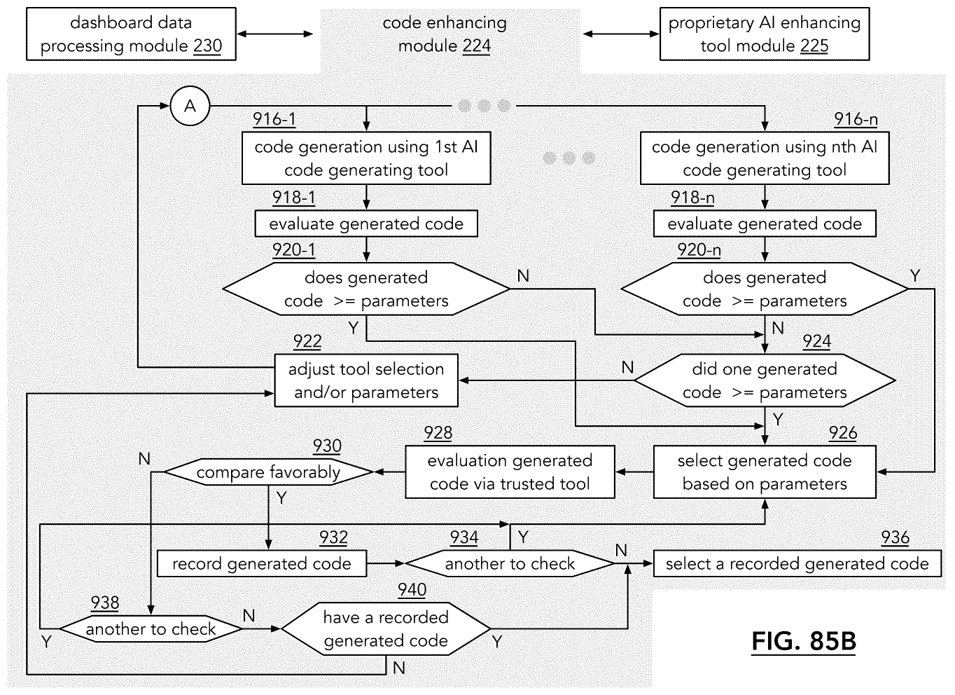

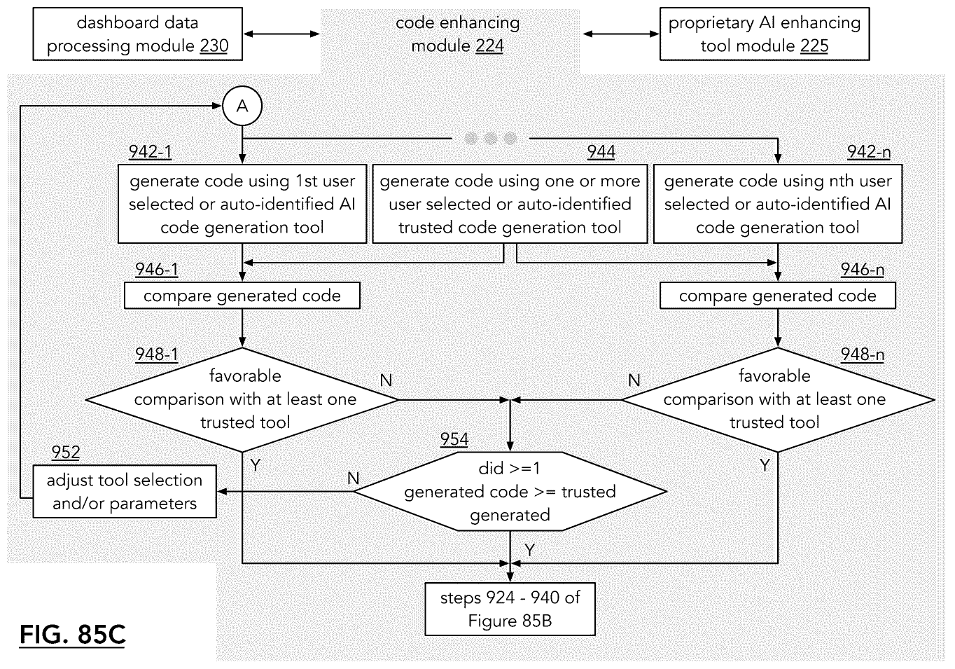

FIGS. 85A-85C are a logic diagram of an embodiment of a method for code generation. The method begins at step 900 of FIG. 85A, where the code enhancement module 224 obtains sectioned code for code generating. The code enhancement module 224 may obtain the sectioned code in a variety of ways. For example, the code enhancement module 224 retrieves the sectioned code from the repository. As another example, the code enhancement module 224 receives it from the code sectioning module 222 of the code enhancement system 104.

The method continues at step 902, where the code enhancement module 224 determines code information, which is defined in the glossary section. The method continues at step 904, where the code enhancement module 224 obtains enhancement parameters (e.g., purpose parameters and/or operation parameters).

The method continues at step 906, where the code enhancement module 224 identifies a set of viable AI code generating tools based on the code information and based on the parameters. The set of viable AI code generating tools includes AI tools and/or proprietary AI tools and may further include a set of trusted tools. The code enhancement module 224 identifies the set of viable AI code generating tools using the code information, the AI tool records (e.g., tables) 227, and/or the proprietary AI tool records (e.g., tables). If the code enhancement module 224 is including trusted tools in the set of viable tools, the code enhancement module 224 uses the code information and the trusted tool records (e.g., tables) to identify trusted tools.

For example, the code enhancement module 224 creates a use case of the code 202 and, based on the use case, finds AI tools and/or proprietary AI tools that have comparable use cases. As another example, the code enhancement module 224 selects each AI tool and/or proprietary AI tool that is identified as performing code generating. As a further example, the code enhancement module 224 selects AI tools and/or proprietary AI tools based on their respective code generating attributes and desired attributes for the code generating of the code 202.

The method continues at step 908, where the code enhancement module 224 determines whether the user or the system is to select the specific AI tools and/or proprietary AI tools (and, when desired, the trusted tools) to use to code generate the code. When the user has elected to select the specific AI tools via a GUI, or the like, the method continues at step 910, where the code enhancement module 224 provides set of viable AI code generating tools to the dashboard data processing module 230, which generates a GUI that enables the user to select from the set of viable AI code generating tools. The method continues at step 912, where the code enhancement module 224 receives identity of the selected AI code generating tool(s) from the dashboard data processing module 230. The method continues at step 916-1 through step 916-n of FIG. 85B.

If, at step 908, the system is to auto select the AI code generating tools, the method continues at step 914, where the code enhancement module 224 selects one or more AI code generating tools. The method continues at step 916-1 through step 916-n of FIG. 85B, where, at step 916-1, the code enhancement module 224 code generates the code using a first AI code generating tool (or first set of AI code generating tools). If there is only one AI code generating tool or only one set of AI code generating tools, the parallel branches of the method with the -n reference number are not executed.

When there are more than one AI code generating tool or more than one set of AI code generating tools, the code enhancement module 224, at step 916-2 through -n, code generates the code using the second through the nth AI code generating tool (or nth set of AI code generating tools) to create versions of code generated code. Note that a set of AI code generating tools collaborates to produce a version of the code generated code.

The method continues at step 918-1 through -n, where the code enhancement module 224 evaluates the versions of code generated code as produced by the various combination of AI tools. The versions of the AI code generated code are evaluated using one or more AI code generating evaluation tools. The method continues at step 920-1 through 920—n, where the code enhancement module 224 determines, based on the evaluation, whether the AI code generated code meets or exceeds the parameters.

For each of steps 920-1 through 920—n where the code generated code did not meet or exceed the parameters, the method continues at step 924, where the code enhancement module 224 determines whether at least one AI version of code generated code met or exceeded the parameters. If not, the method continues at step 922, where the code enhancement module 224 adjusts the selection of an AI code generating tool and/or adjusts a parameter. The method repeats at steps 916-1 through 916—n using the adjusted AI tools and/or based on the adjusted parameters.

For each of steps 920-1 through 920—n where the code generated code did meet or exceed the parameters and for a yes answer to step 924, the code enhancement module 224 selects one of the AI versions of code generated code at step 926. The method continues at step 928, where the code enhancement module 224 evaluates the code generated code via a trusted tool.

The method continues at step 930, where the code enhancement module 224 determines whether the evaluation of step 928 was favorable. As an example, a comparison is favorable when the AI code generated code is substantially identical to the trusted code generated code. As another example, the comparison is favorable when the trusted tool verifies the methodology and resulting code generating of the AI version of the code generated code.

When the comparison of step 930 is favorable, the method continues at step 932, where the code enhancement module 224 records the AI code generated code as having a successful evaluation. The method continues at step 934, where the code enhancement module 224 determines whether there is another version of AI code generated code to be evaluated. If yes, the method repeats at step 926. If not, the method continues at step 936, where the code enhancement module 224 selects one of the recorded versions of AI code generated code to output as the code generated code.

If, at step 930, the comparison was unfavorable, the method continues at step 938, where the code enhancement module 224 determines whether there is another version of AI code generated code to be evaluated. If yes, the method repeats at step 926. If no, the method continues at step 940, where the code enhancement module 224 determines whether there is at least one AI code generated code that has passed evaluation by the trusted tool. If yes, the method continues to step 936. If not, the method repeats at step 922.

FIG. 85C is a logic diagram of an alternative method to the method of FIG. 85B. This method branches from step 912 or step 914 of FIG. 85A. This method includes steps 924-1 through 942—n, where the code enhancement module 224 generates “n” versions of AI code generated code using “n” combinations of AI tools and/or AI proprietary tools. At step 944, the code enhancement module 224 code generates the code using a trusted tool to produce a trusted code generated code.

The method continues at steps 946-1 through 946—n, where the code enhancement module 224 compares respective versions of the AI code generated code to the trusted code generated code. The method continues at steps 948-1 through 948—n, where the code enhancement module 224 determines which of the comparisons were favorable. In an example, a version of AI code generated code compares favorably to the trusted version of code generated code when it is code generated in an identical or near identical manner as the trusted version. As another example, an AI version of code generated code compares favorably to the trusted version of code generated code when the trusted tool verifies the AI version of the code generated code.

For each of the comparisons of steps 948-1 through 948—n that was not favorable, the method continues at step 954, where the code enhancement module 224 determines whether at least one of the versions of AI code generated code compared favorably to the trusted version. If no, the method continues at step 952, where the code enhancement module 224 adjusts an AI tool and/or a parameter. The method continues at steps 942-1 through 942-n using the adjusted AI tools and/or the adjusted parameters.

For each of the comparisons of steps 948-1 through 948—n that was favorable and for a yes answer to step 954, the method continues by executing steps 924-940 of FIG. 85B.

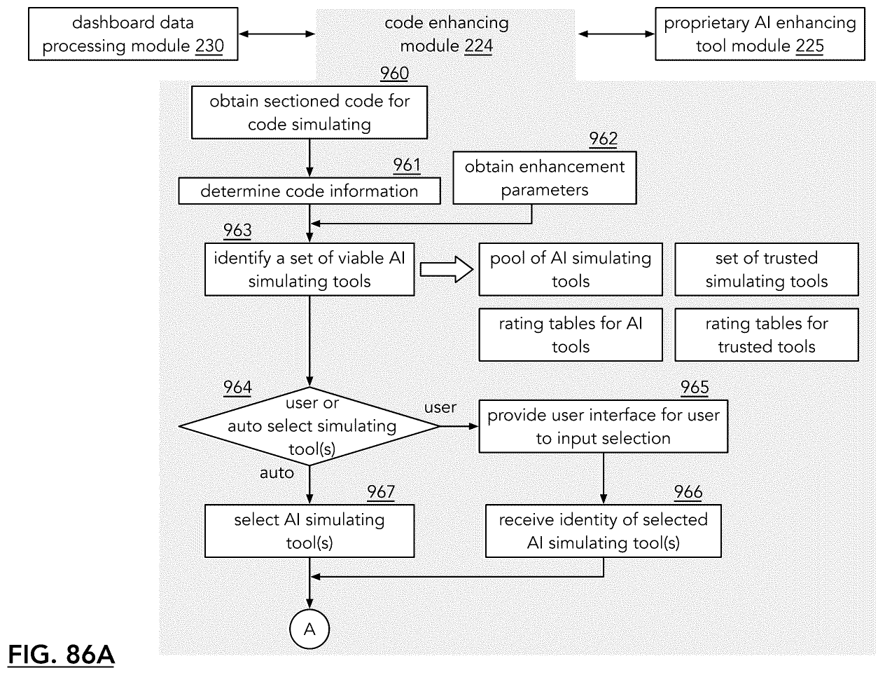

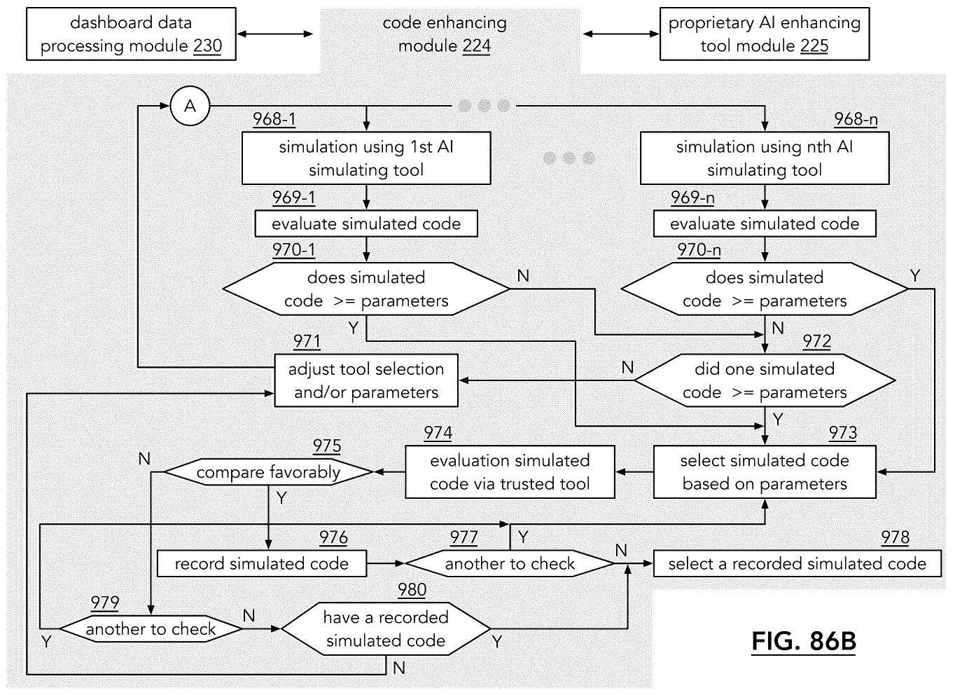

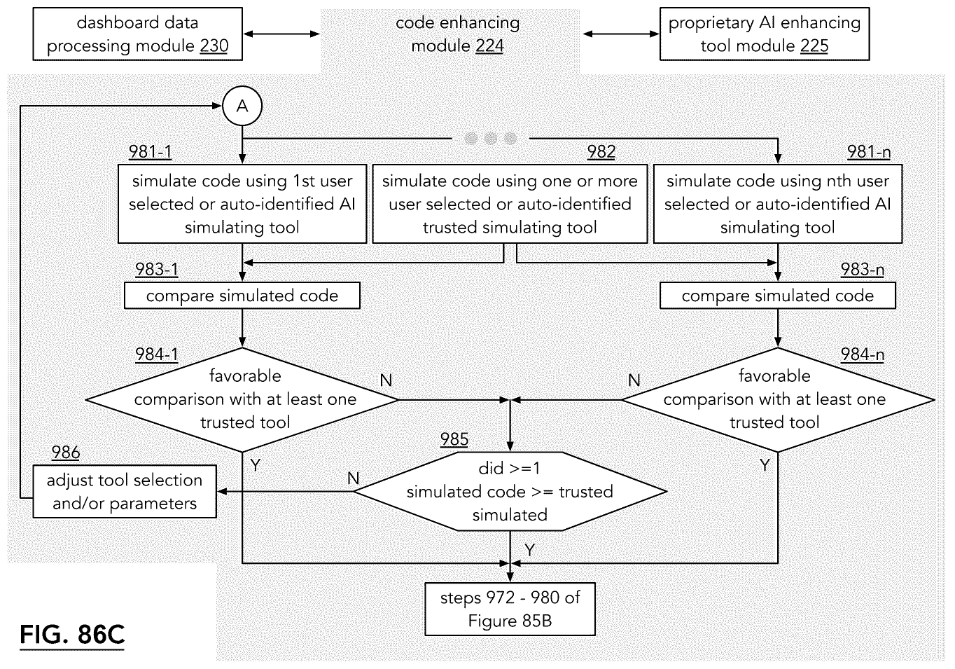

FIGS. 86A-86C are a logic diagram of an embodiment of a method for simulating code. The method begins at step 960 of FIG. 86A, where the code enhancement module 224 obtains sectioned code for simulating. The code enhancement module 224 may obtain the sectioned code in a variety of ways. For example, the code enhancement module 224 retrieves the sectioned code from the repository. As another example, the code enhancement module 224 receives it from the code sectioning module 222 of the code enhancement system 104.

The method continues at step 961, where the code enhancement module 224 determines code information, which is defined in the glossary section. The method continues at step 962, where the code enhancement module 224 obtains enhancement parameters (e.g., purpose parameters and/or operation parameters).

The method continues at step 963, where the code enhancement module 224 identifies a set of viable AI code simulating tools based on the code information and based on the parameters. The set of viable AI code simulating tools includes AI tools and/or proprietary AI tools and may further include a set of trusted tools. The code enhancement module 224 identifies the set of viable AI code simulating tools using the code information, the AI tool records (e.g., tables) 227, and/or the proprietary AI tool records (e.g., tables). If the code enhancement module 224 is including trusted tools in the set of viable tools, the code enhancement module 224 uses the code information and the trusted tool records (e.g., tables) to identify trusted tools.

For example, the code enhancement module 224 creates a use case of the code 202 and, based on the use case, finds AI tools and/or proprietary AI tools that have comparable use cases. As another example, the code enhancement module 224 selects each AI tool and/or proprietary AI tool that is identified as performing code simulating. As a further example, the code enhancement module 224 selects AI tools and/or proprietary AI tools based on their respective code simulating attributes and desired attributes for the simulating of the code 202.

The method continues at step 964, where the code enhancement module 224 determines whether the user or the system is to select the specific AI tools and/or proprietary AI tools (and, when desired, the trusted tools) to use to simulate the code. When the user has elected to select the specific AI tools via a GUI, or the like, the method continues at step 965, where the code enhancement module 224 provides set of viable AI code simulating tools to the dashboard data processing module 230, which generates a GUI that enables the user to select from the set of viable AI code simulating tools. The method continues at step 966, where the code enhancement module 224 receives identity of the selected AI code simulating tool(s) from the dashboard data processing module 230. The method continues at step 968-1 through step 968-n of FIG. 86B.

If, at step 964, the system is to auto select the AI code simulating tools, the method continues at step 967, where the code enhancement module 224 selects one or more AI code simulating tools. The method continues at step 968-1 through step 968-n of FIG. 86B, where, at step 968-1, the code enhancement module 224 simulates the code using a first AI simulating tool (or first set of AI simulating tools). If there is only one AI simulating tool or only one set of AI simulating tools, the parallel branches of the method with the -n reference number are not executed.

When there are more than one AI simulating tool or more than one set of AI simulating tools, the code enhancement module 224, at step 968-2 through -n, simulates the code using the second through the nth AI simulating tool (or nth set of AI simulating tools) to create versions of simulated code. Note that a set of AI simulating tools collaborates to produce a version of the simulated code.

The method continues at step 969-1 through -n, where the code enhancement module 224 evaluates the versions of simulated code as produced by the various combination of AI tools. The versions of the AI simulated code are evaluated using one or more AI code simulating evaluation tools. The method continues at step 970-1 through 970—n, where the code enhancement module 224 determines, based on the evaluation, whether the AI simulated code meets or exceeds the parameters.

For each of steps 970-1 through 970—n where the simulated code did not meet or exceed the parameters, the method continues at step 972, where the code enhancement module 224 determines whether at least one AI version of simulated code met or exceeded the parameters. If not, the method continues at step 971, where the code enhancement module 224 adjusts the selection of an AI simulating tool and/or adjusts a parameter. The method repeats at steps 968-1 through 968—n using the adjusted AI tools and/or based on the adjusted parameters.

For each of steps 970-1 through 970—n where the simulated code did meet or exceed the parameters and for a yes answer to step 972, the code enhancement module 224 selects one of the AI versions of simulated code at step 973. The method continues at step 974, where the code enhancement module 224 evaluates the simulated code via a trusted tool.

The method continues at step 975, where the code enhancement module 224 determines whether the evaluation of step 974 was favorable. As an example, a comparison is favorable when the AI simulated code is substantially identical to the trusted simulated code. As another example, the comparison is favorable when the trusted tool verifies the methodology and resulting simulating of the AI version of the simulated code.

When the comparison of step 975 is favorable, the method continues at step 976, where the code enhancement module 224 records the AI simulated code as having a successful evaluation. The method continues at step 977, where the code enhancement module 224 determines whether there is another version of AI simulated code to be evaluated. If yes, the method repeats at step 973. If not, the method continues at step 978, where the code enhancement module 224 selects one of the recorded versions of AI simulated code to output as the simulated code.

If, at step 975, the comparison was unfavorable, the method continues at step 979, where the code enhancement module 224 determines whether there is another version of AI simulated code to be evaluated. If yes, the method repeats at step 973. If no, the method continues at step 980, where the code enhancement module 224 determines whether there is at least one AI simulated code that has passed evaluation by the trusted tool. If yes, the method continues to step 978. If not, the method repeats at step 971.

FIG. 86C is a logic diagram of an alternative method to the method of FIG. 86B. This method branches from step 966 or step 967 of FIG. 86A. This method includes steps 981-1 through 981—n, where the code enhancement module 224 generates “n” versions of AI simulated code using “n” combinations of AI tools and/or AI proprietary tools. At step 982, the code enhancement module 224 simulates the code using a trusted tool to produce a trusted simulated code.

The method continues at steps 983-1 through 983—n, where the code enhancement module 224 compares respective versions of the AI simulated code to the trusted simulated code. The method continues at steps 984-1 through 984—n, where the code enhancement module 224 determines which of the comparisons were favorable. In an example, a version of AI simulated code compares favorably to the trusted version of simulated code when it is simulated in an identical or near identical manner as the trusted version. As another example, an AI version of simulated code compares favorably to the trusted version of simulated code when the trusted tool verifies the AI version of the simulated code.

For each of the comparisons of steps 984-1 through 984—n that was not favorable, the method continues at step 985, where the code enhancement module 224 determines whether at least one of the versions of AI simulated code compared favorably to the trusted version. If no, the method continues at step 986, where the code enhancement module 224 adjusts an AI tool and/or a parameter. The method continues at steps 981-1 through 981—n using the adjusted AI tools and/or the adjusted parameters.

For each of the comparisons of steps 984-1 through 984—n that was favorable and for a yes answer to step 890, the method continues by executing steps 972-980 of FIG. 86B.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e., machine/non-human intelligence.

As applicable, one or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

As applicable, one or more functions associated with the methods and/or processes described herein can be implemented in a system that is operable to electronically store digital data in a memory device. Such storage cannot practically be performed by the human mind because the human mind is not equipped to electronically store digital data.

The preceding technical discussion may include a discussion regarding one or more of: an advantage(s) of a solution(s) to a problem(s), a benefit(s) of a solution(s) to a problem(s), an issue(s) giving rise to a problem(s), a market need(s) for a solution(s) to a problem(s), a value proposition(s) of a solution(s) to a problem(s), and/or the like. As may be applicable, the determining of an advantage(s) of a solution(s) to a problem(s), the determination of a benefit(s) of a solution(s) to a problem(s), the determination of an issue(s) giving rise to a problem(s), the determination of a market need(s) for solving a problem(s), the determination of a value proposition(s) for solving a problem(s), and/or the like can be deemed as one or more discoveries that constitute an invention and/or constitute part of an inventive step to create an invention.

While particular combinations of various functions and features of the one or more embodiments have been expressly described herein, other combinations of these features and functions are likewise possible. The present disclosure is not limited by the particular examples disclosed herein and expressly incorporates these other combinations.

### Glossary Section

Acceptance Testing (AI Evaluation Functions) refers to gathering feedback from testing processes of a system to be used for further improvement. Acceptance testing further assists in the understanding of business requirements for individual functions of a software system.

Adapt to new technologies (Purpose Parameters) is used to adapt to technologies by designing them with the purpose of scalability and flexibility by updating and upgrading purpose parameters to tailor to emerging technologies. This in turn, produces a modular software architecture that supports emerging technologies.

Add new code to existing code (Purpose Parameters) involves extending the code's current functionality to account for advancements in technology, user demand, user feedback, etc. To adequately update, further development includes review of existing functionality of code, identify points of extension, determine new functions, and select new purpose parameters values.

Add New Features to Existing code (Purpose Parameters) ensures that features in demand based upon advancements in technology, user demand, user feedback, etc. are integrated smoothly with an existing system. This process includes but is not limited to: understanding the existing codebase, defining new features, and updating the code accordingly with new purpose parameters that are cohesive with the goals of the system.

Adhere to regulatory Requirements is regarding compliance to regulatory requirements so that software, data management processes, and/or analysis techniques comply with legal and industry standards. By configuring a system to handle different regulatory contexts dynamically, data can be managed to meet specific regulatory obligations without hardcoding rules into the system.

Behavior-driven Development (AI Evaluation Functions) refers to the development of a software system through a variety of behavior-specific testing and functional situations that outline executable scenarios for the application.

Build life cycle analysis in software refers to the efficiency and effectiveness of the various stages involved in building a software application. The build life cycle encompasses the entire process from writing code to producing deployable software artifacts. Optimizing this performance helps in accelerating software development, improving productivity, and ensuring timely delivery of high-quality software.

Build times in software refers to the duration it takes to compile source code, link it, and generate executable software artifacts. Build times impact productivity, software acceleration, feedback loops, and overall development efficiency.

Built-in Plug-in performance refers to the effectiveness and efficiency of plugins that are integrated into a software application or development environment by default. These plugins extend the functionality of the software and are designed to enhance software acceleration, productivity, streamline workflows, and provide additional features without requiring external installations.

“Code Acceleration” is software focused to achieve faster runtime performance and reduce compute usable effortlessly with GenAI, leading to lower carbon emissions and/or quicker execution speeds.

Code Coverage Analysis (AI Evaluation Functions) refers to the process of measuring how much of the codebase is exercised by automated tests. This analysis helps determine the extent to which the code has been tested, highlighting areas that may need additional testing to ensure robustness, reliability, and correctness. In the context of AI, where models and algorithms are complex, code coverage analysis helps the system behave as expected across various scenarios.

Code Generation of an application programming interface (API) is regarding one or more software generated mechanisms that enable two software components to communicate with each other using a set of definitions and protocols. They play a significant role in code generation, particularly in automating the creation of code that interacts with other software components, services, or systems.

Code Generation (Web Applications) involves the automated creation of various parts of a web application's codebase. This can significantly speed up development, reduce errors, and ensure consistency, especially in repetitive tasks or when adhering to specific frameworks and architectures. Examples include ruby on rails, Django and ASP.NET.

“Code information” means any information regarding the code, which includes, but is not limited to, the type of code (e.g., user application, system application, utility application, operating system, a sub-routine of an application or an operating system, a bug fix for an application or an operating system), the programming language, the platform (e.g., local, cloud, etc.), initial creation information, bug fix information, update information, upgrade information, previous enhancement information, documentation, etc.

Code Linting (AI Evaluation Functions) refers to the process of using lint tools called “linters” to assess software code in order to identify programmatic and stylistic issues. Code linting helps maintain a clean, readable, and consistent codebase.

“Code Optimization” is hardware focused to enhance code efficiency by leveraging LLMs for optimizing speed, memory usage, and sustainability, all while cutting down on cloud costs and technical debt.

Code Performance refers to the efficiency and speed at which a software application executes its tasks. It encompasses various aspects of how well the code runs, including execution time, memory usage, CPU utilization, responsiveness, and throughput. Code optimizations can also improve tasks by using AI language tools that assist in how code performance can be improved by making suggestions on software architecture.

Code Profiling is the process of analyzing a program to determine its performance characteristics, such as the frequency and duration of function calls, memory usage, IO operations, and CPU utilization and gives a detailed overview of such.

Code-level Diagnostics refers to the detailed analysis and troubleshooting of software code to identify, understand, and resolve issues related to performance, correctness, security, and maintainability right down to a single line of code. Issues that code-level diagnostics evaluate are bugs and poorly optimized code. These diagnostics assist to ensure the quality and efficiency of their code which in turn, leads to optimized software acceleration.

Code Metrics and Complexity Analysis (AI Evaluation Functions) refers to the assessment of the quality, maintainability, and complexity of the codebase used to develop and deploy AI systems. These analyses help ensure that the AI system is built on a solid foundation, reducing the risk of errors, improving performance, and making the code easier to maintain, extend, and debug. Code metrics gauges quality, efficiency and maintainability of a system while complexity analysis is directed toward assessing the structural complexity of the system.

Code Review/Code Inspection (AI Evaluation Functions) is an automated process conducted by an AI evaluation tool that utilizes machine learning algorithms to analyze sections of code for any potential issues that cause performance issues to a system. Code review/inspection is further utilized to ensure that the inspected code is adhering to best practices.

Compliance Audits (AI Evaluation Functions) is regarding AI tools that implement functions such as compliance audits to ensure that a system, as a whole, is complying with laws such as GDPR, CCPA and other regional data regulations. Such compliance audits can assist a system reduce the risk of legal issues that arise from non-compliance with regulations.

Compliance Testing (AI Evaluation Functions) refers to the process of assessing whether an AI system adheres to specific regulatory, legal, ethical, and industry standards. This ensures that the AI system operates within the boundaries of applicable laws and guidelines, and that it meets the necessary requirements for deployment in its intended domain.

Compiler Optimization involves techniques used by compilers to improve the performance and efficiency of the code they generate including common techniques such as: inlining, loop unrolling, constant folding, dead code elimination, common subexpression elimination, strength reduction, and register allocation. In addition to performance compiler optimization improves software acceleration by generating improved code quality and reducing energy consumption.

Compliance Checklist (AI Evaluation Functions) refers to the method of auditing a comprehensive audit of a software system to verify the systems adherence to regulatory requirements including but not limited to: organizational regulations, industry standards, and governmental regulations.

Configuration and Change Testing (AI Evaluation Functions) refers to the process of evaluating how changes in the system's configuration, environment, or version affect the performance, accuracy, and overall behavior of the AI system. This type of testing helps ensure that the AI system remains stable, reliable, and effective when updates or modifications are made. Configurations testing is directed toward how the system acts in accordance with various configurations and settings while change testing is directed toward verifying that software updates, patches, etc. do not degrade system performance.

Configuration Files are used to store configuration settings separately from the codebase. This separation allows for easier management, flexibility, and maintenance of application settings without altering the main code. Configuration files define the parameters, options, settings and preferences that are applied to operating systems, infrastructure devices, and computer programs that define the behavior of the software applications without altering source code and its implemented logic. Configurations files store information pertaining to environment settings, database connections, user preferences and application options and are normally stored in human-readable formats so that they are easily interpreted and understandable.

Context and Reasoning (Operational Parameters) refers to the understanding and interpretation of the data collected about a code to make informed decisions or take appropriate actions. Context refers to the environment and conditions in which the data is collected. Reasoning refers to the logical process of analyzing the data in context of drawing conclusions.

Deadlocks refer to a situation where two or more processes are unable to proceed with their execution because each process is waiting for the other to release a resource that it needs. This creates a cycle of dependencies that prevents any of the involved processes from continuing. While deadlocks are typically discussed in the context of multi-threading and resource allocation, they can also occur in memory management, particularly in systems with sophisticated memory allocation strategies. With improved software optimization where memory allocation, memory leaks and overall memory management is optimal, an application may avoid Memory Deadlocks and improve overall software acceleration.

Documentation Review (AI Evaluation Functions) refers to the process of systematically evaluating the documentation associated with code to ensure that it is accurate, comprehensive, clear, and useful for all intended stakeholders.

Documentation Translation refers to a system's ability to translate a document from one format/language to another. For example, a first format being a word document translated into a second format being a PDF. Examples of documentation that are capable of being translated include but are not limited to: user documentation, In-application text, technical documentation, legal and compliance documents, marketing and sales material, internal documentation.

Dynamic Baselining refers to the process of establishing performance benchmarks that automatically adjust over time based on the observed behavior of a software application over the development or maintenance period of a project. These baselines help in identifying anomalies and performance issues by comparing current and past metrics against a dynamically updated reference point which can be an obvious indicator of the level of software acceleration of a system.

Dynamic Code Analysis (AI Evaluation Functions) refers to the examination and evaluation of the AI system's code and behavior while the program is running. Unlike static code analysis, which examines the code without executing it, dynamic analysis focuses on monitoring and evaluating the code during execution to identify runtime issues, performance bottlenecks, and other operational behaviors.

Embedded systems (e.g., specialized computing systems that perform dedicated functions or tasks within a larger mechanical or electrical system) simulations refer to the process of using software to model and analyze the behavior of embedded systems. These simulations assist engineers in designing, testing, and validating embedded systems before deploying them in real-world applications.

Embedded systems simulation (electrical) is regarding an embedded system simulation of an electronic circuit involves creating a virtual model of an electronic circuit integrated with an embedded system to study, analyze, and test its behavior before actual hardware implementation. This type of simulation helps in verifying the design, identifying potential issues, and optimizing performance without the need for physical prototypes. It is widely used in the development of complex embedded systems in various industries, including automotive, aerospace, consumer electronics, and industrial automation.

Embedded systems simulation (mixed signal) is regarding an embedded system simulation of a mixed-signal circuit (e.g., electronic circuit that processes both analog and digital signals) involves creating a virtual model of a system that includes both analog and digital components integrated with an embedded system. Mixed-signal circuits are commonly found in sensor interfaces, communication systems, and data converters. Simulating these circuits allows for comprehensive analysis and testing of the entire system's behavior, ensuring that both analog and digital components work harmoniously before physical prototypes are developed.

Error Tracking refers to the systematic process of detecting, recording, analyzing, and managing errors that occur within a software application so that a developer can ultimately resolve issues occurring in the system that will substantially improve software acceleration. Types of error tracking include frontend error tracking and backend error tracking where frontend error tracking focuses on the bugs occurring in software code where backend error tracking relates to page exceptions and script errors.

Excessive Memory Use refers to a situation where a software application consumes more memory than necessary, leading to inefficient use of system resources. This can result in degraded performance, increased latency, reduced system stability, and, in severe cases, system crashes or out-of-memory errors. Causes of excessive memory use include but are not limited to: Memory Leaks, Inefficient Algorithms, Large Data Structures, Unreleased Resources, Duplicate Data, Caching Without Limits, Retaining Unused Objects and Fragmentation.

Execution Time refers to the overall time a system takes in order to complete a specific task including the execution times of individual nodes and time spent on system services. Measuring and optimizing execution time involves identifying performance bottlenecks, selecting efficient algorithms, and making various code and system-level improvements. Specific factors that determine execution time include but are not limited to Wall-clock time, CPU time, Latency periods, and throughout. Factors affecting execution time include but are not limited to Memory access patterns, system resource availability, concurrency and parallelism, and compiler optimization.

Expand Functionality of Code (Purpose Parameter) refers to modifying or extending the existing codebase to support additional operations, use cases, or behaviors based on the values of these parameters. This process allows the code to handle new scenarios without duplicating or overcomplicating the existing logic. This process includes but is not limited to reviewing existing code functionality, identifying existing codes gaps inefficiencies, and defining new purpose values for purpose parameters.

Extract Method is a software refactoring technique used to improve code readability, maintainability, and reusability. It involves identifying a block of code within a method that performs a distinct function or task and then moving that block of code into a new method with a descriptive name. This new method is then called from the original location. This technique helps simplify complex methods, reduces code duplication, and clarifies the intent of the code. The extractor method is applicable to software architectures that are long, complex, and difficult to understand and where there are similar blocks of code that perform the same function, appear in multiple locations.

Framework-Specific Practices refers to specific practice in software development that helps manage changes to code, facilitates collaboration, sections code in accordance to a particular framework, and maintains a history of the project's evolution. By following best practices, developers can ensure that their projects are well-organized, maintainable, and scalable.

Functions and Methods differ from each other; however, both are constructs in software programming that help section code by encapsulating specific tasks and behaviors. Functions are self-contained modules or blocks of code that perform a specific task in accordance with parameters that return a value when executed. Methods are functions that are associated with a particular object when executed and have the ability to modify the data of the object they are called on to execute. Key differences between functions and methods are functions, are stand alone and can be used anywhere in the program whereas methods belong to a particular class. Functions do not have access to instance data (e.g., data within a field pertaining to a class. For example: year, make, and model are all data instances of a vehicle) unless explicitly passed by the function whereas methods automatically have access to instance data.

Full Stack Monitoring is an approach to monitor all types of resources and integrates all monitoring techniques. Full stack monitoring's comprehensive tracking and analysis of all layers and components of a software application, from the front-end user interface to the back-end servers and databases, and including the underlying infrastructure. This holistic approach helps ensure optimal performance, quick detection of issues, and overall system reliability. This approach helps optimize software acceleration by gauging a system's overall performance and assist in remediating any issues that occur within the system.

Fuzz Testing (AI Evaluation Functions), commonly referred to as “Fuzzing”, refers to a software technique that introduces unexpected inputs into a system in order to determine defects and vulnerabilities of the system. The overall goal of fuzzing includes but is not limited to identifying bugs, flawed software code, software performance issues, and security issues.

General Code Generation refers to software techniques or systems that generate program code which may be used independently based on inputs and characteristics. General code generation includes but is not limited to template-code based generation, model-driven code generation, domain-specific code generation, domain-specific code generation, scaffolding, code generators in integrated development environments, APIs and SDKs, and database code generation.

Hardware in-loop simulations: (HIL) simulations refer to a testing methodology where real hardware components are integrated into a simulation environment to create a hybrid system. This approach allows for comprehensive testing and validation of hardware and software in a controlled, repeatable environment. HIL simulations are widely used in various industries, including automotive, aerospace, robotics, and industrial automation, to ensure that systems behave as expected before deploying them in real-world conditions. Different types of testing include but are not limited to real-time simulations, hardware integration, and closed-loop testing.

Header Comments are comments placed at the beginning of a file, function, or section of code to provide information about the code. Header comments improve code readability and maintainability by providing context to the code, including the original author. Additionally, header comments within code makes the contents more understandable and easier to navigate in a collaborative environment. It should be noted that header comments are not a part of code functions and will be ignored by the compiler but can be used to identify sections of code.

Hotspot analysis is a common approach for optimizing software acceleration. It is a technique used to identify the parts of a software application that consume the most resources, such as CPU time, memory, or I/O operations. These parts, known as “hotspots,” which are critical areas where optimization efforts can have the most significant impact on overall performance. By focusing on hotspots, developers can improve the efficiency and speed of an application more effectively than by making broad, unfocused changes.

Improve Data Analysis (Purpose Parameters) involves customizing the analysis process to suit specific goals, contexts, or requirements. This can help tailor the data analysis pipeline, optimize performance, and ensure that the analysis is aligned with the intended outcomes.

Improve Data Management (Purpose Parameters) allows for customized data operations to be used for specific needs of a software program. Data management can optimize data storage, improve data processing, enhance data security, improves data integrity and helps conduct efficient data retrieval.

Improve Execution Speed (Operational Parameters): is regarding the improvement of the execution speed of software by providing insights into performance bottlenecks, enabling optimization, and ensuring efficient resource utilization. Employing effective operational parameters can help identify performance bottleneck issues, help improve adequate resource allocation, assists with efficient load balancing, reduces startup and initialization time etc.

Improve Hardware Efficiencies (Purpose Parameters) allows greater cohesiveness between hardware and associated software based on specific tasks to be performed. Better optimization of hardware capabilities and lowering its resources helps better the overall efficiency of a system. For example, leveraging a GPU's processing power to perform a resource draining task can preserve CPU processing power.

Improve Interoperability (Operational Parameters) is regarding the improvement of interoperability of a software system with another software system, or by software components within the system, by providing insights and data that help ensure the system can effectively communicate, exchange data, and operate with other systems, platforms, and/or components.

Improve Maintainability (Operational Parameters) is regarding the improvement of maintaining software by providing insight and feedback that help streamline the identification of issues, guide best practices, and support efficient maintenance processes.

Improve Performance (Operational Parameters) is regarding the improvement of performance of software by providing real-time insights into how the system is functioning, identifying bottlenecks, and guiding optimizations. Ways in which effective use of operational parameters improve performance of a software system include but are not limited to: tracking CPU usage, monitoring memory allocation, network latency tracking, tracking dynamic resource scaling, etc.

Improve Portability (Operational Parameters) is regarding improvement of software by providing insights that help ensure the system can run effectively across different environments, platforms, and configurations.

Improve Robustness (Operational Parameters) is regarding the improvement of the robustness of software by providing data and insights that help identify potential issues, guide preventive measures, and enhance the system's ability to handle unexpected situations. The methods in which robustness of software can be improved include but are not limited to: tracking early occurrences of errors, monitoring resource usage and allocation, fault tolerance and remediation metrics, monitoring resiliency to unpredicted environments and conditions, predictive maintenance, etc.

Improve Scalability (Purpose Parameters) is regarding the improvement of scalability software by providing data and insights that help ensure the software can run effectively across different environments, platforms, and configurations. As used herein, scalability refers to software's ability to handle an increased amount of tasks and include, but is not limited to, performance scalability, horizontal scalability, vertical scalability, database scalability, network scalability, software architecture scalability, cost scalability, and/or operational scalability.

Improve Software Efficiencies (Purpose Parameters) is regarding the improvement of software efficiencies with regard to performance, maintainability, execution time, scalability, etc.

Improve Software Integrity (Purpose Parameters) is regarding the improvement of software integrity by designing software so that specific operations are governed by context-aware rules and behaviors. This assists software in maintaining its reliability, consistency, and security across different scenarios. Software integrity can be improved through: context-aware validation, purpose-driven error handling, controlled feature activation, environment-specific configurations, purpose-based data integrity checks, version control rollback mechanisms, automated testing and verification, enhanced logging and monitoring, controlled data manipulation and access control and permissions.

Improve User Efficiency (Purpose Parameter) is regarding improvement of user efficiency by tailoring the software's behavior, interface, and operations to specific tasks or contexts. By dynamically adapting the software to the user's current needs, purpose parameters can help streamline workflows, reduce unnecessary steps, and ensure that users can complete their tasks more quickly and effectively.

Improve User Experience (Purpose Parameter) is regarding the improvement of user experience by making software intuitive, flexible and responsive overall, aligning with the needs of a user. This can be done by tailoring code to the user's exact needs or to learn the user's function and adapt accordingly.

Improve User Productivity (Purpose Parameter) is regarding the improvement of user productivity by customizing software behavior, interfaces, and workflows to align with specific tasks or goals. By tailoring the software to the user's current needs, purpose parameters help streamline processes, reduce unnecessary actions, and ensure that users can focus on their most critical tasks.

Increase Parallelism (Operational Parameter) is regarding an increase in parallel section of threads of code, processes, etc. Increasing parallelism can be enhanced by identifying bottlenecks, bugs and overall performance issues to help optimize system functions. Techniques to increase parallelism include, but are not limited to: monitoring thread usage metrics, monitoring the size of a thread pool and overall thread management, load balance monitoring, asynchronous processing, hardware acceleration, etc.

Inline Metho is a technique in software refactoring where the software code of a method is moved to where it is being called upon where the method is. This method assists in replacing the usage of static, instance, and method extension within its body and optionally removes the method declaration. In typical cases, since this method moves faster than normal functions, the inline method is used when there are long methods in the software code and the function calls embedded in the sections of code are bottlenecking overall performance. For example, if software code contains long unnecessary blocks of code, the inline method is able to break the code down into smaller more manageable sections.

Integrated Development Environment (IDE) is a software application that provides a comprehensive suite of tools and features to facilitate software development. An IDE typically combines a code editor, compiler or interpreter, debugger, and other development tools into a single interface, making it easier for developers to write, test, and debug their code efficiently.

Integrated Development Environment (IDE): is a software application that provides a comprehensive set of tools for software development in a single, unified interface. An IDE is designed to streamline the development process by integrating all the necessary tools that a developer needs, such as a code editor, compiler or interpreter, debugger, and more, into one cohesive environment.

Integration Testing (AI Evaluation Functions) refers to a methodology of testing individual units or components of a software system to ensure that the interactions between them are functioning as intended. Although integration does focus on individual units, the main purpose for the testing is to ensure the cohesiveness of the system as a whole.

Internet and Network Protocols refer to the rules and conventions for communication between network devices. Simulating these protocols allows researchers, developers, and engineers to study, test, and optimize network behaviors and interactions without the need for physical hardware. This practice assists in the understanding of how different protocols function under various conditions and for developing new protocols and network solutions. Protocols include but are not limited to: transmission control protocol, internet protocol, user datagram protocol, hypertext protocol, hypertext transfer protocol, file transfer protocol, simple mail transfer protocol, domain name system, dynamic host configuration protocol and border gateway protocol.

LCNC: Stands for Low-Code/No-Code development, which refers to a software development approach that allows the creation of applications and workflows using visual tools, drag-and-drop interfaces, and pre-built templates rather than writing code manually. LCNC software includes features that make the lack of experience easier to navigate by offering drag and drop interfaces, visual workflow designs, pre-built templates and components, easy data integration and management, cross-platform capabilities, customizable logic, and collaboration tools.

LCNC (Business Processes) is regarding the use of the resources and flexibility of LCNC software platforms to identify business processes and/or particular processes that impact the use of software in a business setting. These platforms empower businesses to streamline operations, reduce manual work, and enhance productivity by allowing users, even those with limited technical expertise, to build and deploy applications that automate and manage various business processes.

Low-Code/No-Code (LCNC—Mobile App) assists in the creation of a mobile application.

LCNC (Visual User Interface) is regarding a visual user interface in the context of Low-Code/No-Code (LCNC) development refers to the graphical interface provided by LCNC platforms that allows users to design, develop, and manage applications without needing to write traditional code. This interface is highly visual and intuitive, enabling users to create applications by manipulating graphical elements rather than coding directly. Common visual interfaces used are: Out Systems Development environment which utilizes drag and drop tools such as buttons, text boxes, forms, and charts to provide a user greater understanding of their specific needs that software architecture can provide.

LCNC in system integration refers to the process of connecting and coordinating different software systems, applications, and data sources to work together within a low-code or no-code environment. This integration enables these systems to share data, automate workflows, and function cohesively without the need for extensive custom coding.

Layer and Component Recognition is used in sectioning software by identifying and organizing different parts of a software system into distinct layers and components. Each layer and component has a specific responsibility and interacts with other parts of the system in a well-defined manner making the system modular and easy to manage.

Logical Separation refers to the practice of organizing code and system components in a way that separates different concerns, functionalities, or layers logically. This helps improve readability, maintainability, scalability, and modularity of the codebase.

Management system translation functions to manage the localization and translation of language assets (e.g., assets that gather, maintain and process data) such as a content management system (CMS), enterprise resource planning (ERP) system, or customer relationship management (CRM) system-so that it can operate in a different environment, be integrated with other systems, or meet new business requirements.

Memory Access Patterns refer to the way in which a system reads from and/or writes to a secondary memory. Optimizing these patterns can impact the performance of an application because modern CPUs rely heavily on efficient memory usage to achieve high performance. Understanding and improving memory access patterns can lead to better cache utilization, reduced memory latency, and overall faster execution of software which leads to improved software acceleration.

Memory Deadlocks refer to a situation where two or more processes are unable to proceed with their execution because each process is waiting for the other to release a memory resource that it needs. This creates a cycle of dependencies that prevents any of the involved processes from continuing. While deadlocks are typically discussed in the context of multi-threading and resource allocation, they can also occur in memory management, particularly in systems with sophisticated memory allocation strategies. With improved software optimization where memory allocation, memory leaks and overall memory management is optimal, an application may avoid Memory Deadlocks.

Memory Debugging is the process of a developer manually or with the use of an AI tool, finding defects or inefficiencies in software code while resolving said defects and inefficiencies.

Memory Leaks occur when a process that has allocated memory and fails to free the required memory. Memory leaks may also occur when a program incorrectly manages memory allocations, resulting in memory that is no longer needed not being released back to the system. This causes the program to consume increasing amounts of memory over time, which can lead to degraded performance and eventually cause the application or the entire system to run out of memory and crash. Specific causes of memory leaks include but are not limited to: dangling references, circular references, unreleased resources, improper memory management as stated above, and persistent data structures. Signs that memory leak is occurring are system degradation including experiencing slow processing speed, lack of memory availability, system instability (crashes).

Memory Management is a technique that is applied in optimizing computers' main memory dynamically and determining the allocation of resources to applications requiring memory and applications needing less or no memory. Effective memory management ensures that a program uses memory efficiently, preventing memory leaks, fragmentation, and other issues that can degrade performance or cause a program to crash.

Microarchitecture Exploration refers to the process of investigating and optimizing the low-level hardware details of a computer system's microarchitecture to improve the performance of software applications. This involves understanding how the underlying hardware executes instructions and utilizes resources such as CPU cores, caches, memory, and pipelines. By exploring and tuning these details, developers can optimize their software to better leverage the capabilities of the hardware, resulting in more optimal software acceleration.

Microservice Recognition refers to the identification and division of a software architecture into a collection of loosely coupled, independently deployable services. Microservices are a style of software architecture where a large application is composed of small, independent services that communicate over well-defined APIs. Each microservice is focused on a specific business function and can be developed, deployed, and scaled independently.

Migration (Purpose Parameter) refers to the process of transitioning data, software, or systems from one state, version, environment, or platform to another. When a purpose parameter involves migration, it typically dictates how this transition should occur, ensuring that the migration process aligns with the specific goals or requirements of the task.

Model-based Testing (AI Evaluation Functions) refers to the systematic approach for a system to develop test cases from system requirements from a system under test. The objective of Model-based testing is to evaluate a software's capabilities, efficiency and reliability by automating task execution, data validation and error identification.

Model Driven Development is a software development approach that focuses on creating and exploiting abstract models as the primary artifacts of the development process. In MDD, these models represent the structure, behavior, and functionality of the software system and are used to generate, analyze, and evolve the actual code automatically or semi-automatically.

Modular Recognition refers to the ability of system software and tools to manage modular components of a codebase promoted by various software code languages. This involves identifying sections of a code, understanding, and utilizing discrete, self-contained modules that can be developed, tested, and maintained independently but work together to form a complete application. Building software structure that adheres to modular design principles results in a flexible, and desirable software system.

Modules and Packages are concepts for organizing and sectioning code in a way that breaks down complex systems into smaller more manageable parts.

A module is a single file that can be imported into another module or program that contains code. Modules are used to break down large programs into smaller, manageable, and organized files. Each module can define functions, classes, and variables, and can include runnable code that perform a specific task.

A package is a collection of modules organized into a directory hierarchy. Packages allow for a hierarchical structuring of the module namespace using dot notation. This helps in organizing large codebases into sub-packages and modules.

Move Field is a software refactoring technique similar to Move method, however, is in regard to a field. Move field is used to enhance the design and maintainability of a codebase by relocating a field (or member variable) from one class to another. This technique is typically applied when a field is more relevant to another class based on its usage, thereby improving cohesion, reducing coupling, and aligning the field's responsibility with the appropriate class. When the move field technique is properly applied, it leads to cleaner, modular, and more robust software.

Move Method is a software refactoring technique used to improve the design and maintainability of a codebase by relocating a method from one class to another. This refactoring is typically used when a method is more relevant to another class due to its functionality, dependencies, or the data it operates on. Moving a method can enhance code cohesion, reduce coupling, and better align with the principles of object-oriented design. The move method also occurs when a method is used to move in another class than its own class. The original method of the old class is then turned into a reference to the new method.

Multiple Domain System simulations are regarded as prominent approaches for co-dependent system designs and refer to the method of simulating systems across one or more systems that interact with each other. Multi-domain simulations help in capturing the comprehensive behavior of such systems by integrating models from various domains into a cohesive simulation framework. Challenges that face multiple domain system simulations include model integration due to multiple systems following a specific complex framework.

Mutation Testing (AI Evaluation Functions) refers to a testing technique used to evaluate the quality and effectiveness of the existing test suite by intentionally introducing small changes or “mutations” into the code and then checking if the test suite can detect these changes. Mutation testing identifies weaknesses in the test cases, ensuring that they are thorough enough to catch potential errors in the AI system.

Namespaces are used to section and structure software code effectively by organizing software code and prevent naming conflicts. By grouping related identifiers and defining scopes, namespaces enhance code organization, modularity, and maintainability. Different programming languages implement namespaces in various ways, but the core principles remain the same; they provide a structured way to manage and access different parts of a codebase.

Network Simulation refers to a technique where a software program replicates the behavior of a real network in order to gauge functionality and collect important metrics and allows researchers, engineers, and network administrators to study network protocols, configurations, and scenarios without the need for physical hardware. Network simulation assists in designing, testing, and optimizing network infrastructures and protocols.

Object-oriented programming (OOP) focuses on sectioning software design around data or objects (e.g., an instance of a class) rather than functions and logic. Object-oriented programming helps create software that is modular, reusable, and easy to maintain that aims to make software design more intuitive when applied to real-world scenarios.

Parallelism divides a task into multiple smaller subtasks that can be executed simultaneously by multiple threads on separate CPUs. This approach leverages multi-core processors to improve the performance and efficiency of software applications by executing multiple operations concurrently. Effective thread parallelism can significantly reduce the execution time of computationally intensive tasks and enhance the overall responsiveness of an application ultimately improving the software acceleration of applications.

Parameter Object refactoring technique is used to simplify method signatures and improve code readability by grouping related parameters into a single object. This technique is particularly useful when a method has several parameters that are logically related, making the method calls more concise and manageable.

Pattern Recognition is used in sectioning software by identifying an application of design patterns that provide reusable solutions to common problems or challenges encountered in software design. Types of design patterns include creational patterns that deal with object creation mechanisms, structural patterns that deal with object composition or structure, and behavioral patterns that deal with object interaction and responsibility.

Performance bottlenecks refer to specific parts of a software application that significantly limit its overall performance. These bottlenecks slow down the application, causing inefficiencies that can affect the user experience and system resource utilization. Types of Performance bottlenecks include but are not limited to CPU bottlenecks, memory bottlenecks, I/O bottlenecks, Network Bottlenecks, and synchronization Bottlenecks.

Performance and Load testing refer to a method of assessing an AI systems ability to handle specific task efficiently under stress, high demand and other environments. Performance testing is an evaluation that gauges speed, accuracy and resource utilization while load testing is how the system behaves under dynamic workload.

Physical phenomena refers to the modeling and analysis of natural and man-made processes and behaviors that occur in the physical world. These phenomena encompass a wide range of disciplines, including physics, chemistry, biology, engineering, and environmental science. By simulating physical phenomena, software can predict and visualize how systems and materials behave under various conditions, enabling researchers and engineers to study and optimize complex systems without the need for physical experiments.

Mitigate Intellectual Property Risk (operational Parameters) is effectuated by providing insights and controls that help protect proprietary information, prevent unauthorized access, and/or detect potential infringements. Effective uses include, but are not limited to, monitoring encryption during transmission or storage, transfer logging, the utilization of data loss prevention tools with operational parameters, regulatory compliance tracking, etc.

“Quality of Code” refers to following established practices for readability, maintainability, efficiency, etc.

Quality (Operational Parameters) is regarding real-world data and insight that can be used to optimize and enhance software reliability and user experience. In addition, quality is regarding optimization, reliability and scalability, security enhancements including monitoring access patterns more efficiently and patch management, and/or user experience improvements such as user data interaction.

Reduce CPU Usage (Operational Parameters) is regarding the reduction of CPU usage by code, which involves obtaining detailed insights into how processing resources are being utilized, identifying inefficiencies, and/or guiding optimizations.

Reduce Manufacturing Costs (Purpose Parameters) involves dynamically adjusting the manufacturing processes, resource allocation, and/or workflow configurations to optimize efficiency, minimize waste, and enhance productivity, which can further be adjusted to adapt to different production scenarios, materials, and goals, leading to cost-effective operations.

Reduce Memory Storage (Operational Parameters) can be accomplished by providing insights into how memory is being used, identifying inefficiencies, and guiding optimization efforts. Ways in which operational parameters can help in reducing memory storage include but are not limited to: memory usage monitoring, data compression and optimization, interprets how data structures are employed, cache performance tracking, etc.

Refactoring is regarding a process of restructuring existing computer code without changing its external behavior. The primary goal of refactoring is to improve the code's internal structure, making it more readable, maintainable, and efficient. Here are some key aspects and benefits of code refactoring.

Regression Testing (AI Evaluation Functions) refers to the method of testing a software system following changes to ensure proper and intended function of individual units of the system and the system as a whole. This assists in maintaining software stability and minimize risks associated with software updates.

Real-time Performance refers to a system's ability to process data sets within a time constraint. Real-time performance in the context of software acceleration includes but are not limited to: determinism, latency, throughput, and Jitter. For example, reducing the latency period that occurs between receiving an input and generating an output by an application increases software acceleration. As mentioned, other aspects such as Jitter (e.g., a system's response time) increase software acceleration by executing tasks quicker, optimizing overall system performance.

Regions refer to specific sections of software code with a user-defined name that are grouped together commonly used in integrated development environments that support code folding or outlining making interpreting long lengths of code easier and more manageable to navigate.

Rename Variable is a method in software refactoring that adds more clarity to a section of code by renaming a variable to a more appropriate one. Renaming a variable can help understand the purpose of the usage of variables in software architecture more clearly and enhances code quality.

Replace Condition with Polymorphism is a refactoring technique used to eliminate complex conditional logic (like if or switch statements). Polymorphism allows objects of different types to be treated as if from a common object type and/or it allows different object types to be represented by a single object interface, enhances flexibility, extensibility, and reusability of code.

Replace Temp with Query is a software refactoring technique where a temporary variable (temp) that holds the result of an expression is replaced with a method call (query) that returns the result of that expression. This technique improves code readability, maintainability, and reduces duplication by encapsulating the logic in a method call rather than scattering it throughout the code. This technique is applicable to situations where, the temporary variable makes the code less readable and a query would make the code more intuitive and understandable. This technique is further applicable where a temporary variable is needed in multiple instances and hiding complex logic functions.

Root-cause analysis (RCA) refers to the process of identifying the fundamental underlying causes of problems, defects, or issues within a software system. The goal is to determine what caused the problem, so that effective solutions can be implemented to prevent recurrence.

Requirement Traceability (AI Evaluation Function) refers to the ability to track and link each part of the AI system's code, design, and behavior back to its original requirements. This helps ensure that all specified requirements are addressed and that the system meets its intended purpose.

Scalability refers to a system's ability to handle an increasing amount of work or to be easily expanded to accommodate growth. This concept helps determine how well a software system can adapt to increasing demands, such as more users, larger datasets, or more complex computations, without sacrificing performance or functionality.

Security (Operational Parameters) of software can be enhanced by providing insights into how the software behaves in real-world scenarios, detecting potential vulnerabilities, and ensuring that security measures are effectively mitigating risks. Using operational parameters effectively can help improve anomaly detection and remediation of a system, level of vulnerability to attacks, access and authentication control, and incident response.

Security Testing (AI Evaluation Functions) refers to a method of checking a system's level of vulnerability, resiliency towards potential risks and gauges overall system weaknesses. These vulnerabilities can be created by anything from system software flaws to outdated system software.

Snippet recognition in the context of software development refers to the ability of a code editor, integrated development environment (IDE), or other programming tools to recognize and handle small, reusable sections of code, known as snippets. These snippets can be templates for common coding patterns, boilerplate code, or frequently used functions and structures.

Software Component Translation refers to the method of converting any software components to functioning in a different environment, framework or software language than that of what they were developed for.

Spoken Language Translation is a method of converting spoken phrases from one language to another in real-time or sometime after the language has been spoken. This also includes translating phrases in a language into subtitles.

Static Code Analysis (AI Evaluation Functions) refers to the automated examination of AI code without actually executing the program. The purpose is to identify potential errors, security vulnerabilities, code quality issues, and adherence to coding standards. Static analysis assists in AI development due to the complexity of algorithms and the need for reliable and efficient code.

Sub-Routine is a set of operational instructions of a particular programming language that performs a specific task within the code. A sub-routine may also be referred to as a procedure, a function, or a method. Sub-routines are a fundamental building block is developing code and include one or more of encapsulation, can be called multiple times at various parts of the code, can accept parameters inputs and/or output parameters, can include a plurality of smaller sub-routines, may be part of a bigger sub-routine, and return a value of further use by the code.

Synchronization refers to the cooperative act and coordination of two or more threads to ensure that they can safely access shared resources without causing data corruption or inconsistencies by a thread reaching a known point of operation in relationship to other threads before continuing. In a multi-threaded environment, threads often need to read from or write to shared data structures, and synchronization mechanisms are used to control the access to these shared resources.

System Simulation refers to the process of studying how changing characteristics of variables, code structure and other elements of software affect a system as a whole. Computer models are used to replicate this allows for analysis, design, and/or optimization of a system in a virtual environment without the cost and risk associated with physical prototypes or operational disruptions. Types of system simulations include but are not limited to: discrete event simulation, continuous simulation, agent-based simulation, Monte Carlo simulation and Hybrid simulation.

System Testing (AI Evaluation Functions) refers to a comprehensive assessment of a system to identify defects, validate a system's functionality, and ensure its overall quality and functionality to operate in a real-world environment.

Task Execution Time refers to the duration it takes for individual tasks or operations within a software application to complete.

Test-Driven Development (AI Evaluation Functions) is a software development approach where tests are written before the actual code is implemented. This methodology helps ensure that the AI models and components are designed to meet specific requirements from the outset, fostering high-quality, reliable, and maintainable code.

Thread Contention affects software acceleration where two or more threads attempt to access the same resource at the same time causing increased latency periods, slower system processing, and overall reducing system performance. Additional causes of thread contention include but are not limited to: high frequency of lock acquisitions, long critical sessions insufficient resources and or insufficient resource allocation, poor lock granularity and resource deadlock.

Thread Utilizations refers to the use of threads to maximize the performance and efficiency of a software application. It involves ensuring that threads are actively performing useful work rather than being idle or waiting for resources. High thread utilization means that the available threads are being used efficiently, leading to better parallelism and improved overall performance. Threads enable concurrent execution of tasks within a single process, allowing for more efficient use of CPU resources and improved application performance, especially on multi-core processors.

Transaction Tracing is a method that includes monitoring and debugging to track the flow and execution of transactions within a system. It involves recording detailed information about the sequence of operations, including their timing, context, and interactions, to help identify performance bottlenecks, errors, and inefficiencies. Distributed transaction tracing is however not referred to database transactions but rather, in the context of Application performance monitoring, transaction tracing is regarding end-to-end request code execution that's scope reaches across one or more applications at any given time. Transaction tracing is useful in software acceleration due to its ability to identify and resolve causes of poor system performance and determining underperforming elements of the system causing software acceleration to go down.

Transaction Visibility refers to a user's ability to view current and upcoming transactions occurring within their system. This is utilized in complex, distributed systems where transactions may span multiple services, databases, and network boundaries. Transaction visibility provides insights into the performance, health, and correctness of transactions, facilitating debugging, performance tuning, and ensuring reliable operation. The foresight that transaction visibility offers users and developers help mitigate issues within their system resulting in improved software acceleration.

Translation Memory includes a database of previously translated text along with their corresponding translations. The segments of texts that are typically stored are sentences, phrases, etc. Translation memory includes but is not limited to storing translations, retrieving matches, identifying fuzzy matching (e.g., if a previous segment does not match up with a translated segment), contextual consistency, and efficiency. Translation memory is applicable to User interface translations, documentation translations and software localization. Translation memory offers several benefits such as consistency and quality assurance.

Translation (Purpose Parameter) refers to the process of converting or mapping data, functions, or values from one form to another, often between different systems, layers, or contexts. This translation helps ensure that data or functions can be understood and processed correctly by various components within a software application.

Unit Testing (AI Evaluation Functions) refers to the method of troubleshooting individual units of an AI system such as specific function, method, or algorithms to ensure proper function. This method includes but is not limited to: identifying the unit to be tested, writing a test case that properly tests the specific function, method or algorithm, writing a test case that models its behavior and running the test to obtain results.

Update (Purpose Parameter): Updating refers to the process of modifying or refining a purpose parameters to better control its behavior or function. This helps ensure that data is transferred or preserved in a desired manner. Updating is typically regarding minor changes to existing code.

Upgrade (Purpose Parameter) refers to enhancing the purpose parameter so that it can support new features, run optimally and or operate in accordance with requirements that are changing. Reasons for upgrading purpose parameters of user feedback, advancements in technology and consumer demand. Upgrading is typically regarding replacing code with a newer version.

Usability Testing (AI Evaluations Functions) refers to the assessment of how effectively and efficiently users can interact with an AI system or tool, focusing on user experience (UX), ease of use, and overall satisfaction. The goal is to ensure that the AI tool is intuitive, accessible, and meets the needs and expectations of its target users.

User interface Translation refers to the process of adapting the text and elements within a software application's user interface from one language to another. UI translation involves but is not limited to: text elements, layout adjustments, cultural adaptation date/time/number formats, input methods, accessibility, and testing.

What is claimed is:

1. A code enhancement system comprises:
a code input module operably coupled to:
receive software code for enhancement; and
store the software code;
a code sectioning module operably coupled to:
obtain a set of code enhancement parameters,
identify a set of code sectioning tools from a plurality of code sectioning tools, wherein the set of code sectioning tools includes at least one trusted code sectioning tool and a plurality of artificial intelligence (AI) code sectioning tools; and
section the software code in accordance with the set of code sectioning tools to produce a plurality of sets of AI code sections and a set of trusted code sections;
a code enhancement module operably coupled to:
obtain the set of code enhancement parameters,
identify a set of coding enhancing tools from a plurality of code enhancing tools, wherein the set of code enhancing tools includes at least one trusted code enhancing tool and a plurality of AI code enhancing tools;
enhance a code section of the set of trusted code sections and corresponding code sections of the plurality of set of AI code sections to produce an enhanced trusted code section and a plurality of enhanced AI code sections; and
an enhanced code evaluation module operably coupled to:
generate a score for the enhanced trusted sectioned code based on how well the enhanced trusted section code meets a set of objectives of the set of code enhancement parameters;
generate a plurality of scores for the plurality of enhanced AI code sections based on how well the plurality of enhanced AI sectioned codes met the set of objectives;
compare the plurality of scores for the plurality of enhanced AI code sections to the score for the enhanced trusted sectioned code;
when a score for an enhanced AI code section compares favorably to the score of the enhanced trusted code section, identify the enhanced AI code section as a favorable enhanced AI code sections; and
when one or more favorable enhanced AI code sections are identified, output the one or more favorable enhanced AI code sections.

2. The code enhancement system of claim 1, wherein the code sectioning module is further operably coupled to obtain the set of code enhancement parameters by one of:
receiving the set of code enhancement parameters via a user interface; and
auto-determining the set of code enhancement parameters based on user data.

3. The code enhancement system of claim 1, wherein a code enhancement parameter of the set of code enhancement parameters comprises:
a purpose parameter; or
an operation parameter, wherein the purpose parameter is regarding one of:
translation,
migration,
update,
upgrade,
improve software (SW) efficiencies,
improve hardware (HW) efficiencies,
expand functionality of code,
add new code to existing code, improve user experience,
add new features to existing code,
improve data management,
improved data analysis,
adherence to regulatory requirements,
improve data integrity,
adapt to new technologies,
improve user efficiency,
improve user productivity,
reduce costs from manufacturer and/or user,
score the code with respect to one or more operation parameters,
generate a confidence factor for the code, and
generate a trustworthiness factor for the code;
wherein the operational parameter is regarding one of:
quality,
security,
mitigating intellectual property risk,
context and reasoning,
improve execution speed,
reduce memory storage,
reduce central processing unit usages,
increasing parallelism,
improve robustness,
improve portability,
improve clarity,
improve performance,
improve maintainability,
improve scalability, and
improve interoperability.

4. The code enhancement system of claim 1, wherein the code sectioning module is further operably coupled to identify the set of code sectioning tools by one of:
receiving the identity of the set of code sectioning tools via a user interface; and
auto-determining the set of code sectioning tools based on the set of code enhancement parameters.

5. The code enhancement system of claim 1, wherein the code enhancement module is further operably coupled to identify the set of coding enhancing tools by one of:
receiving the identity of the set of code enhancing tools via a user interface; and
auto-determining the set of code enhancing tools based on the set of code enhancement parameters.

6. The code enhancement system of claim 1 further comprises:
a proprietary AI enhancing tool module operably coupled to:
analyze performance of the set of code sectioning tools;
based on the performance of a code sectioning tool of the set of code sectioning tools, rate reliability of the code sectioning tool to meeting corresponding objectives of the set of code enhancement parameters to produce a rating of the code sectioning tool, wherein the rating of the code sectioning tool is a factor in choosing the code sectioning tool to be in a subsequent set of code sectioning tools;
analyze performance of the set of code enhancing tools; and
based on the performance of a code enhancing tool of the set of code enhancing tools, rate reliability of the code enhancing tool to meeting corresponding objectives of the set of code enhancement parameters, wherein the rating of the code enhancing tool is a factor in choosing the code enhancing tool to be in a subsequent set of code enhancing tools.

7. The code enhancement system of claim 6, wherein the proprietary AI enhancing tool module further operably coupled to:
generate a proprietary AI code sectioning tool based on the analysis of the set of code sectioning tools, wherein the proprietary AI code sectioning tool is selectable for inclusion in the subsequent set of code sectioning tools; and
generate a proprietary AI code enhancing tool based on the analysis of the set of code enhancing tools, wherein the proprietary AI code sectioning tool is selectable for inclusion in the subsequent set of code enhancing tools.

8. The code enhancement system of claim 1 further comprises:
a code enhancing engine that includes:
a plurality of code sectioning modules that includes the code sectioning module;
a plurality of code enhancement modules that includes the code enhancement module; and
a plurality of enhanced code evaluation modules that include the enhanced code evaluation module.

9. The code enhancement system of claim 1, wherein the enhanced code evaluation module comprises:
an enhanced code scoring module operably coupled to:
generate the score for the enhanced trusted sectioned code; and
generate the plurality of scores for the plurality of enhanced AI code sections.

10. The code enhancement system of claim 1 further comprises:
a dashboard data processing module is operably coupled to the code input module, the code sectioning module, the code enhancement module, and the enhanced code evaluation module, wherein the dashboard data processing module is operably coupled to perform at least one of:
enable a graphical user interface for selecting the software code for enhancement;
enable the graphical user interface for selecting the set of code enhancement parameters;
enable the graphical user interface for selecting the set of code sectioning tools;
enable the graphical user interface for selecting the set of coding enhancing tools;
enable the graphical user interface to display the score for the enhanced trusted sectioned code;
enable the graphical user interface to display the plurality of scores for the plurality of enhanced AI code sections; and
enable the graphical user interface to display the one or more favorable enhanced AI code sections.

11. A computer readable memory comprises:
a first memory that stores operational instructions that, when executed by a code input module of a code enhancement system, causes the code input module to:
receive software code for enhancement; and
store the software code;
a second memory that stores operational instructions that, when executed by a code sectioning module of the code enhancement system, causes the code sectioning module to:
obtain a set of code enhancement parameters,
identify a set of code sectioning tools from a plurality of code sectioning tools, wherein the set of code sectioning tools includes at least one trusted code sectioning tool and a plurality of artificial intelligence (AI) code sectioning tools; and
section the software code in accordance with the set of code sectioning tools to produce a plurality of sets of AI code sections and a set of trusted code sections;
a third memory that stores operational instructions that, when executed by a code enhancement module of the code enhancement system, causes the code enhancement module to:
obtain the set of code enhancement parameters,
identify a set of coding enhancing tools from a plurality of code enhancing tools, wherein the set of code enhancing tools includes at least one trusted code enhancing tool and a plurality of AI code enhancing tools;
enhance a code section of the set of trusted code sections and corresponding code sections of the plurality of set of AI code sections to produce an enhanced trusted code section and a plurality of enhanced AI code sections; and
a fourth memory that stores operational instructions that, when executed by an enhanced code evaluation module of the code enhancement system, causes the enhanced code evaluation module to:
generate a score for the enhanced trusted sectioned code based on how well the enhanced trusted section code meets a set of objectives of the set of code enhancement parameters;
generate a plurality of scores for the plurality of enhanced AI code sections based on how well the plurality of enhanced AI sectioned codes met the set of objectives;
compare the plurality of scores for the plurality of enhanced AI code sections to the score for the enhanced trusted sectioned code;
when a score for an enhanced AI code section compares favorably to the score of the enhanced trusted code section, identify the enhanced AI code section as a favorable enhanced AI code sections; and
when one or more favorable enhanced AI code sections are identified, output the one or more favorable enhanced AI code sections.

12. The computer readable memory of claim 11, wherein the second memory further stores operational instructions that, when executed by the code sectioning module, causes the code sectioning module to obtain the set of code enhancement parameters by one of:
receiving the set of code enhancement parameters via a user interface; and
auto-determining the set of code enhancement parameters based on user data.

13. The computer readable memory of claim 11, wherein a code enhancement parameter of the set of code enhancement parameters comprises:
a purpose parameter; or
an operation parameter, wherein the purpose parameter is regarding one of:
translation,
migration,
update,
upgrade,
improve software (SW) efficiencies,
improve hardware (HW) efficiencies,
expand functionality of code,
add new code to existing code, improve user experience,
add new features to existing code,
improve data management,
improved data analysis,
adherence to regulatory requirements,
improve data integrity,
adapt to new technologies,
improve user efficiency,
improve user productivity,
reduce costs from manufacturer and/or user,
score the code with respect to one or more operation parameters,
generate a confidence factor for the code, and
generate a trustworthiness factor for the code;
wherein the operational parameter is regarding one of:
quality,
security,
mitigating intellectual property risk,
context and reasoning,
improve execution speed,
reduce memory storage,
reduce central processing unit usages,
increasing parallelism,
improve robustness,
improve portability,
improve clarity,
improve performance,
improve maintainability,
improve scalability, and
improve interoperability.

14. The computer readable memory of claim 11, wherein the second memory further stores operational instructions that, when executed by the code sectioning module, causes the code sectioning module to identify the set of code sectioning tools by one of:
receiving the identity of the set of code sectioning tools via a user interface; and
auto-determining the set of code sectioning tools based on the set of code enhancement parameters.

15. The computer readable memory of claim 11, wherein the third memory further stores operational instructions that, when executed by the code enhancement module, causes the code enhancement module to identify the set of coding enhancing tools by one of:
receiving the identity of the set of code enhancing tools via a user interface; and
auto-determining the set of code enhancing tools based on the set of code enhancement parameters.

16. The computer readable memory of claim 11 further comprises:
a fifth memory that stores operational instructions that, when executed by a proprietary AI enhancing tool module of the code enhancement system, causes the proprietary AI enhancing tool module to:
analyze performance of the set of code sectioning tools;
based on the performance of a code sectioning tool of the set of code sectioning tools, rate reliability of the code sectioning tool to meeting corresponding objectives of the set of code enhancement parameters to produce a rating of the code sectioning tool, wherein the rating of the code sectioning tool is a factor in choosing the code sectioning tool to be in a subsequent set of code sectioning tools;
analyze performance of the set of code enhancing tools; and
based on the performance of a code enhancing tool of the set of code enhancing tools, rate reliability of the code enhancing tool to meeting corresponding objectives of the set of code enhancement parameters, wherein the rating of the code enhancing tool is a factor in choosing the code enhancing tool to be in a subsequent set of code enhancing tools.

17. The computer readable memory of claim 11, wherein the fifth memory further stores operational instructions that, when executed by the proprietary AI enhancing tool module, causes the proprietary AI enhancing tool module to:
generate a proprietary AI code sectioning tool based on the analysis of the set of code sectioning tools, wherein the proprietary AI code sectioning tool is selectable for inclusion in the subsequent set of code sectioning tools; and
generate a proprietary AI code enhancing tool based on the analysis of the set of code enhancing tools, wherein the proprietary AI code sectioning tool is selectable for inclusion in the subsequent set of code enhancing tools.

18. The computer readable memory of claim 11 further comprises:
a fifth memory that stores operational instructions that, when executed by a dashboard data processing module of the code enhancement system, causes the dashboard data processing module to:
enable a graphical user interface for selecting the software code for enhancement;
enable the graphical user interface for selecting the set of code enhancement parameters;
enable the graphical user interface for selecting the set of code sectioning tools;
enable the graphical user interface for selecting the set of coding enhancing tools;
enable the graphical user interface to display the score for the enhanced trusted sectioned code;
enable the graphical user interface to display the plurality of scores for the plurality of enhanced AI code sections; and
enable the graphical user interface to display the one or more favorable enhanced AI code sections.
